(19) United States
(12) Patent Application Publication
(10) Pub. No.: US 2005/0181765 A1
(43) Pub. Date: Aug. 18, 2005

(54) System and method of controlling access and credentials for events

(76) Inventor: Gerald Mark, Los Angeles, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/056,523

(22) Filed: Feb. 11, 2005

Related U.S. Application Data
(60) Provisional application No. 60/544,808, filed on Feb. 13, 2004.
(60) Provisional application No. 60/558,808, filed on Apr. 2, 2004.
(60) Provisional application No. 60/559,662, filed on Apr. 5, 2004.
(60) Provisional application No. 60/625,930, filed on Nov. 8, 2004.

(51) Int. Cl. H04M 1/66; H04M 1/68; H04M 3/16

(52) U.S. Cl. 455/411; 455/410

(57) ABSTRACT

Registrants or representatives request access levels and provide information to the event organizers. The information can be personal identification information, the company they represent, the work they will perform at the event, the resources they will require, and the like. Administrators review the requests and information to decide which areas the registrants will be allowed to access at the event. The registrants receive credentials, which permit the registrants' physical access to the approved event areas.

This application claims the benefit of priority under 35 U.S.C. § 119(e) of U.S. Provisional Application No. 60/544,808 filed on Feb. 13, 2004, and entitled SYSTEM AND METHOD OF CONTROLLING ACCESS AND CREDENTIALS FOR EVENTS, U.S. Provisional Application No. 60/558,808 filed on Apr. 2, 2004 and entitled SYSTEM AND METHOD OF CONTROLLING ACCESS AND CREDENTIALS FOR EVENTS, U.S. Provisional Application No. 60/559,662 filed on Apr. 5, 2004 and entitled SYSTEM AND METHOD OF CONTROLLING ACCESS AND CREDENTIALS FOR EVENTS, U.S. Provisional Application No. 60/625,930 filed on Nov. 8, 2004 and entitled SYSTEM AND METHOD OF ASSIGNING SEATS AND/OR TABLES, AS WELL AS ISSUING PERSONALIZED TICKETS FOR PATRONS ATTENDING EVENTS, the entirety of which are incorporated herein by reference.

### FIELD OF THE INVENTION

The invention relates generally to controlling access and credentials for events.

### SUMMARY OF THE INVENTION

Embodiments of the invention provide on-line registration systems and methods that provide for the efficient and straightforward creation of access control and credentialing processes. In an embodiment, the event registrant/representative can obtain a unique user ID/password or master EC ID and enter the site to register for one or multiple events by selecting from a list of events and filling out a separate registration form for each event that will be housed in each event's specific database or table. In another embodiment, the registrant/representative could select from a list of hyperlinks that are attached to a registration form on an event's server and submit a registration form for that specific event independent of the EC software and server(s). In another embodiment, the registrant/representative could select from a list of events on a web site and submit one standard form that would be sent to the administrator results areas for multiple selected events and could be viewed individually by each event's administrator in each event's specific database(s) or table(s). In another embodiment the registrant/representative could select from a list of events on a web site and submit one standard form that would be sent to the event organizer via email, fax, wireless communications devices and the like.

In an embodiment, an event has associated physical areas and access levels, where event organizers limit a number of people allowed in each physical area for security purposes, safety regulations, and safety considerations, and to permit the event to run smoothly. In an embodiment, a method of controlling access and credentials to the event comprises receiving a request by a registrant for one or more individuals associated with the registrant for access to an event, presenting the registrant with the terms and conditions of the event over a network, and receiving an acceptance of the terms and conditions from the registrant over the network. The method further comprises presenting the registrant with a registration form over the network after the registrant has accepted the terms and conditions of the event, receiving a completed registration form comprising requests to access levels for the event and registration information over the network, and storing requests for the access levels and registration information in a database. The method further comprises confirming receipt of the completed registration form to the registrant over the network, receiving changes to the registration network over the network, modifying the database to include results of an approval process based on the registration information, and notifying the registrant of the results of the approval/denial process. The results of the approval process comprise one of an approved status, a denied status, and an undecided status. The method further comprises presenting the registrant having access approval with at least one credential and granted access level over a network, receiving from the registrant background information of the individual assigned the credential over the network, automatically decrementing a quantity of assigned credentials and access levels after the registrant assigns the credential and access level to each individual over the network, and modifying the database to include the results of the approval process based on the background information.

In an embodiment, a method of controlling access and credentials to an event having associated access levels comprises receiving a request for access to an event by a registrant for one or more individuals associated with the registrant for an event, presenting the registrant with the terms and conditions of the event over a network, and receiving an acceptance of the terms and conditions from the registrant over the network. The method further comprises presenting the registrant with a registration form over the network after the registrant has accepted the terms and conditions of the event, receiving a completed registration form comprising requests to the access levels for an event and registration information over the network, storing requests for the access levels and registration information in a database, and confirming receipt of the completed registration form to the registrant over the network. The method further comprising modifying the database to include a status of the requests for the access levels, notifying the registrant of access approval, presenting the registrant having access approval with at least one credential and granted access level over a network, and receiving from the registrant background information of the individual assigned the credential over the network.

In an embodiment, a method of controlling access and credentials to an event, where the event is associated with access levels comprises receiving a request for access to an event by a registrant, wherein the registrant represents one or more individuals, presenting the registrant with a registration form over the network after the registrant has accepted terms and conditions of the event, and receiving a completed registration form comprising requests to access levels for an event and registration information over the network. The method further comprises storing requests for the access levels and registration information in a database, modifying the database to include a status of the requests for the access levels, and presenting the registrant having access approval with at least one credential and granted access level over a network.

In an embodiment, article of manufacture comprises a computer readable medium having computer readable program code embodied therein, where the computer readable program code causes a computer to execute a process of controlling access and credentials to an event having associated access levels. The article of manufacture comprises computer readable program code configured to receive a request by a registrant for one or more individuals associated with the registrant for access to an event, computer readable program code configured to present the registrant with a registration form over the network after the registrant has accepted terms and conditions of the event, and computer readable program code configured to receive a completed registration form comprising requests to access levels for an event and registration information over the network. The article of manufacture further comprises computer readable program code configured to store requests for the access levels and registration information in a database, computer readable program code configured to modify the database to include results of an approval process and computer readable program code configured to present the registrant having access approval with at least one credential and granted access level over a network.

In an embodiment, an apparatus for controlling access and credentials to an event having associated access levels, comprises means for receiving a request by a registrant for one or more individuals associated with the registrant for access to an event, means for presenting the registrant with a registration form over the network after the registrant has accepted terms and conditions of the event, and means for receiving a completed registration form comprising requests to access levels for an event and registration information over the network. The apparatus further comprises means for storing requests for the access levels and registration information in a database, means for modifying the database to include a status of the requests for the access levels, and means for presenting the registrant having access approval with at least one credential and granted access level over a network.

In an embodiment, an apparatus for controlling access and credentials to an event having associated access levels comprises a server comprising a computer processor, a computer storage medium, and a database stored in the computer storage medium. The computer processor including arithmetic logic circuits performs the computer-implemented steps of receiving a request for access to an event by a registrant for one or more individuals associated with the registrant for an event, presenting the registrant with the terms and conditions of the event over a network, and receiving an acceptance of the terms and conditions from the registrant over the network. The computer processor further performs the computer-implemented steps of presenting the registrant with a registration form over the network after the registrant has accepted the terms and conditions of the event, receiving a completed registration form comprising requests to the access levels for an event and registration information over the network, and storing requests for the access levels and registration information in a database. The computer processor further performs the computer-implemented steps of confirming receipt of the completed registration form to the registrant over the network, modifying the database to include a status of the requests for the access levels, and notifying the registrant of access approval. The computer processor further performs the computer-implemented steps of presenting the registrant having access approval with at least one credential and granted access level over a network, and receiving from the registrant background information of the individual assigned the credential over the network.

In an embodiment, an apparatus for controlling access and credentials to an event having associated access levels comprises the computer implemented steps of receiving a request for access to an event by a registrant, wherein the registrant represents one or more individuals, presenting the registrant with a registration form over the network after the registrant has accepted terms and conditions of the event, and receiving a completed registration form comprising requests to access levels for an event and registration information over the network. The apparatus further comprises the computer-implemented steps of storing requests for the access levels and registration information in a database, modifying the database to include a status of the requests for the access levels, and presenting the registrant having access approval with at least one credential and granted access level over a network.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements.

FIG. 1 illustrates a block diagram illustrating an embodiment of an online credential registration and access control system.

FIG. 2 illustrates another embodiment of an online credential registration and access control system.

FIG. 3A-B illustrate an embodiment of a media registration process.

FIG. 4A-B illustrates another embodiment of a media registration process.

FIG. 5 illustrates an exemplary screen shot of an embodiment of a login form.

FIG. 6A-F illustrates exemplary screen shots of another embodiment of a user ID and password request process.

FIG. 7 illustrates exemplary screen shot of an embodiment of a user ID/Password Reminder Form.

FIG. 8A-B illustrates exemplary screen shots of an embodiment of an agreement.

FIG. 9A-K illustrates exemplary screen shots of an embodiment of a media credential form.

FIG. 10 illustrates an exemplary screen shot of an embodiment of a confirmation form.

FIG. 11A-E illustrates exemplary screen shots of an embodiment of a phone and modem order form.

FIG. 12A-B illustrates exemplary screen shots of an embodiment of a registration form in which the previous registration information can be viewed or edited.

FIG. 13A-G illustrates exemplary screen shots of an embodiment of a media background check information form.

FIG. 14A-E illustrates exemplary screen shots of an embodiment of a media background check information form showing an automatic reduction of access area allotment.

FIG. 15A-E illustrates exemplary screen shots of an embodiment of a publicist credential form.

FIG. 16 illustrates an embodiment of a production/crew registration process.

FIG. 17 illustrates another embodiment of a production/crew/artist registration process.

FIG. 18 illustrates another embodiment of a production/crew/artist registration process.

FIG. 19 illustrates another embodiment of a production/crew/artist registration process.

FIG. 20A-B illustrates exemplary screen shots of an embodiment of a production or vendor or artist or fan or guest registration form.

FIG. 21A-E illustrates exemplary screen shots of another embodiment of a production or vendor or artist or fan or guest registration form.

FIG. 22A-F illustrates exemplary screen shots of an embodiment of a pre-assigned vendor/production user ID and password login and registration area.

FIG. 23A-B illustrates exemplary screen shots of an embodiment of an administrator login form.

FIG. 24A-D illustrates an exemplary screen shot of an embodiment of an administrator results selection area screen.

FIG. 25A-F illustrates an exemplary screen shot of an embodiment of an administrator new, approved, denied, and display all record/form results review areas.

FIG. 26A-C illustrates exemplary screen shots of an embodiment of an administrator media record review form.

FIG. 27A-K illustrates exemplary screen shots of an embodiment of an administrator background check review form.

FIG. 28A-B illustrates exemplary screen shots of an embodiment of a credentials total area.

FIG. 29A-B illustrates exemplary screen shots of an embodiment of a credential status letter generator area.

FIG. 30A-F illustrates exemplary screen shots of an embodiment of a production user ID and password generator for vendors or production crew by vendor or production administrators, respectively.

FIG. 31A-M illustrates exemplary screen shots of an embodiment of a user ID and password data review area and mass update tool.

FIG. 32A-O illustrates exemplary screen shots of an embodiment of product and vendor credential request review area.

FIG. 33A-J illustrates exemplary screen shots of an embodiment of the administrator access rights assignment area.

FIG. 34A-B illustrates exemplary screen shots of an embodiment of a workstation view at a credential center or via a remote server connected through the internet and the like.

FIG. 35A-B illustrates exemplary screen shots of an embodiment of an administration log-in and view at a credentialing center or via a remote server connected through the internet and the like.

FIG. 36A-C illustrates exemplary screen shots of an embodiment of administrator functions and column grid view.

FIG. 37A-B illustrates exemplary screen shots of an embodiment of access control counting function.

FIG. 38A-D illustrates exemplary screen shots of an embodiment of how the credential software can be searched and filtered.

FIG. 39A-N illustrates exemplary screen shots of an embodiment of the administrative area that allows for the real-time customization/configuration of the credential software infrastructure.

FIG. 40A-D illustrates exemplary screen shots of an embodiment that shows the View Expiration Grid.

FIG. 41A-B illustrates exemplary screen shots of an embodiment that shows how once a record is located in the database, the operator whether in workstation or administrator mode can attach a photo, scan an RFID chip and or the like, and print a credential.

FIG. 42 illustrates an embodiment of a physical credentialing process.

FIG. 43A-D illustrates front views of exemplary credentials, according to an embodiment of the invention.

FIG. 44A-B illustrates back views of exemplary credentials, according to an embodiment of the invention.

FIG. 45A-C illustrates exemplary screen shots of an embodiment of the scanning software and display screen used to read credentials/tickets at an event.

FIG. 46A-B illustrates an exemplary front and back view, respectively, of a parking credential, according to an embodiment of the invention.

### DETAILED DESCRIPTION OF THE PREFERRED EMBODIMENT

For a more detailed understanding of the invention, reference is made to an exemplary embodiment usable in, for example, the entertainment industry. However, an artisan will recognize from the disclosure herein, more general applicability to many different industries and many different applications.

An event is an organized gathering of people that may involve relatively few people to more than 15,000 participants. This invention is particularly advantageous for events with a substantially large number of participants. The event venue often comprises several physical areas or access levels. Event organizers may limit the number of people allowed in each area for security purposes, safety regulations, safety considerations, and the like. The number of people allowed access to specific areas is often limited to allow the event to run smoothly.

To request access to an event, an individual registers for the event. In an embodiment, a representative for a group of people may register for the group instead of each person registering individually.

During the registration process, the individual registrant or group representative requests credentials for the event. In an embodiment, the individual registrant or group representative requests credentials, and access levels to specific areas of the venue.

Credentials are often associated with physical areas or access levels of an event. A large venue can have many different locations or access levels within the event. Each location can require differing amounts of security and access control.

Credentials can be simple, such as, for example, allowing individuals access to an easily enforced common area set by predetermined boundaries. Further, credentials can be very complex, such as, for example, allowing certain individuals access to multiple areas or access levels of the venue.

A registrant or representative requests a specific type of credential(s) associated with the required function they are to perform at the event. There can be numerous types of credentials requested and issued for an event. If the event is an award show, examples of credential types can be media, publicist, production staff and crew, artists, audience members, fans, security, other vendors, and the like. Within a credential type, additional credential types may be further defined. For example, in an embodiment, media credentials can be further defined as photo credentials, print credentials, radio credentials, television credentials, messenger credentials, technical assistant credentials, and the like.

Further, in an embodiment, the registrant or representative requests access to other specific areas of the venue or access levels that are needed for the function they are to perform at the event.

In another embodiment, the online credential registration and access control system can automatically assign access levels to the requested credential(s). The automatically assigned access levels are associated with a credential type or a group's function at the event. The administrator(s), usually at the initial launching of the system for their event, predetermine the automatically assigned access levels associated with the credential(s). The administrator can also assign levels to individual's or group's after registration of such parties has occurred.

For example, a photographer at an awards show requests a media photo credential for the event. The event organizer can associate the media photo credential with specific access levels, such as for example, the general photo room. In addition, the photographer can request access to additional areas, such as, for example, the arrivals area, the digital transmission room, and the like. These are areas of the event that the photographer needs to access in order to perform his job functions.

In addition to requesting credentials, registrants, or representatives provide information to the event organizers. The information can be personal identification information, the company they represent, the work they perform at the event, the resources they require, and the like. Required resources can be, for example, cable hookups, telephones, parking, and the like.

Administrators review the credential or access level requests and background information. Administrators modify, grant, or deny the registrants' and representatives' credential requests during the registration process or even after the registration is closed. In an embodiment, administrators may modify the access levels associated with an approved credential for a specific individual or a specific group of individuals. Thus, the administrators decide which areas of the venue the registrants will be allowed to access before, during, or after the event.

When the event is an award show, for example, the venue may be partitioned into areas, such as, for example, the arrivals area, the media facility, the photo room, the general media room, the digital transmission room, and the like. Each area of the venue has an associated access level. A media representative that desires to cover this event, for example, may request three media television credentials and a media photographer credential. A vendor responsible for installing the red carpet, for example, may request access specifically to the arrivals area.

The administrator(s) reviews the requests. The administrator can, for example, approve two of the media television credential requests and the media photographer credential request and deny one of the media credential requests. The approved media credentials allow three individuals to each access the access levels at the event associated with the media credential, such as, for example, the media facility and the general media room. Further, the administrator can modify, for example, the access levels associated with one of the media credentials to also allow access to the arrivals area.

Further, for example, the administrator can approve access to the arrivals area to the carpet installer vendor. The system would recognize employees of the carpet vendor and would automatically provide them with access to a predetermined area(s), for example the arrivals area, that they need access in order to perform their function.

Using the system, the administrator(s) inform the registrant/representative whether their requests are approved or denied. If a representative has been granted multiple credentials for their company, they then assign the credentials granted to registrants within their company.

In an embodiment, the registrants supply additional background information. In another embodiment, a security check is performed using the background information. After the registrants supply the background information and pass the security check, the registrants are approved to receive a physical credential.

Granted credentials and the associated access areas are recorded in the registrant's unique credential record and are incorporated into the registrant's physical credential when it is issued. A physical credential permits the individual approved for the credential to enter the access levels associated with the granted credential. In an embodiment, a physical credential can be a simple color-coded card. In another embodiment, the physical credential can be a card with an embedded radio frequency chip, which is programmed with, or used as an identification tracker to locate, the access levels associated with the granted credential. An individual presents the physical credential to gain access to the venue and/or to areas throughout the venue.

Embodiments of the invention enable administrators to very efficiently review thousands of applications. If more than one administrator is granting the access level approval, as may be the case for a large event, the administrators can efficiently coordinate their approvals. In an embodiment one administrator may be responsible for assigning access and approving multiple vendors working the event, while another administrator may be responsible for assigning access and approving production crew members working the event.

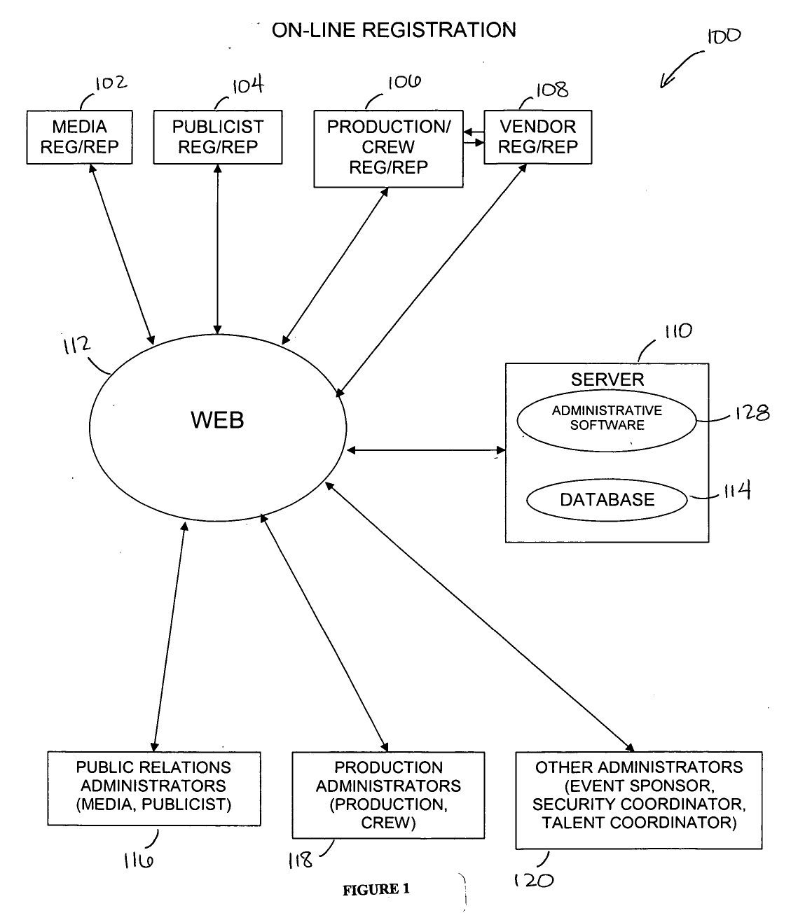

FIG. 1 illustrates an embodiment of an online credential registration and access control system 100. Registrants, such as, for example, media registrants 102, publicist registrants 104, production/crew registrants 106, vendor registrants 108, and the like, request credentials to an event through an online registration process. In addition, often times a common point of contact for registration is determined at a company. This representative is responsible for requesting credentials, and assigning to individuals within the representative's company the credentials granted to that company by the event's administrator. In an embodiment, representatives also provide the administrators with the individuals' background information. Thus, representatives from, for example, the media, publicists, production/crew, vendors, event sponsors, security, the audience, talent and artists, coordinators, and the like, also request credentials for an event through an online registration process.

The access levels associated with these credentials are built into online processes and administrative software 128 residing in a server 110. The registrants and representatives 102, 104, 106, 108 submit their requests and information to the server 110 via a communication medium 112. The requests and information are stored in a database 114.

In one embodiment, the communications medium 112 is the Internet, which is a global network of computers. In other embodiments, the communications medium 112 can be any communication system including by way of example, dedicated communication lines, telephone networks, wireless data transmission systems, two-way cable systems, customized computer networks, interactive kiosk networks, personal digital assistant devices, interactive television networks, cellular phone networks, wireless communication devices/networks, and the like.

An administrator grants credentials with associated access levels to the registrants and representatives 102, 104, 106, 108. In an embodiment, a public relations administrator 116 grants credentials with associated access levels to the media and publicist registrants and representatives 102, 104. In another embodiment, a production administrator 118 grants credentials with associated access levels to registrants and representatives, such as the production, crew, and vendor registrants and representatives 106, 108. In another embodiment, other administrators 120 grant credentials with associated access levels to registrants and representatives, such as audience, event sponsors, security coordinator, and talent coordinator registrants and representatives.

In yet another embodiment, the registrants and representatives request specific access levels according to the task they are to perform at the event. For example, electricians request specific access to the physical area requiring electrical work. In this embodiment, the production administrator 118 grants access levels to the production, vendor, audience, crew, talent coordinator, event coordinator, and the like, registrants and representatives 102, 104, 106, 108.

In yet another embodiment, administrators 116, 118, 120 could associate pre-assign access levels to the unique user identification and password used to login to the system. When these users login, they are prompted to fill out their contact and background information. Their access levels are pre-assigned prior to login and they only need to submit background information. In another embodiment the users may also be able to request additional access levels not already granted to them. In an embodiment, an administrator could change pre-assigned access levels later for any individual or group of individuals.

The software 128 allows the administrators 116, 118, 120 to control the request process and the granting of credentials and access levels to registrants and representatives 102, 104, 106, 108. In addition, the software 128 allows the administrators 116, 118, 120 to control the quantity of records submitted for the predetermined areas and to control the quantity of allocated credentials and access levels. The software 128 indicates to the registrant or representative 102, 104, 106, 108 which types of credentials or access levels have been granted, and furthermore, how many individuals may use the credentials associated with those areas. The administrator 116, 118, 120 controls the entire process from the online administrative area using the software tools.

If the administrator 116, 118, 120 decides that a registrant or company representative 102, 104, 106, 108 will only be allowed two credentials with specific access rights, for example, that individual or company can only select the number and type of credentials the administrator 116, 118, 120 has granted. Once they have exhausted their granted credentials, the software 128 automatically turns off the submit function associated with their quantity of granted credentials and access levels barring them from further submissions of registrants 102, 104, 106, 108. The software 128 automatically cross references quantities of credentials and access levels granted with quantities of credentials and access levels submitted, thus controlling the total number of people allowed to access any area of the event.

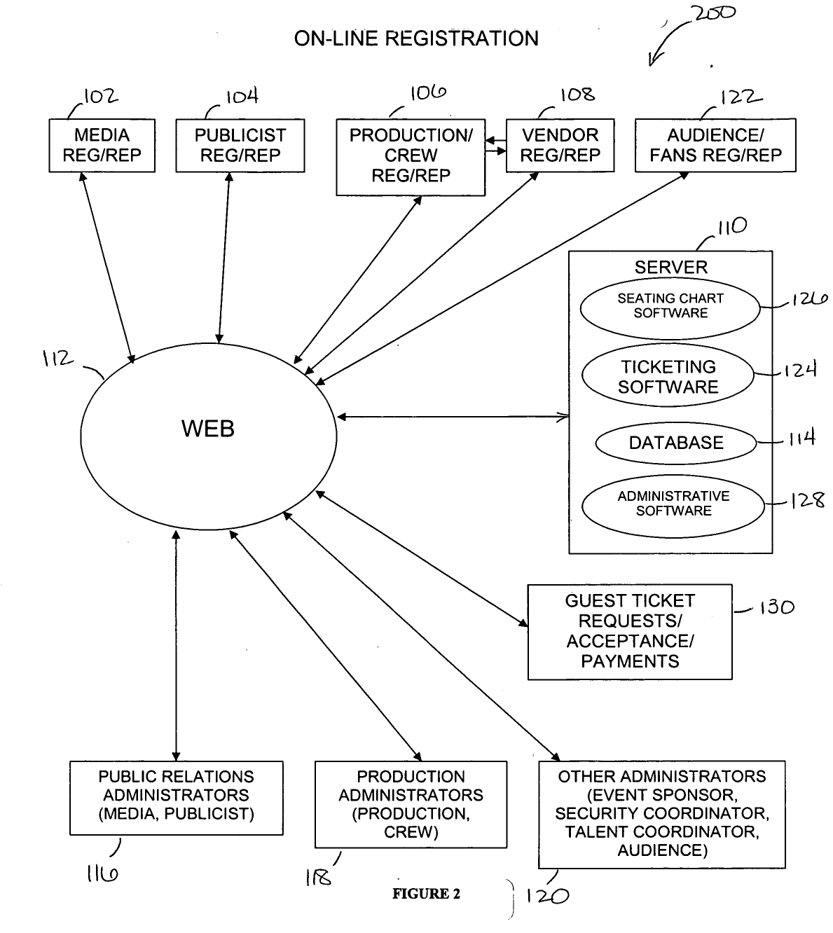

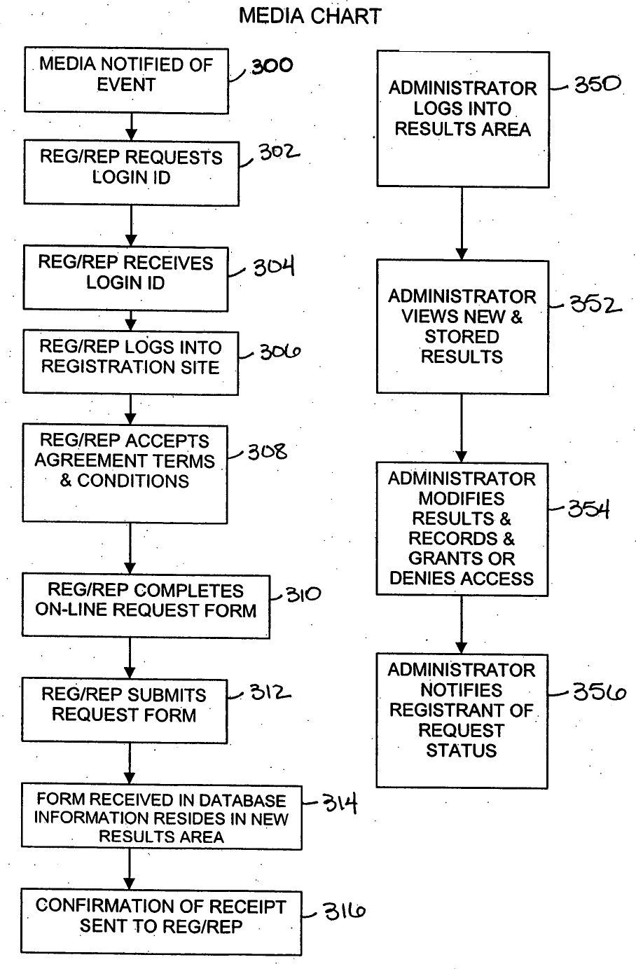

FIG. 2 illustrates another embodiment of an online credential registration and access control system 200. In addition to the media, publicist, production/crew, and vendor registrants and representatives, 102, 104, 106, 108 referenced in FIG. 1, the embodiment of FIG. 2 also comprises audience/fans registrants and representatives 122. Thus, audience registrants and representatives 122 also request access, such as tickets to attend the event, through an online registration process.

Ticket requests are built into the online process and ticketing software 124 residing in the server 110. The software 124 comprises an event-seating chart 126. In one embodiment, the audience registrants 122 submit their requests and information 130 to the software residing in the server 110 via the communication medium 112. In another embodiment, the audience 122 is represented by a representative who submits the requests and information to the software residing in the server 110. The requests and information are stored in the database 114.

The software 124 allows for the administrators 120 to control the request process and the granting of event tickets to audience registrants 122 as well as to control how many records are submitted for the predetermined seating areas. In one embodiment, the administrator 120, through the ticketing software, indicates to the audience registrant 122 whether event tickets have been granted, and furthermore, which seats are assigned to the audience registrant 122. The administrator 120 controls the entire process from the online administrative area using the software tools.

If the administrator 120 grants twenty tickets, for example, to the registrant or audience representative 122, that individual or company cannot select more than the number of tickets the administrator 120 has granted. Once they have used their allotted number of tickets the software 124 automatically turns off the submit function associated with the granted quantity of tickets, barring them from further submissions of audience members. The software 124 will automatically cross-reference the quantity of tickets granted with the number of potential ticket holders submitted, thus controlling, the total numbers of tickets and seating for the event.

### Registrants Request Access

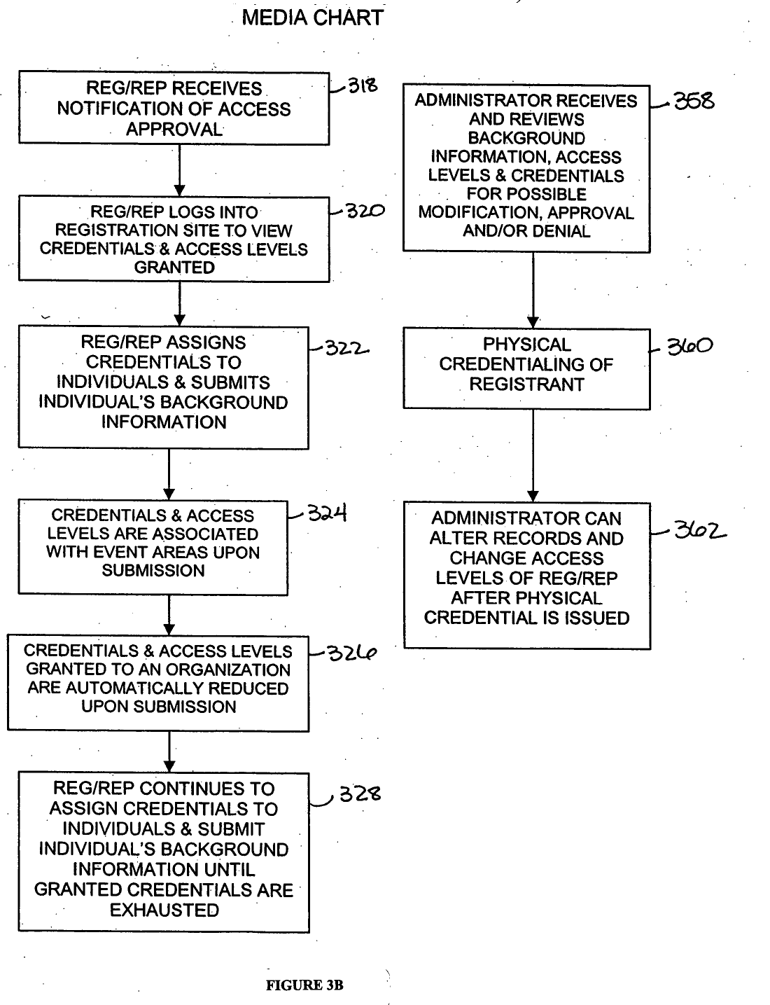

FIGS. 3AB and 4A-B illustrate embodiments of a media registration process. In blocks 300, 400, potential media companies and outlets are notified about an upcoming event. If they are interested in attending the event, or covering the event, they will need to request access to the event's venue. Media outlets, with more than one registrant, often designate one representative within the company to request credentials for a group of registrants from that company.

The media registrants or representatives 102 log onto the event's official web site and navigate their way through the event's web site to the event registration page. At this point, the users have left the event web site and are now on the credentialing registration and access control server 110 of FIG. 1 and FIG. 2. A seamless transition has occurred from the event site to the server 110. In an embodiment, the access control and credentialing web pages look identical to the event's web pages so that the user is unaware of having left the original site and is now on a secured dedicated server 110 using SSL technology. In another embodiment, the software could be housed directly on the client's server(s).

Once at the event registration page, the registrant, or representative 102 is directed to a user identification and password login. If the registrant or representative 102 has not previously been provided with a unique user identification and password, they are asked to obtain this information.

In block 302, the user, who has not previously registered, requests a user identification and password to the credentialing registration and access control server 110. In block 304, the server 110 generates the identification and password, and transmits the identification and password to the user. In an embodiment, email is typically employed to request the identification and to transmit the identification to the registrant or representative 102. In another embodiment, telephone, fax, and the like can be used to request and transmit the identification. Once the user receives the login information, the registrant or representative 102 enters the information into the login area in block 306.

In another embodiment, the user, who has previously registered, logs into a personal registration area using the previously acquired login identification. The user can view multiple event invitations. The user selects the event for registration and enters the login information into the login area.

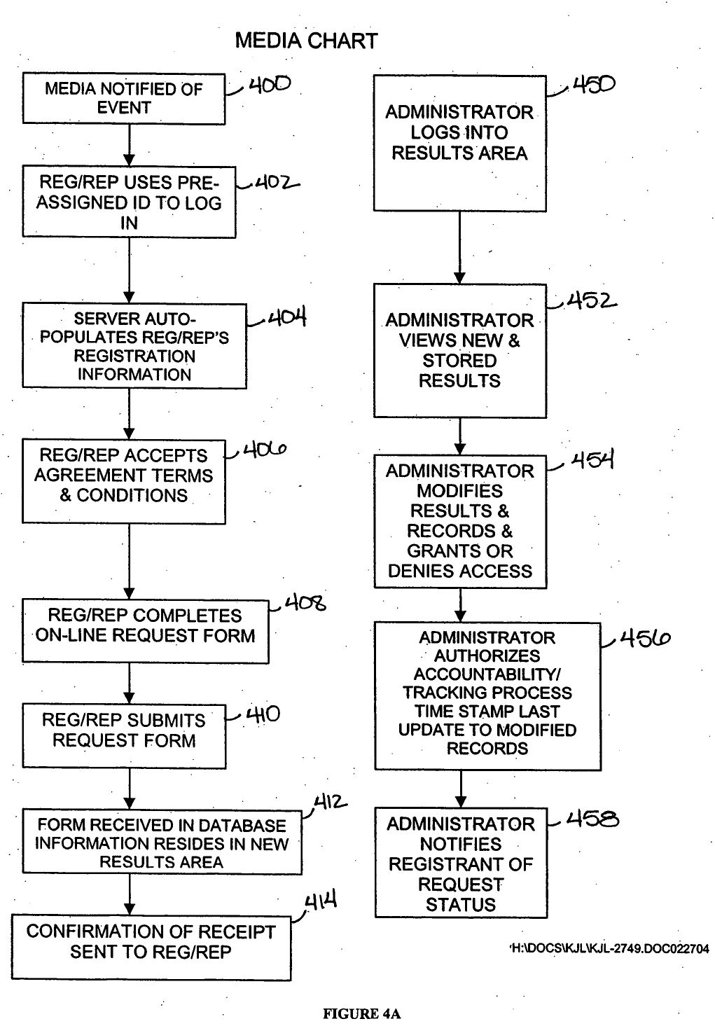

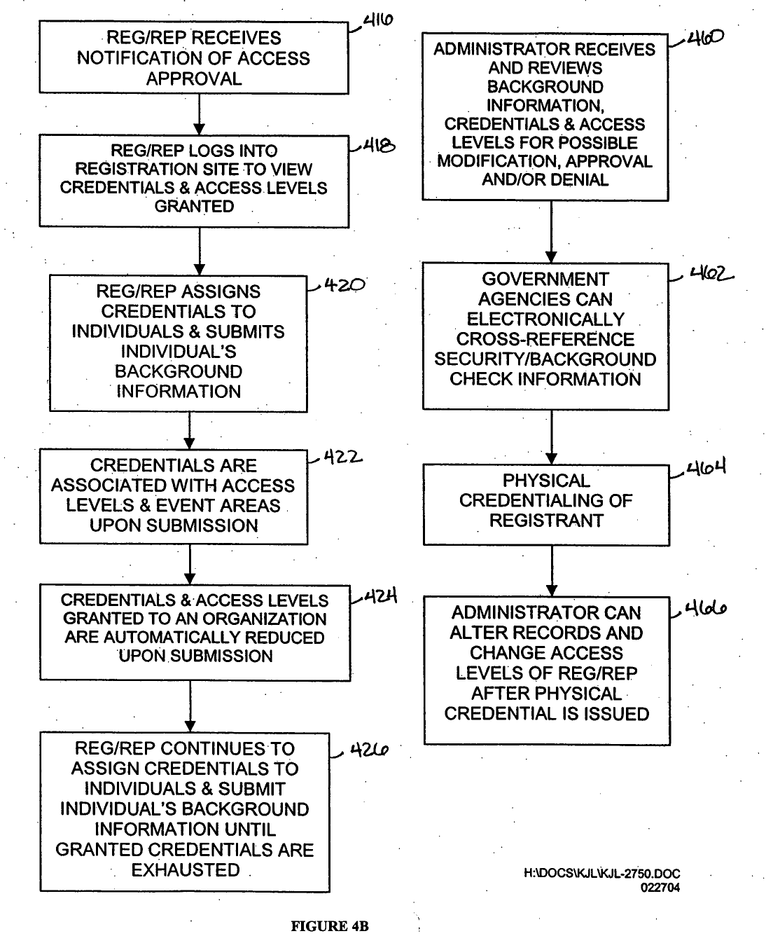

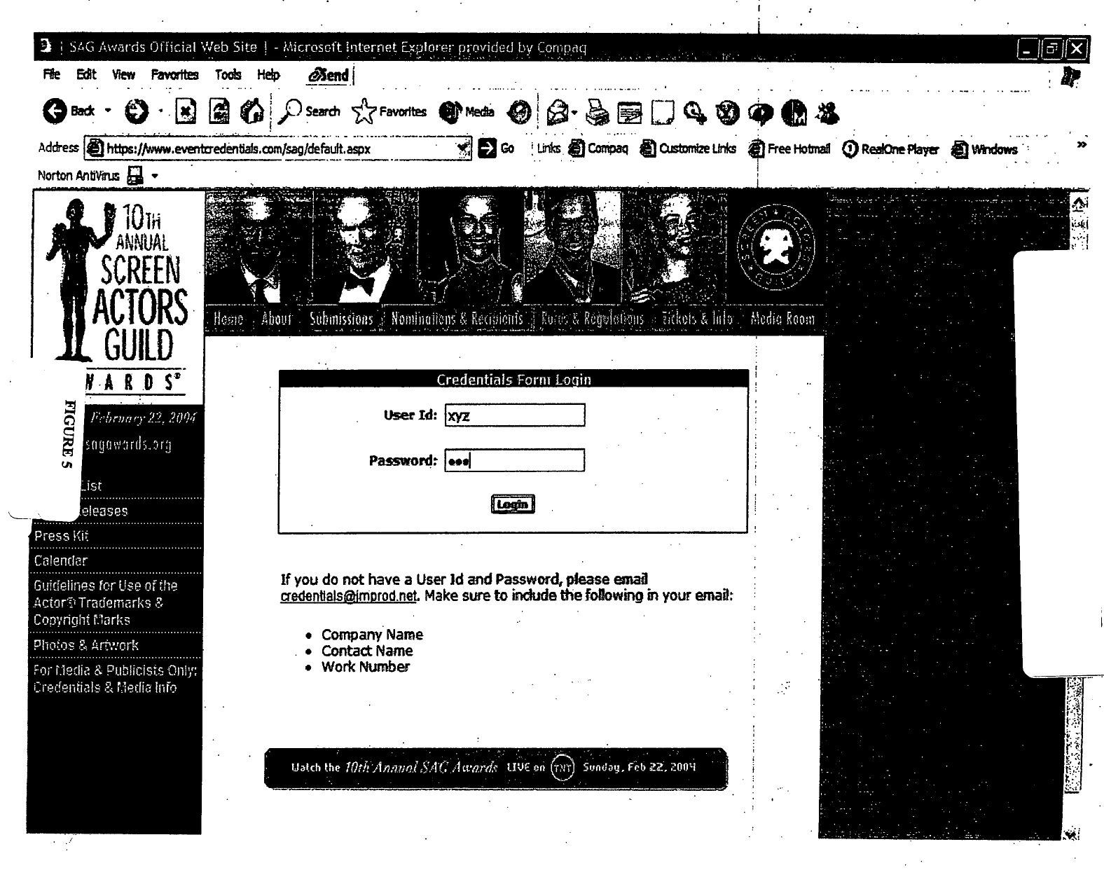

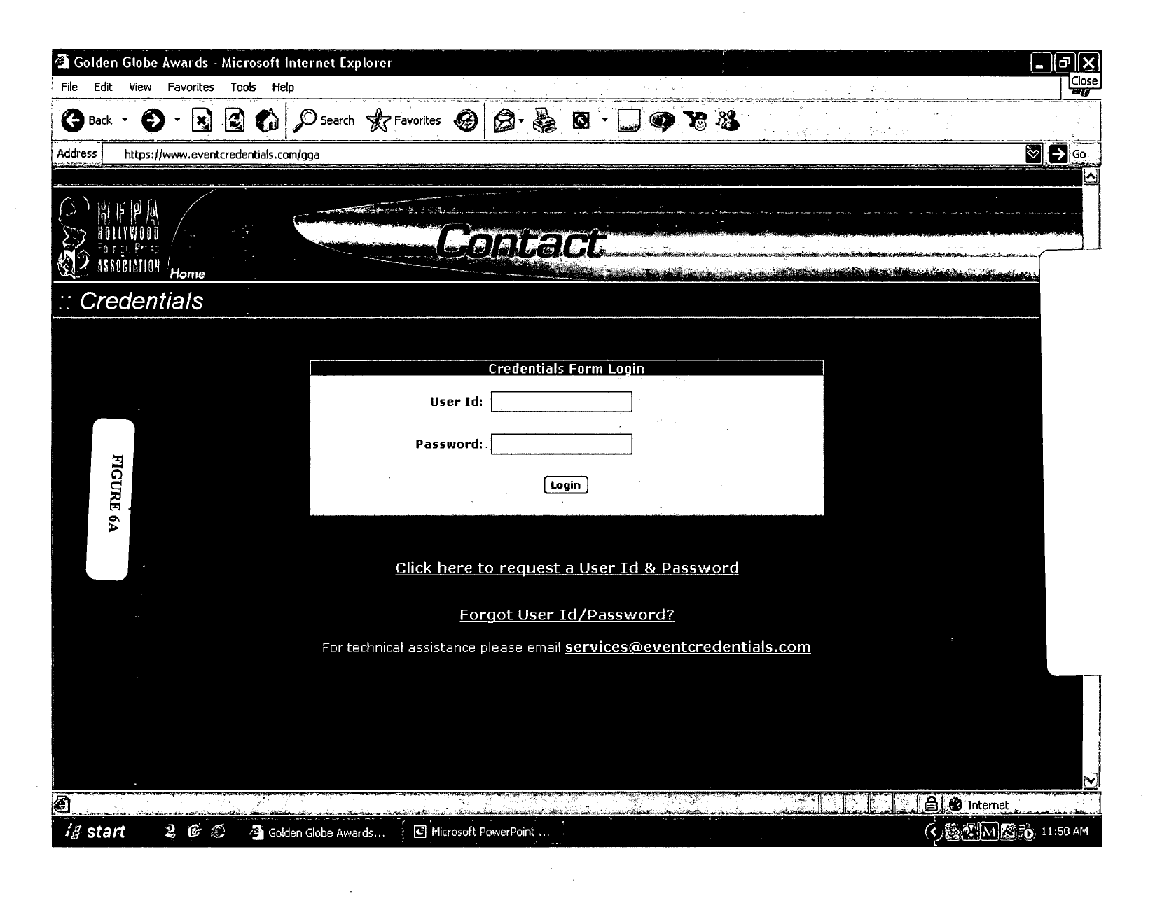

Referring to FIG. 4A, in block 402 the user logs in to the site using a pre-assigned login identification. A media outlet, for example, that typically attends many entertainment award shows, may be assigned a login identification. The assigned login identification is associated with information that the media outlet typically provides when registering. For example, if the same employees of the media outlet attend the events repeatedly, then the same credential requests and background information would be provided to the administrators 116 at each registration.

In block 404, the server 110 auto-populates the registration information for the registrant and representative 102 having a pre-assigned login identification. The registrant and representative 102 review the information and modify the information as appropriate.

In an embodiment, individuals who repeatedly attend events to perform a function or for any other reason, may be issued their own personalized identification card with a radio frequency identification (RF ID) chip or other form of technology embedded into the card as well as a unique user identification number and photo attached to the card. This card could be used as the credential or a part of the credential for numerous events. For example, such individuals would still be required to register for the event and be granted access level rights by the event administrator for a specific event, but their card would just be activated for the specific event and serve as their credential for that event. The card could also be temporally inserted into a physical credential casing provided for that specific event on day of event. Thus allowing these individuals to avoid repeating physical credentialing process described herein for every event they are attending.

FIG. 5 illustrates an exemplary screen shot of a login form. The registration software directs the user to the first step in the registration process.

Referring to FIGS. 3A and 4A, in blocks 308, 406, respectively, the registration process directs the media registrants and representatives 102 to an agreement that requires reading and accepting the terms and conditions of the event's organizers in order to access the event should their credential request be accepted by the event's organizers.

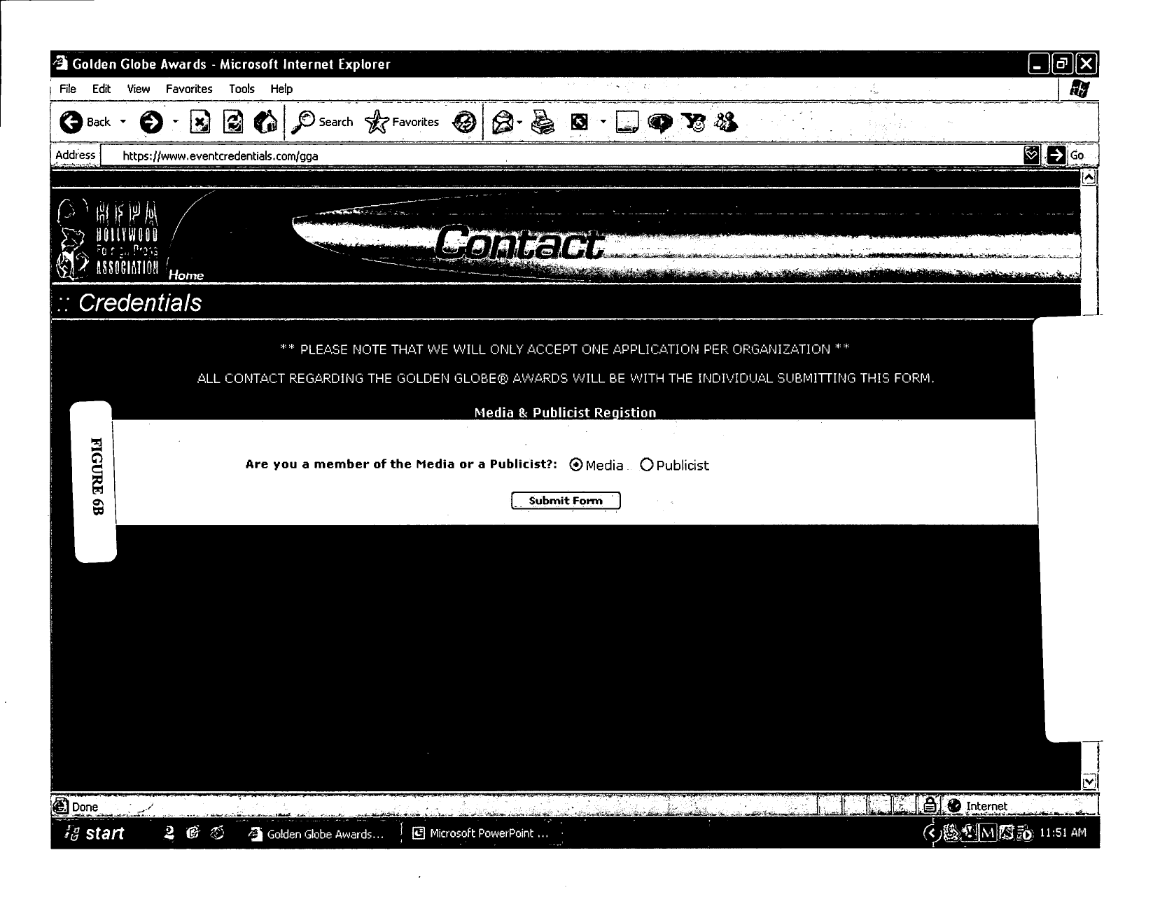

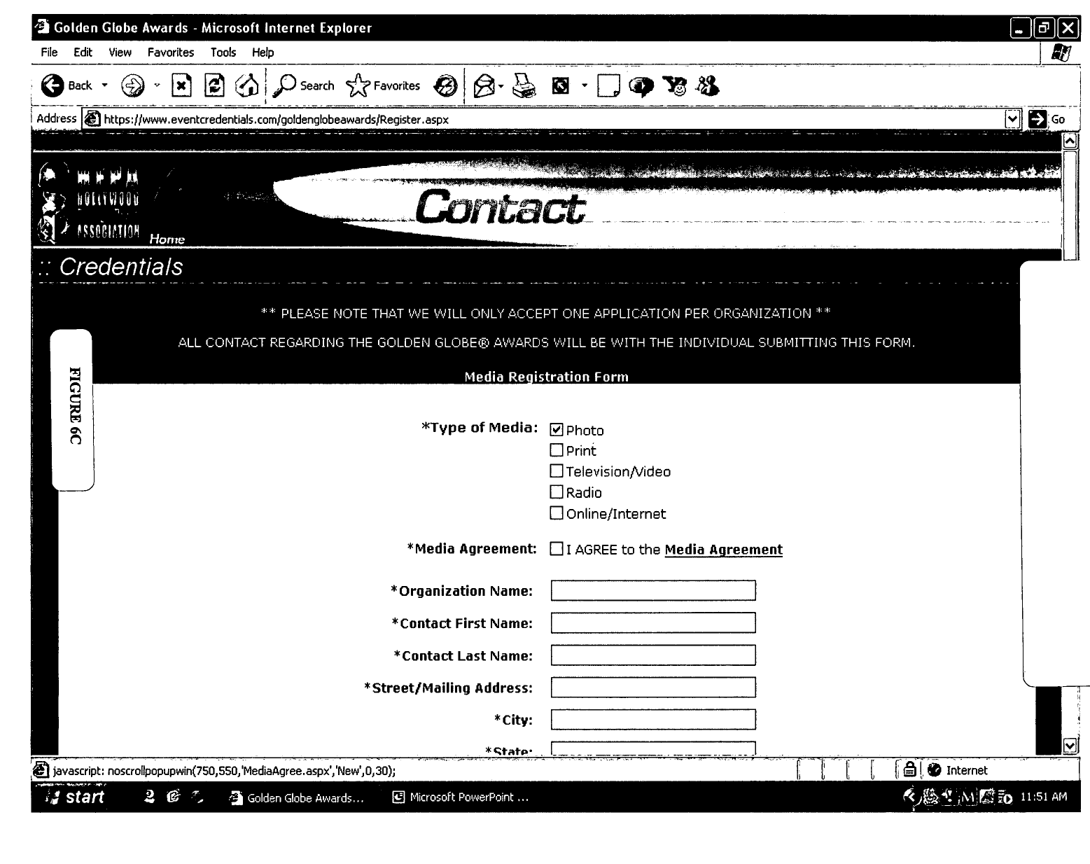

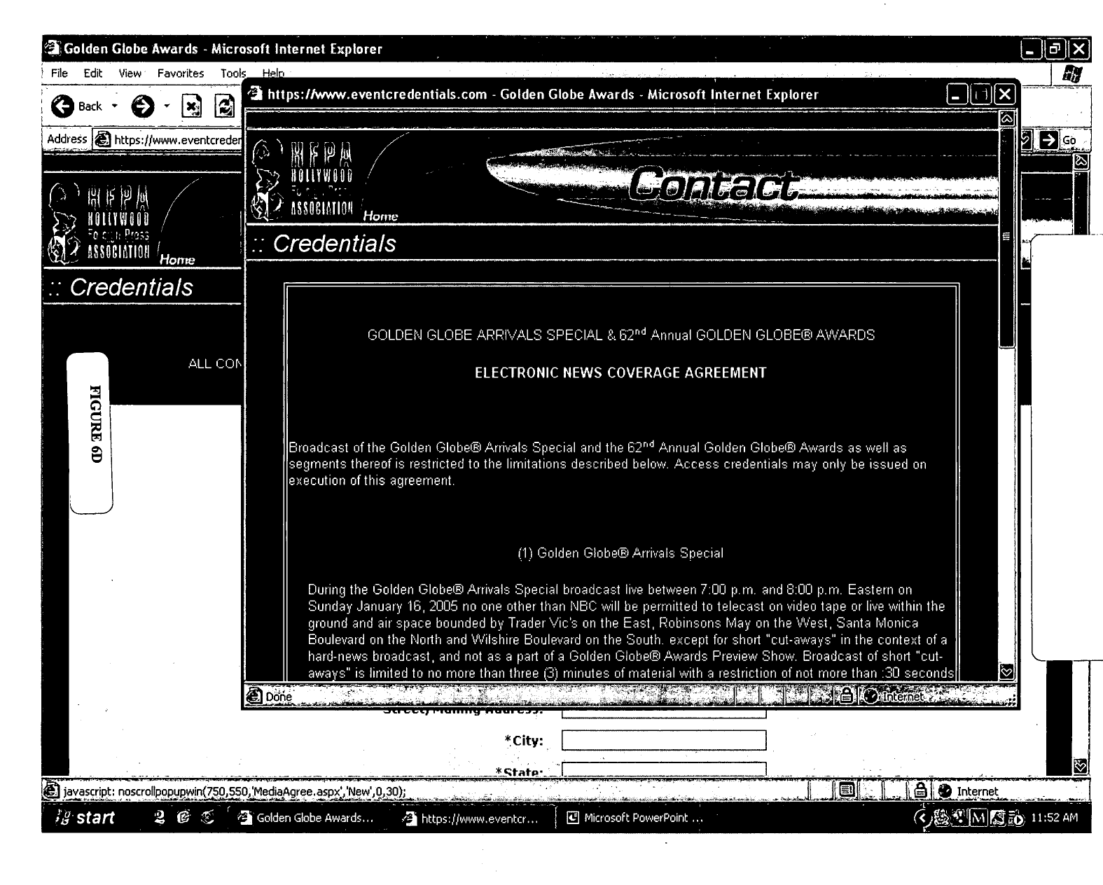

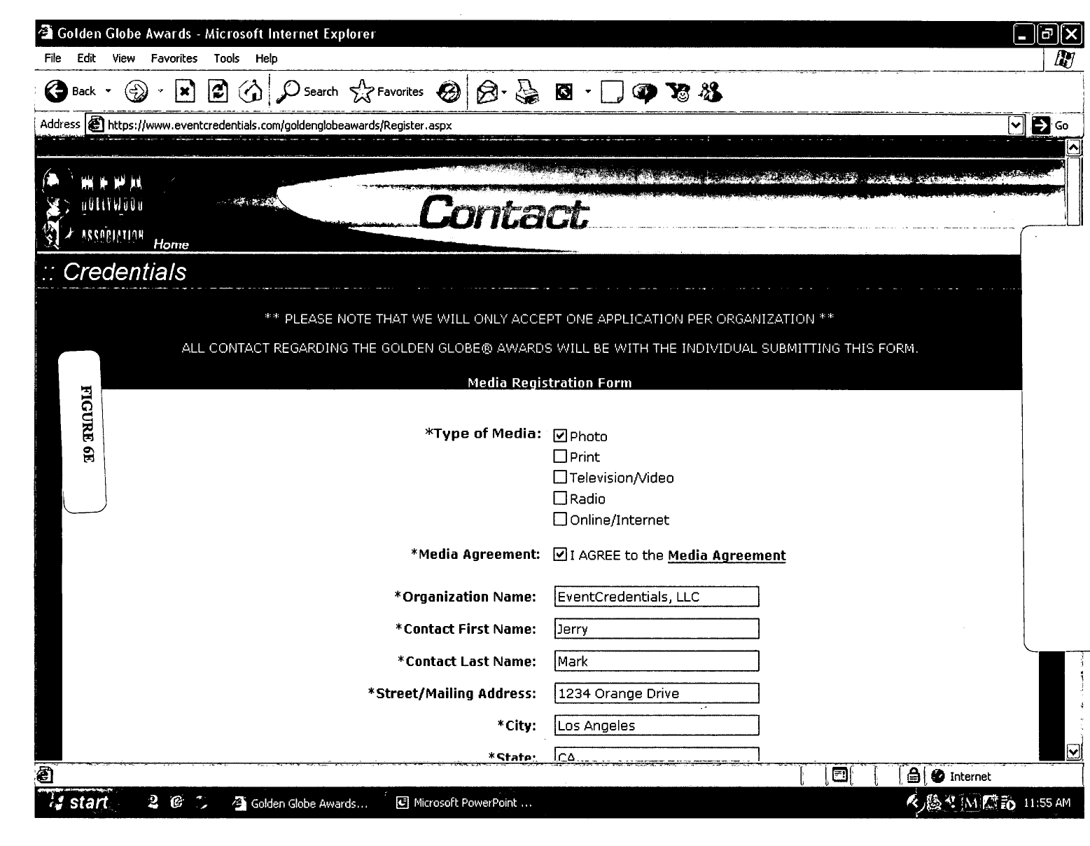

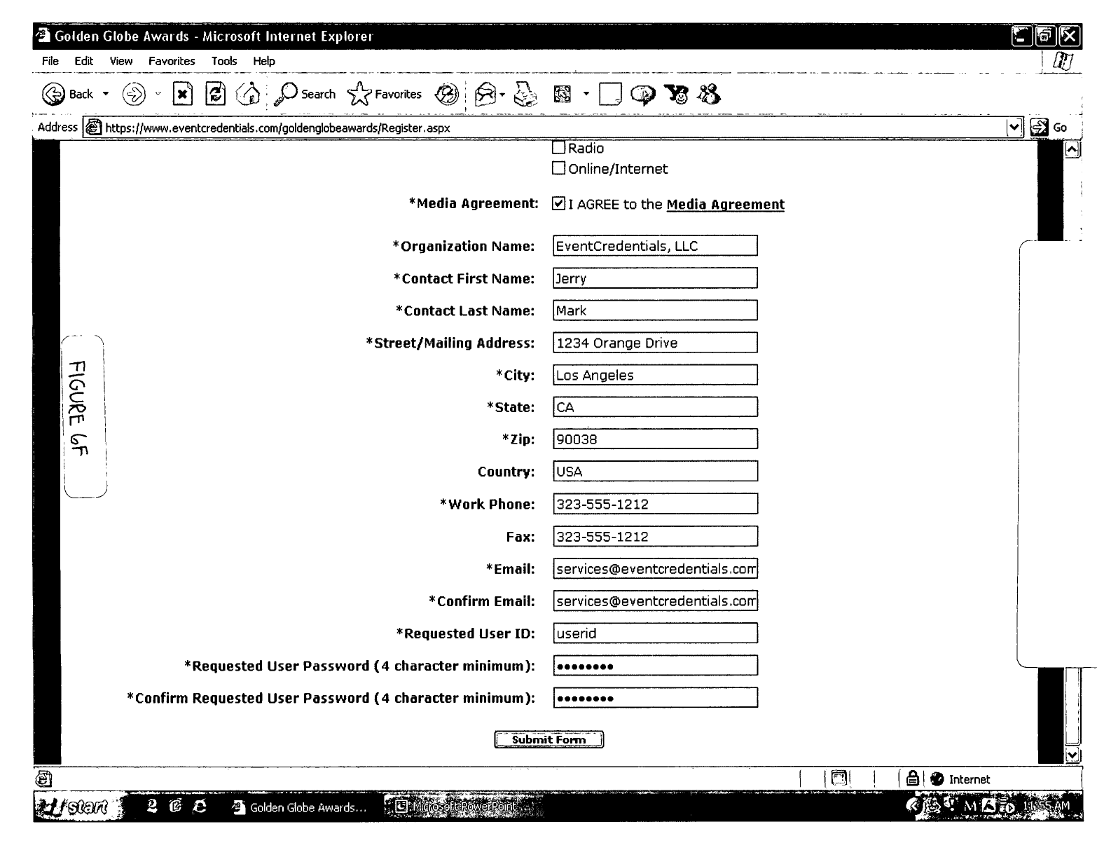

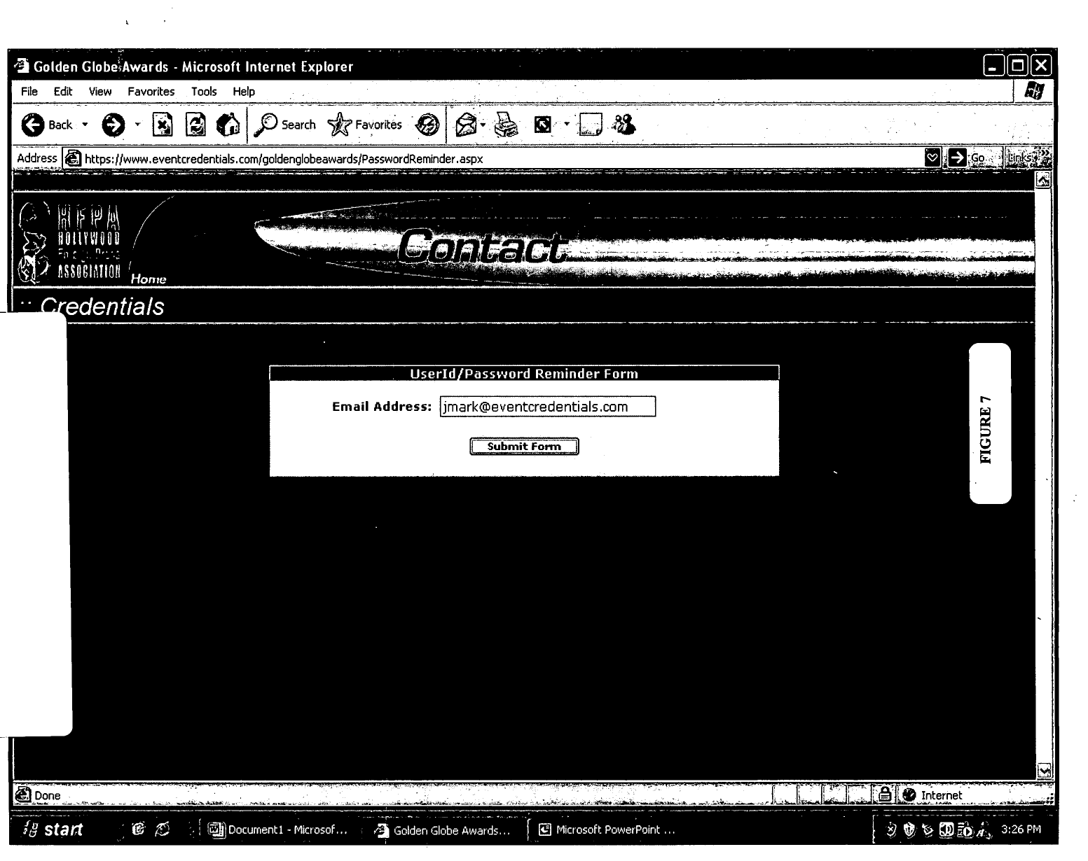

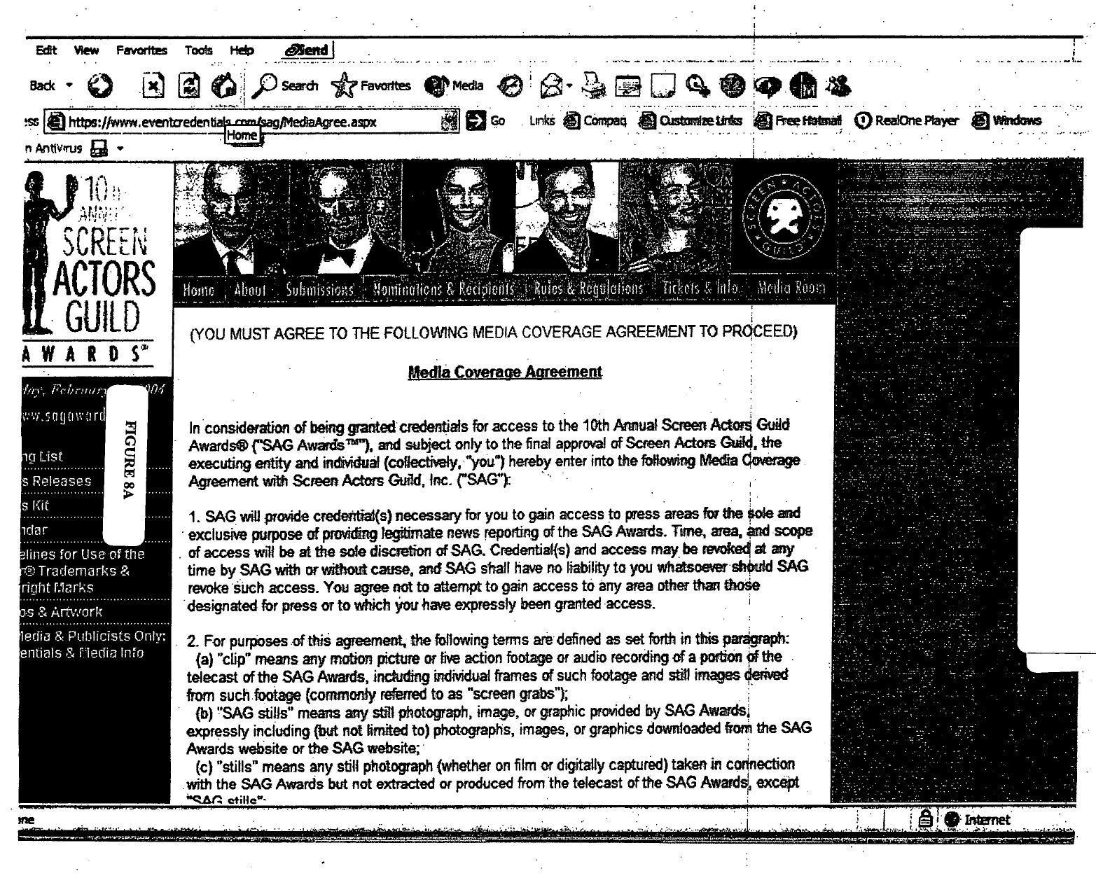

FIG. 6A-F illustrates exemplary screen shots of another embodiment of a user ID and password request process. The user goes to designated web site and locates the login area. Below the login area is typically a hyperlink for on the user to select which will start the process of obtaining or requesting a User ID/Password for current and future use. In this example, after they select the request link, the user is asked if they are a member of the media or if they are a publicist. Based on their selection the user will be taken to the appropriate form to submit their request, which will be associated with their record for database recognition purposes. If the user selects media, which is shown in the screen shots, the user would be required to disclose information about their organization as well as contact information for future correspondence by phone, email, fax, mail, or the like. In this example, the end user is required to agree to a media agreement before submitting his user identification (ID)/password request. In this example, the end user would create his own user ID and password for future visits provided the user ID and password is not already in use by another end user. The system would search the database. If the user ID and password are currently in use, the user would be required to select a different user ID and password that does not match any other user ID and password registered in the database. Once completed successfully the end user would be allowed to continue with the online credential request process.

FIG. 7 illustrates an exemplary screen shot of an embodiment of a user ID/password reminder form. If the end user has forgotten his user ID/password, the forgotten password link may be selected, which will take him to the user ID/password reminder. In an embodiment, the end user would type in their email address and select Submit. If the end user's email address is on file and associated to a previously submitted record in the database, the system can recognize which hyperlink or reminder form the request is coming from and email the end user the appropriate user ID/password information requested to the email address on record.

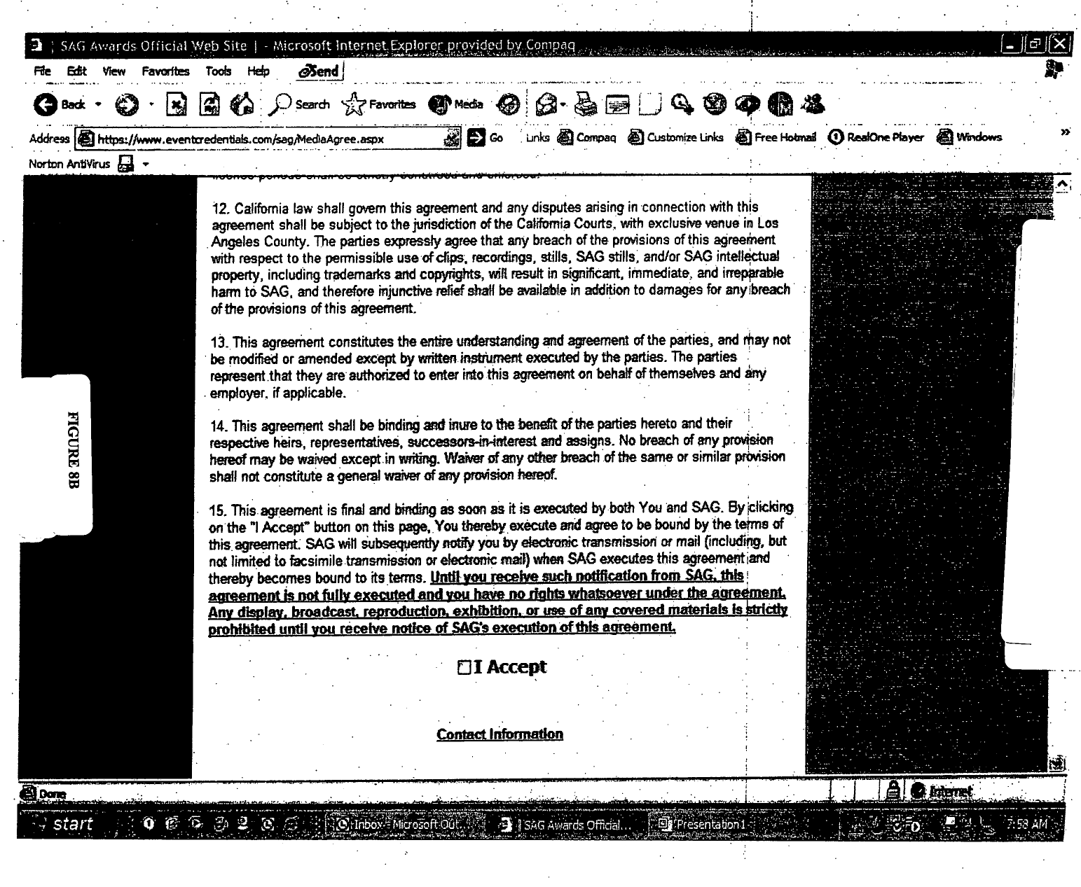

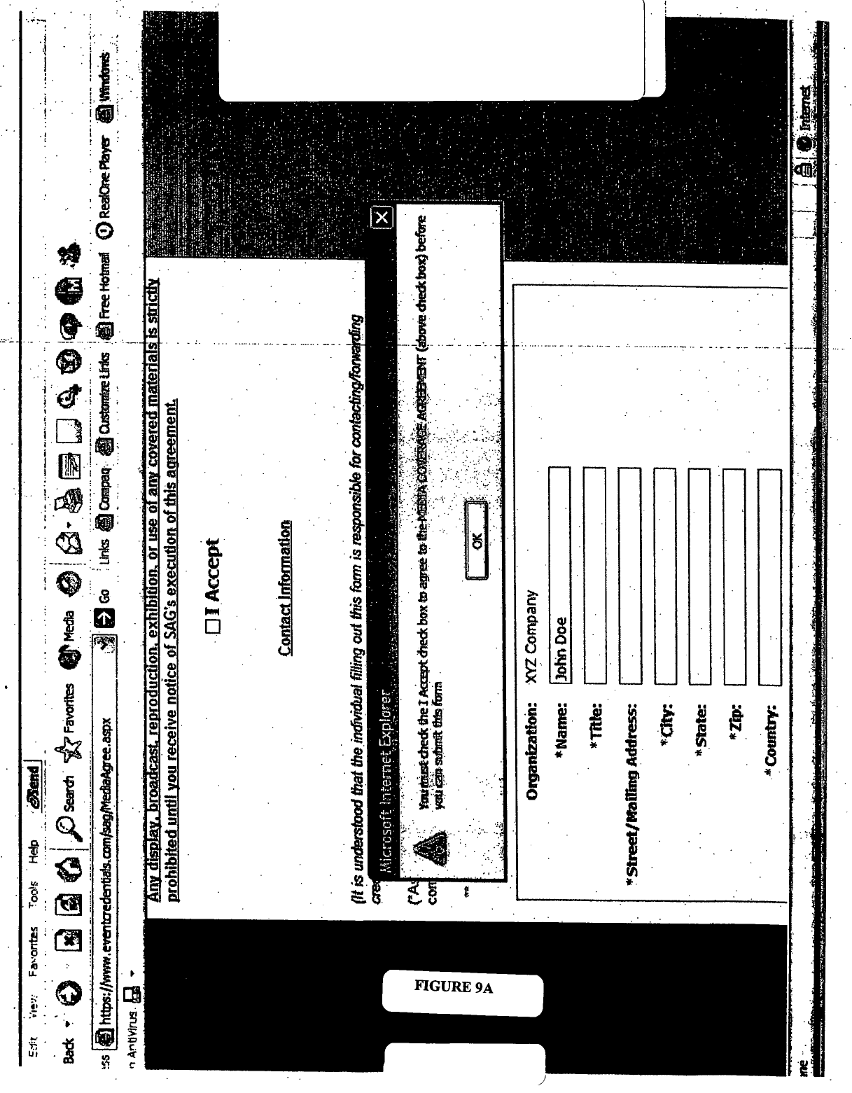

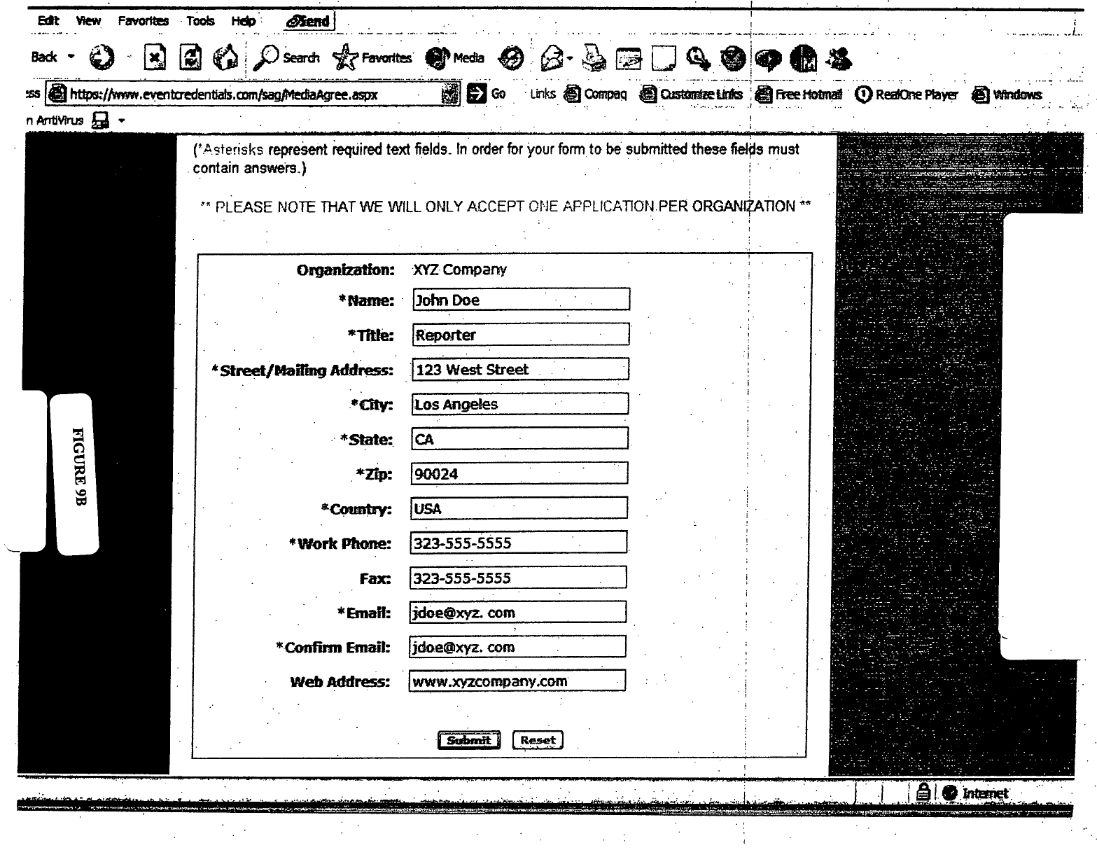

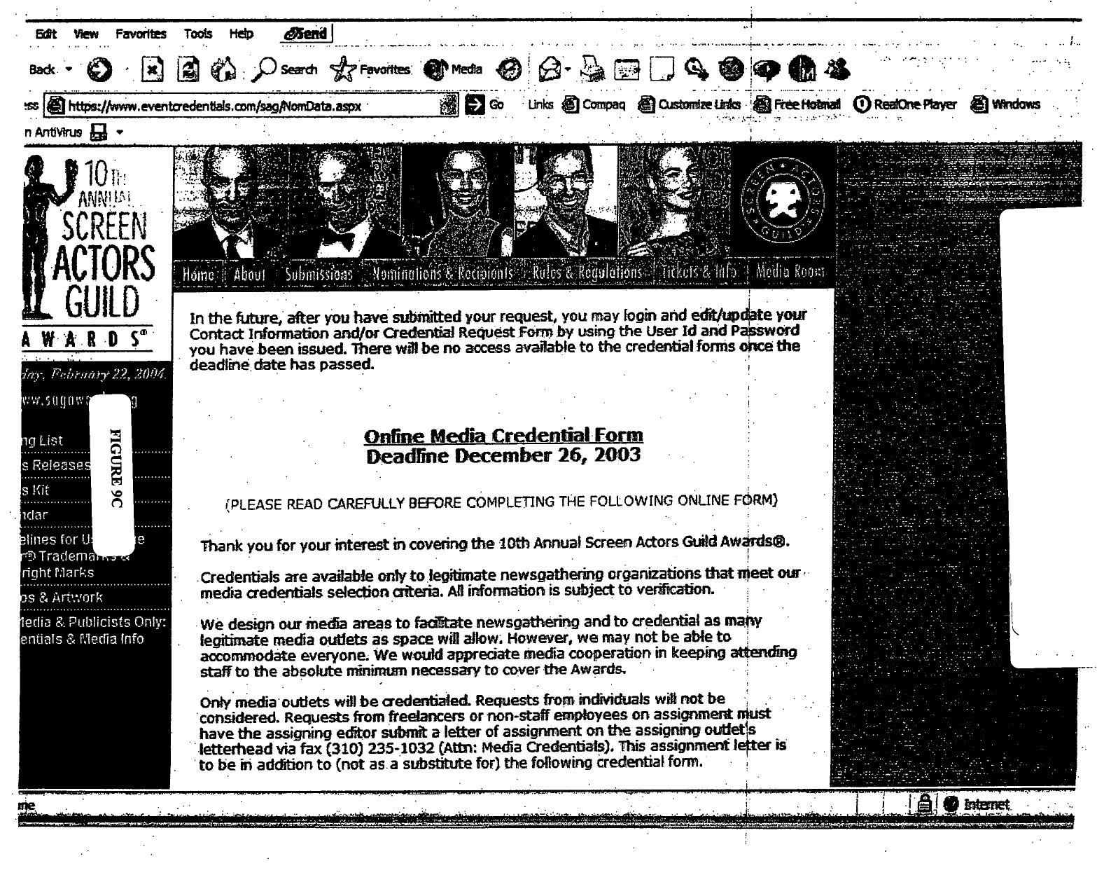

FIG. 8A-B illustrates exemplary screen shots of an embodiment of an agreement. In an embodiment, typically, the registrant or representative 102 will not be allowed to register for the event if this agreement is not accepted. The registration process will not allow the registrant or representative 102 to submit the agreement or form unless the terms of the agreement have been accepted.

Once the media registrant or representative 102 submits the accepted agreement, the media registrant, or representative 102 will then start to enter data into an online application in blocks 310, 408. This form initially asks for contact information such as Title, Company Name, Address, City, State, Zip, Work Phone, Fax, Email Address, Fax Number, Company Name, Company URL, and the like. After submission of the contact information, the registration process directs the user to the media credential application or form.

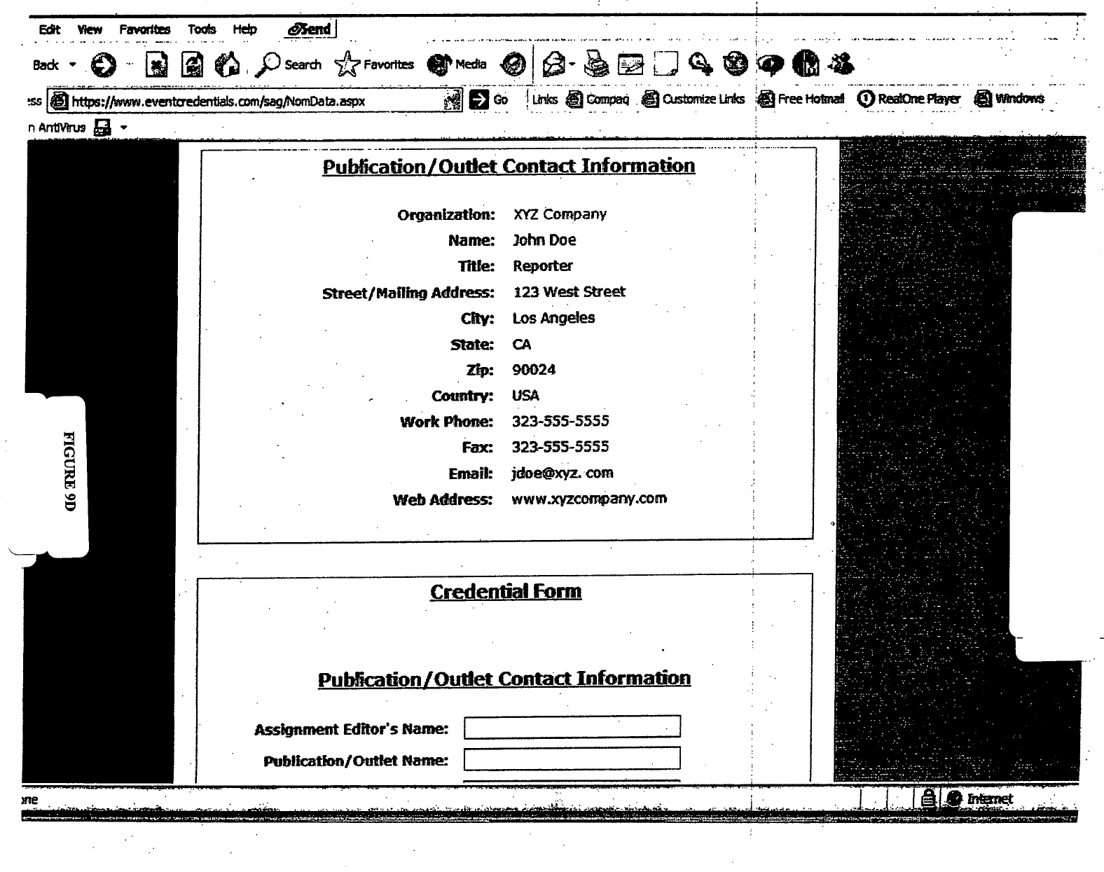

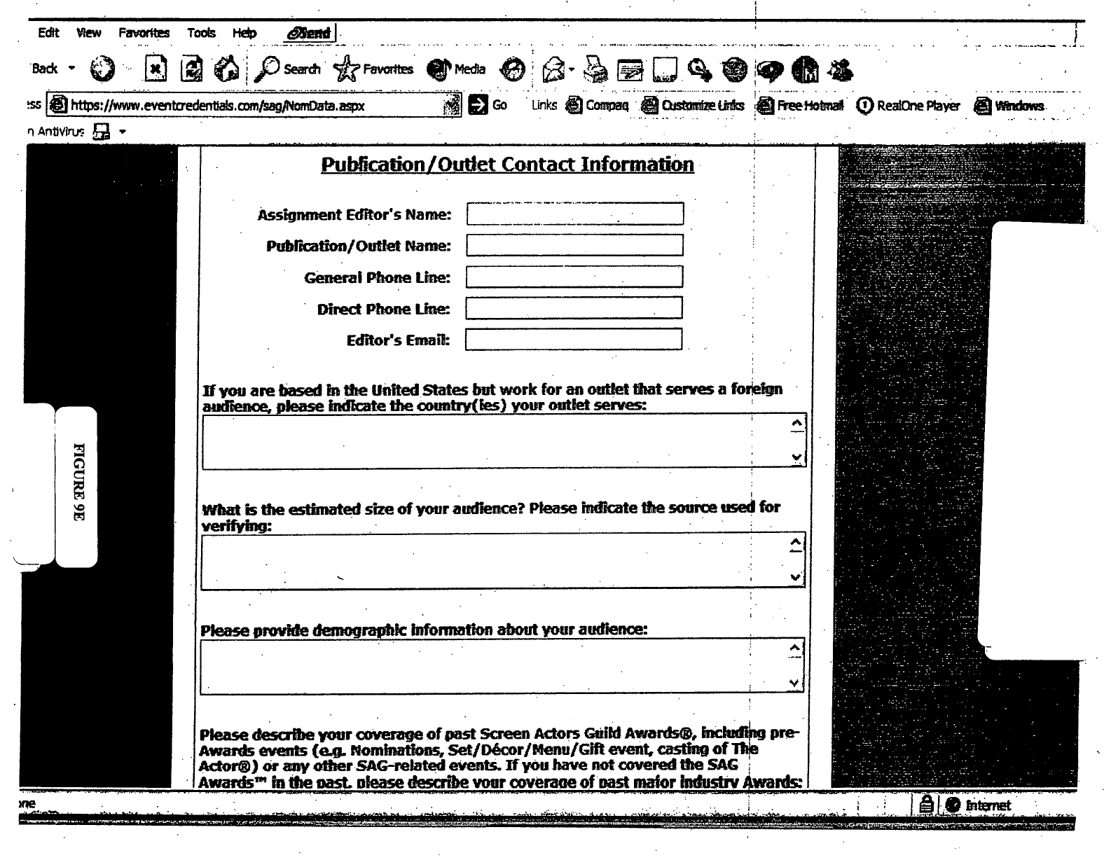

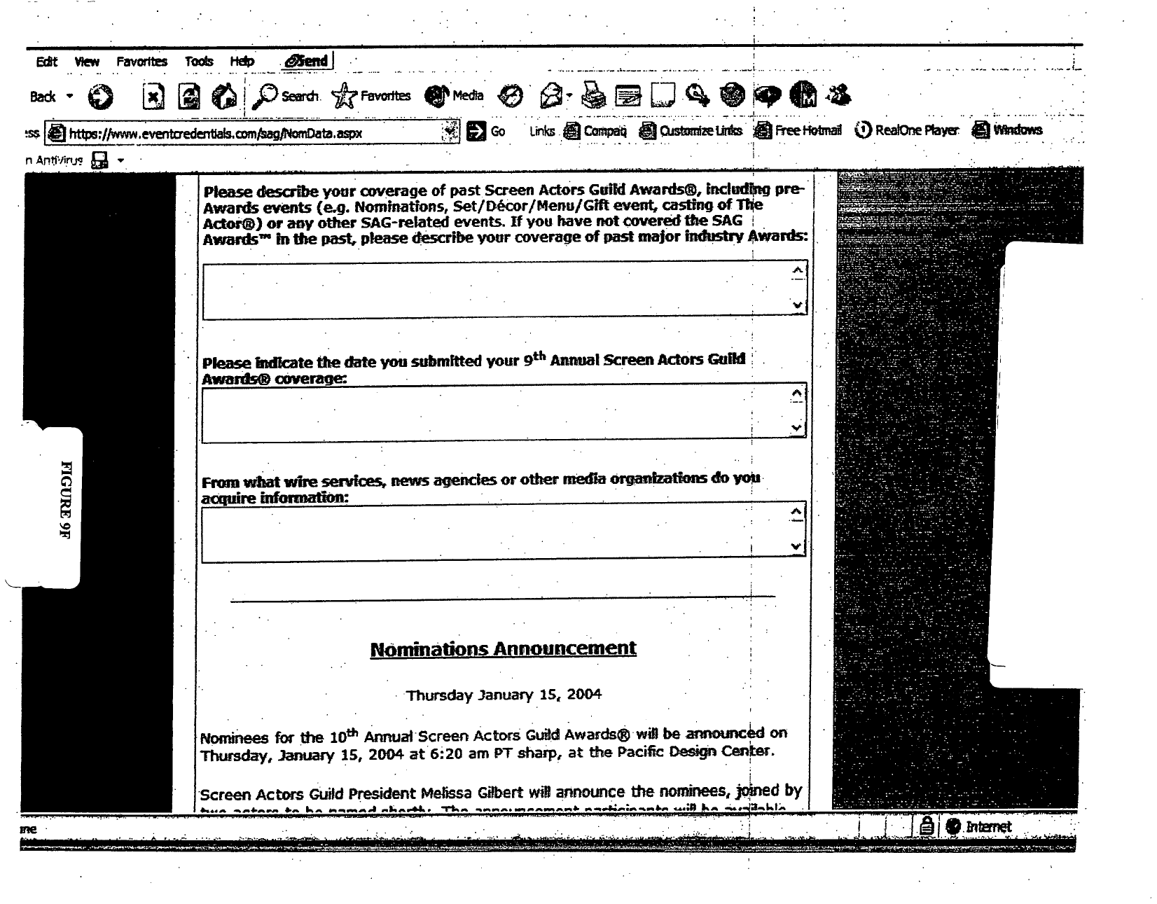

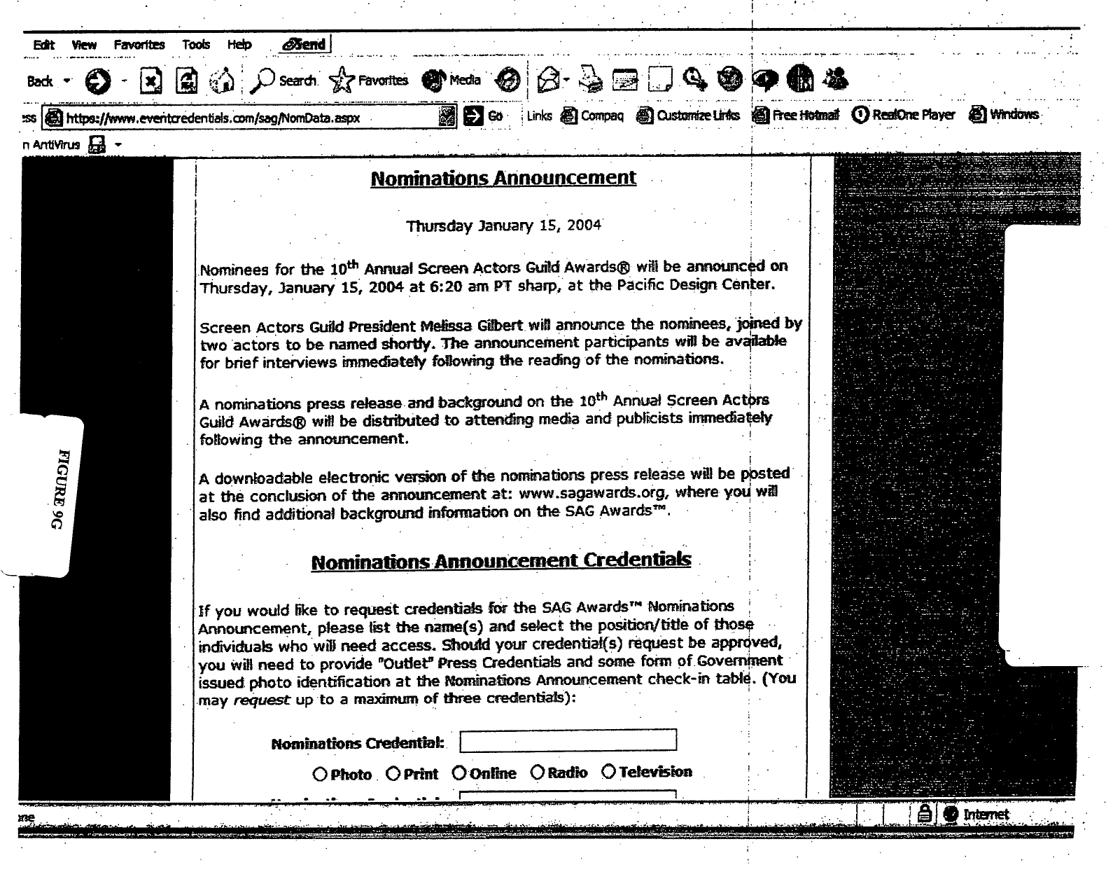

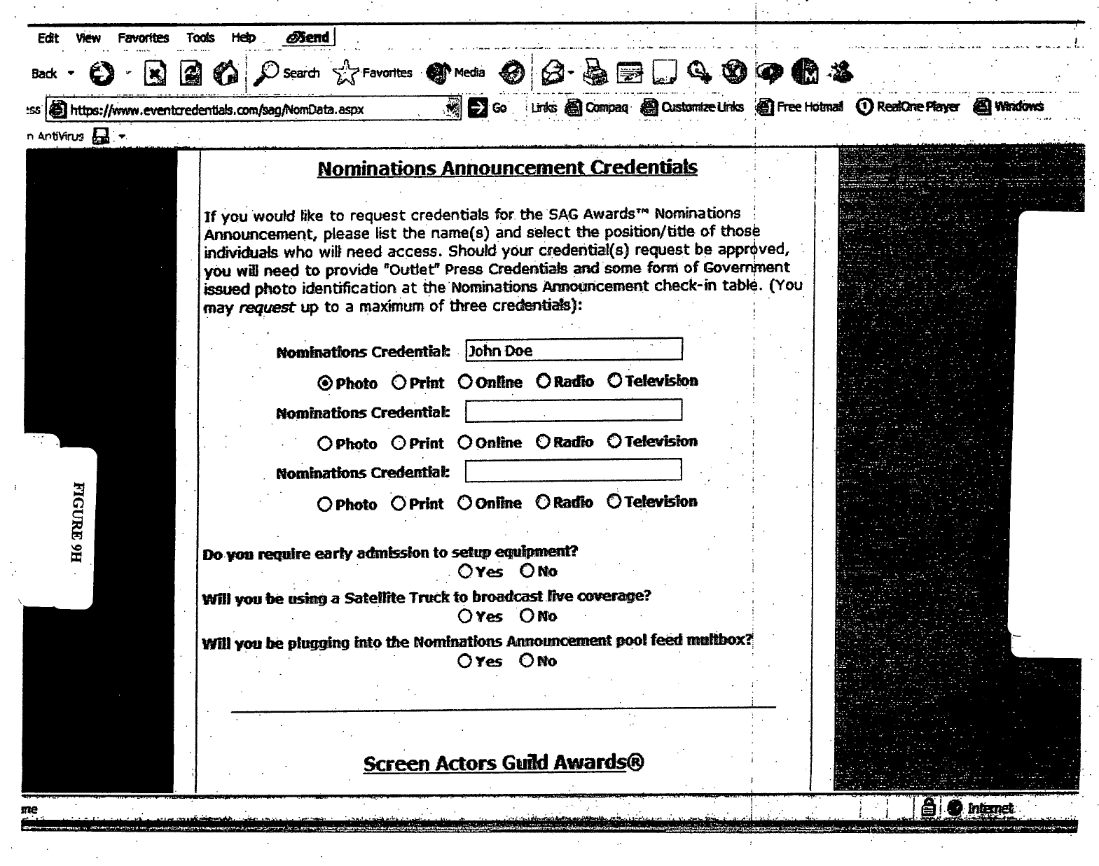

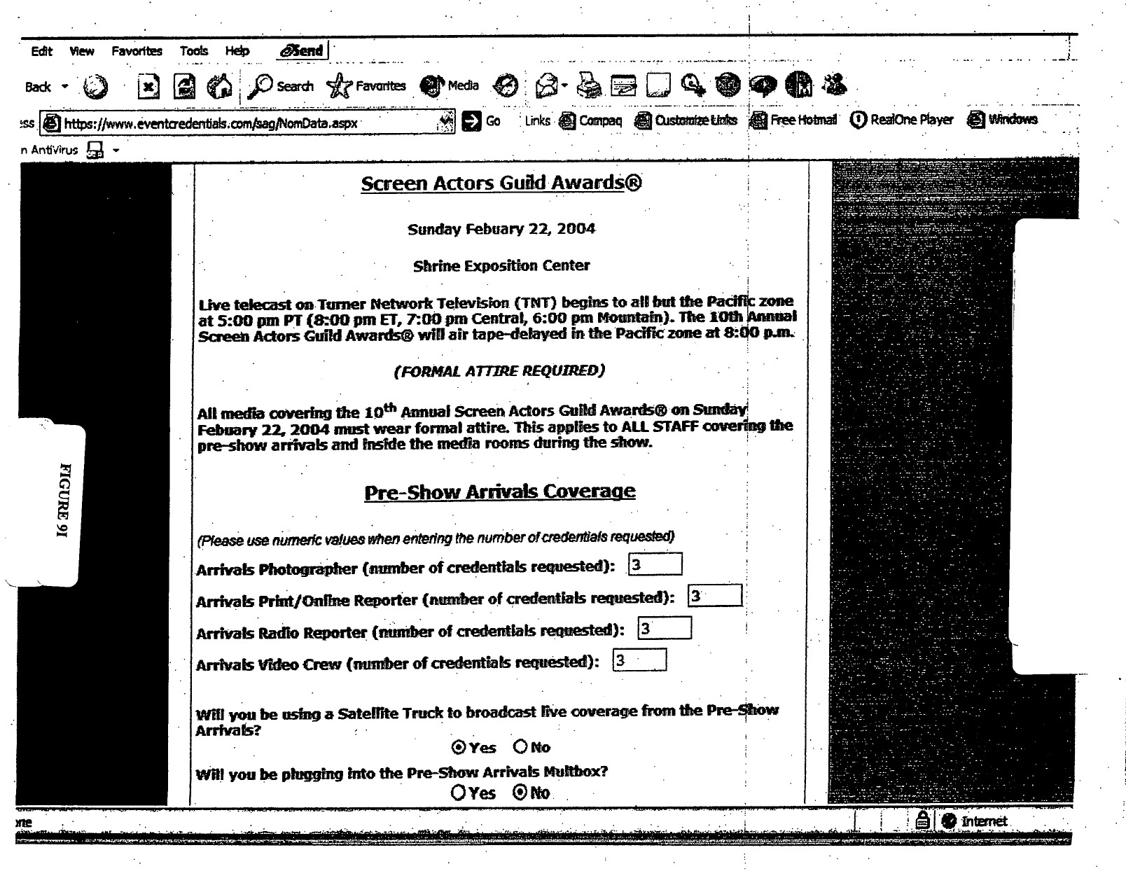

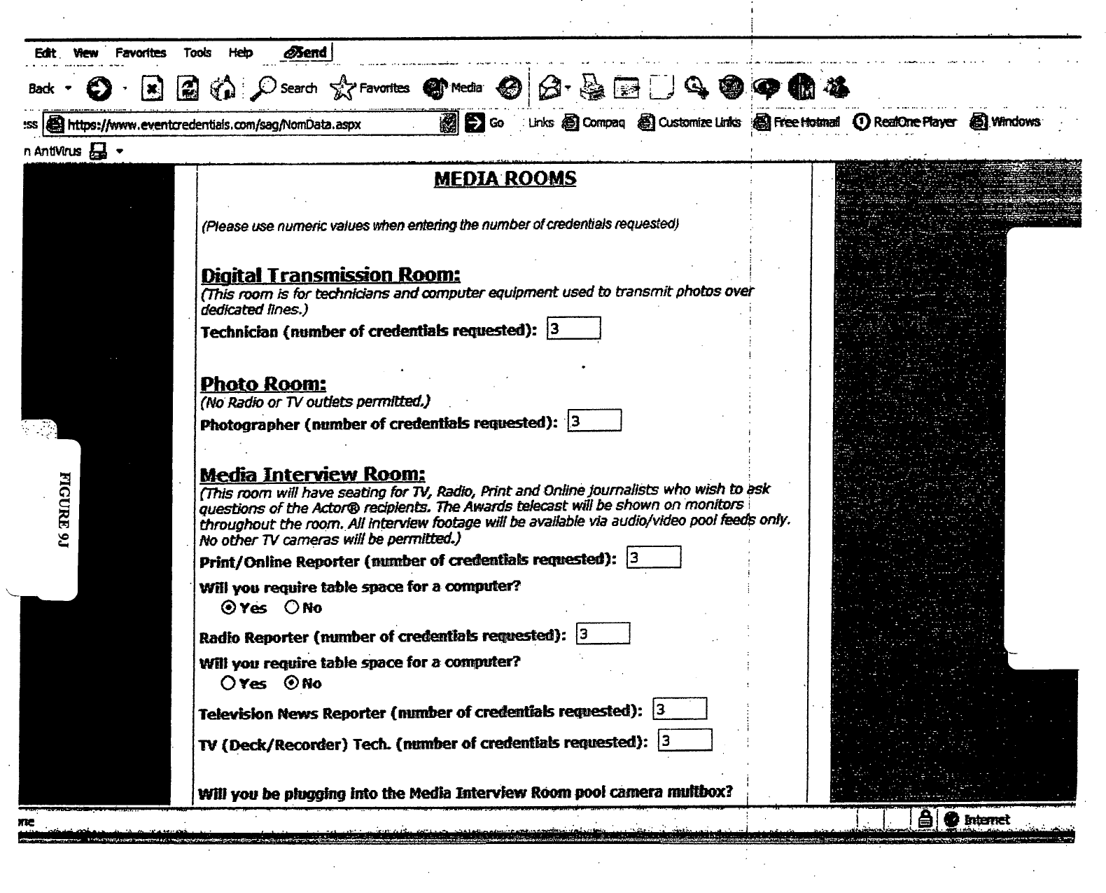

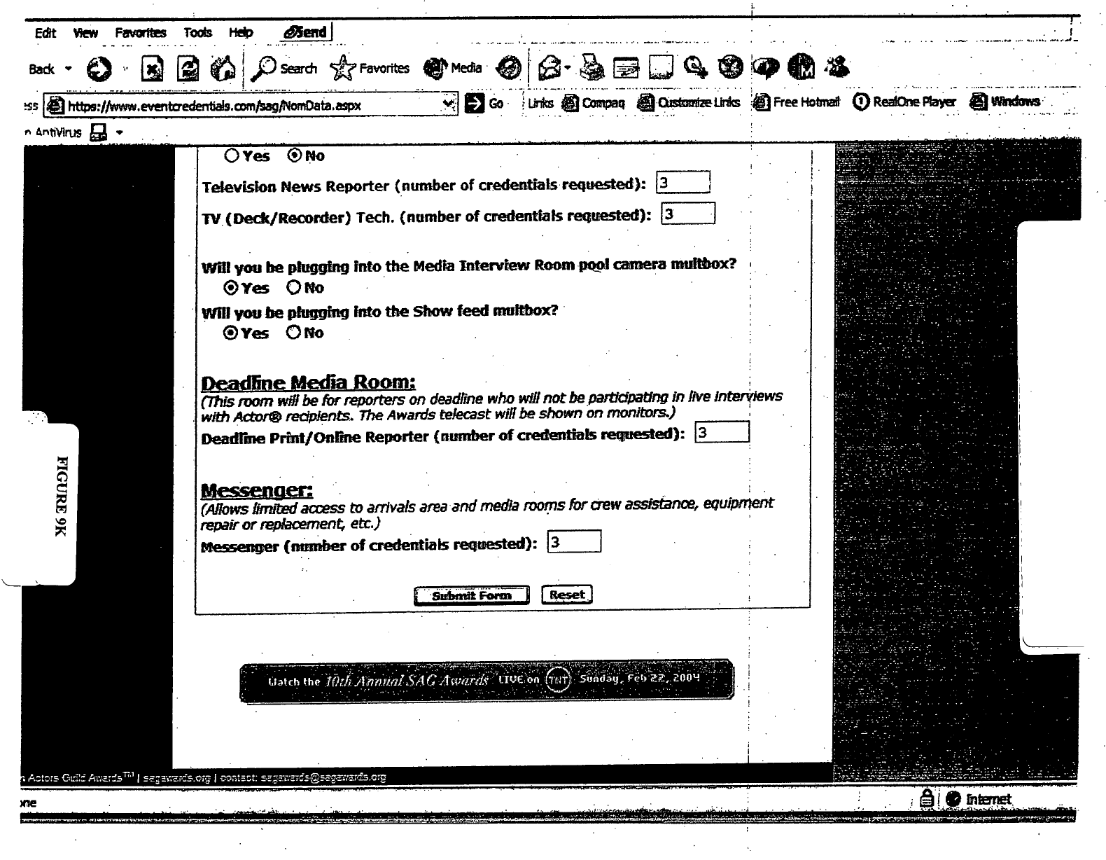

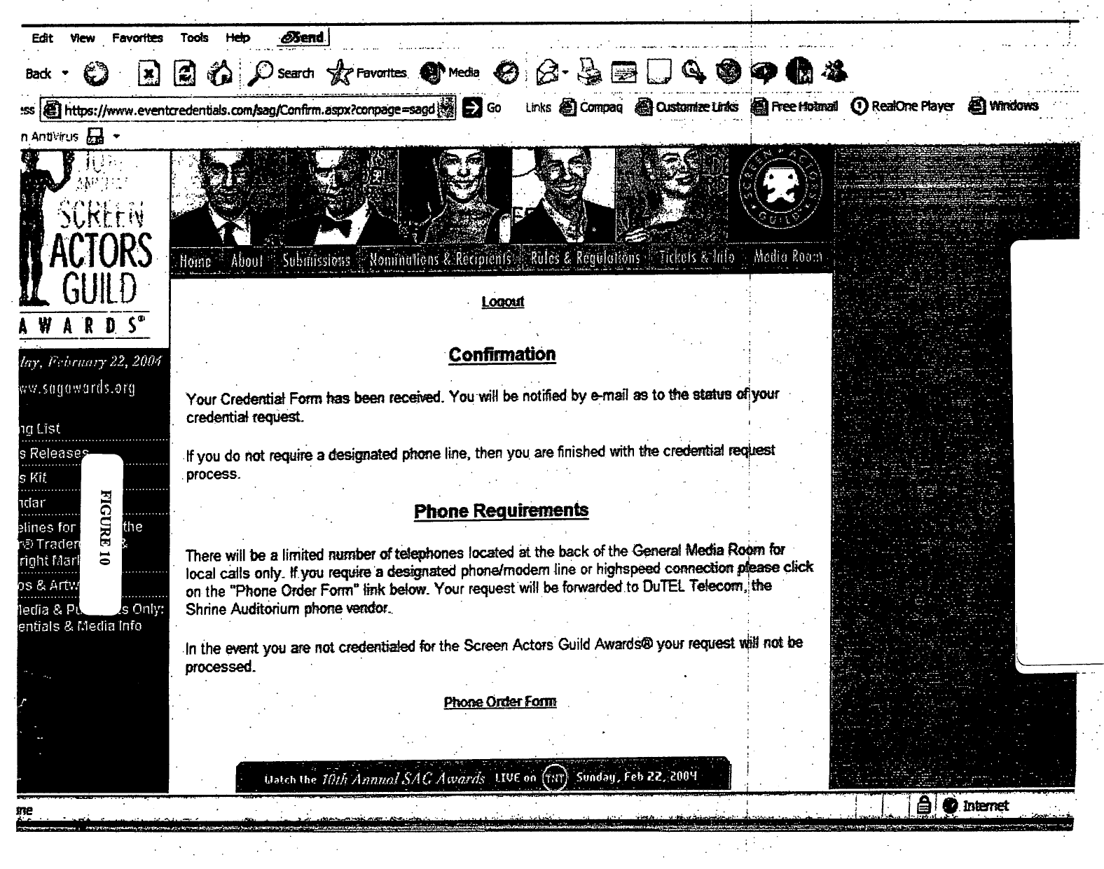

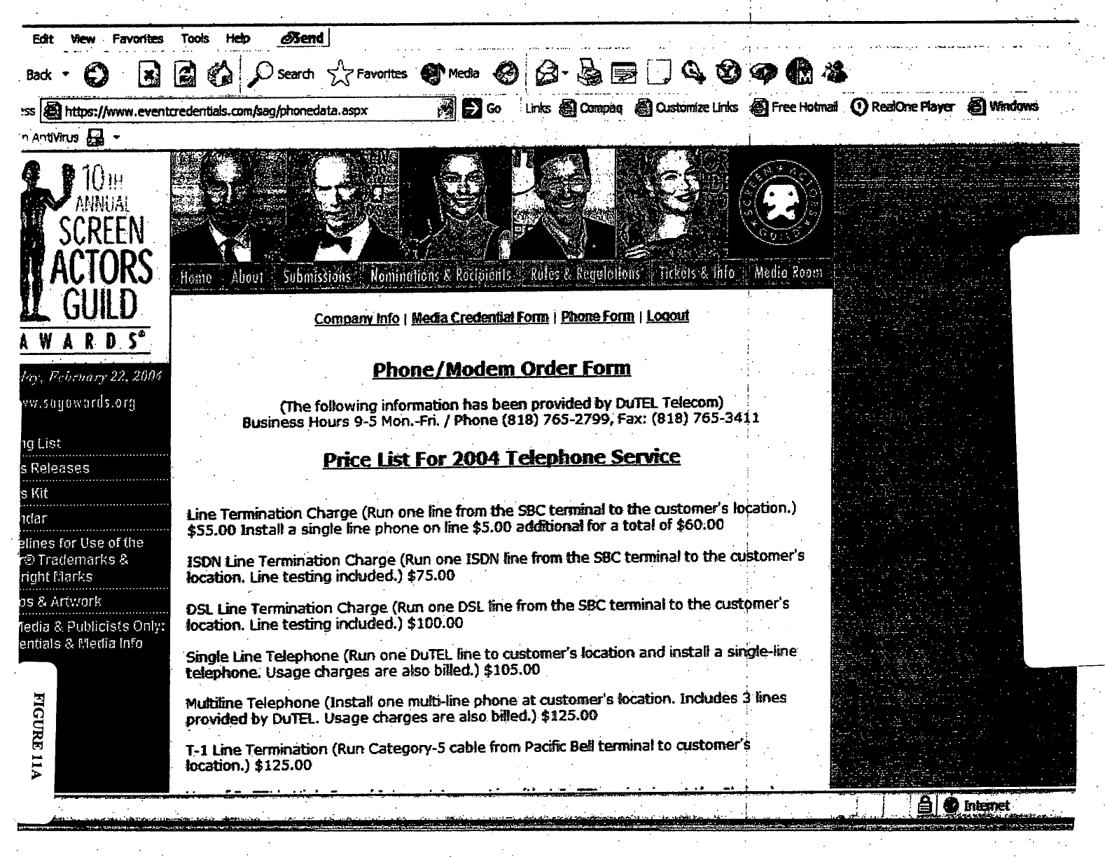

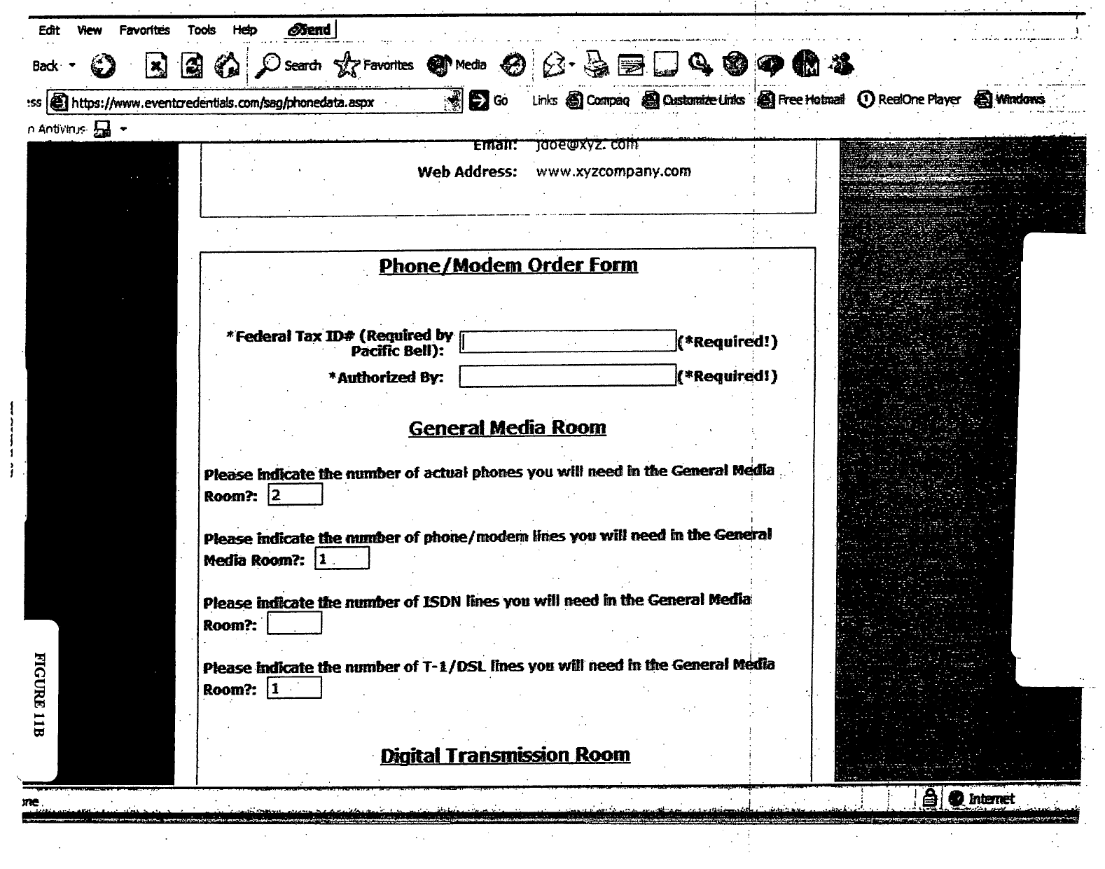

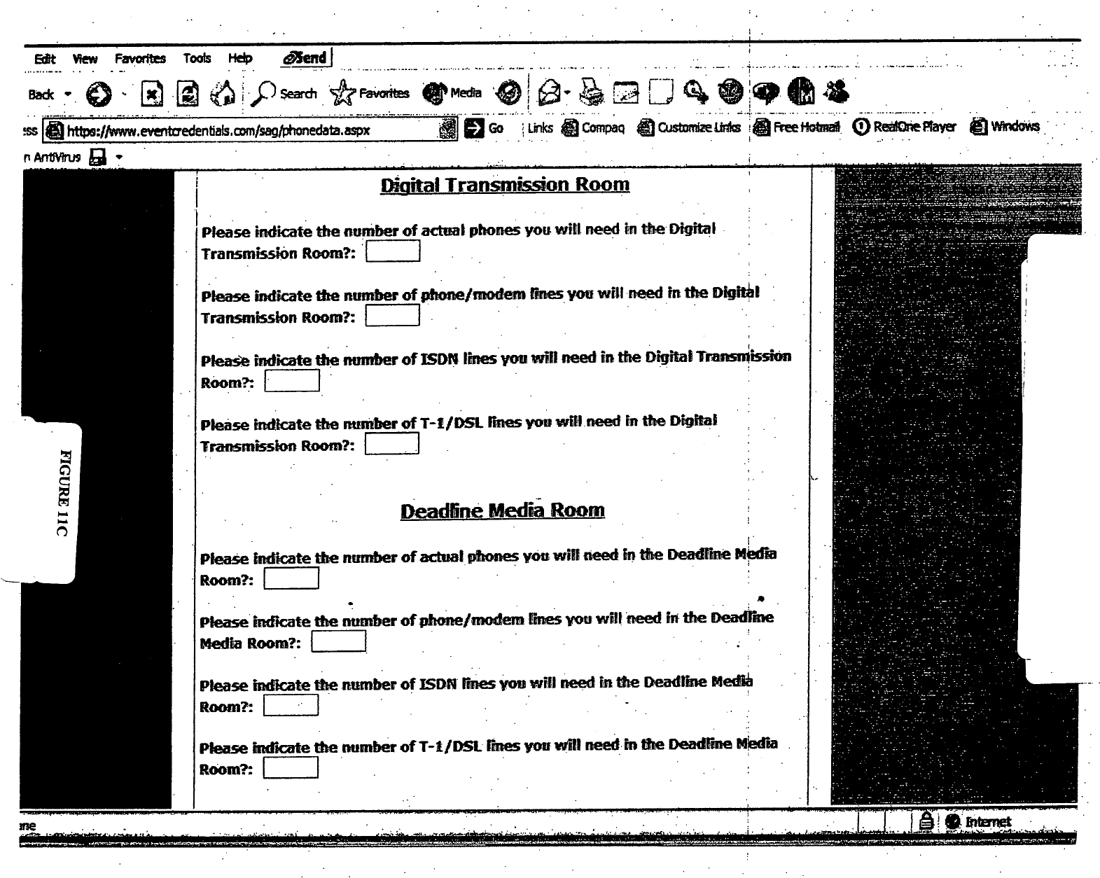

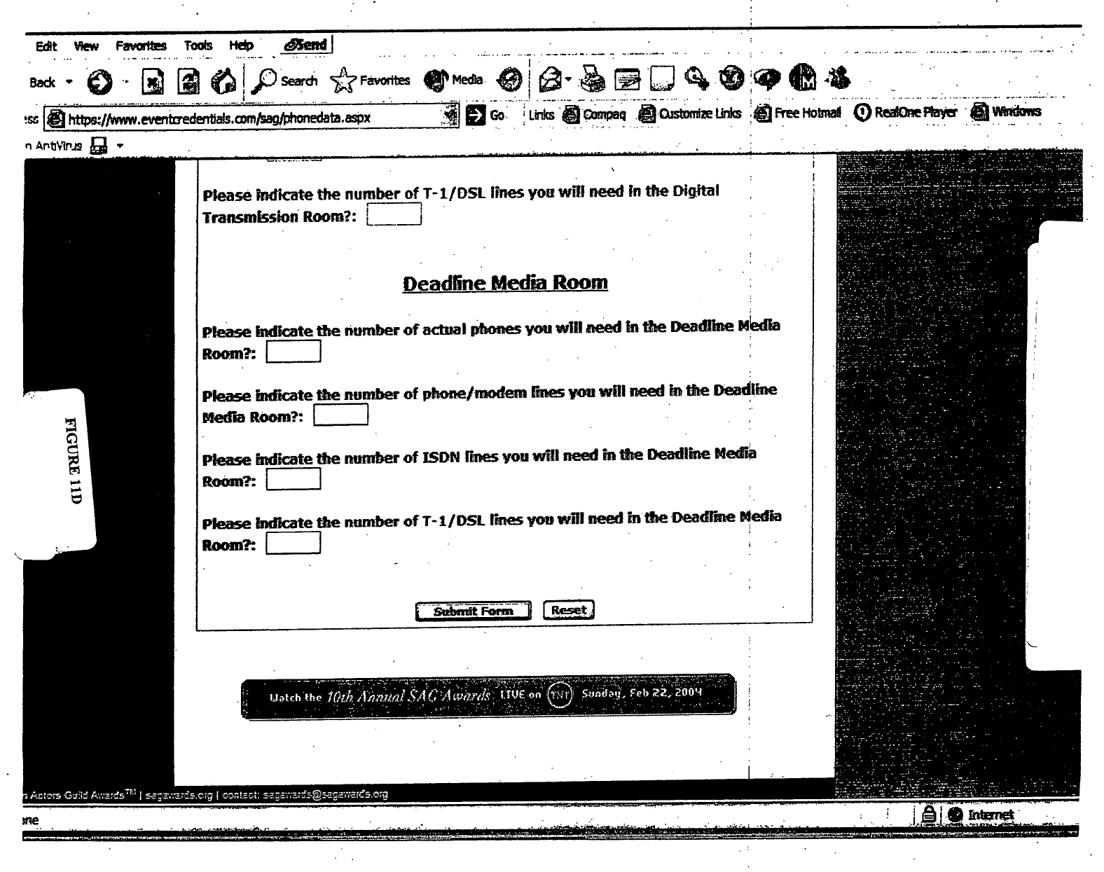

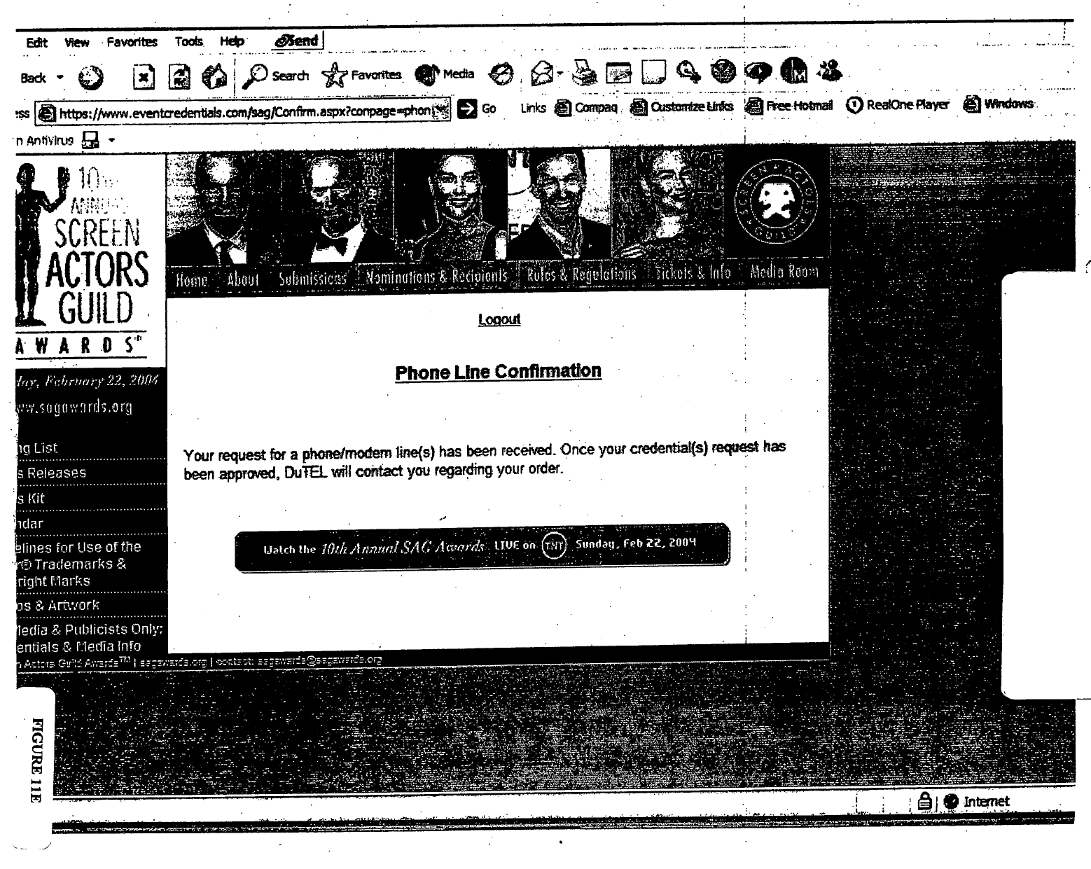

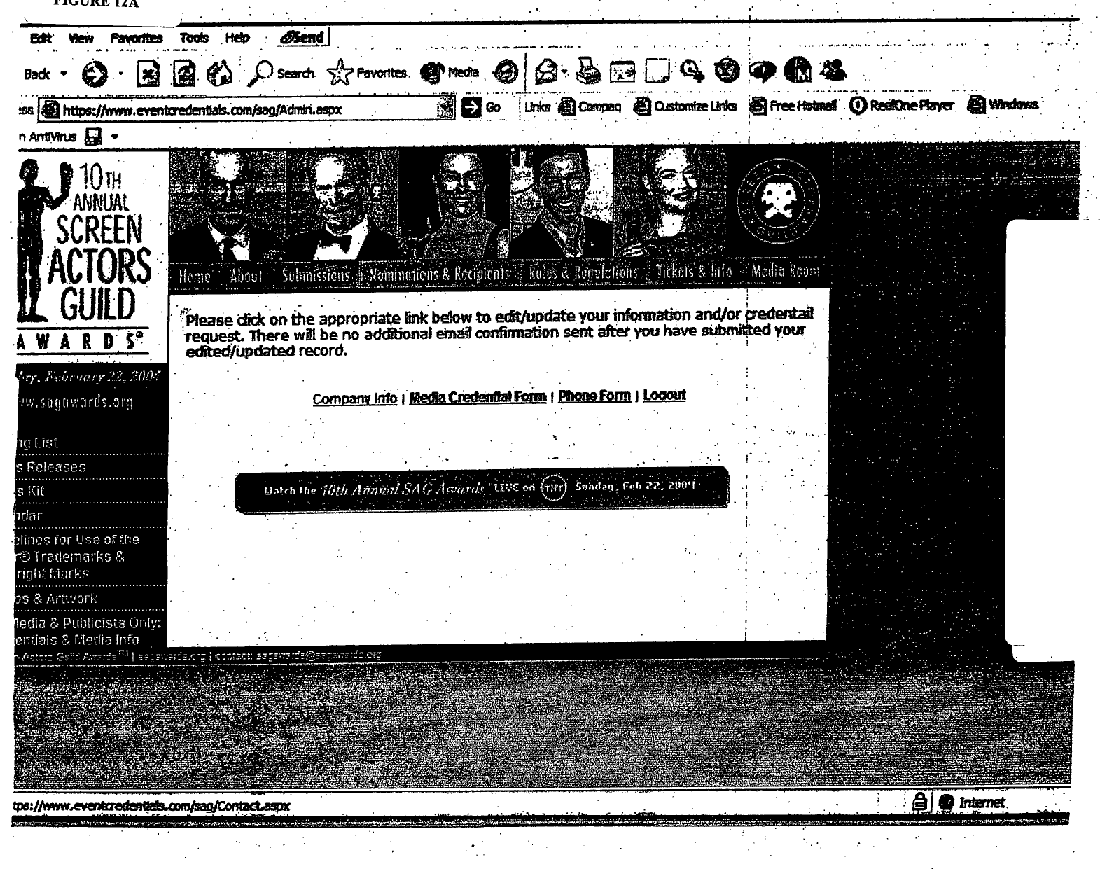

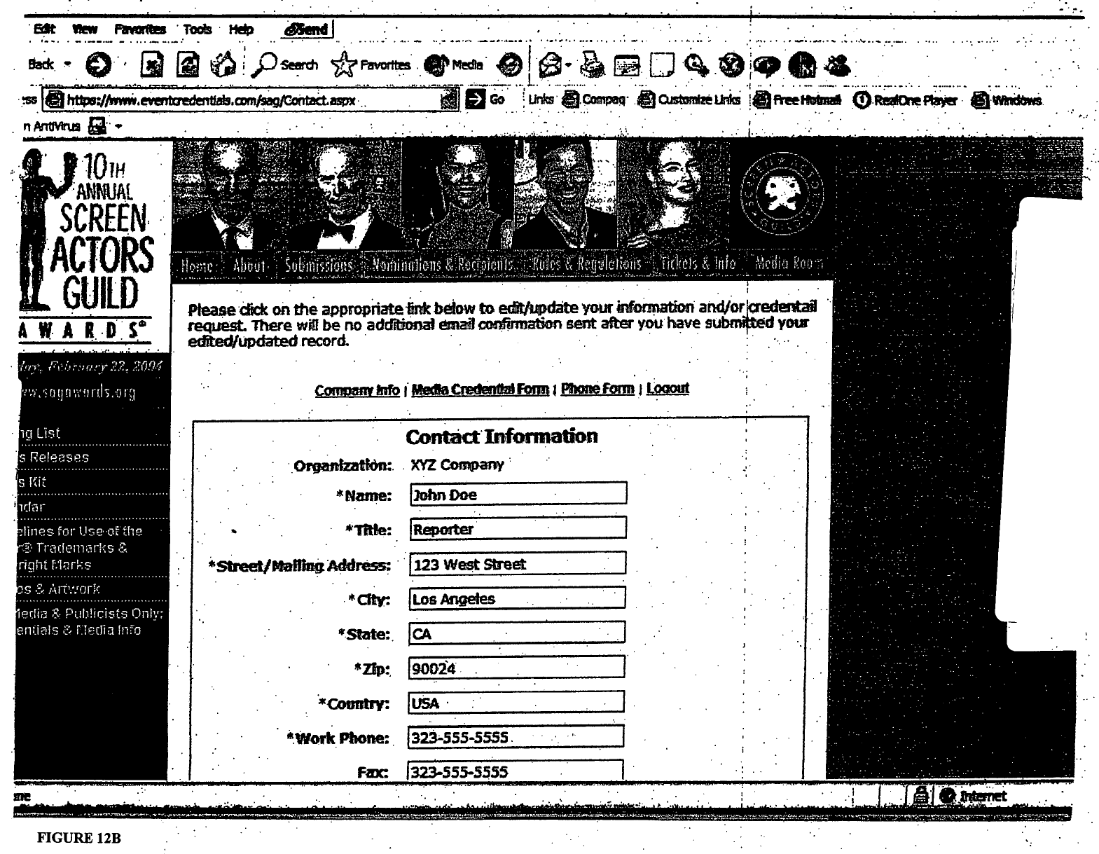

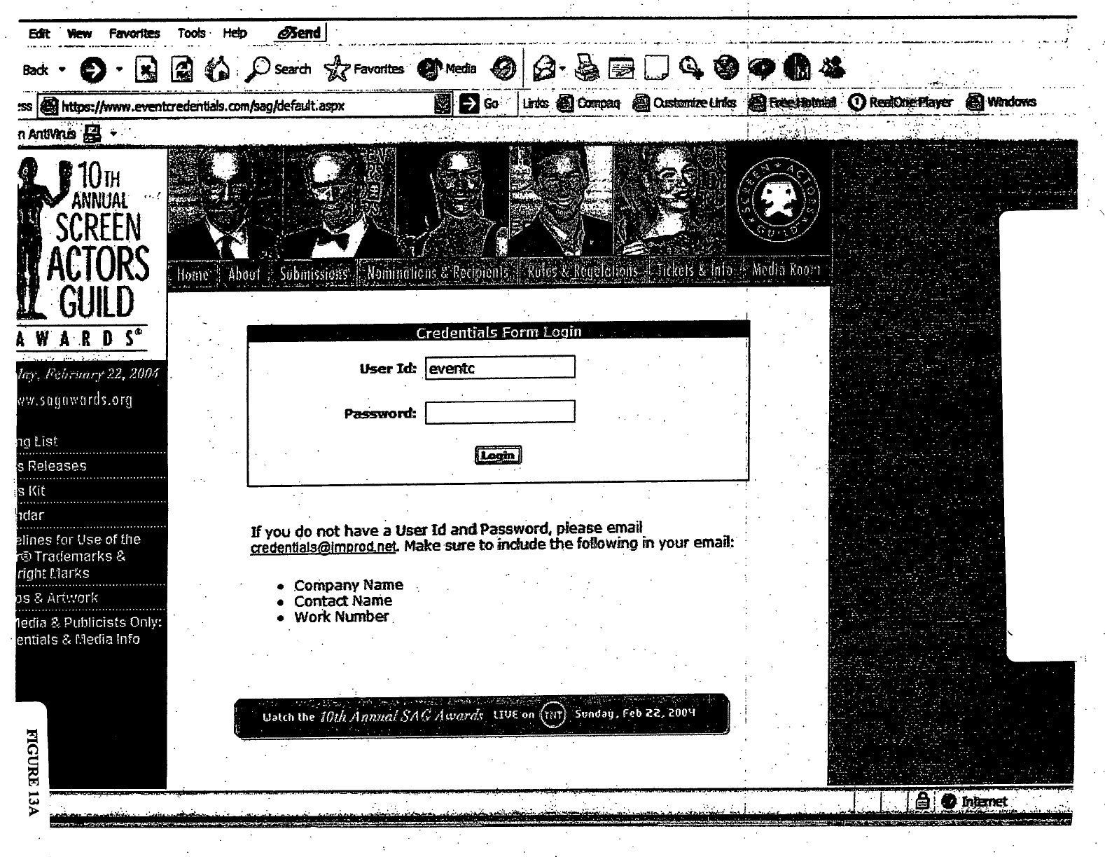

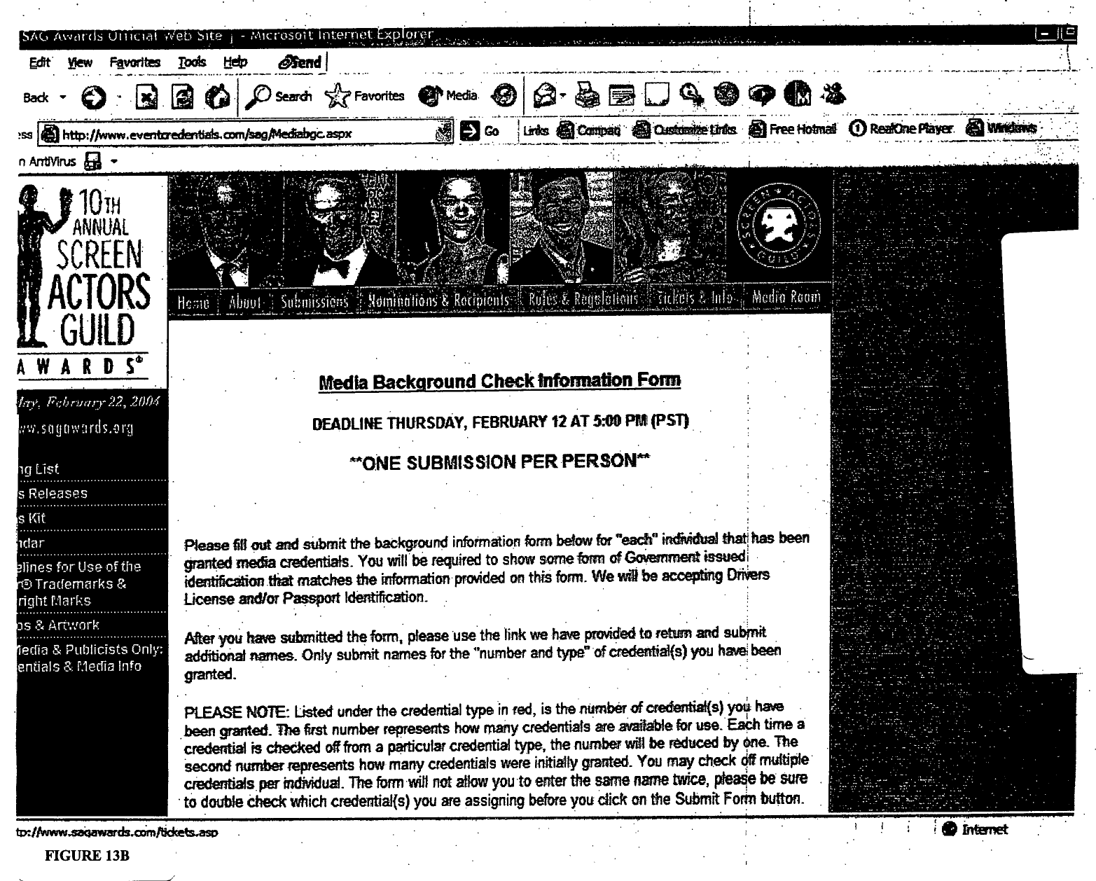

FIG. 9A-K illustrates exemplary screen shots of an embodiment of a media credential application. Media registrants 102 enter data into the online media credential form. Initially, the media credential application displays the contact information the media representative 102 supplied after accepting the agreement.

In addition, specific questions are asked regarding the media company or media outlet. The media registrant or representative 102 supplies information, such as, for example, information regarding demographics, countries served, audience size, and the like, of the media company or media outlet. Administrators 116 use this information to decide which media company or outlet is granted credentials and associated access levels for the event.

The application asks for specific areas within the venue that the company and its designated registrants 102 or an individual registrant 102 would like to request access rights. For example, a form might list several functions employees of the company would perform at the event, such as, for example, arrivals photographer, digital transmissions room technician, print/online reporter, messenger, and the like. The representative 102 requests the number of credentials in each of these areas that they require to perform their job function. As opposed to individual registrants 102 who request access for one person on one form, media representatives 102 may submit multiple registrant's requests per form. However, at this point in the process the representatives 102 are requesting a specific number of registrant credentials associated with specific access areas at the event. Later, if the administrator 116 grants the representatives 102 these credentials, they will be asked to supply background information for each registrant 102 attending from their organization. Additionally, individuals or organization representatives can enter multiple names along with background information into a request form, thus allowing the two-step process mentioned above could be joined together. All information, both the credential request and background information on each individual and credential requested area would be gathered at once during the initial request for access to the event.

Once the registrants and representatives 102 complete the initial form with their credential requests, they submit the form to the server database 114 over an open or encrypted connection in blocks 312, 410. In an embodiment, certain questions on the form are identified as required questions. The form cannot be submitted unless the user answers the required questions.

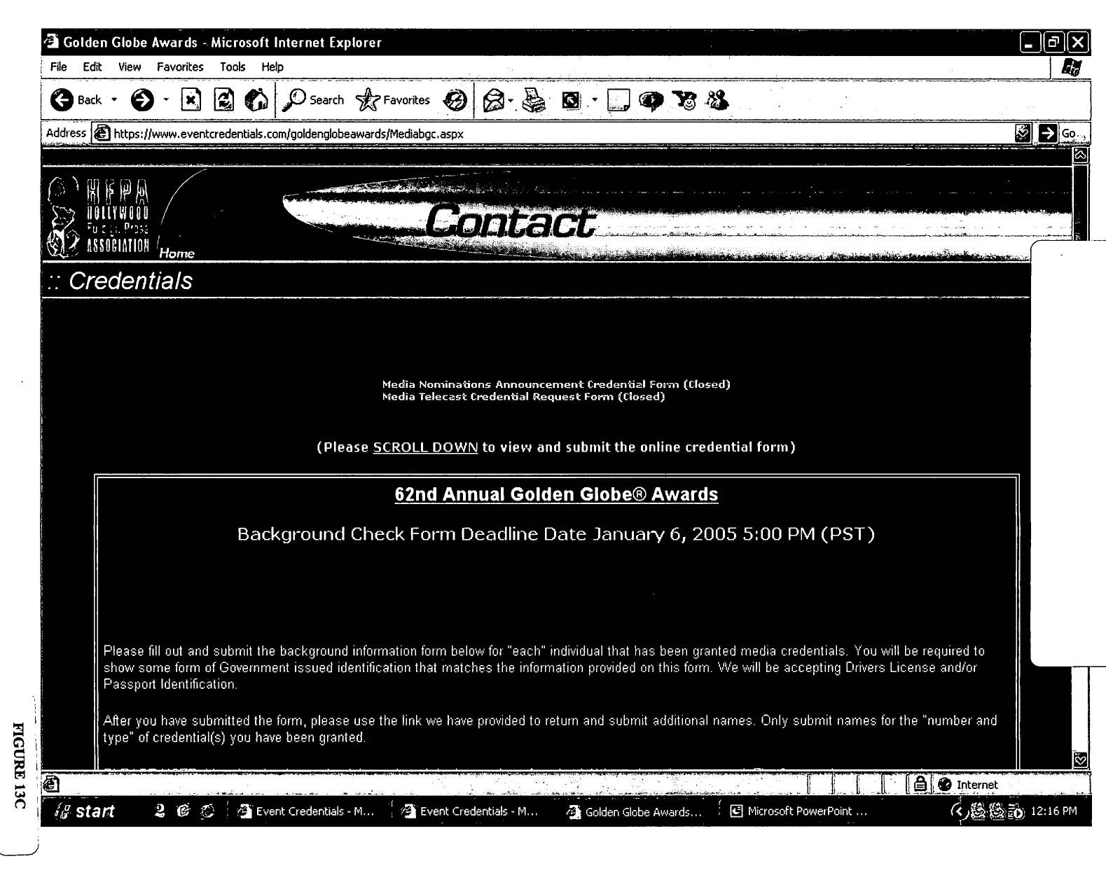

FIG. 10 illustrates an exemplary screen shot of an embodiment of a confirmation.

Referring to FIGS. 3A and 4A, in blocks 314, 412, respectively, the server 110 receives the credential request from the individual registrant or company representative 102. In blocks 316, 414, the server 110 sends a confirmation. In an embodiment, the confirmation is an email. In another embodiment, the confirmation is a facsimile or telephone message and the like.

In an embodiment, with the confirmation notice, the registrant or representative 102 may indicate a need for additional physical support and technical requirements, such as, for example, telephone and modem lines, cable support, televisions trucks or other equipment, space requirements, parking, and the like. FIG. 11A-E illustrates exemplary screen shots of an embodiment of a phone and modem order form. If the administrator 116 approves the credentialing requests, the administrator 116 arranges for the technical support and space requirements of the registrant or representative 102 as indicated on the order form.

FIG. 12A-B illustrates exemplary screen shots of an embodiment of a registration form in which the previous registration information can be viewed or edited. Typically, this occurs after the registrant 102 submits the credential request form and before the submission deadline is reached. The registrants and representatives 102 can update or edit their credential requests after submitting their information by logging in with the unique user identification and password they have been provided or that has been generated by the system for them. The server 110 recognizes the registrant or representative 102 previously submitted an application, and does not require them to execute another user agreement form.

Each time a registrant or representative 102 visits the site or submits another credential request form, they have the ability to view which registrants 102 have also submitted forms from their organizations. The full name of the representative 102 and, if desired, the credentials requested, can be viewed each time a member of a specific organization logs in to submit or edit a credential request form under its unique user identification and password. This allows organizations to monitor whom from their organization are requesting access and to what credentials they are requesting. This is important because later the administrator 116 is likely to limit the overall number of credentials, as well as access levels, for each organization wishing to attend this event. This allows organizations to decide internally who should receive the credentials granted to the organization.

The registration process is often times a multi step process in which registrants and representatives 102 request a certain number of credentials associated with specific access levels. These numbers of credentials and specific access levels are subject to review, approval, and modification by the event administrator 120.

In addition, the registrants and representatives 102 can update or edit their order form for additional services, such as, for example, phones, modems, and the like.

The event administrator 120 has the ability to enable and disable the edit function and usually sets a date after which no changes to initial request forms can be made.

After the submission deadline passes, the administrators 116, 120 accept, deny, or modify the representatives and registrants 102 credential requests.

If the administrator 116 approves the media representative's or registrant's credential request, the media company, or media outlet has access to the venue. Referring to FIGS. 3B and 4B, in blocks 318, 416, respectively, the administrator 116 contacts the registrant or representative 102. In an embodiment, the representative or registrant 102 is notified by email, but could also be notified manually or automatically through any means of current communication or the like.

In blocks 320, 418, the registrant or representative 102 logs into the site with the unique user identification and password. If the administrator 116 denies the registrant's or representative's credential request, the registrant or representative 102 will view a message indicating the decision to deny their request when they return and login with their unique user identification to the site.

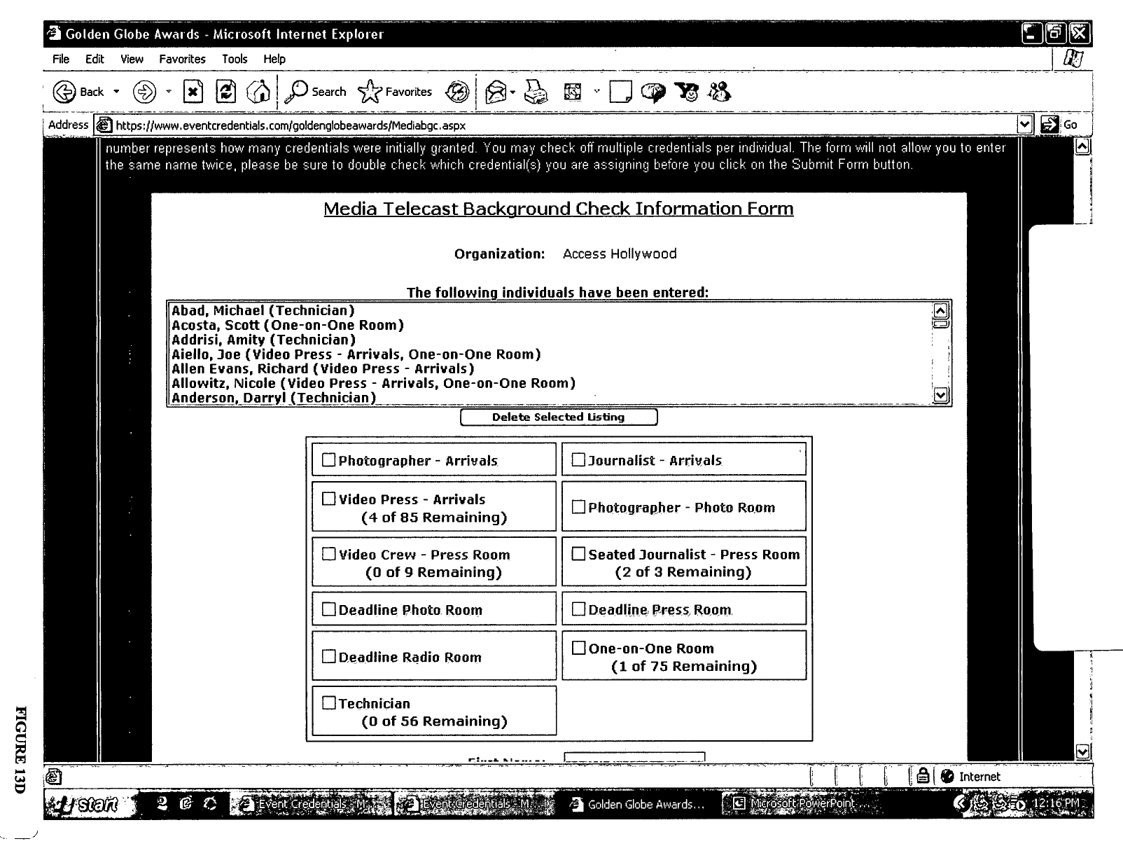

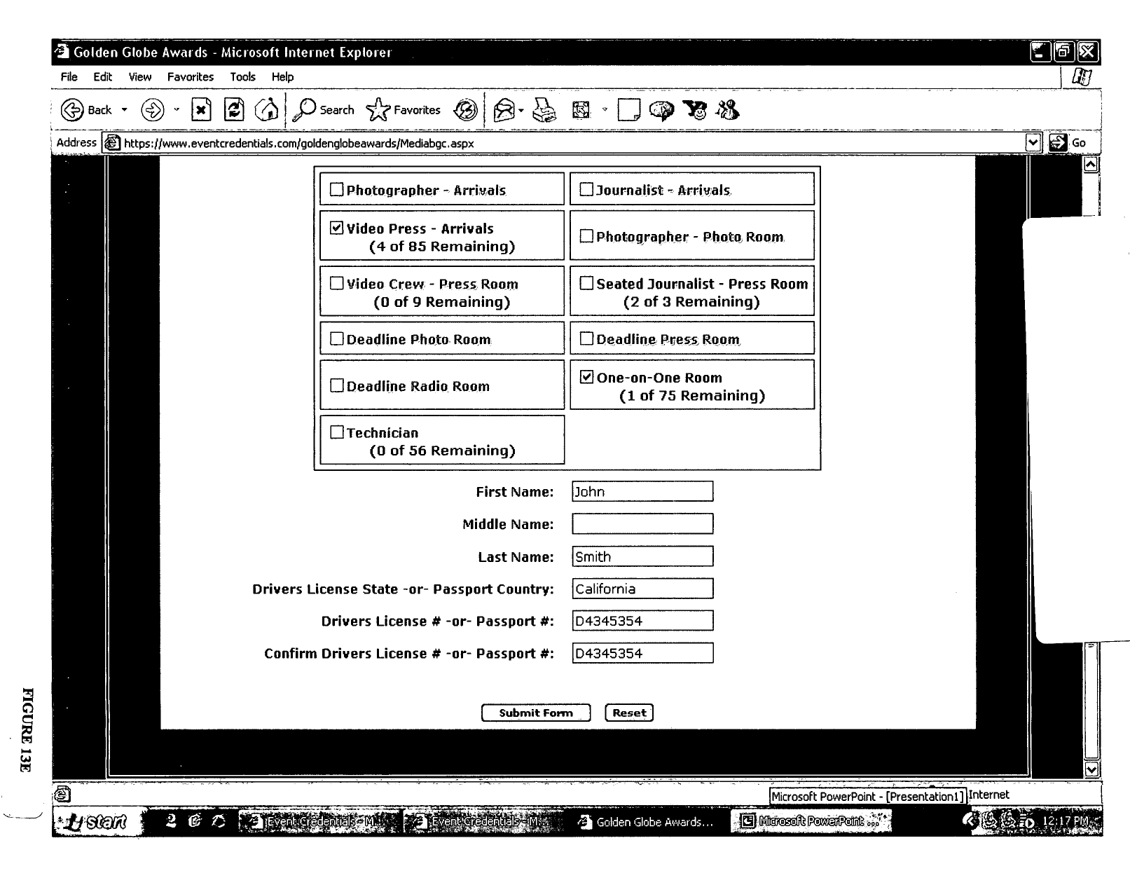

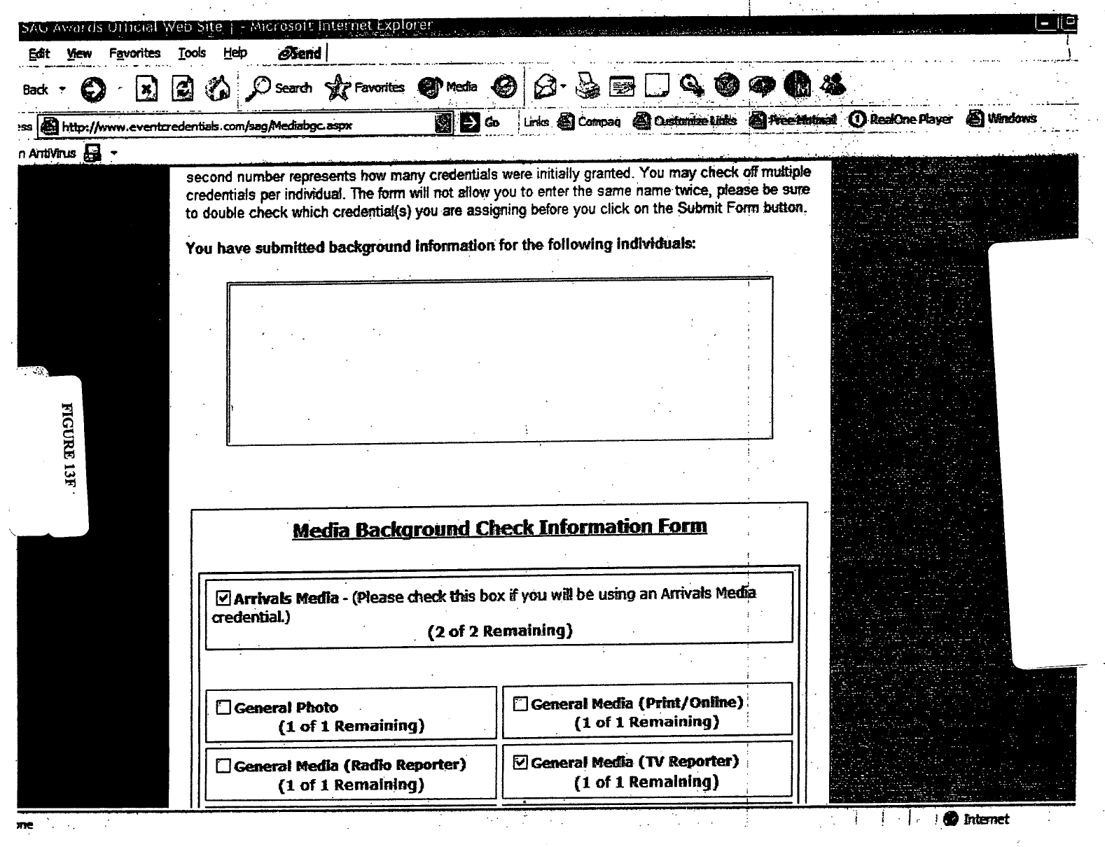

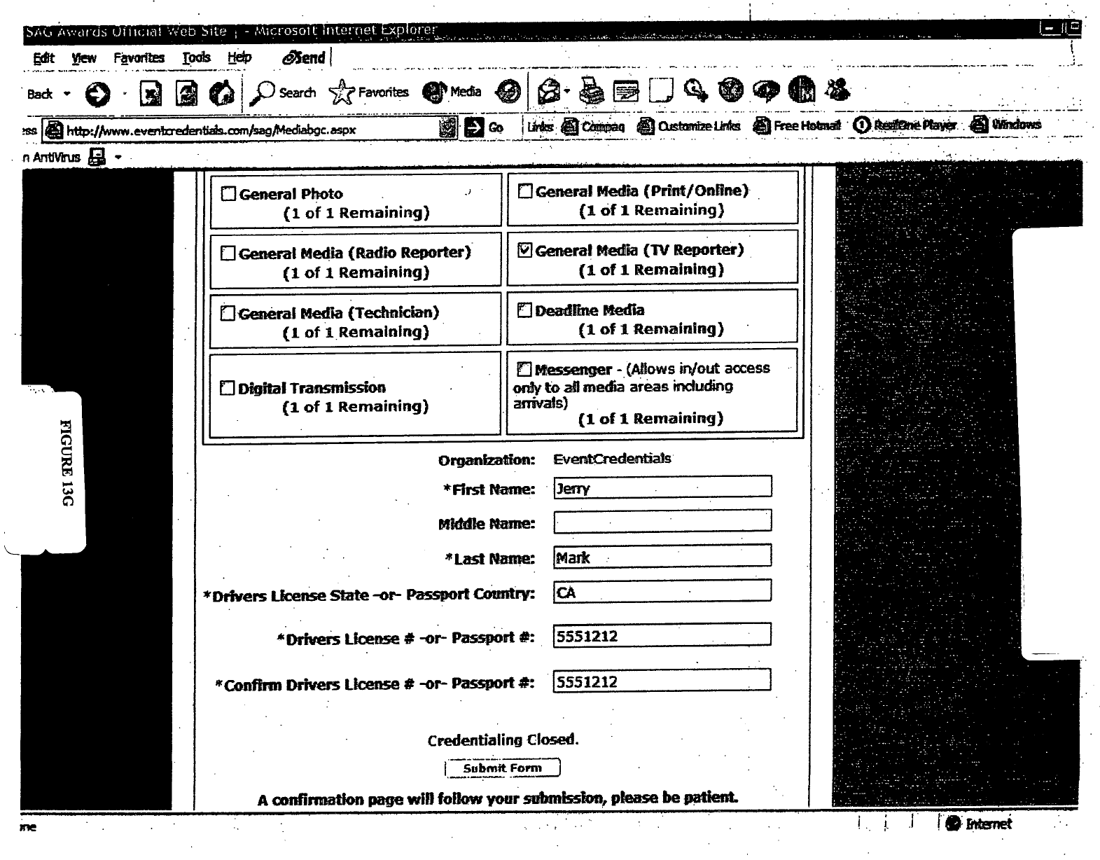

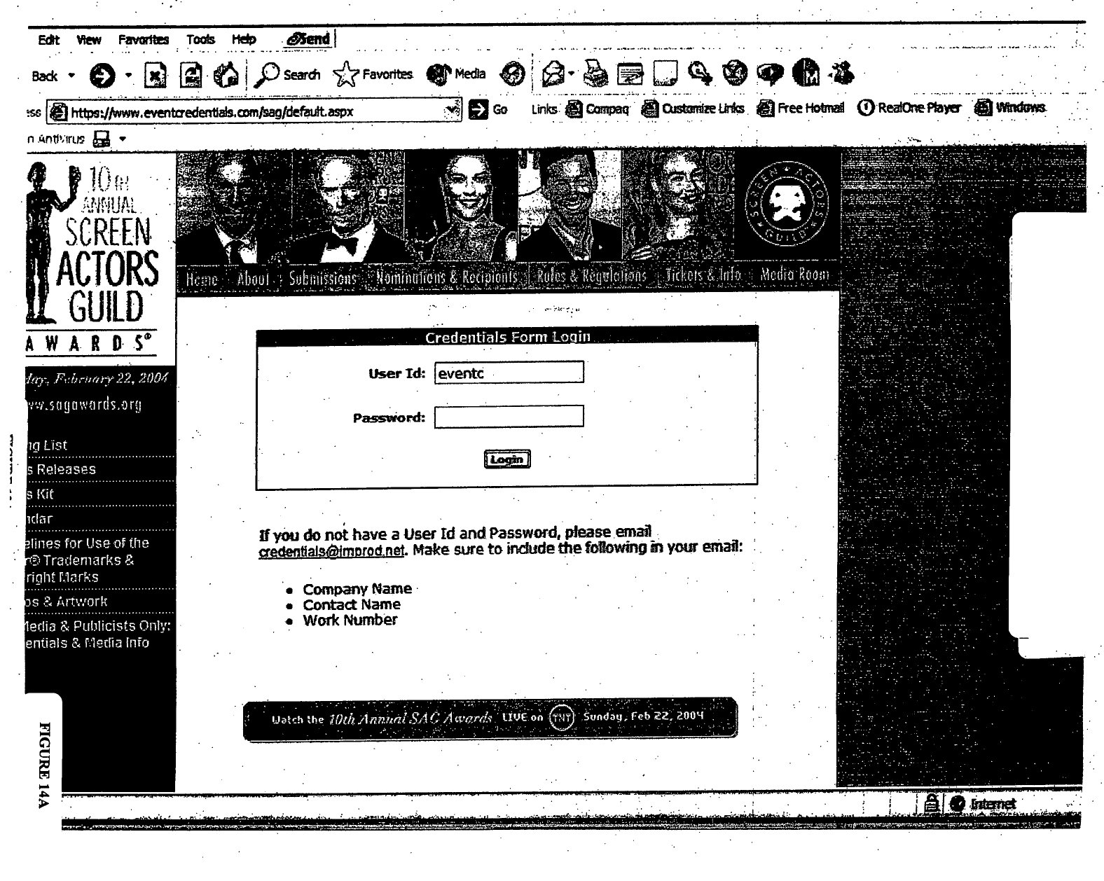

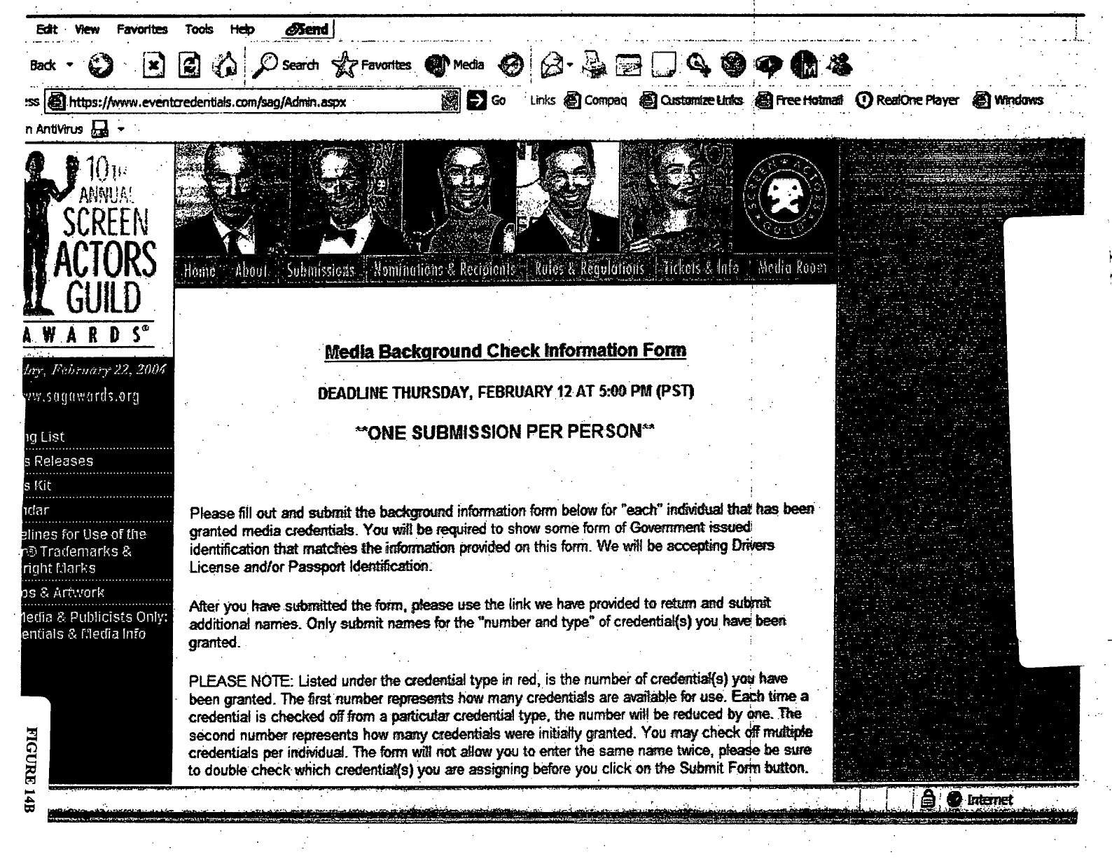

If the administrator 116 approves and/or modifies the registrants' or representatives' credential request, in blocks 322, 420, the registrant or representative 102 will see and then complete a media background check information form. FIG. 13A-G illustrates exemplary screen shots of an embodiment of a media background check information form.

If the user is a representative 102 that requested and received more than one credential for their organization, the representative 102 assigns individuals from the organization to the credentials. The representatives 102 select from a list of access areas and credential types that have been granted to them by the event's administrator 116, 120 and attach this credential type or access level to an individual from their organization. In blocks 324, 422, credentials are associated with access levels and event areas upon submission.

In addition, in an embodiment, the registrant or representative 102 completes background check information for the assigned individual, such as, for example, the individual's name, driver's license number, passport number, and the like. The background check information is entered for security purposes. In an embodiment, a government issued photo identification, such as a driver's license, a passport, or the like, is required to obtain access to the event. In an embodiment, security and governmental agencies cross-reference the information collected on the background check forms.

The event's administrator(s) 116, 120 grants a fixed quantity of credentials. Once the representative 102 submits the access areas and credential types assigned to an individual(s) from the company, in blocks 326, 424, the quantity of access levels and credentials available for assignment reduces automatically from the fixed quantity of granted access areas and credentials. FIGS. 13A-G and 14A-E illustrates exemplary screen shots of an embodiment of a media background check information form showing an automatic reduction of granted access levels and credentials. FIG. 13A-G also shows an example of how a previously entered name and credential(s) can be edited or deleted, thus automatically crediting back the used credential(s) for use by another registrant from that organization.

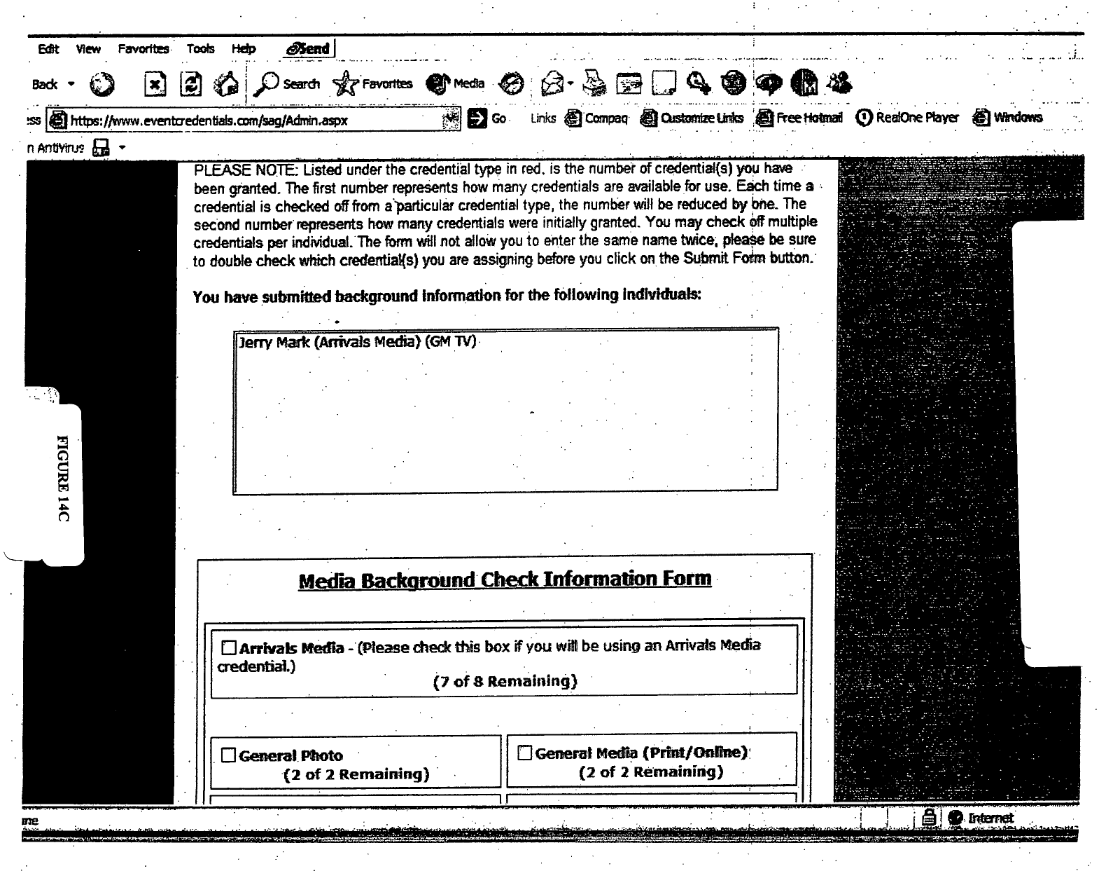

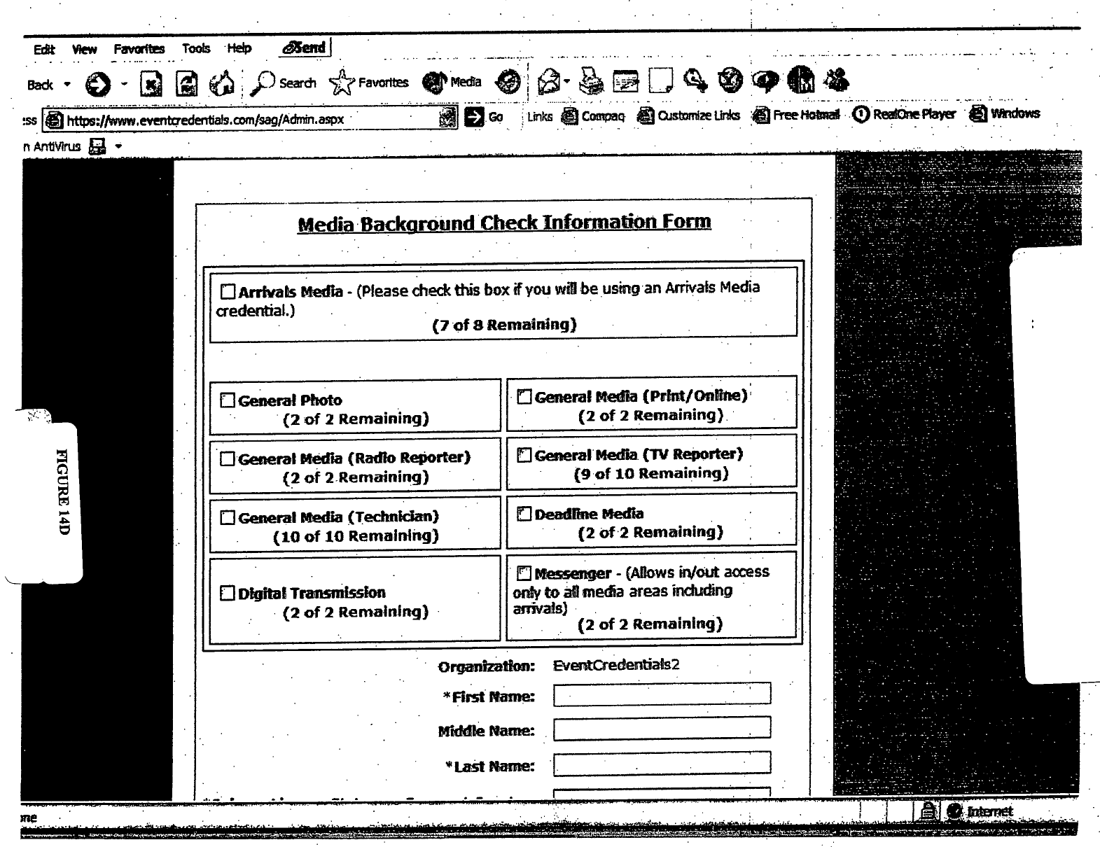

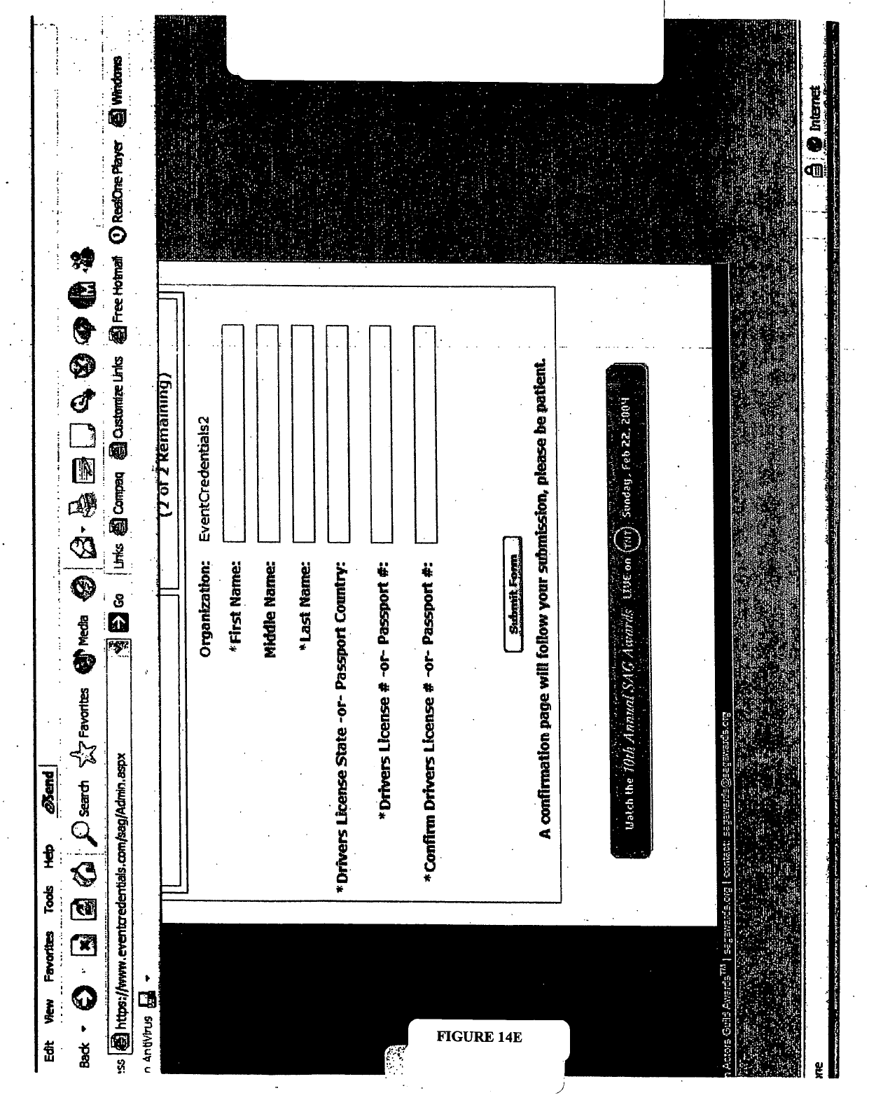

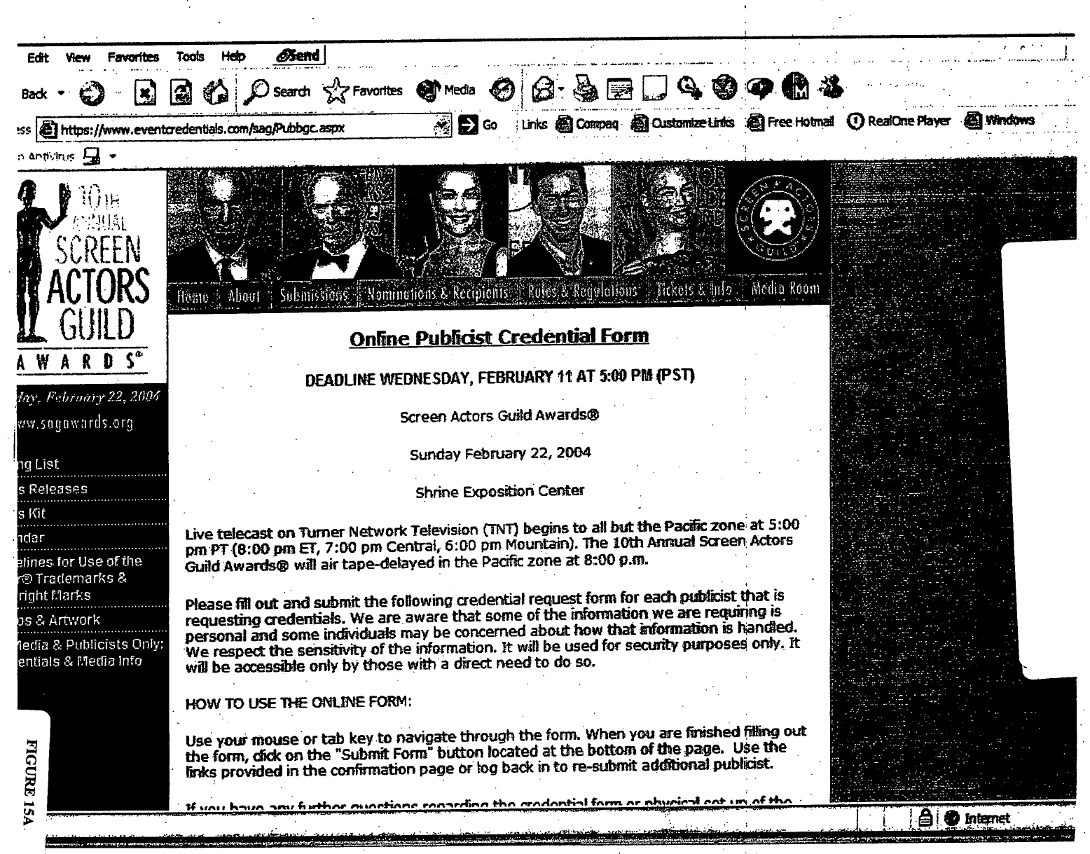

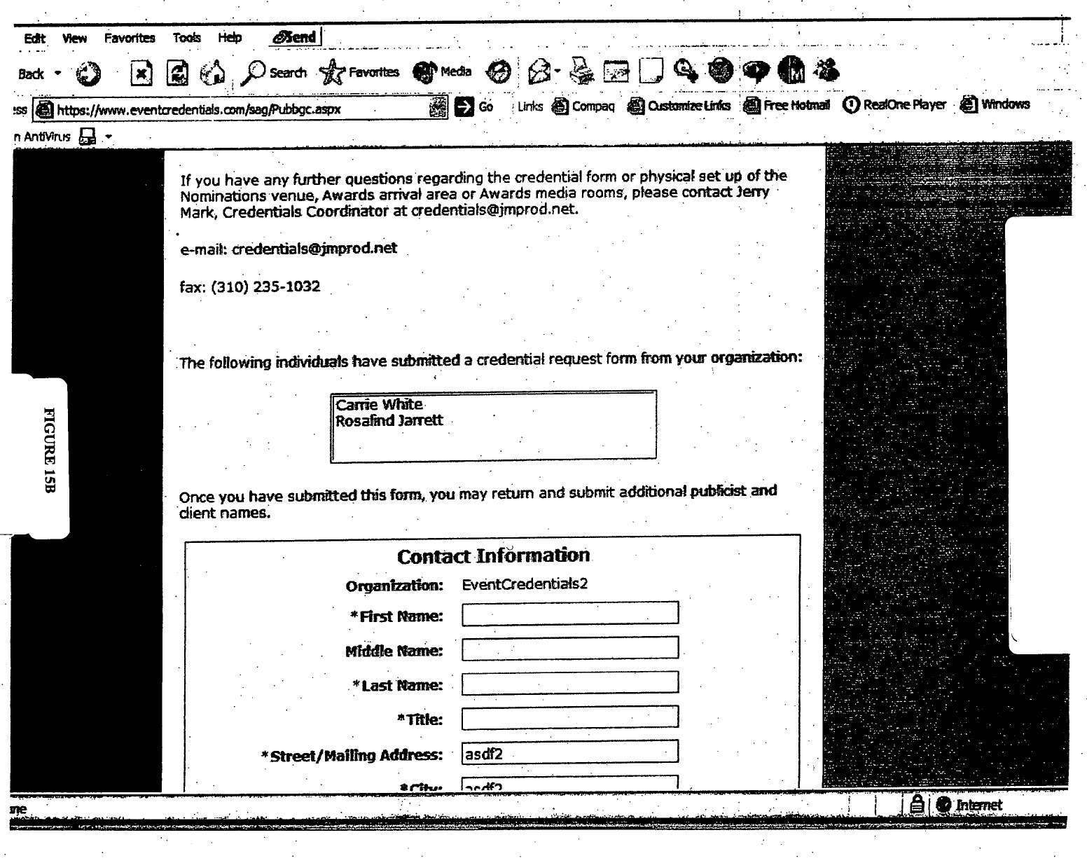

FIG. 14A-E shows seven remaining arrivals media credentials of eight arrivals media credentials granted or allocated after submission of the first individual for an arrivals media credential. In blocks 328, 426, the registrants and representatives 102 continue to assign access levels to individuals from their company and submit background check information for the assigned individuals until the registrants or representatives 102 exhaust the fixed number of granted access levels and credentials.

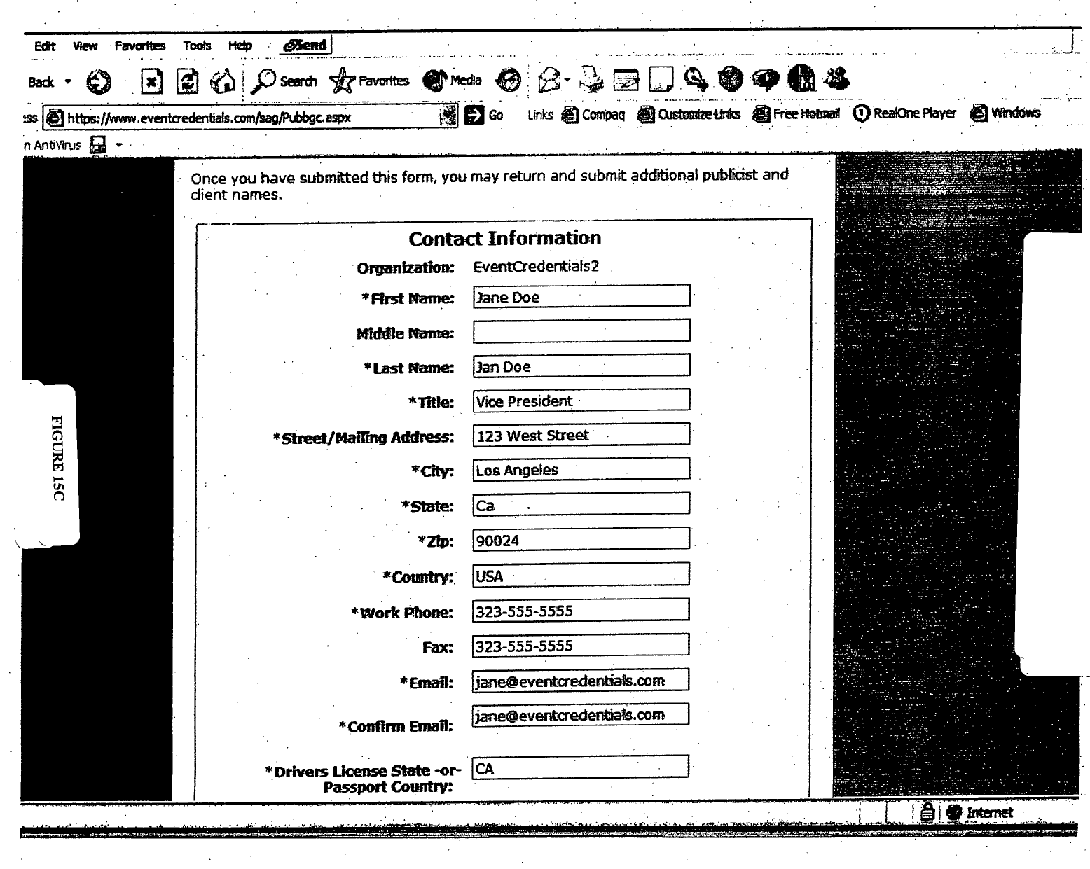

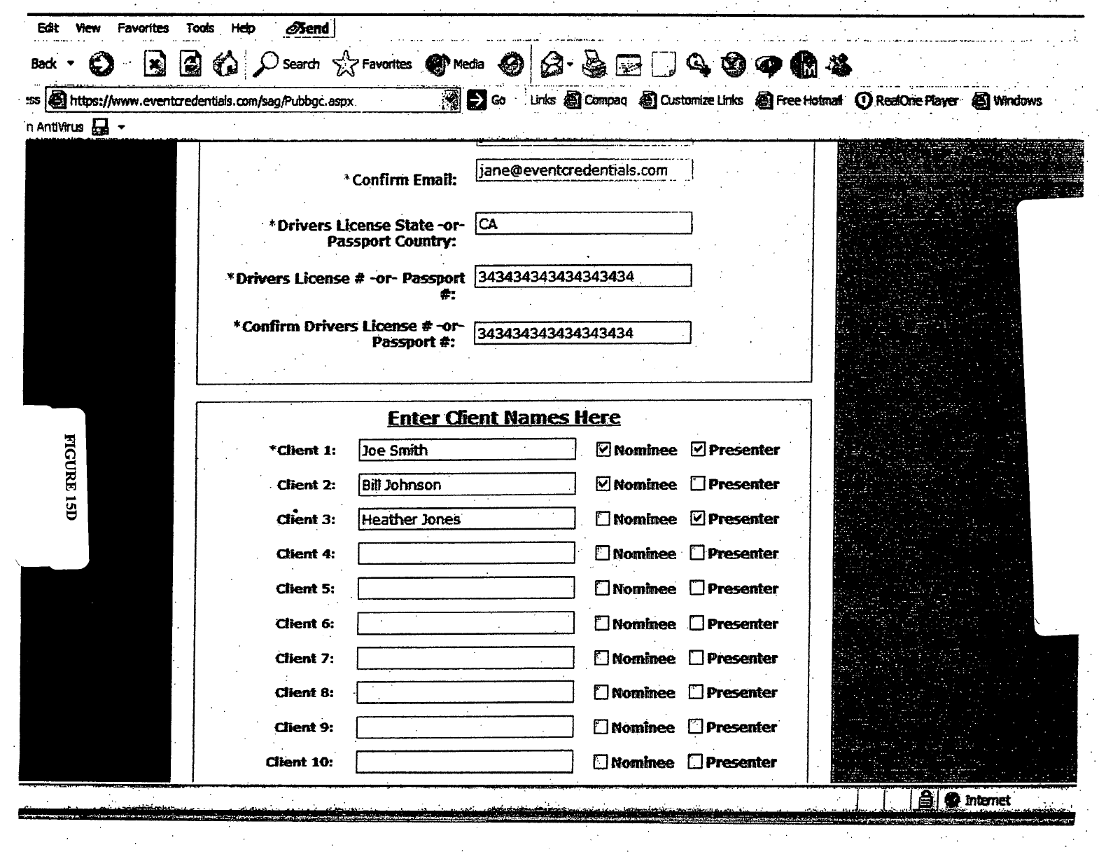

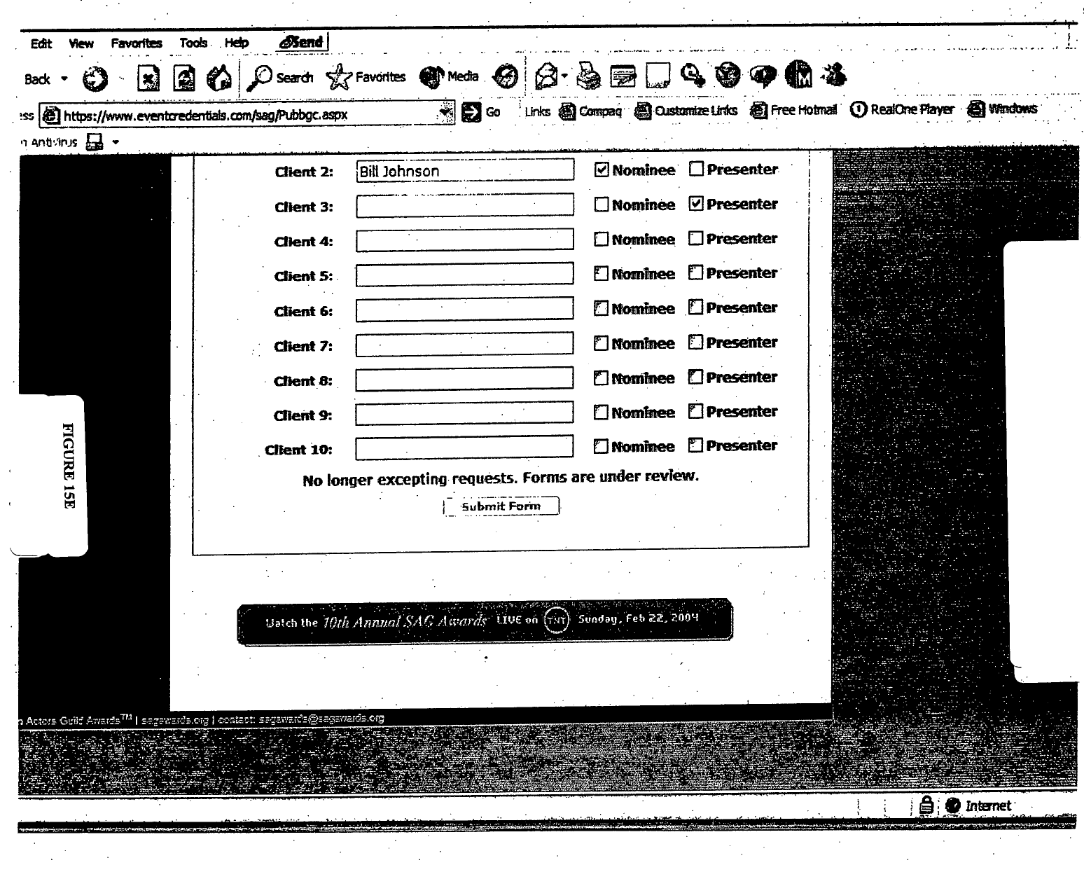

Other registrants and representatives, such as for example, publicist registrants or representatives 104, request event credentials in a similar manner to the process described above. FIG. 15A-E illustrates exemplary screen shots of an embodiment of a publicist credential form.

Publicist registrants or representatives 104 also submit the same contact information as mentioned above for the media registrants or representatives 102. In an embodiment, publicists 104 indicate on the application who their clients are and in what capacity their clients will be attending the event. For example, in the case of an award show, the publicists are asked the name of their client, if their client is nominated, if their client is presenting an award at some point within the production, and the like. The administrators 116 use this information to decide which credentials and areas of access the registrant 104 will be granted for the event or the areas of access can be pre-assigned by the administrator to be automatically assigned based on the answers received to the questions asked in the form.

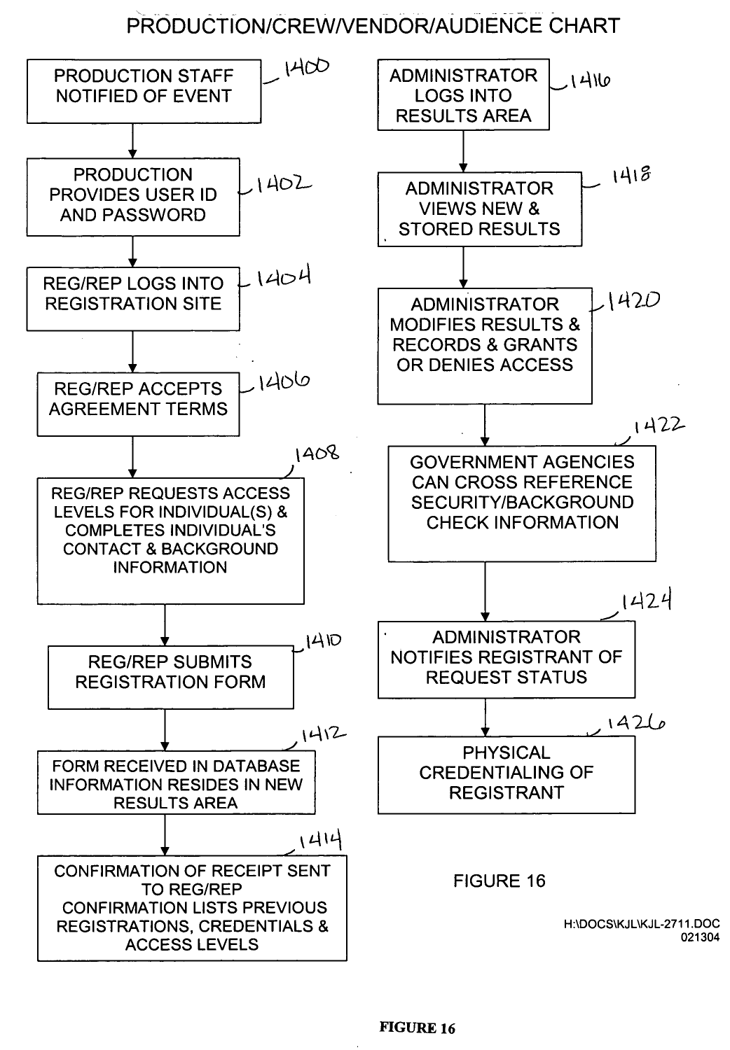

Other registrants, such as production crew 106, vendor staff 108, event staff representatives, guest representatives, and the like, access the site through the above mentioned login process, again obtaining a unique user identification and password. FIGS. 16-18 illustrate embodiments of a production/crew/vendor/audience/artist registration process.

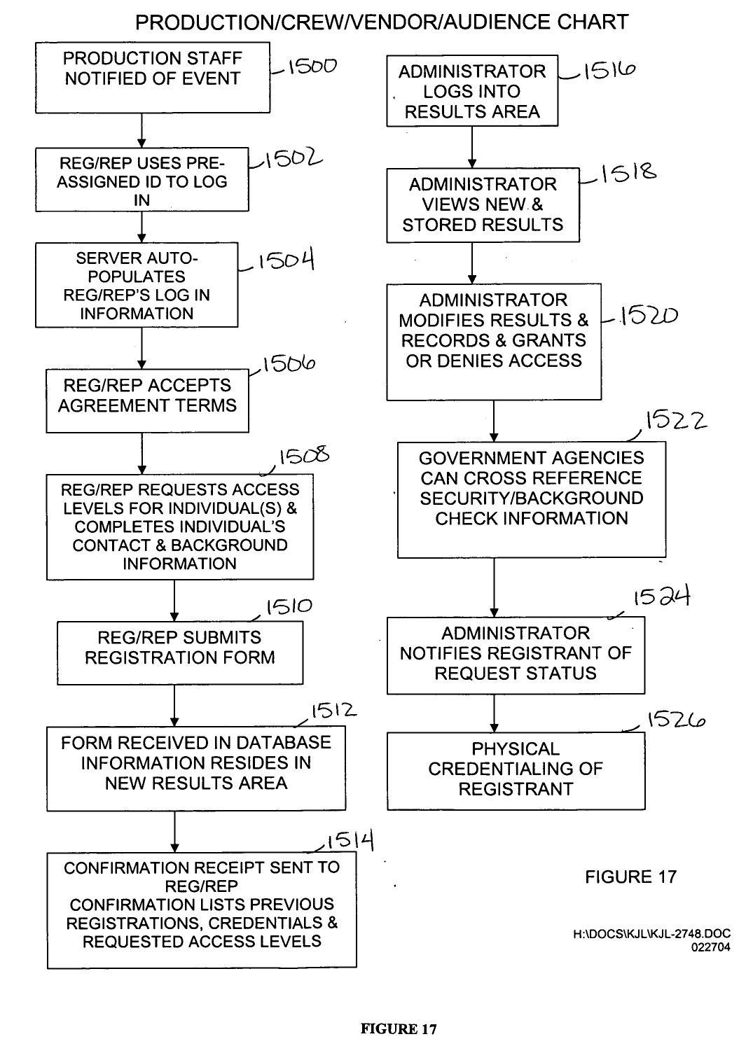

Referring to FIGS. 16 and 17, in blocks 1400, 1500, the production companies, the vendor companies, the crew companies, or the audience representatives receive notification of the event.

Referring to FIG. 16, the company requests a unique user identification from the access control and credentialing server 110. The server 110 generates the user identification and password, and transmits the user identification and password to the company. In block 1402, the company provides the user identification and password to its representative or to its individual registrants 106, 108, 122. In block 1404, the representative 106, 108, 122 logs into the registration site.

In an embodiment illustrated in FIG. 17, the company has a pre-assigned user identification. In block 1502, the company's representatives, or registrants 106, 108, 122 login to the server 110 with the pre-assigned user identification. In block 1504, the server 110 auto-populates the company's or individual's information and/or pre-assigned access levels by the production administrator 118. The server 110 directs the registrant or representative 106, 108, 122 to the first step in the registration process.

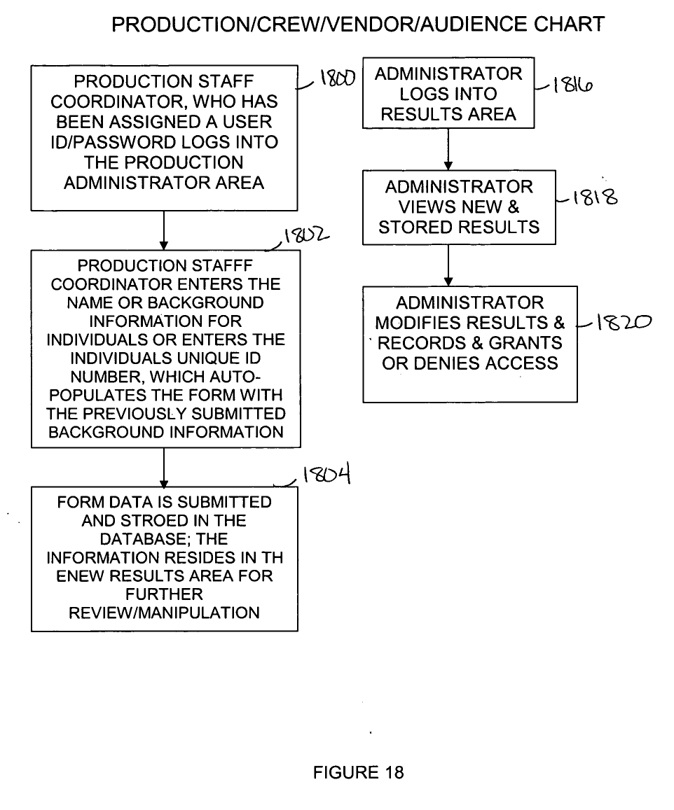

In an embodiment illustrated in FIG. 18, in block 1800, a coordinating member of the production staff is issued a unique user ID/password and logs into the site to submit the names, background information and access levels for other production staff members that will be working or attending an event. If the individuals being entered into the system have been previously issued a unique “master” identification number (EC ID number), the production staff member would only need to enter/submit the number, which would auto-populate in the form or the database in block 1802. The system could be configured to recognize that the EC ID number has visited the event in the past and auto-populate the access levels and any other stored information or photographic images and the like associated to the record in the database. Whether their name/information is manually submitted or an EC ID is used to submit the individuals information the record will reside in the New results area located in the Event Administrator area for latter review and/or manipulation and/or approval or denial by the administrator in block 1804. Over time, a unique master EC ID will be generated and stored for all individuals who registered for an event through the software. Personal contact information including, but not limited to, driver's license number, email address, company name, photograph and the like will be stored in the master database for later recall on any event they attempt to register for that uses the software.

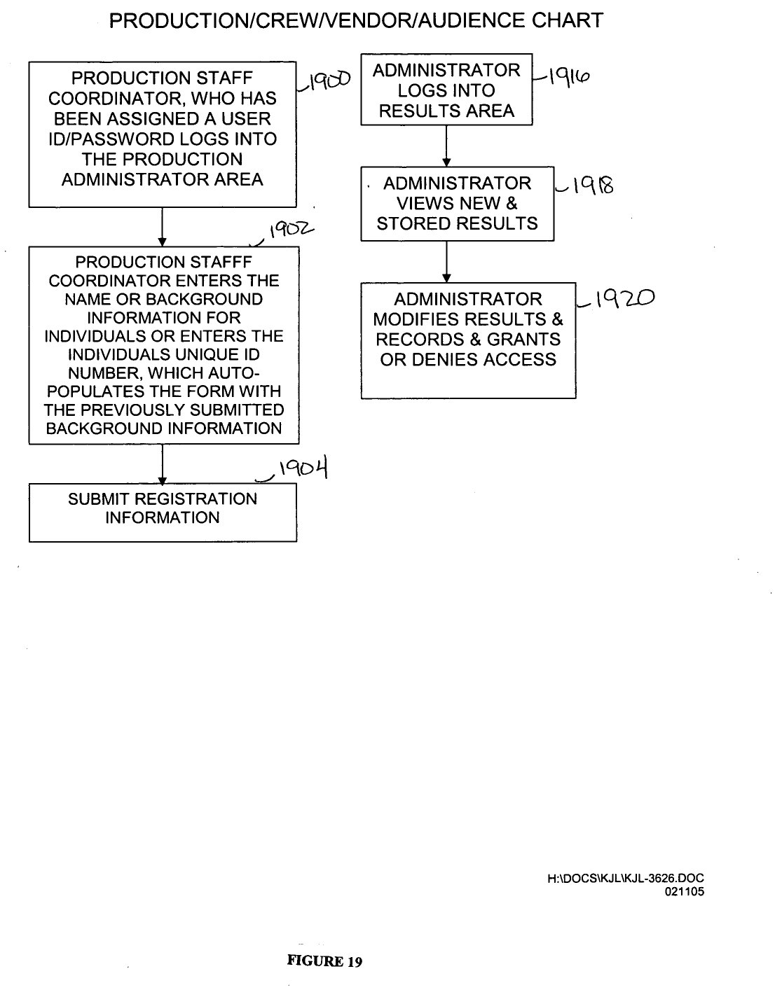

In an embodiment illustrated in FIG. 19, each member of the production staff is notified of the event in block 1900. In block 1092, each production staff member visits the website and provides their name, background information and, if allowed by the event administrator, requests their access levels for the event. The access levels could also be assigned to their record later on by the Administrator during the Administrator review process if the administrator would rather it that way. The end user could also enter their previously issued “master” EC ID number, which would auto-populate their background information and the like into their individual record in the database for this event. Whether their name is manually submitted or an EC ID is used to submit the individuals information in block 1904 the record will reside in the New results area located in the Event Administrator area for latter review and/or manipulation and/or approval or denial by the administrator.

Referring to FIGS. 16 and 17, in blocks 1406, 1506, the registrant or representative 106, 108, 122 accepts the terms and conditions of the event's organizers before proceeding with the credential and access level registration.

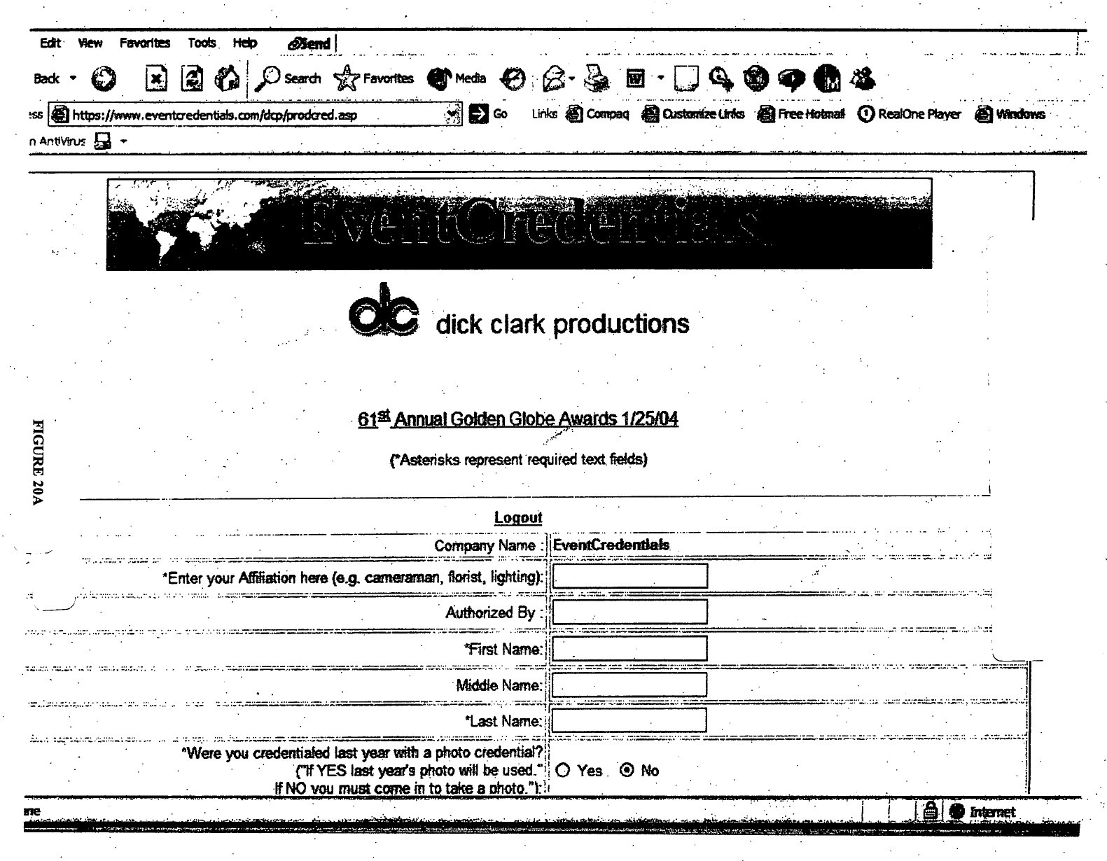

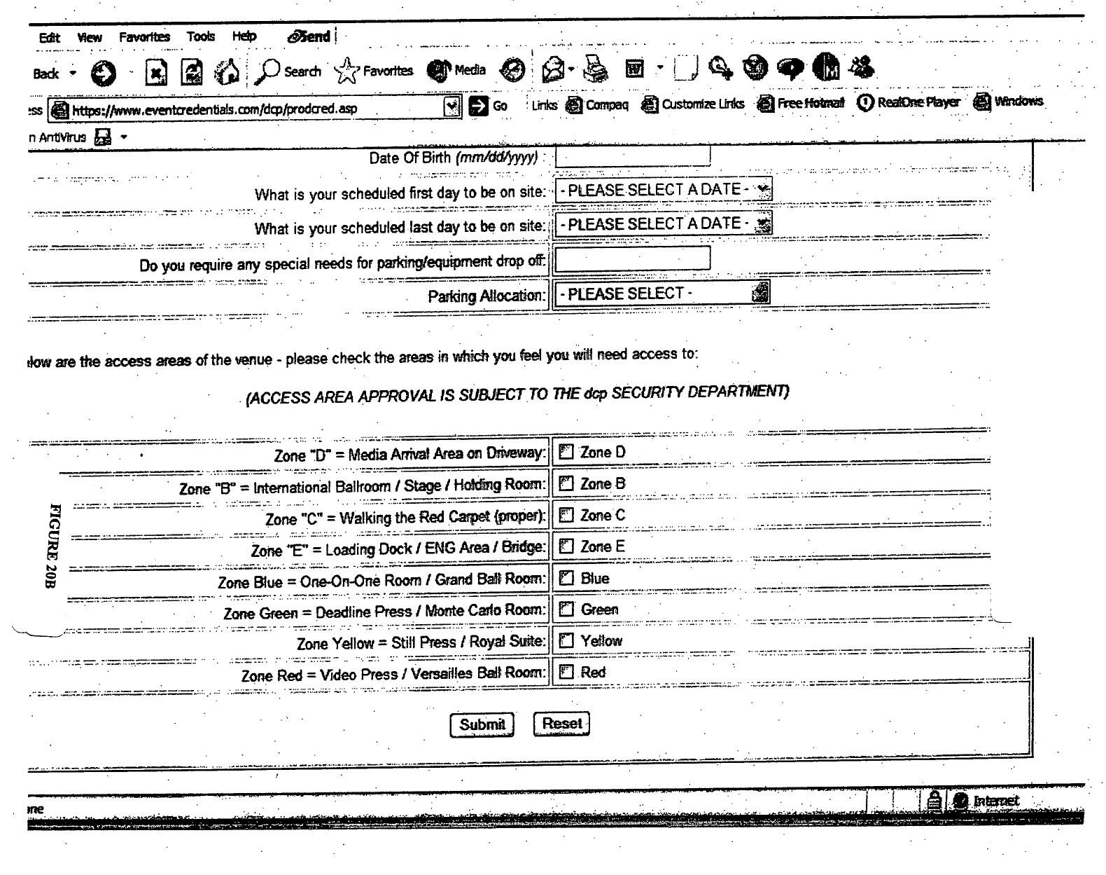

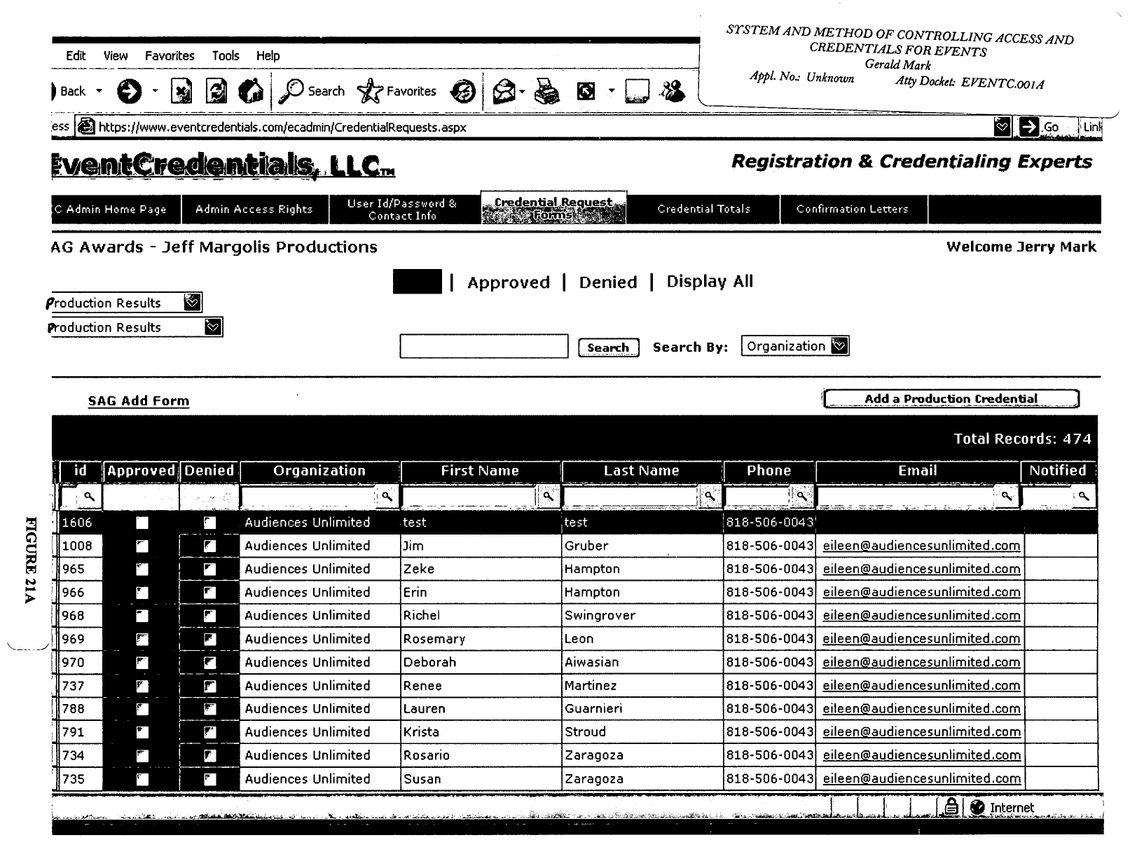

FIG. 20A-B illustrates exemplary screen shots of an embodiment of a production credential registration form. The credential registration process and credential registration forms are similar for other registrants, such as, for example, vendors, crew, security, artists, fans, guests, audience, and the like. The production registrants 106 submit one application per person. In an embodiment, a company may assign a representative 106 to register for a group of employees from the company. This form could be a public (non-password protect page) or could be located behind a generic user ID/password login process, meaning that there could be one user ID/password used for anyone viewing/submitting information through this form.

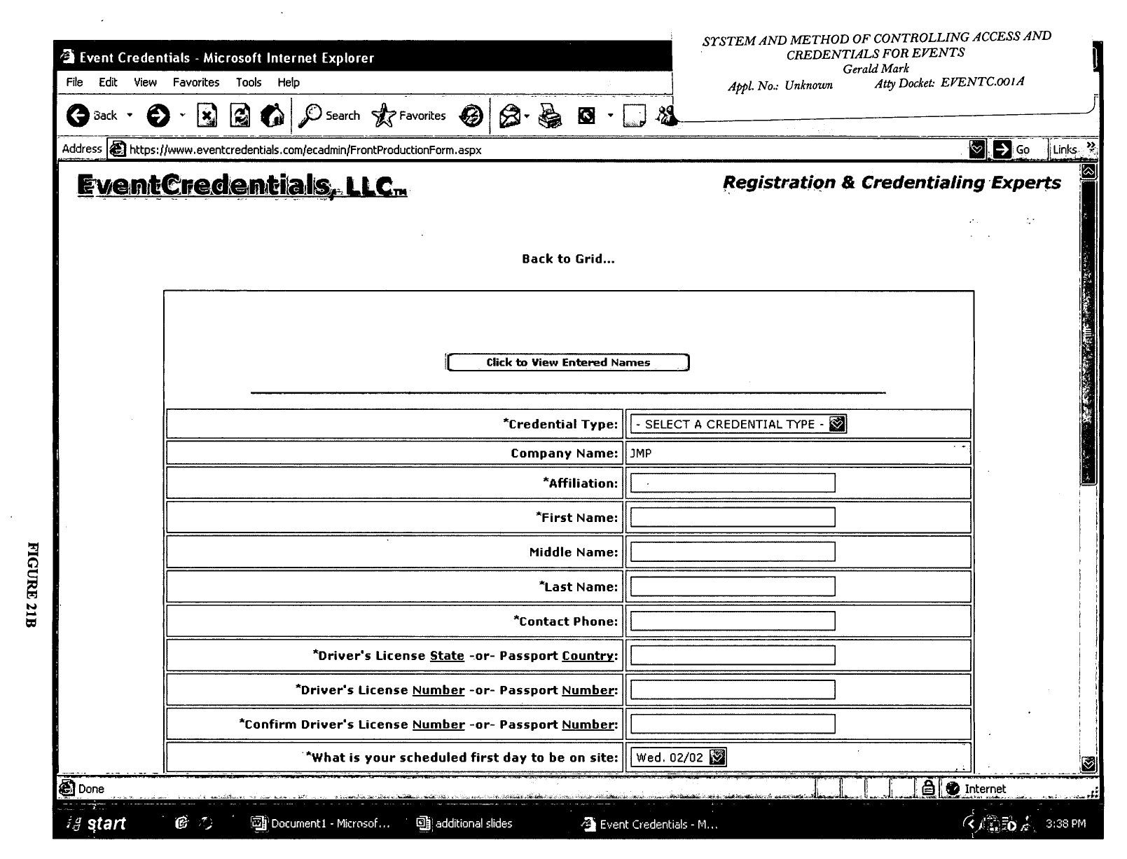

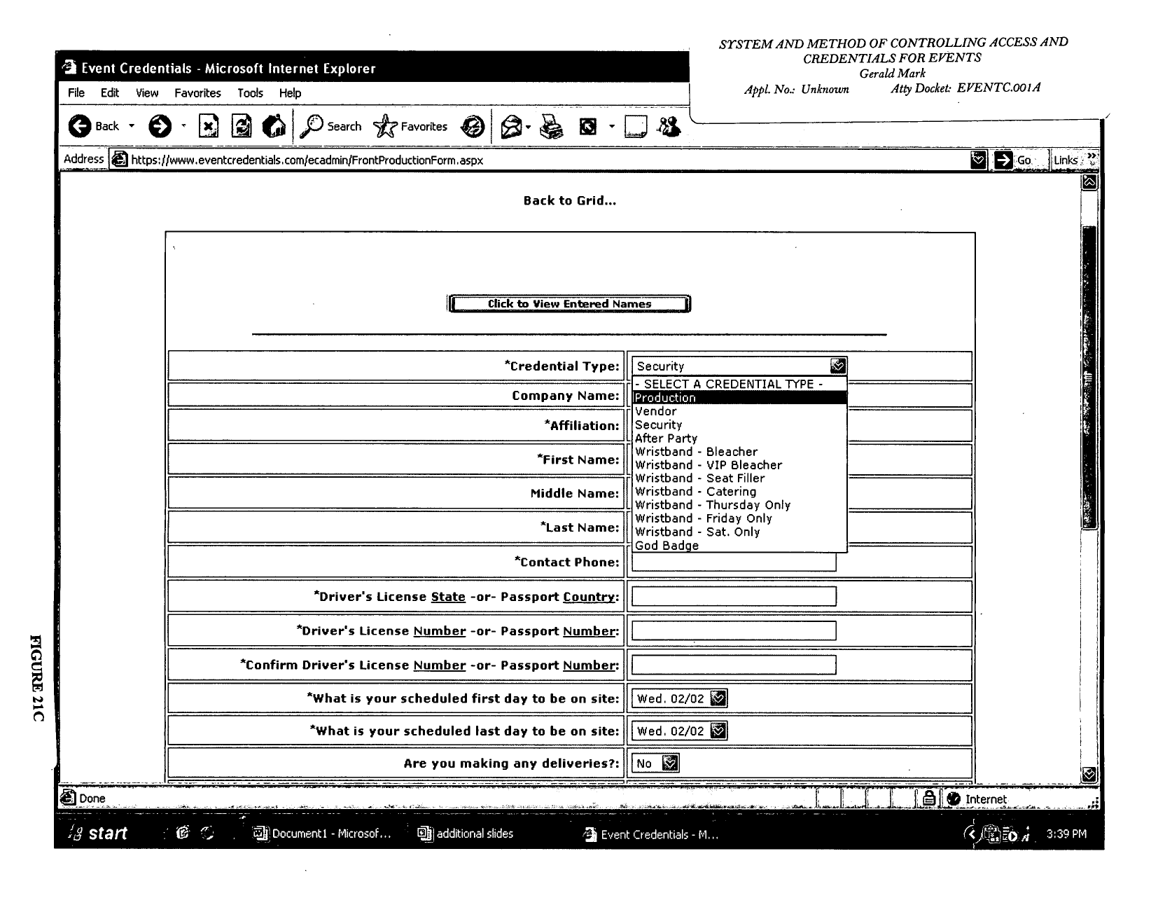

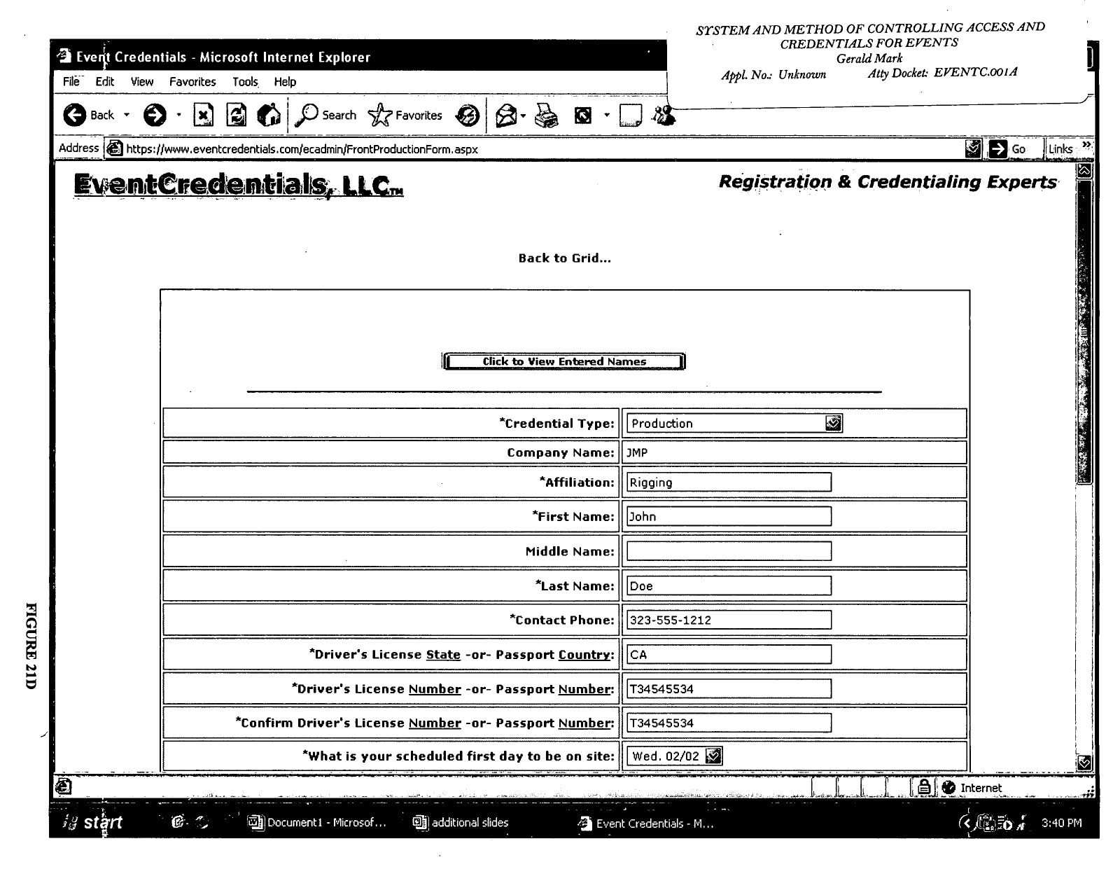

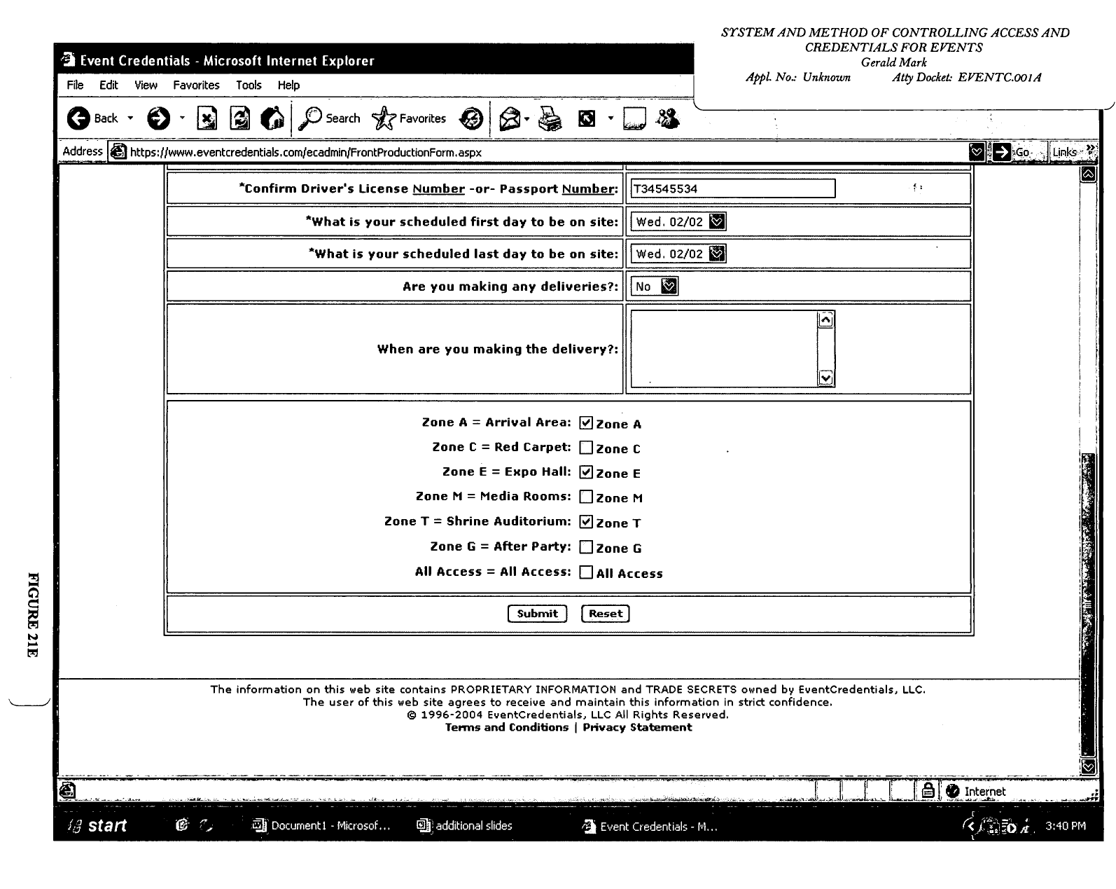

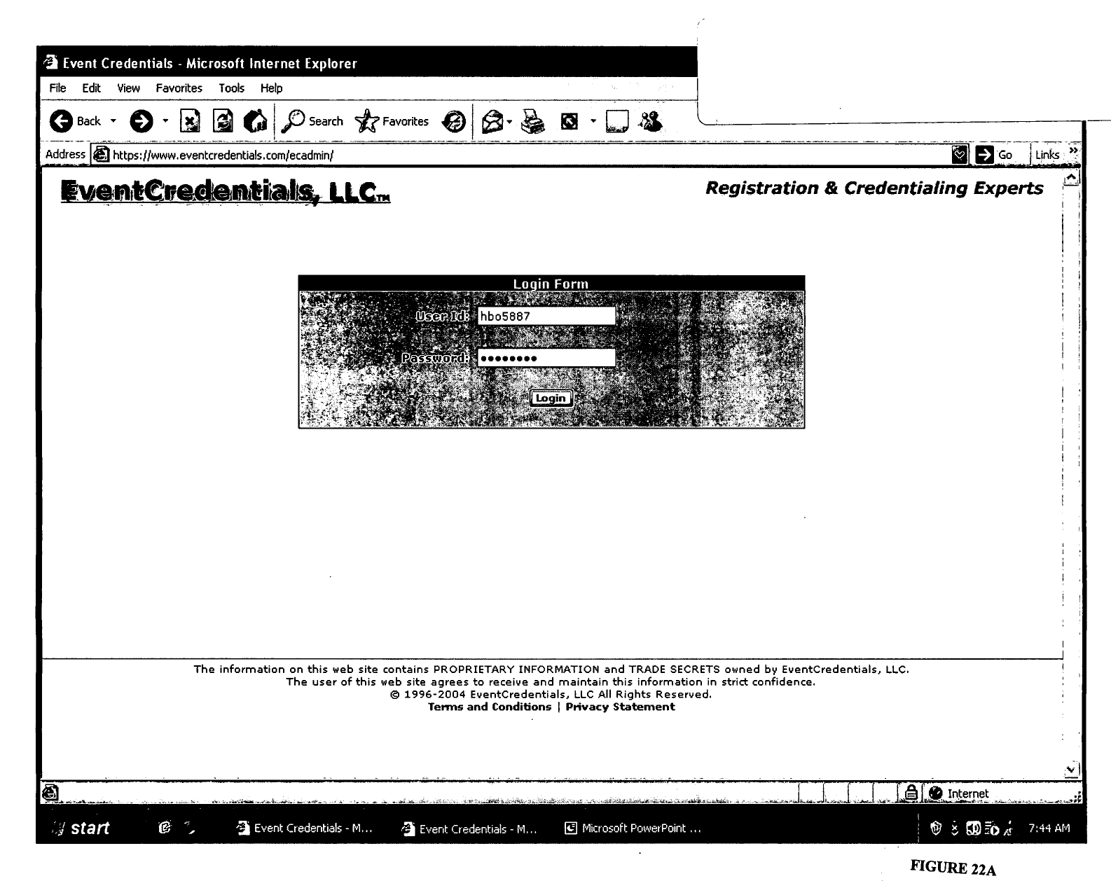

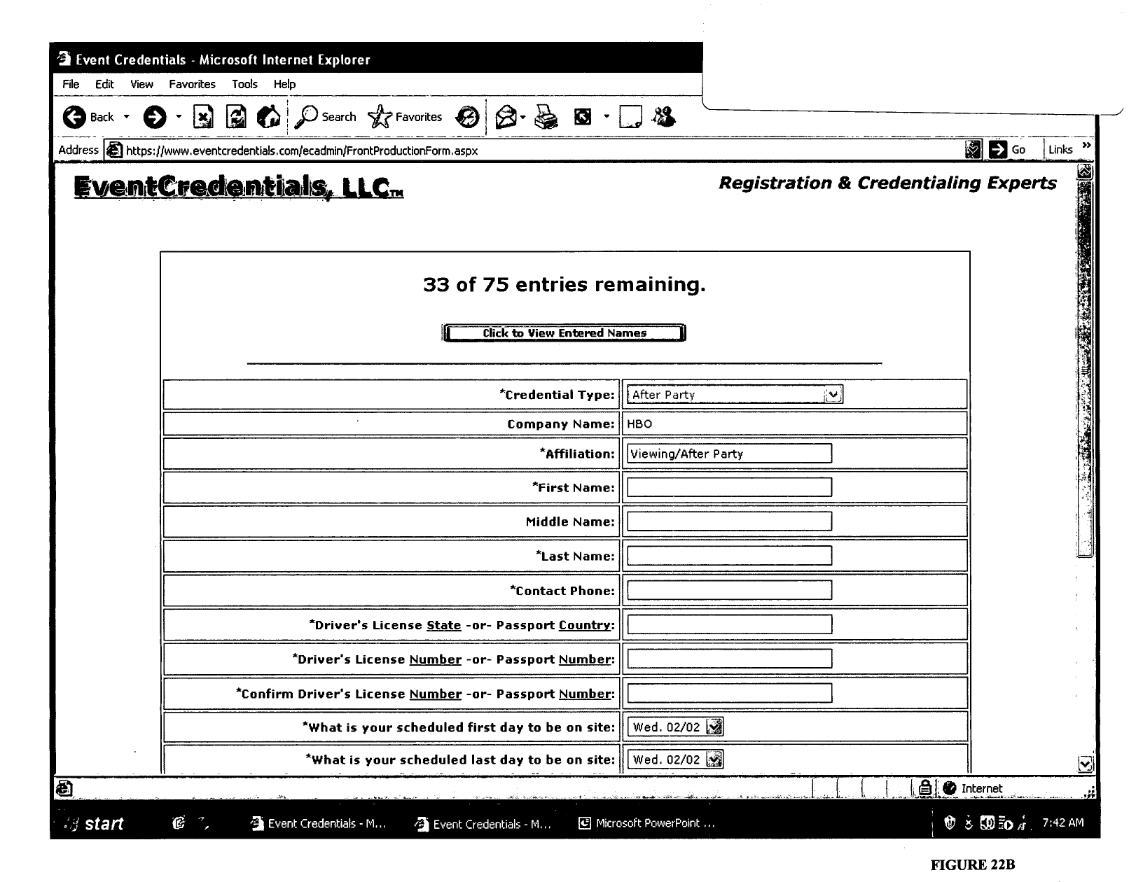

FIG. 21 illustrates exemplary screen shots of an embodiment of a results area, which houses the button/hyperlink to an internal credential request form. The production staff member or administrator, who has been assigned a unique user ID/password would be able to visit this page and click on the button/hyperlink called “Add a Production Credential” which would take them to the internal credential request form. Some or all fields of this form can be configured to auto-populate required data needed during the administrator review process based on the recognition/configuration of the hyperlink used to gain entry. All records entered in through this form from this link are assigned a unique database number, which allow for mass updates of any or all information obtained. Access levels can be assigned by the production staff member at time of form submission or later on using the mass update tool or individually by the administrator during the Administrator review process.

Referring to FIGS. 16 and 17, in blocks 1408, 1508, respectively, the production registrant 106 requests the areas of access, and completes the background check information. In an embodiment, the background check information is the individual's name, driver's license number, passport number, and the like.

After the registrant 106 completes the credential and access level registration form in blocks 1410, 1510, the registrant 106 submits the form to the credentialing server 110. In blocks 1412, 1512, the information resides in the new results area of the database 114. In blocks 1414, 1514, the server 110 sends the registrant 106 a confirmation receipt with a listing of previously submitted registrants 106 from the registrant's company.

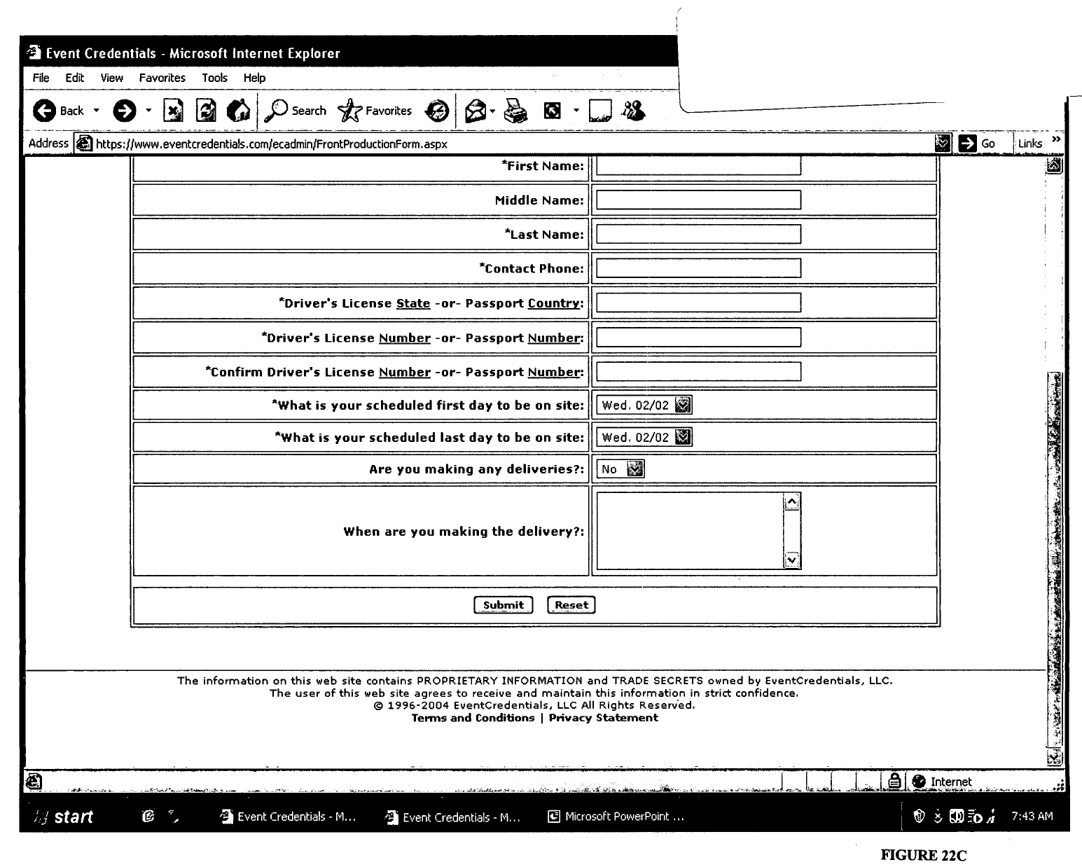

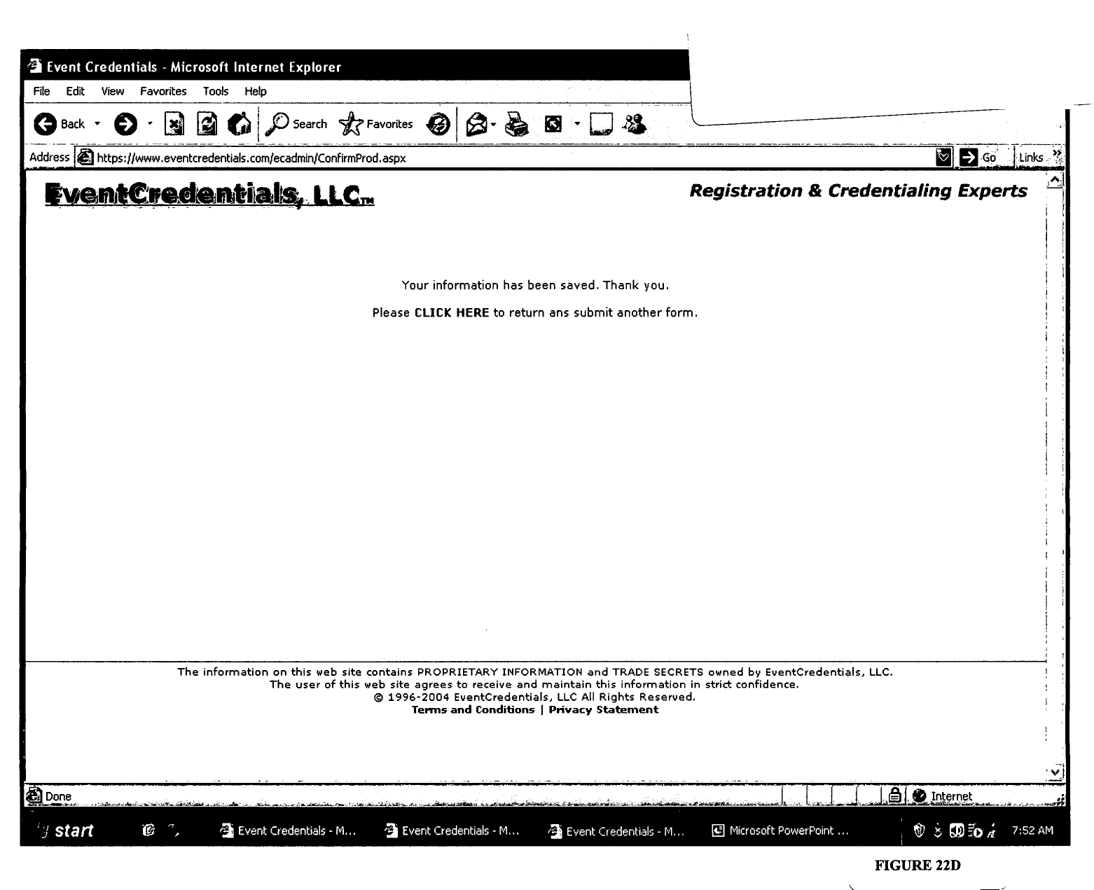

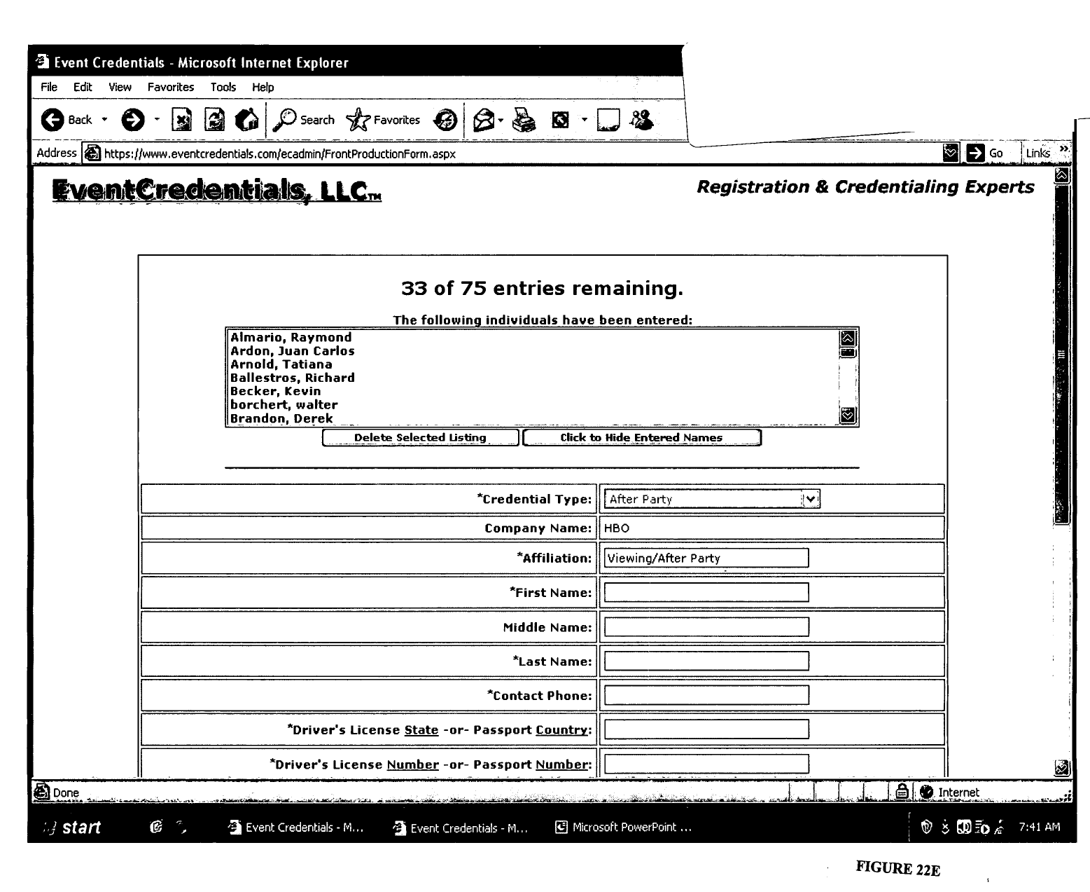

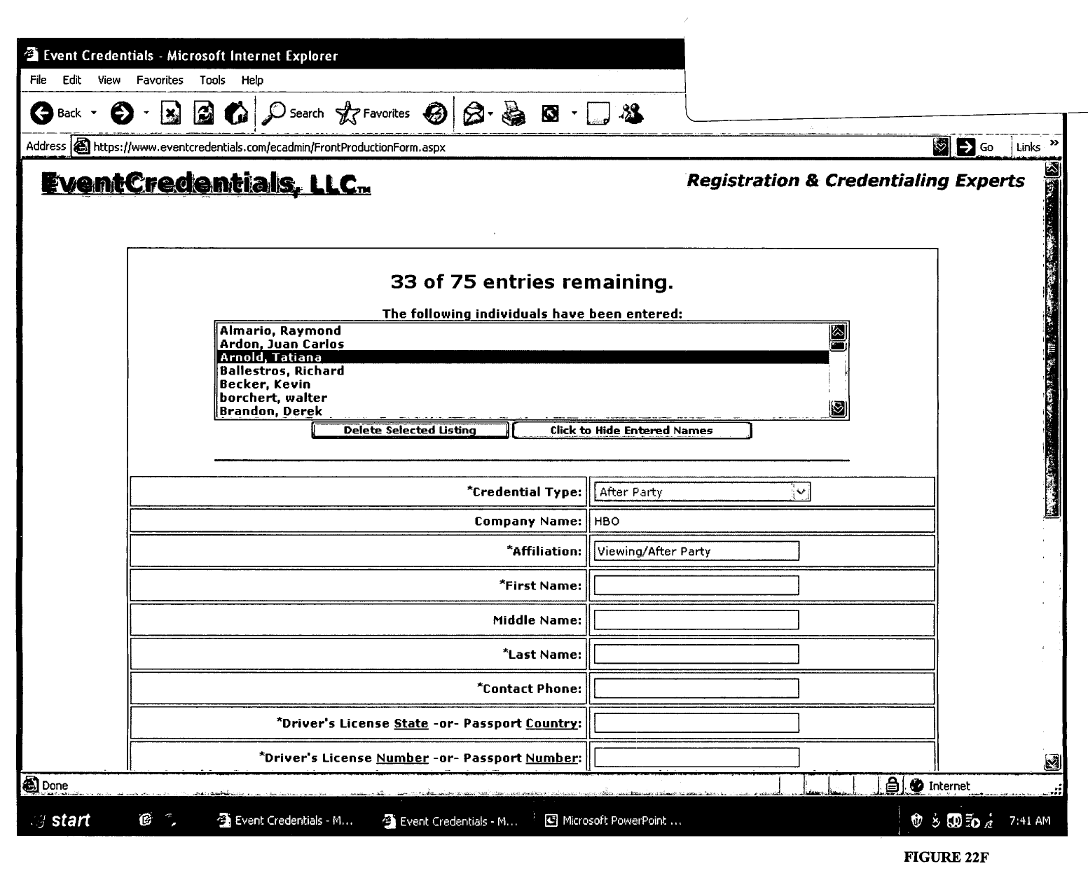

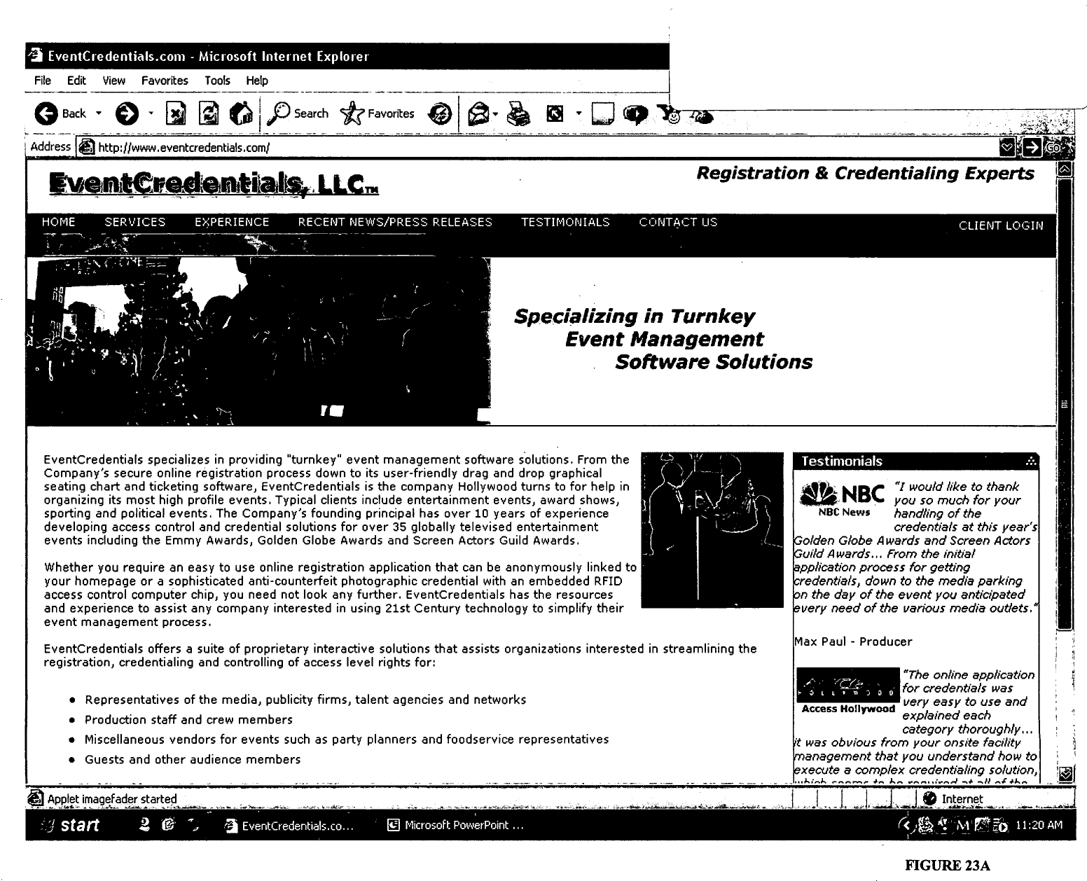

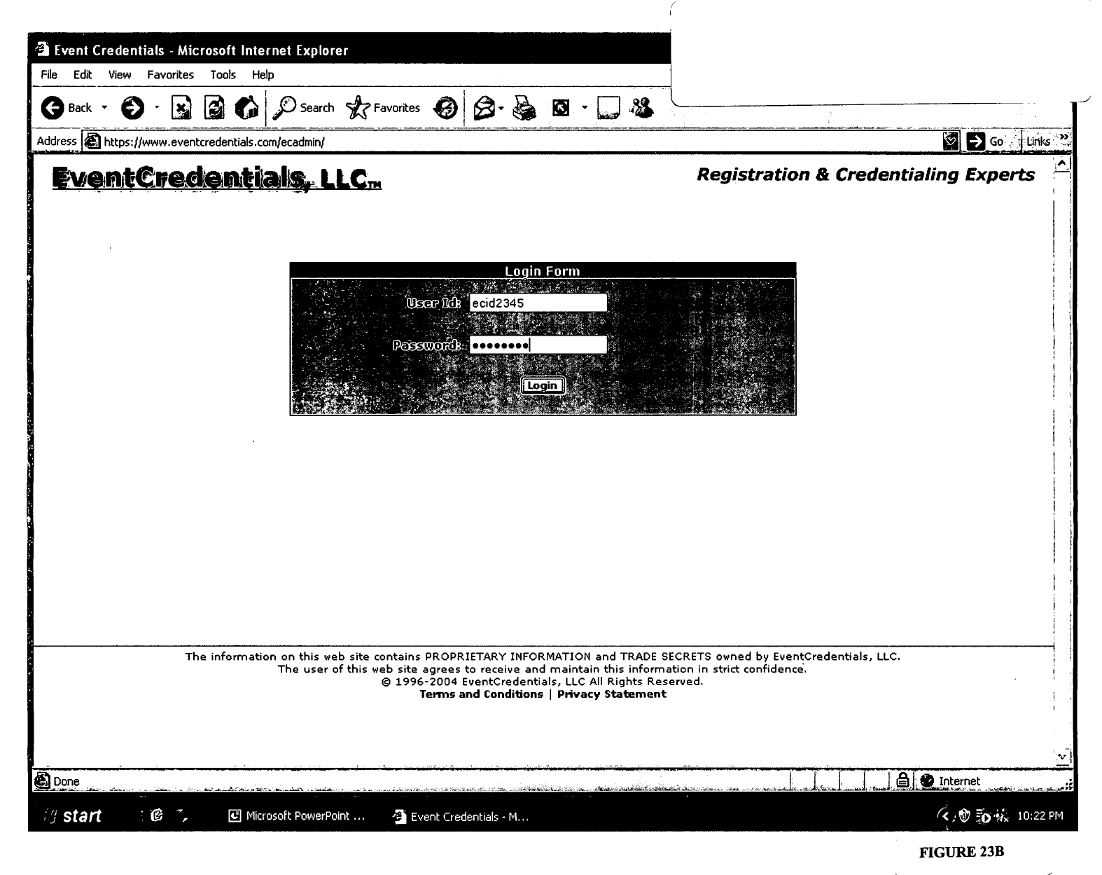

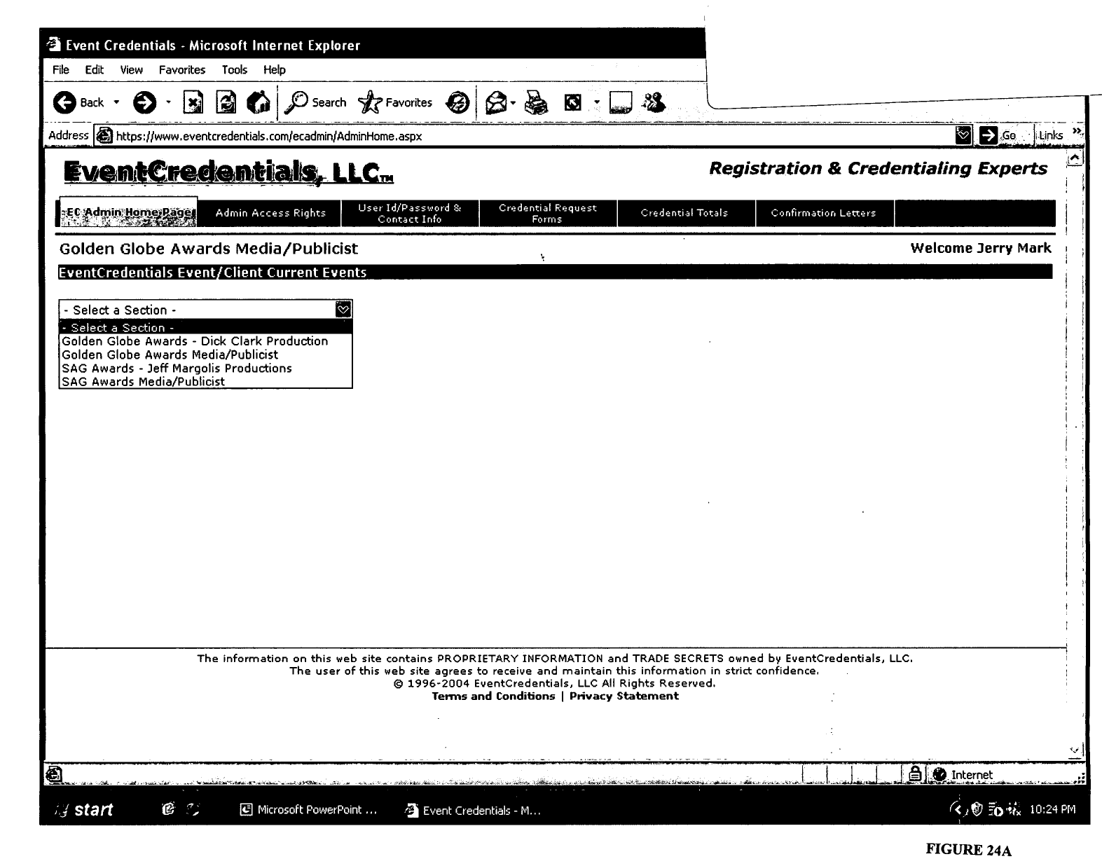

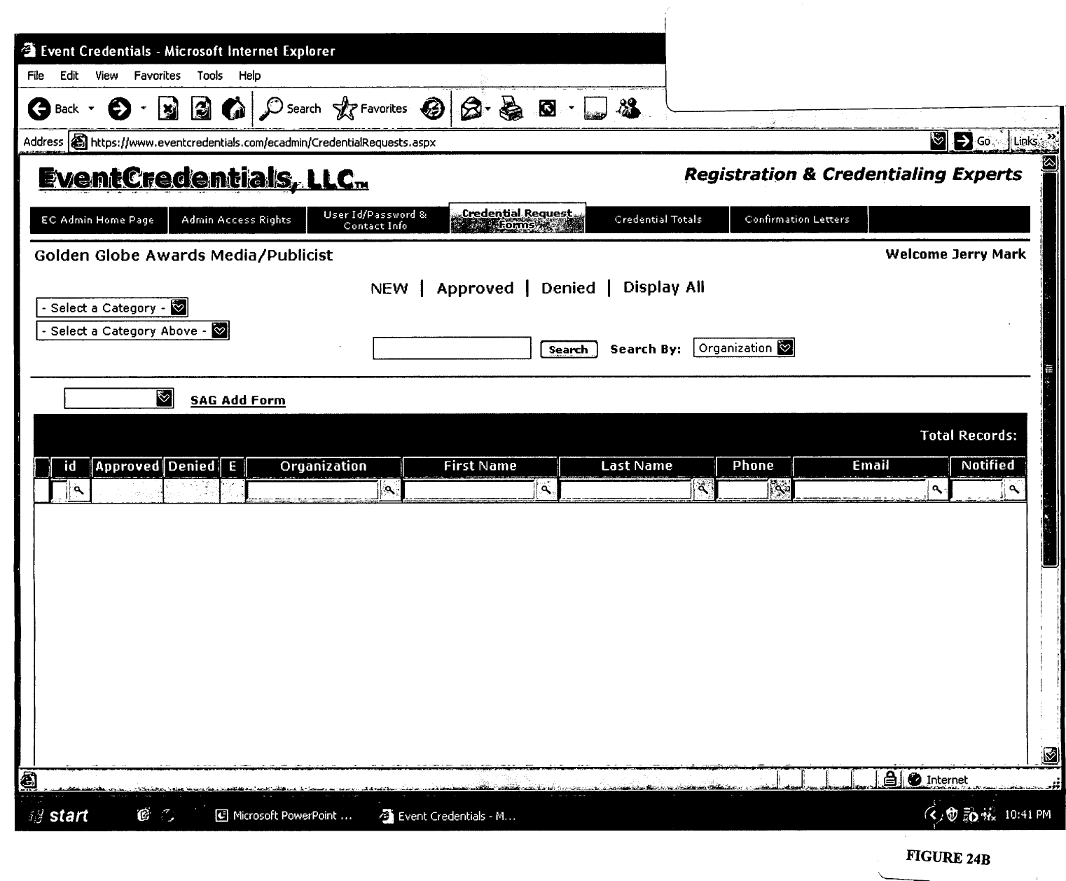

FIG. 22A-F illustrates exemplary screen shots of an embodiment of a pre-assigned vendor/production user ID and password login and registration area. Production staff, vendor, artists, audience/fans, guests, and the like are issued a unique user ID/password to login and submit their personal information and/or in some cases, their credential request. The unique user ID/password is associated to a record entered by the administrator in the administrator area of the system. This allows for any or all data entered previously by the administrator to be auto-populated in the form once the individual has entered their unique user ID/password assigned to them. In the cases where an individual may be filling out the form and submitting multiple times for many individuals, needing access from their company, the form will automatically calculate the number of times it has been submitted and reduce the number of entries each time. At the time the administrator submits the information for the creation of a unique user ID/password, the administrator can also program into each individual ID/password the exact number of forms that are allowed to be entered under the specific user ID/password. Thus, limiting the number of times a credential request form can be submitted. In addition, the administrator can also associate zones/access levels with a form or EC ID number so that the zones will be auto-populated into the form. This form also indicates to the user the names of those individuals who have already been submitted under the assigned unique user ID/password in a text box above the form, which can be opened or hidden. The names/records in this text box can be selected and viewed back in the form for editing/deletion if needed.

### Administrators Review And Modify Requests

Often times an event can have multiple decision makers or administrators 116, 118, 120 overseeing multiple areas of access to an event. Administrators 116, 118, 120 access the administrative area of the site to review registrants 102, 104, 106, 108, 122 completed forms as well as to approve, deny, delete, update, and edit any records that have been submitted via any of the completed online forms. The administrators 116, 118, 120 approve and deny the event credentials requested by the registrants and representatives 102, 104, 106, 108, 122 for the event.

Multiple administrators 116, 118, 120, such as, for example, the event's public relations firm, the event's security, the event's producers, the event's organizers, and the like, can access the site to view in real time results generated by the forms submitted by registrants and representatives 102, 104, 106, 108, 122 that pertain to their portion of an event or the whole event. Certain administrators may be limited in their ability to control and grant registrants' and/or representatives' access levels. In an embodiment, the administrators 116, 118, 120 are limited to control access levels for the venue area they are managing. Referring to FIGS. 3A and 4A, media administrators 116 access the media administrative area of the site to review media registrants 102 completed forms as well as to approve, deny, delete, update, and edit any records that have been submitted via any of the completed online forms. The media administrators 116 approve and deny the event credentials requested by the media registrants and representatives 102 for the event.

In blocks 350, 450, administrators 116, 118, 120 log into the results area. FIG. 23A-B illustrates exemplary screen shots of an embodiment of an administrator login form.

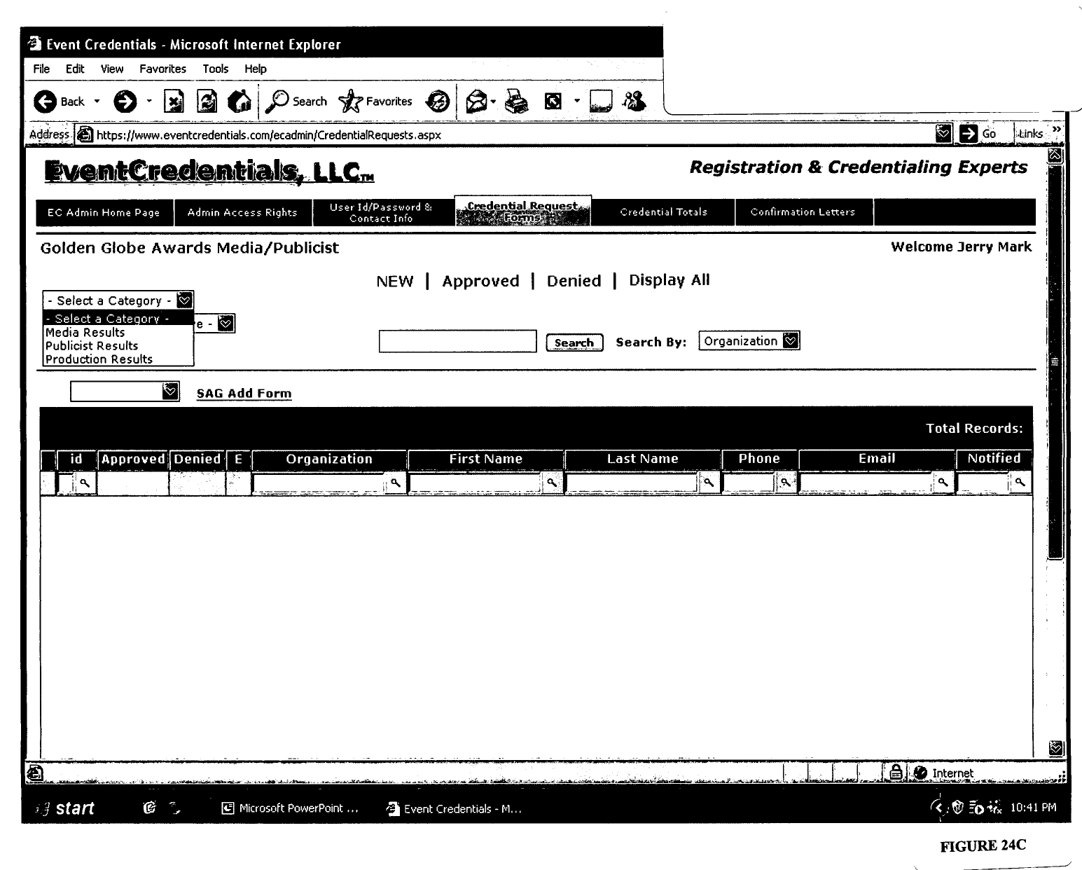

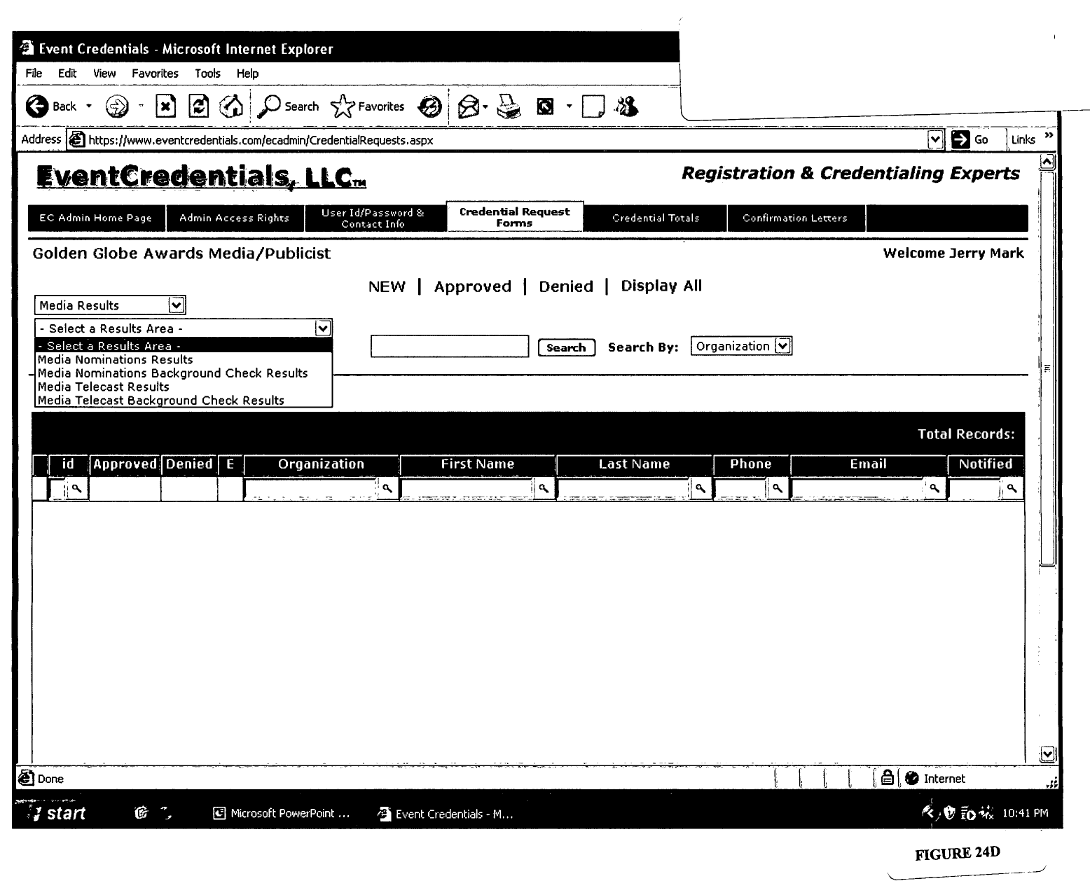

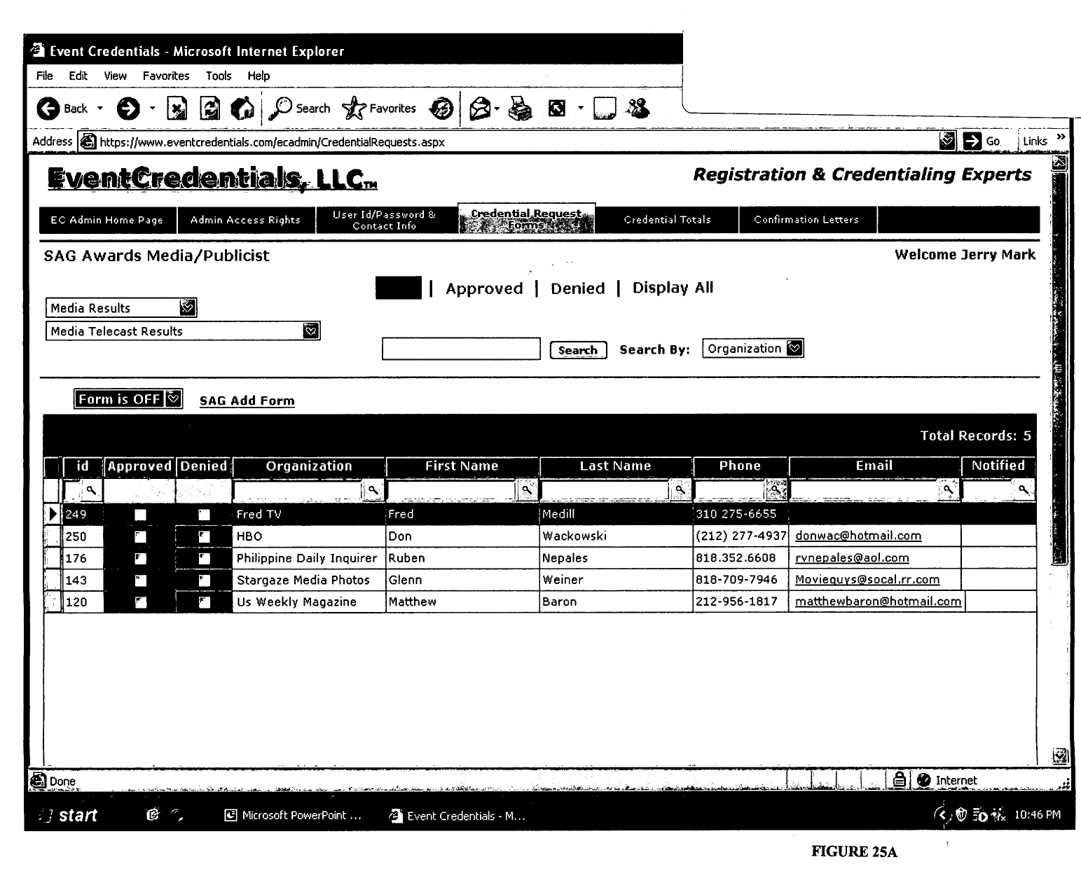

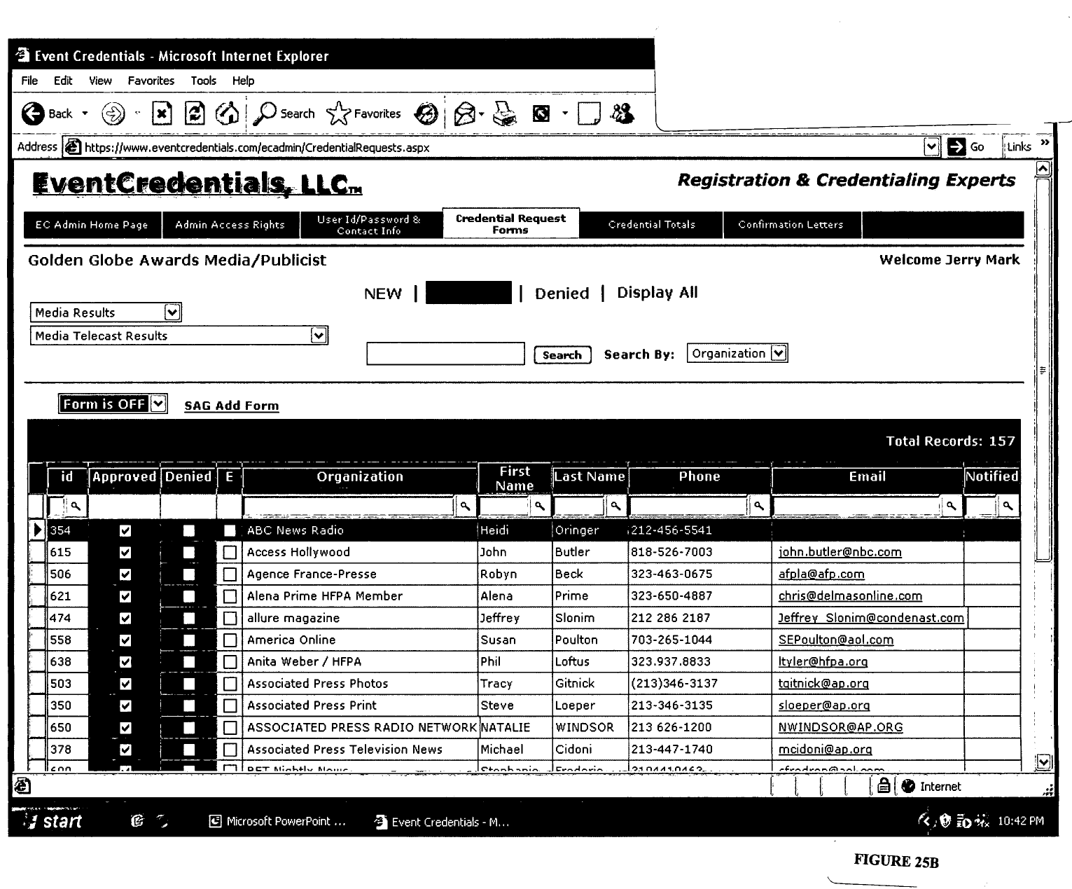

FIG. 24 illustrates an exemplary screen shot of an embodiment of an administrator form results area. The administrator 116, 118, 120 selects which result area to review. In another embodiment, for example, the media administrator 116 may only have access to the media records.

Referring to FIGS. 3A and 4A, in blocks 352, 452, respectively, the administrator 116 reviews the new media entries. The “New Media Entries” is where registrants or representatives records that have not been viewed or are undecided reside.

Other examples of administrator media review areas are “Approved Media”, “Denied Media”, “Display All”, and the like.

“Approved Media” is the area where registrant's records that have been approved are stored while the event administrator 116 awaits submission of background information by the registrant or representative 102 on each individual who is going to access the event using one of their granted credentials.

“Denied Media” is the area where companies' or individuals' records reside if the administrator 116 denies the company or individual access to the event.

“Display All” is a view in which all records are merged, and, in an embodiment, can be identified through a color-coded text or check box display that allows the administrator 116 to easily distinguish between records from each results area. In an embodiment, multiple color-coded check boxes are associated with each record allowing the administrator 116 the ability to more easily manage the approval process. Regardless of where a record is residing, in block 354, 454, the administrator 116 can approve, deny, delete, update, edit or move a record or group of records back to any of the results storage areas.

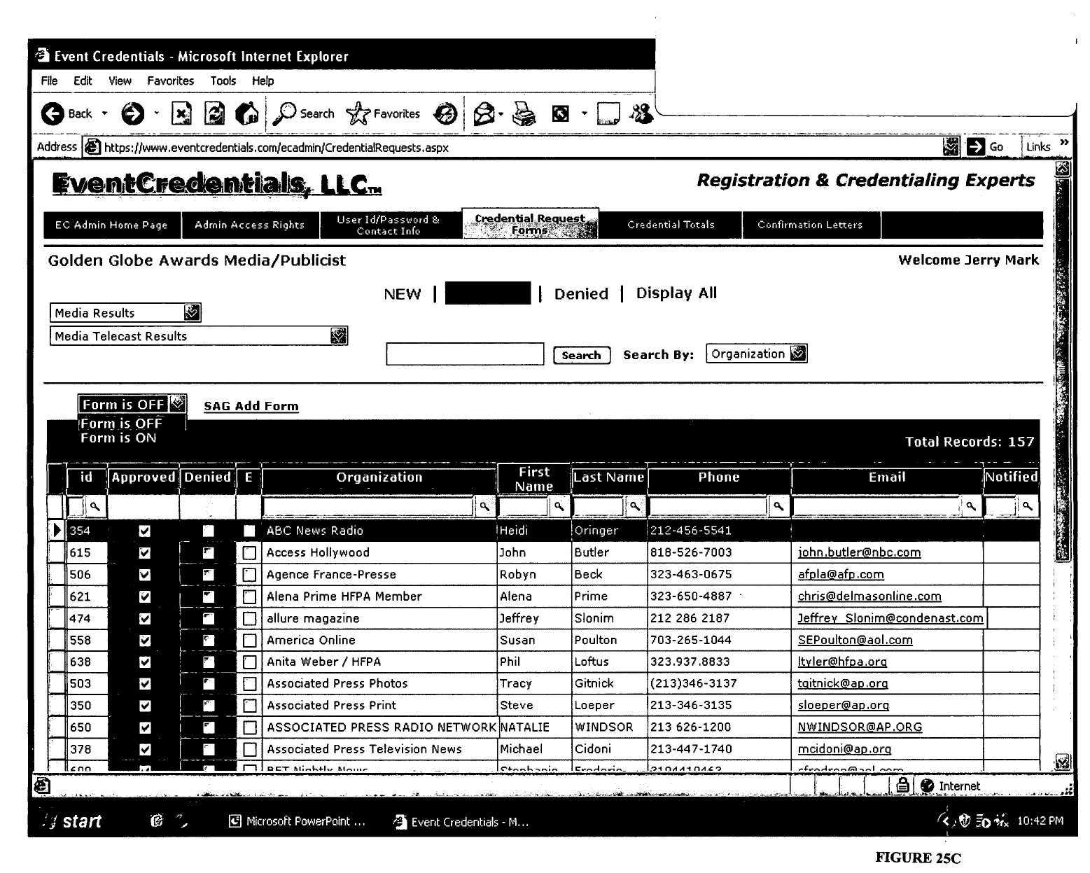

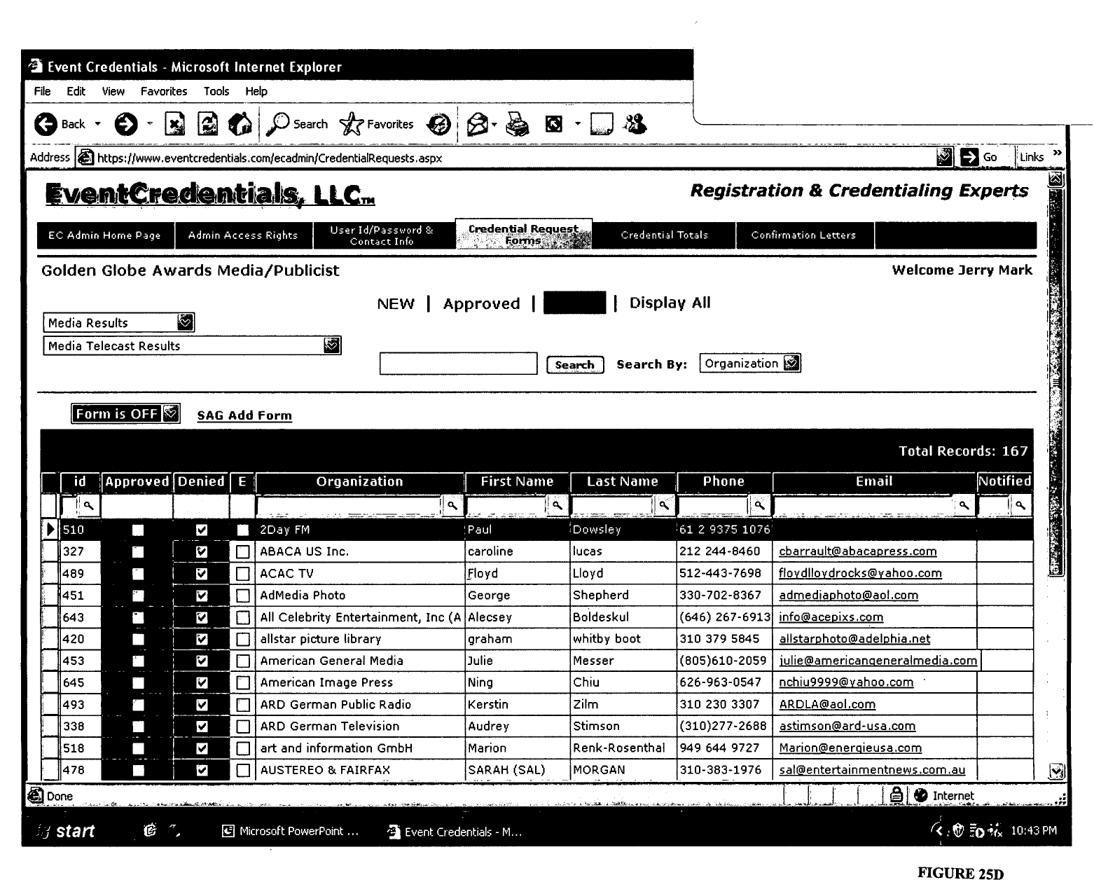

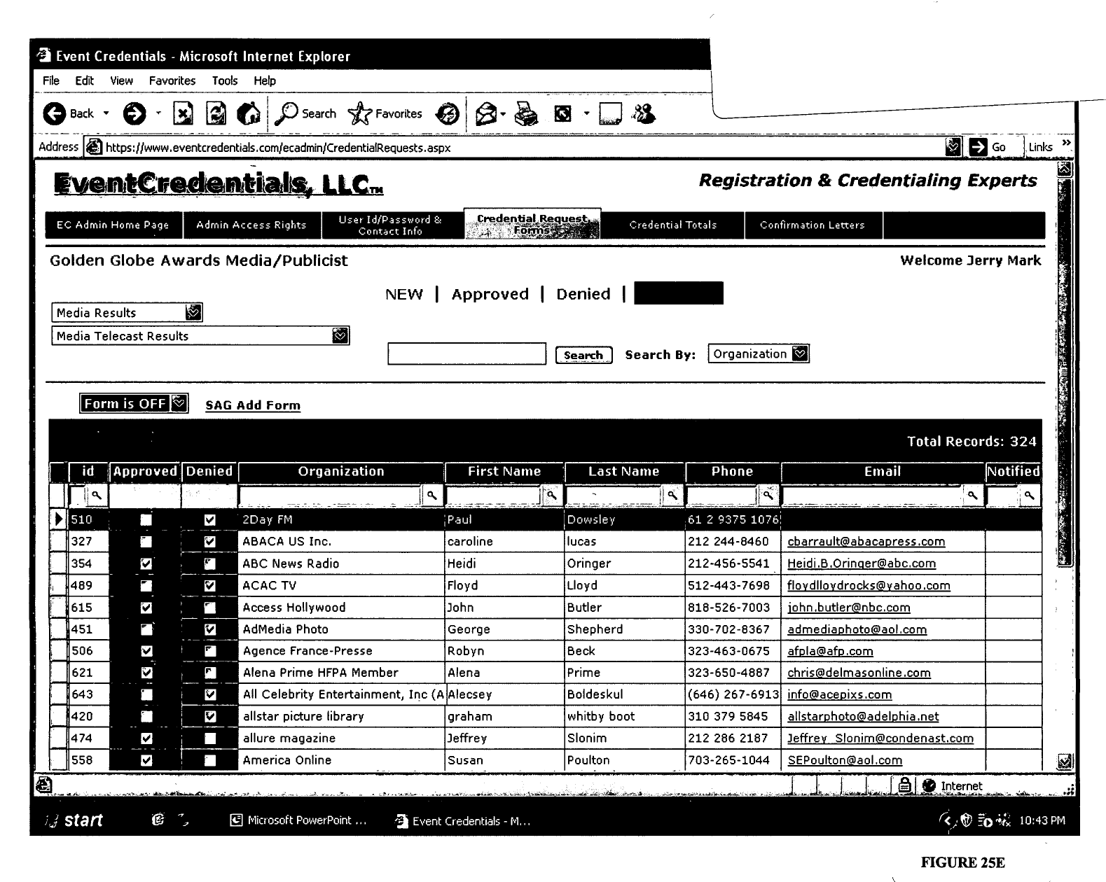

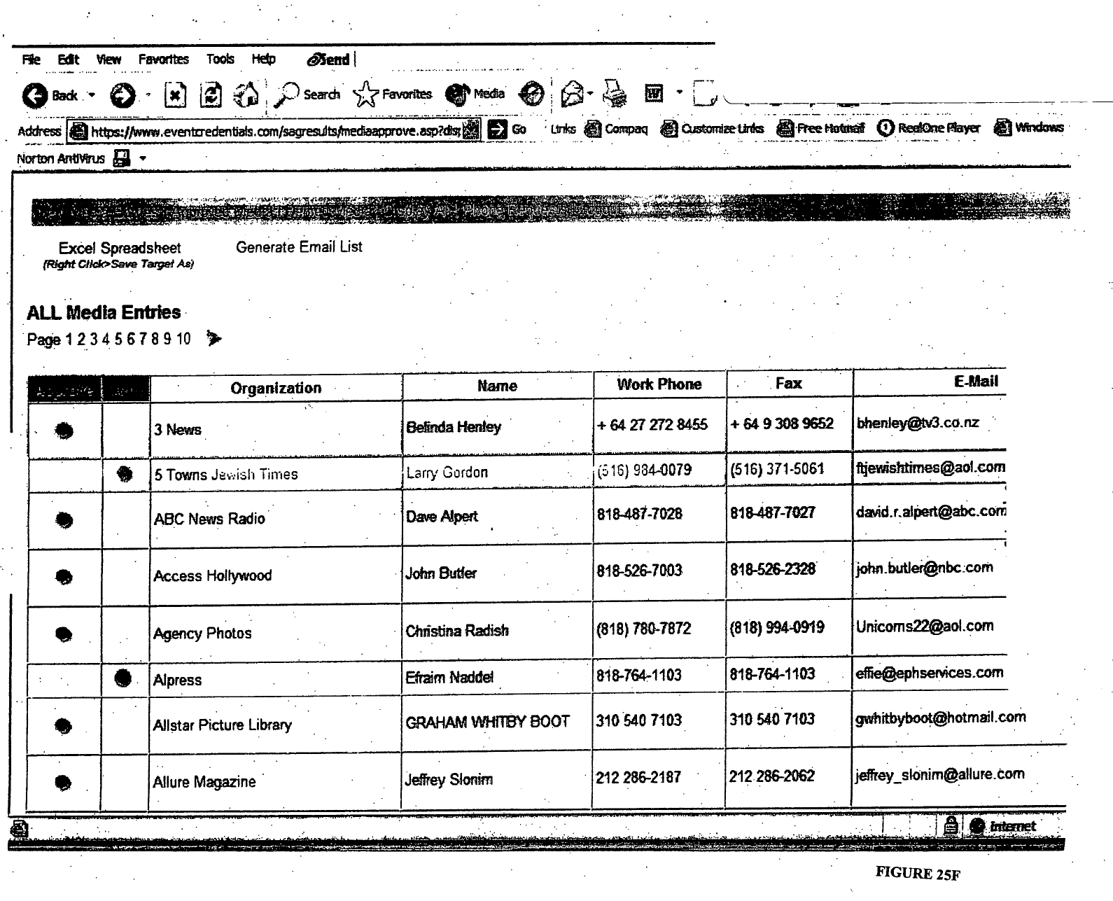

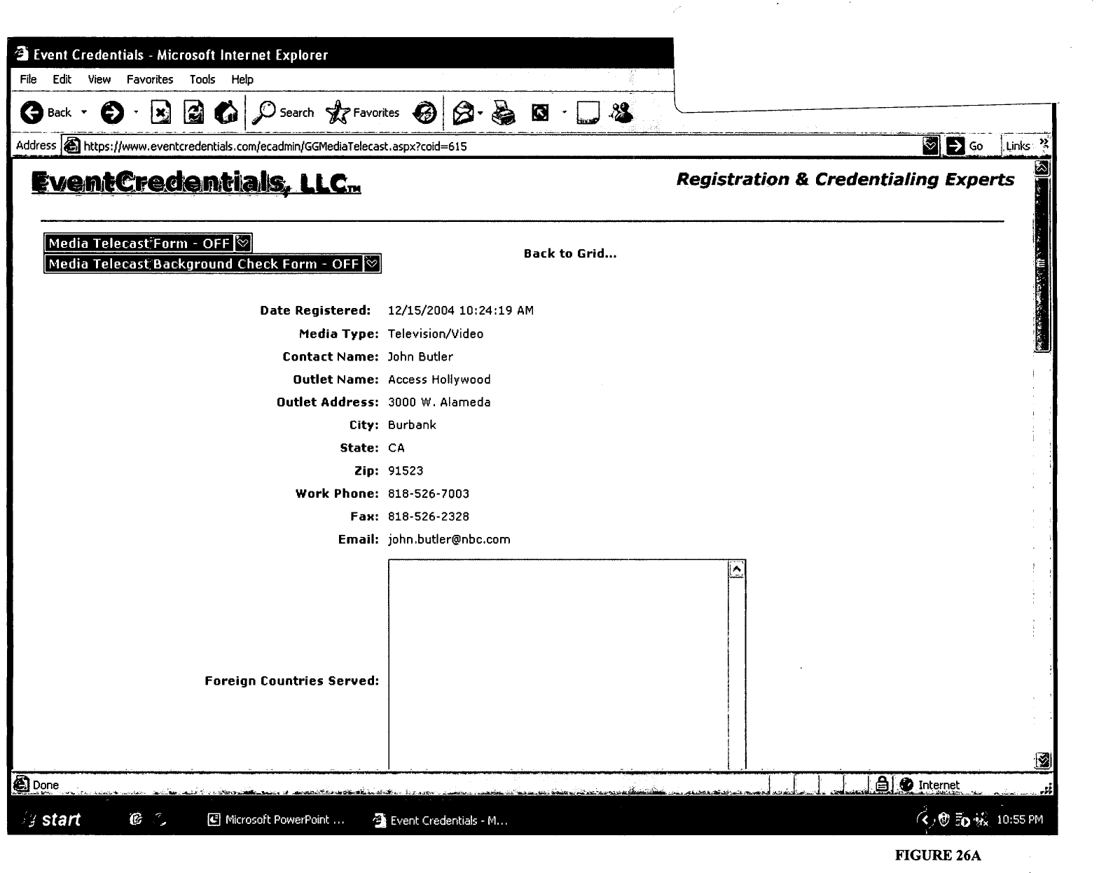

FIG. 25A-F illustrates exemplary screen shots of an embodiment of an administrator New, Approved, Denied and Display All record orform Results area, as well as the form on/off function.

The database Results area can be queried by any piece of information gathered or associated with a record or group of records, such as, for example, last name, drivers license number, and the like. This allows for the tracking, the reporting, and the accounting of specific requests entered in the forms for items required for the performance of an individual or a company work function at the event. At any given time, an event administrator 116, 118, 120 can track and/or calculate numbers of access levels granted in each of the Results areas, an important feature when numbers per event and group participants are limited due to capacity of rooms at each access level.

Referring to FIG. 4A, in block 456, the administrator 116, 118, 120 can time stamp any changes to the records. This is also a useful information-tracking tool.

Referring to FIGS. 3A and 4A, in blocks 356, 458, respectively, the administrator 116 notifies the registrants and representatives 102 of their status manually or automatically with respect to their requested credentials. The registrants and representatives 102 with granted access assign the credentials to individuals and provide the background check information for the individuals having access to the event, as discussed above. In an embodiment, each registrant 102 completes his own background check information. In another embodiment, a representative 102 for a group of individuals provides the background check information or EC ID numbers for each of the individuals in the group.

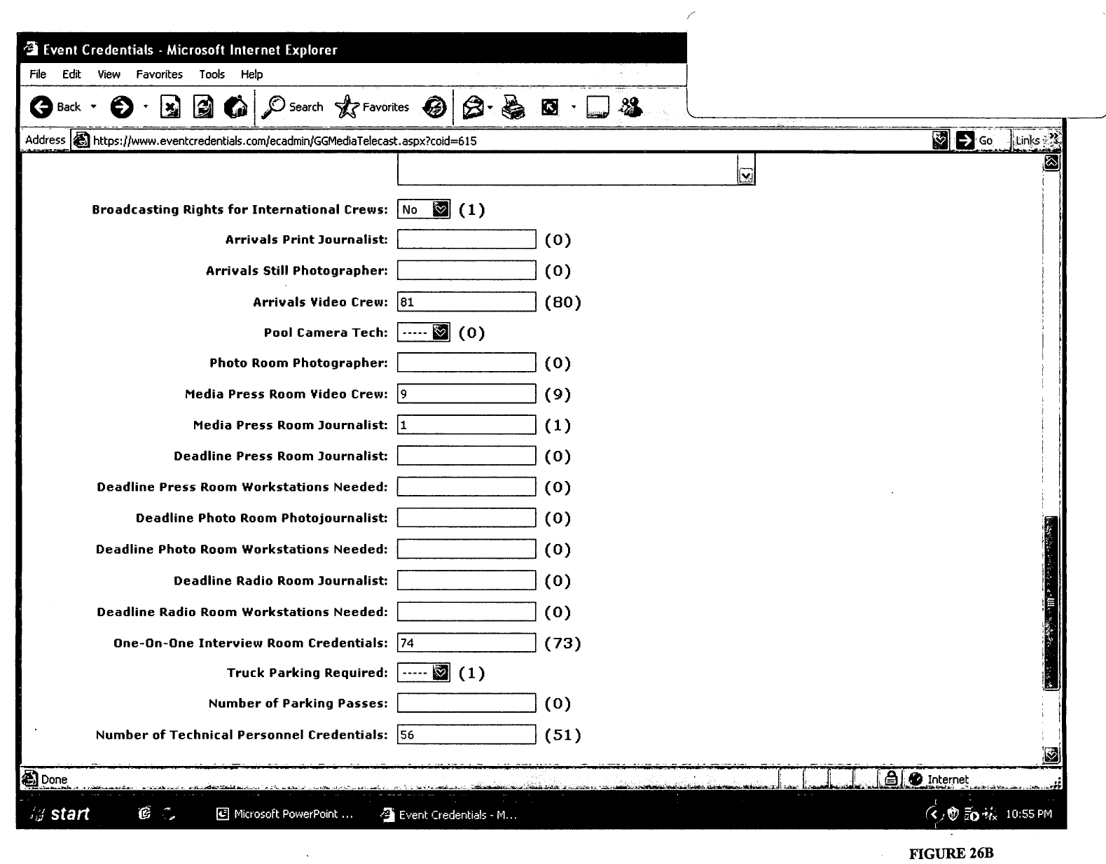

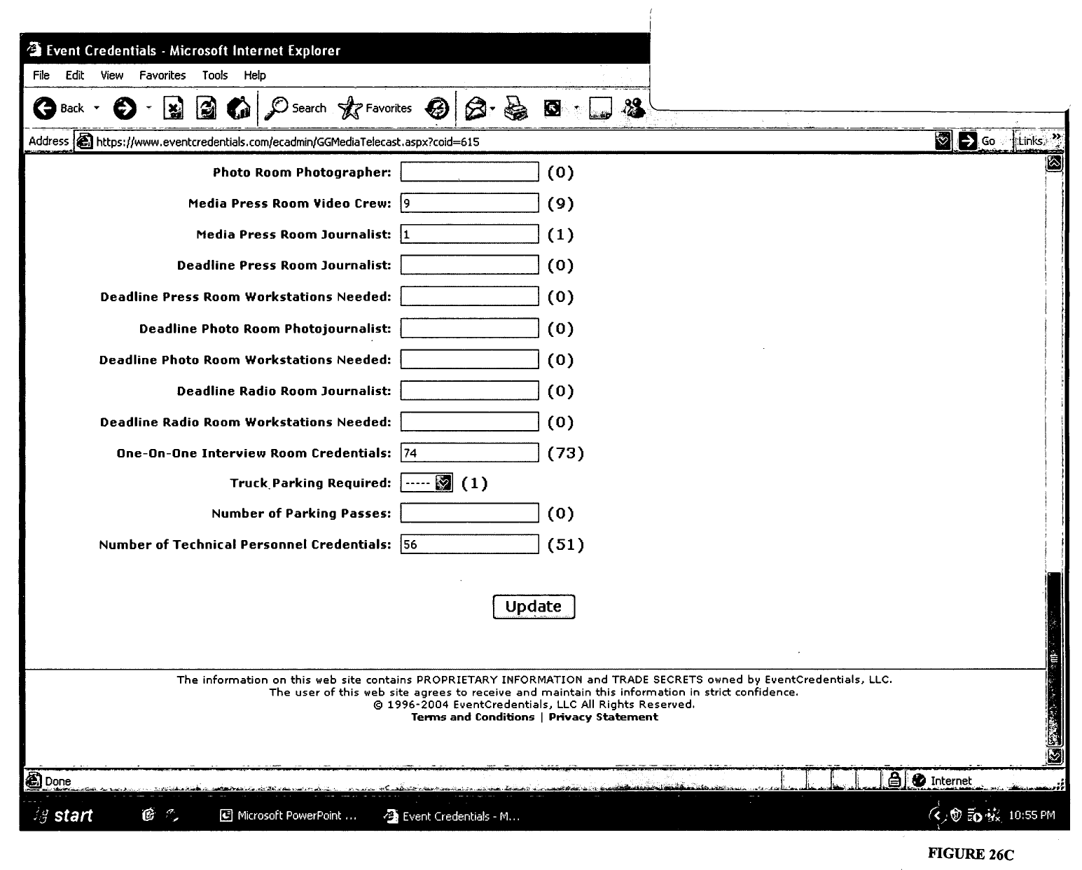

FIG. 26A-C illustrates exemplary screen shots of an embodiment of an administrator media record review form. The administrator 116 opens the first entry in the new media entry list and displays contact information for the media company or outlet. If the administrator 116 accepts the media company, the administrator 116 can revise the quantity of credentials and access areas requested by the media registrant or representative 102. The number to the right of the text field indicates the originally requested number(s) of credentials and always remains the same. After records are modified/updated this often helps the administrator when reviewing records later.

The administrator 116, 118, 120 can manage the entire process worldwide via the Internet. Registrant's requests can be modified within seconds. Notices regarding changes can be emailed to the end users. In an embodiment, confirmation and denial notification can be sent by email individually. In another embodiment, confirmation and denial notification can be sent by email by grouping the records together. All can be done manually or automatically.

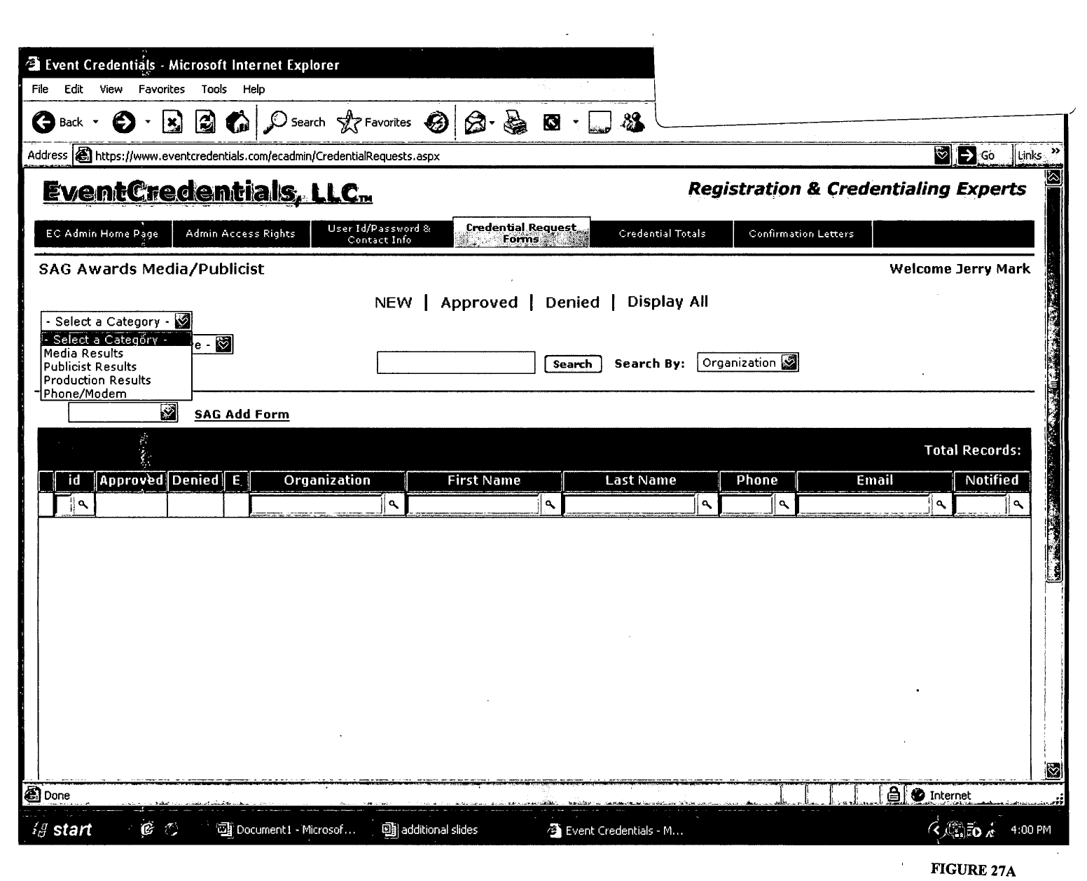

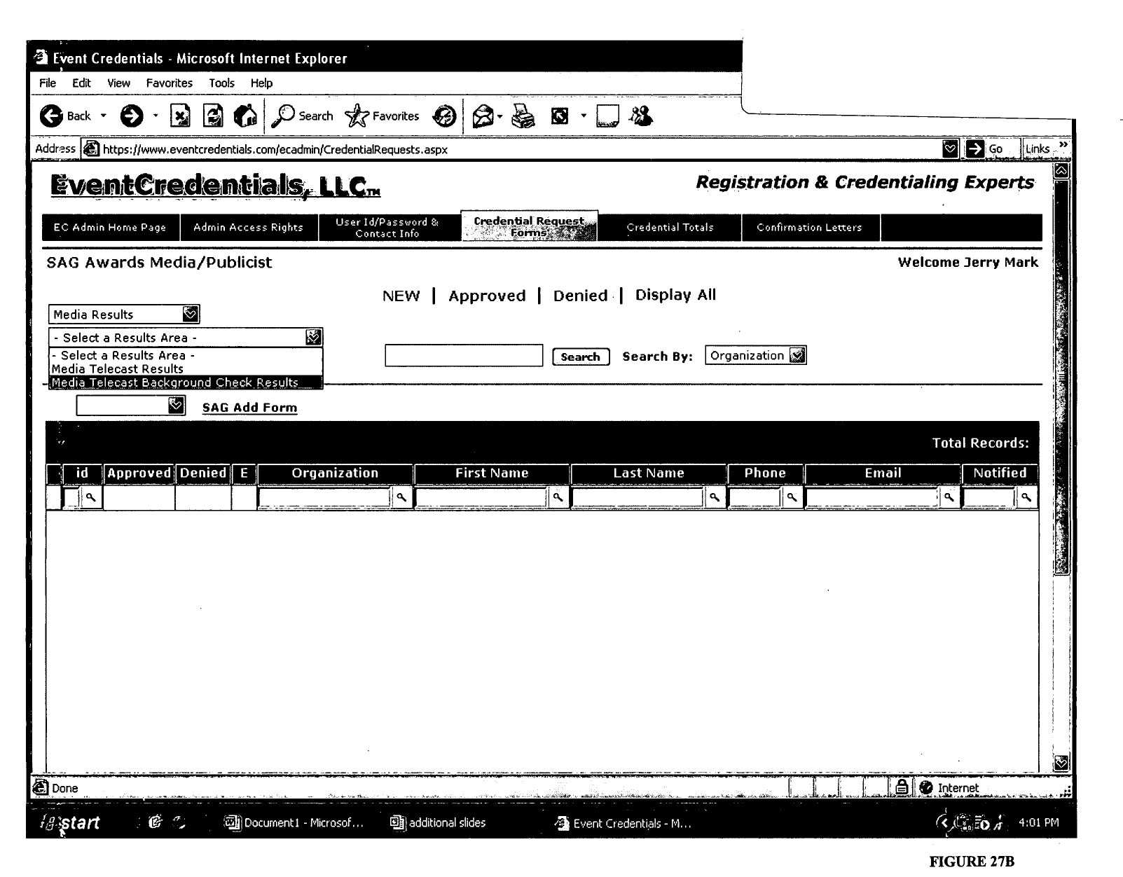

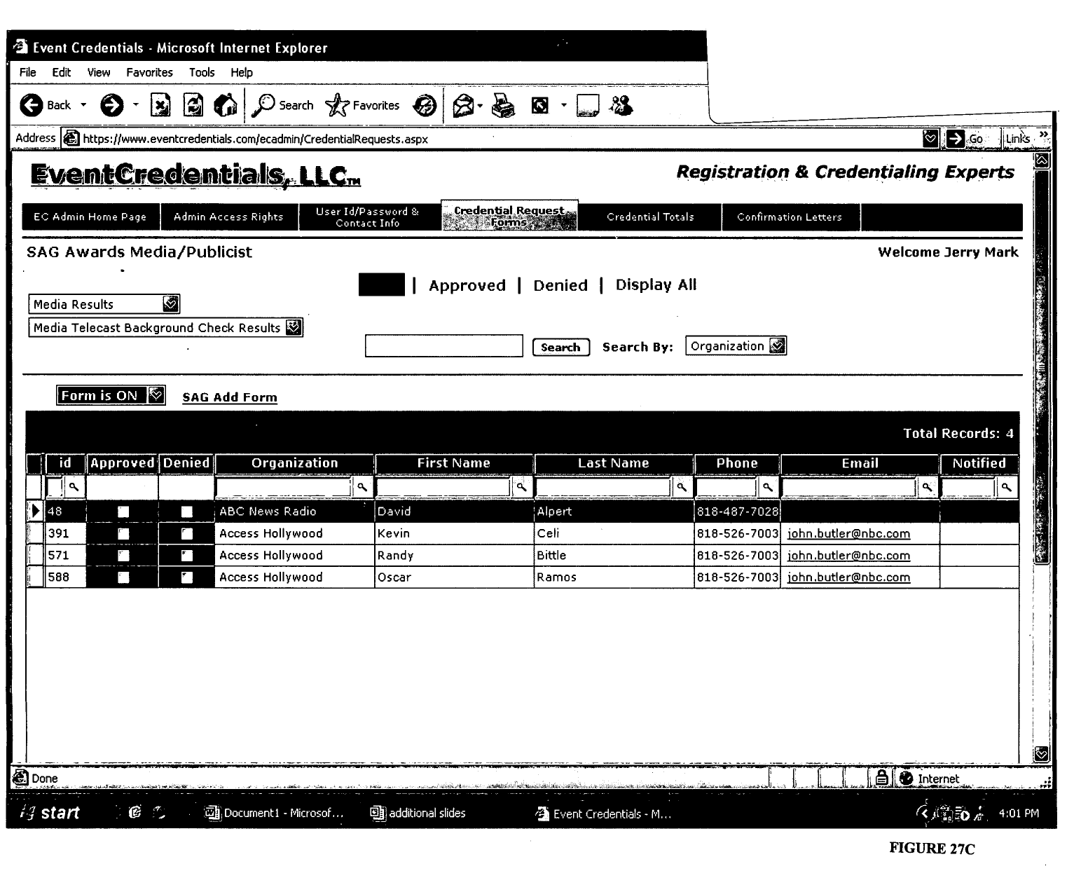

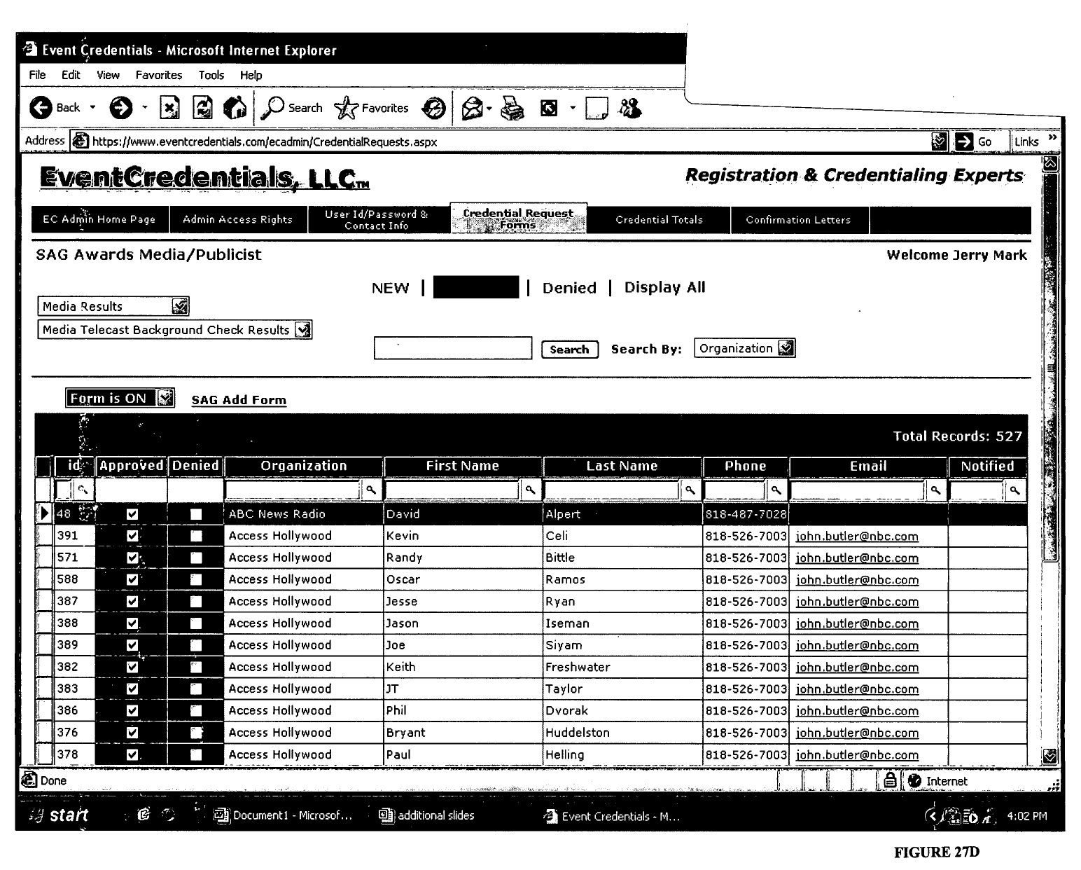

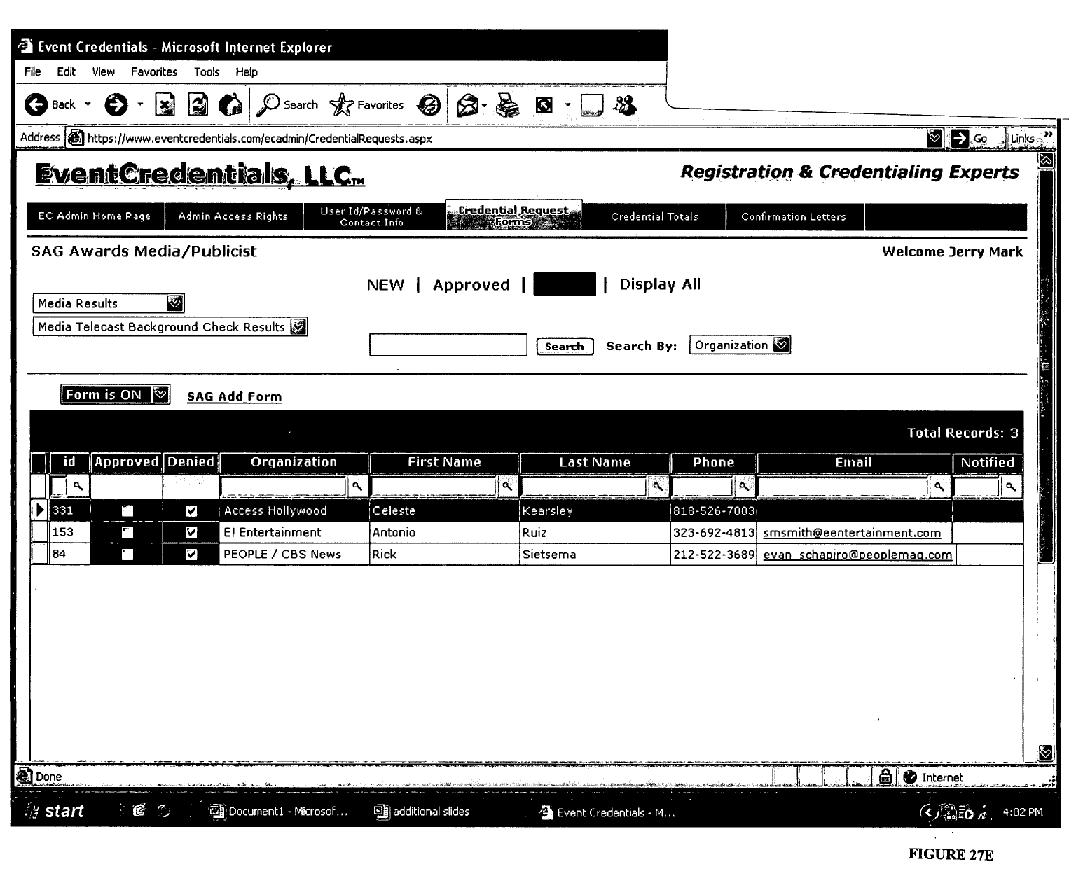

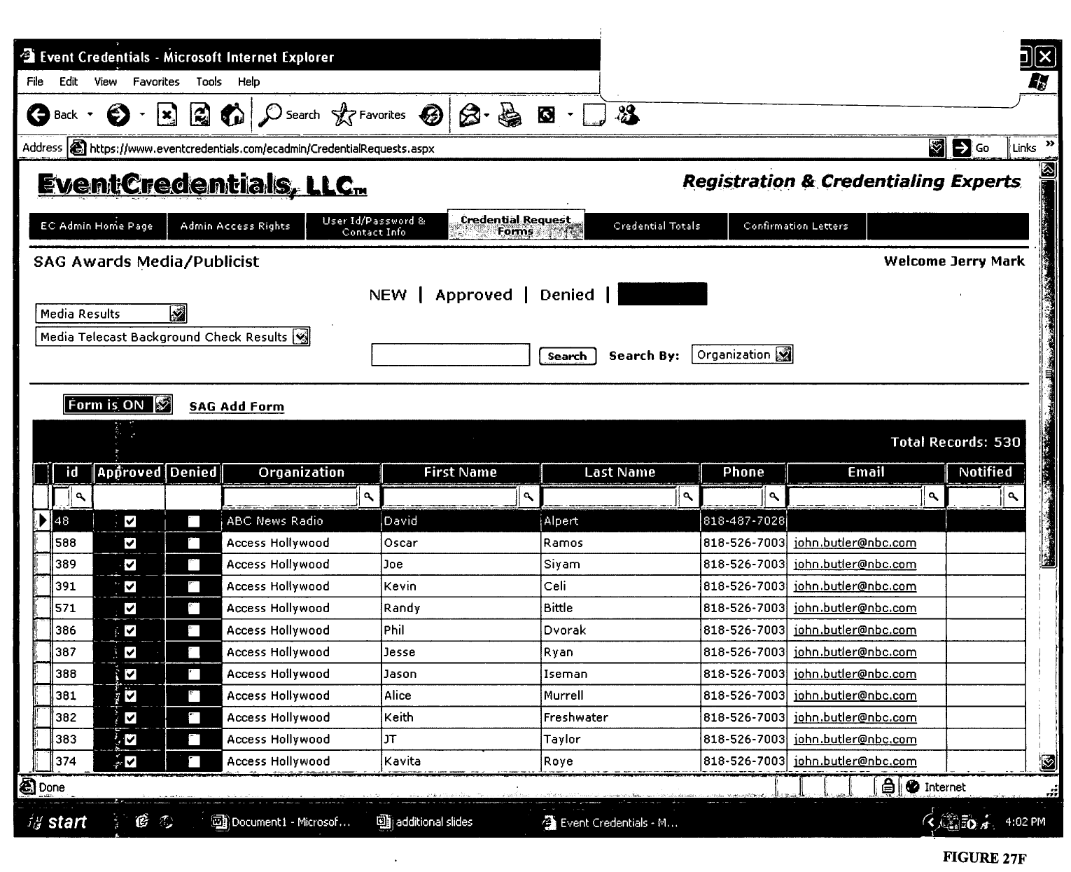

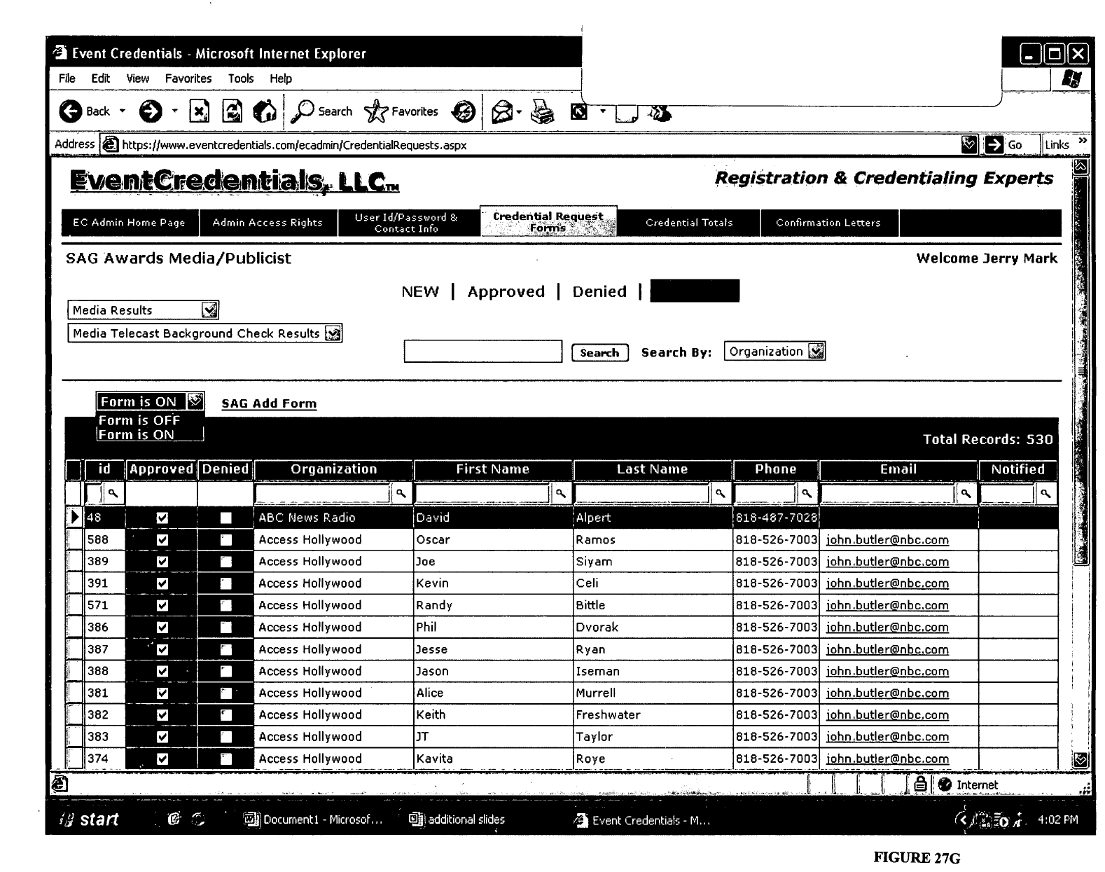

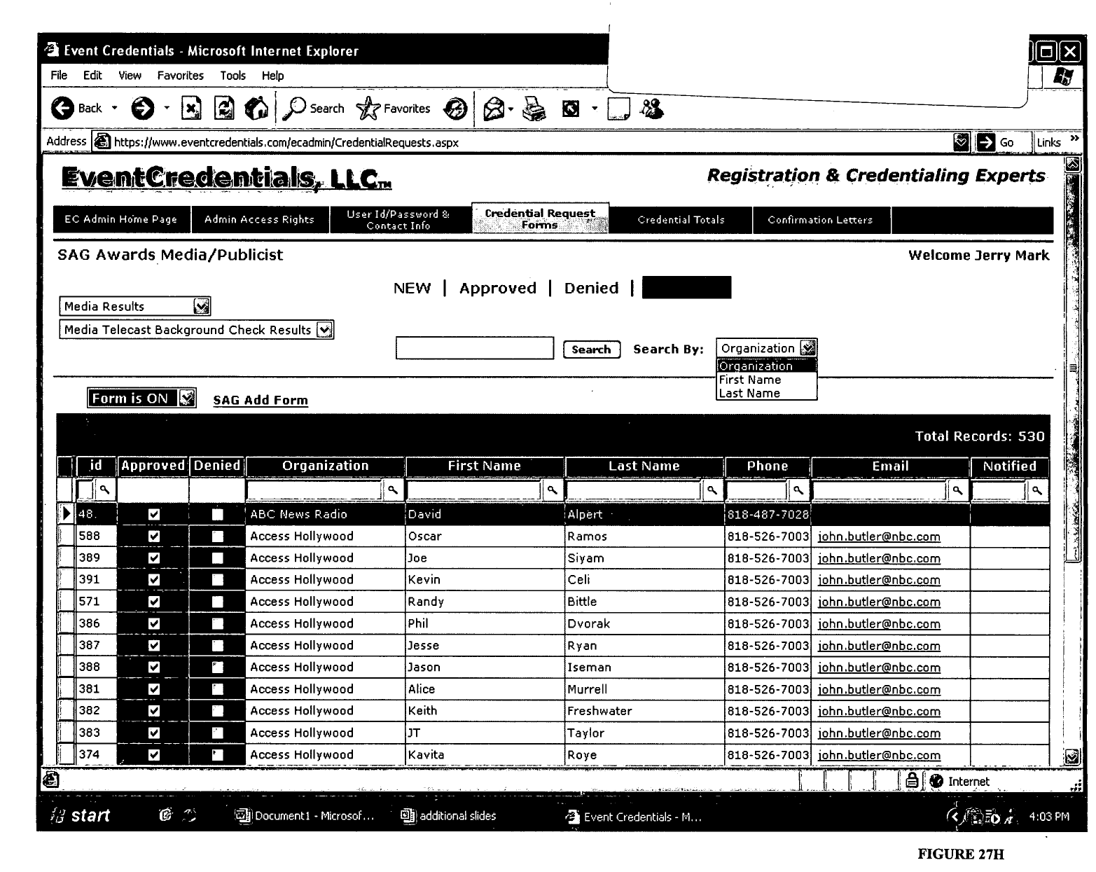

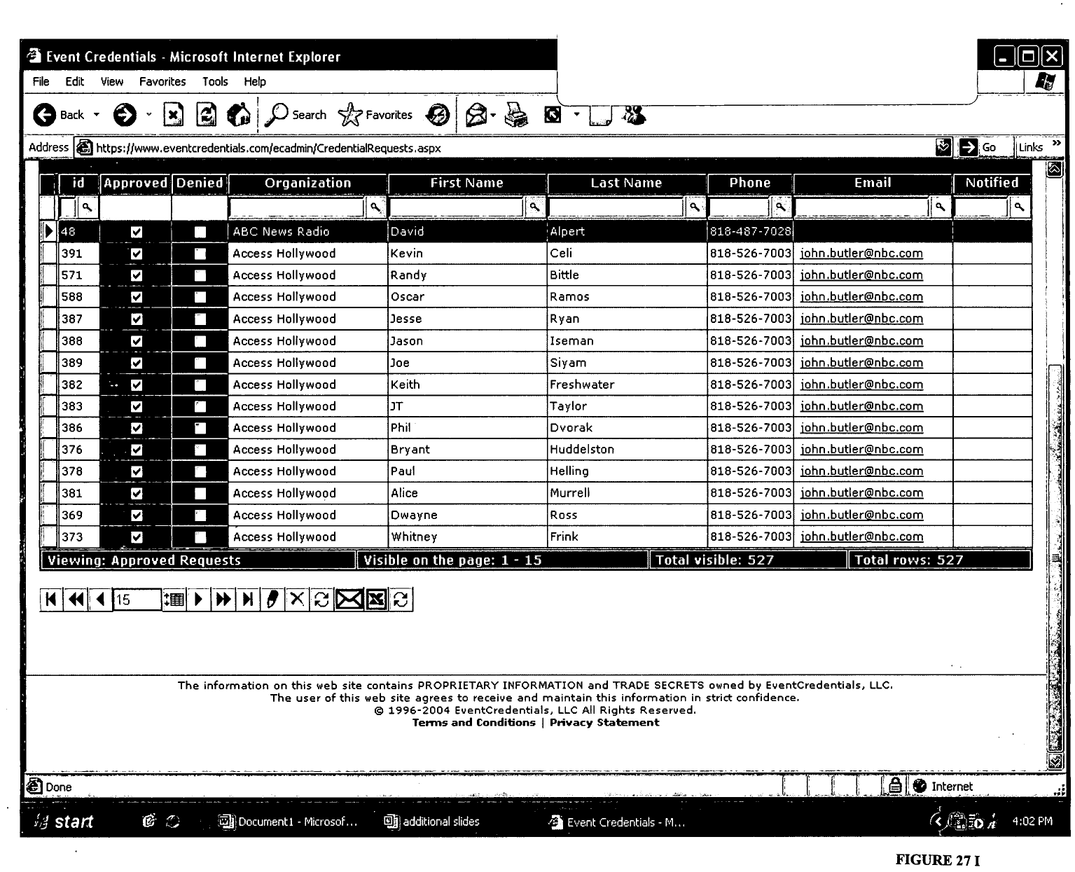

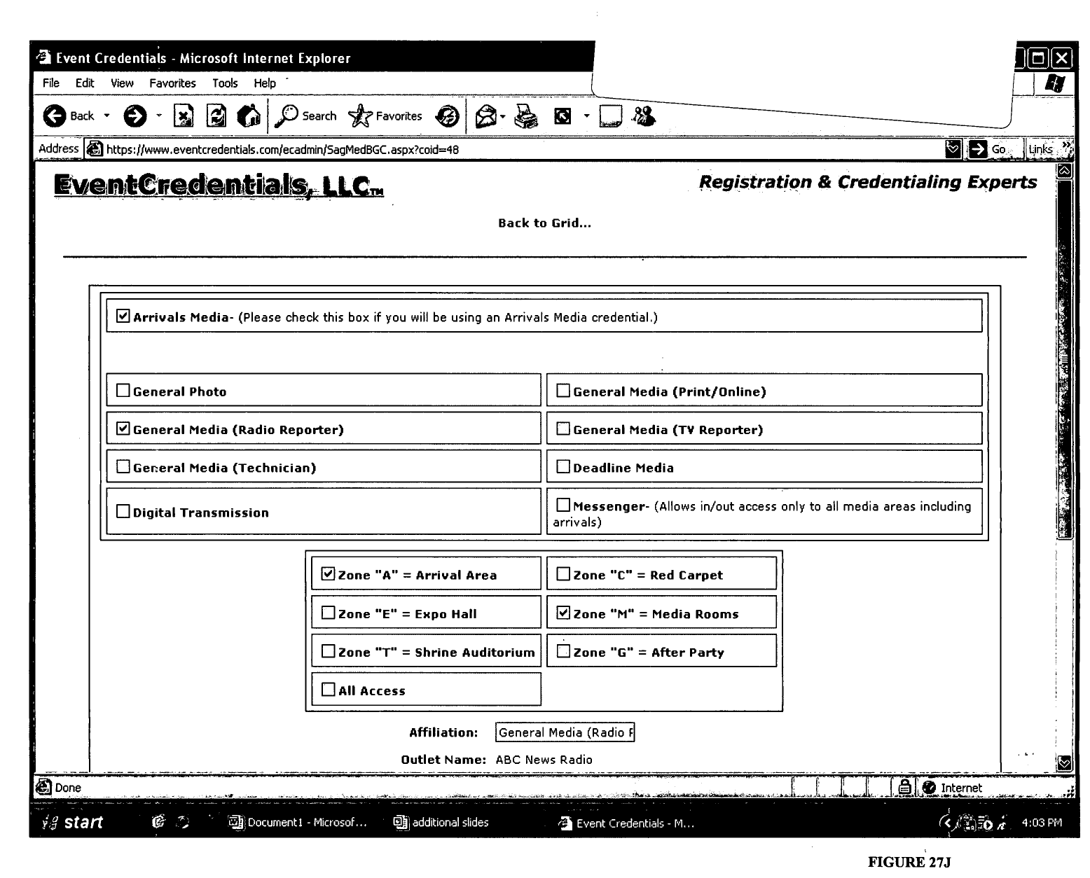

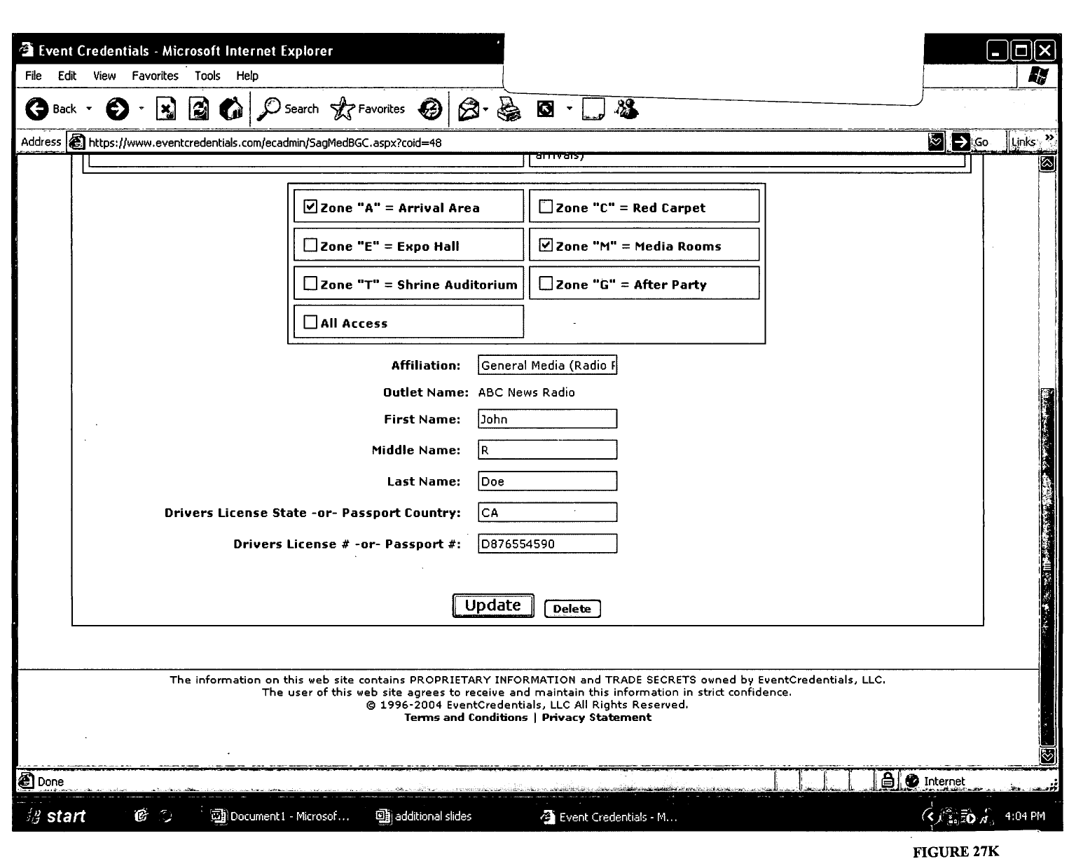

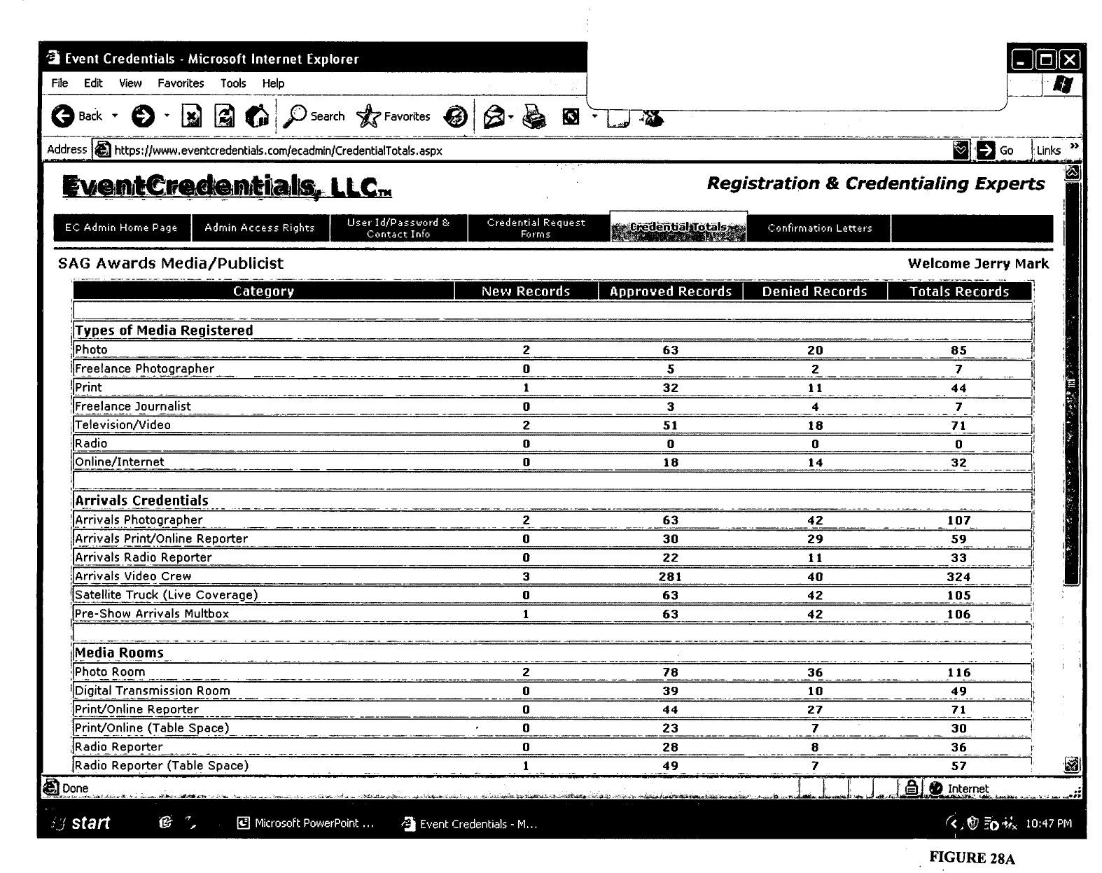

FIG. 27A-K illustrates exemplary screen shots of an embodiment of an administrator background check review form results area which includes the drop-down for selecting the appropriate area, the New, Approved, Denied and Display areas; the several different ways of searching or filtering data by Approved or Denied status, organizations, first name, last name, phone, email and the like. These shots also include the on/off function as well as the actual background form view which displays back what credential the individual selected out of what was granted and the access levels that have been automatically assigned to those credentials for further review and/or manipulation.

Referring to FIGS. 3B and 4B, the administrator 116, 118, 120 logs in and selects the results to review in blocks 358, 460.

In the embodiment illustrated in FIG. 27I-K, the administrator 116 reviews the media background entries. The administrator 116 reviews all new media background entries and selects the first entry, “ABC News Radio”, and reviews the credentials, access levels, and background information for the individual listed. The administrator 116 can review, modify, approve, deny, or delete records.

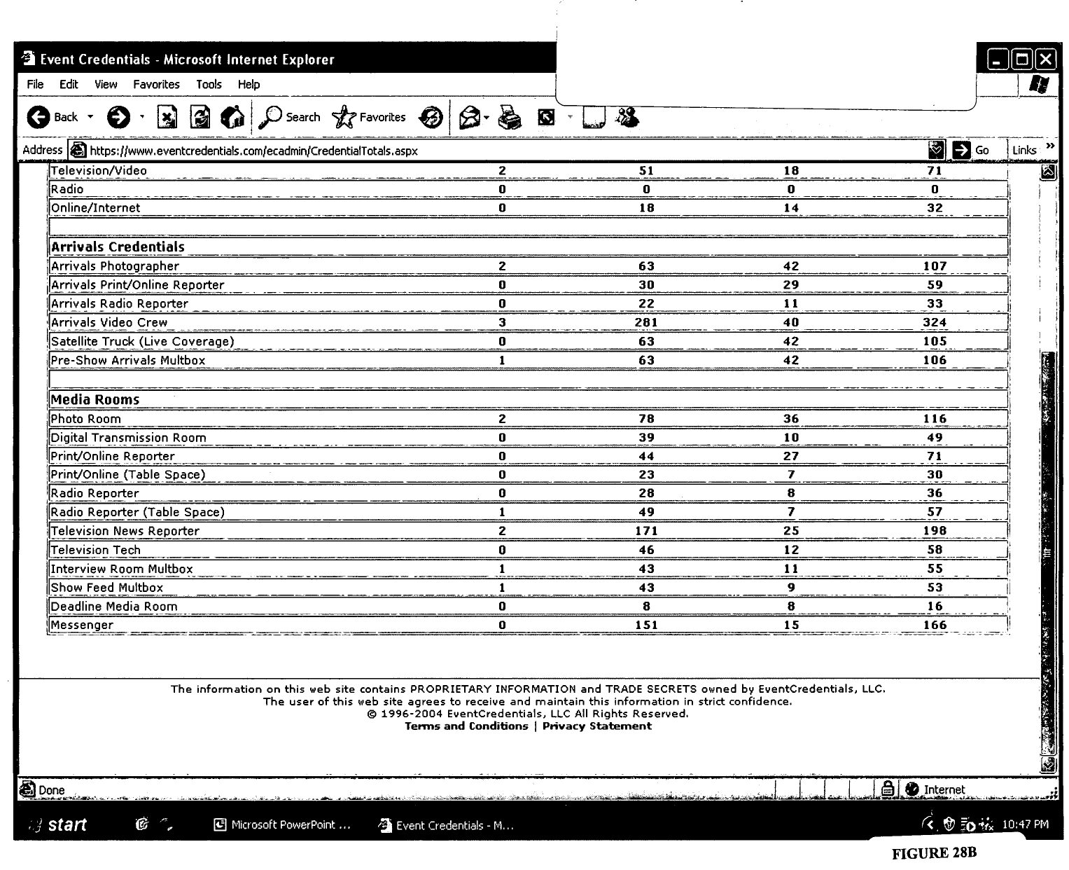

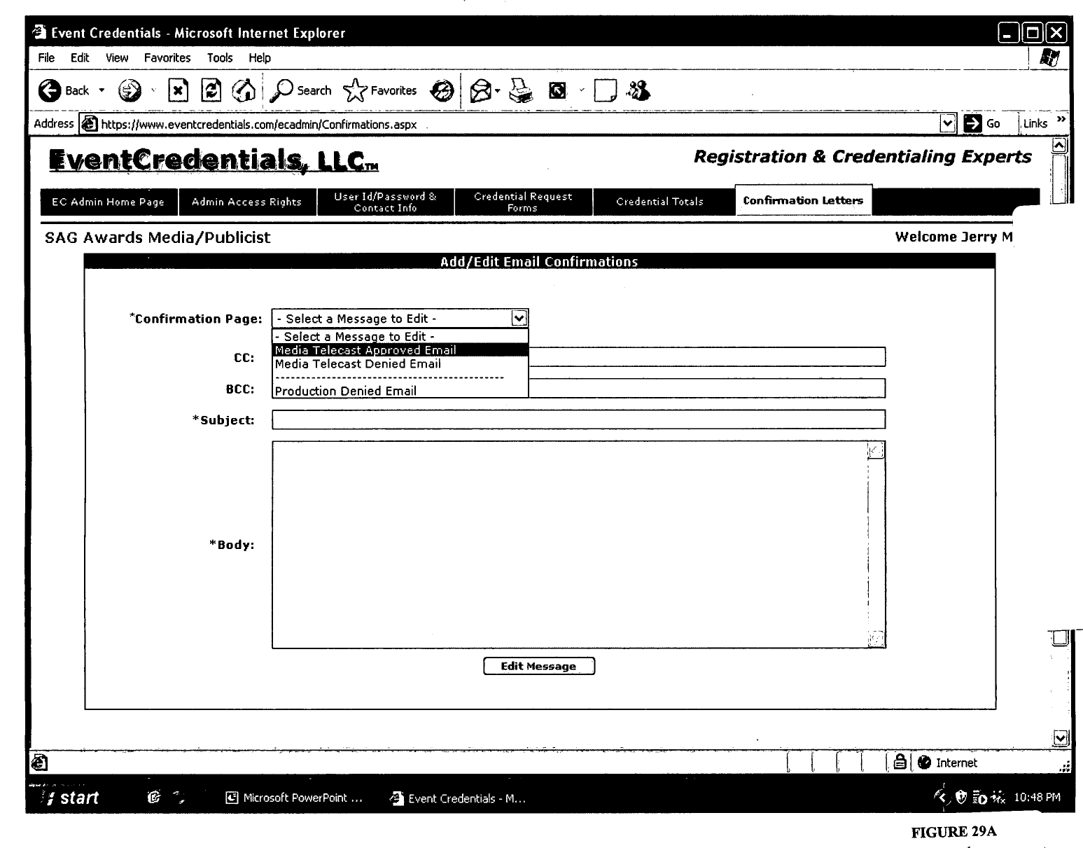

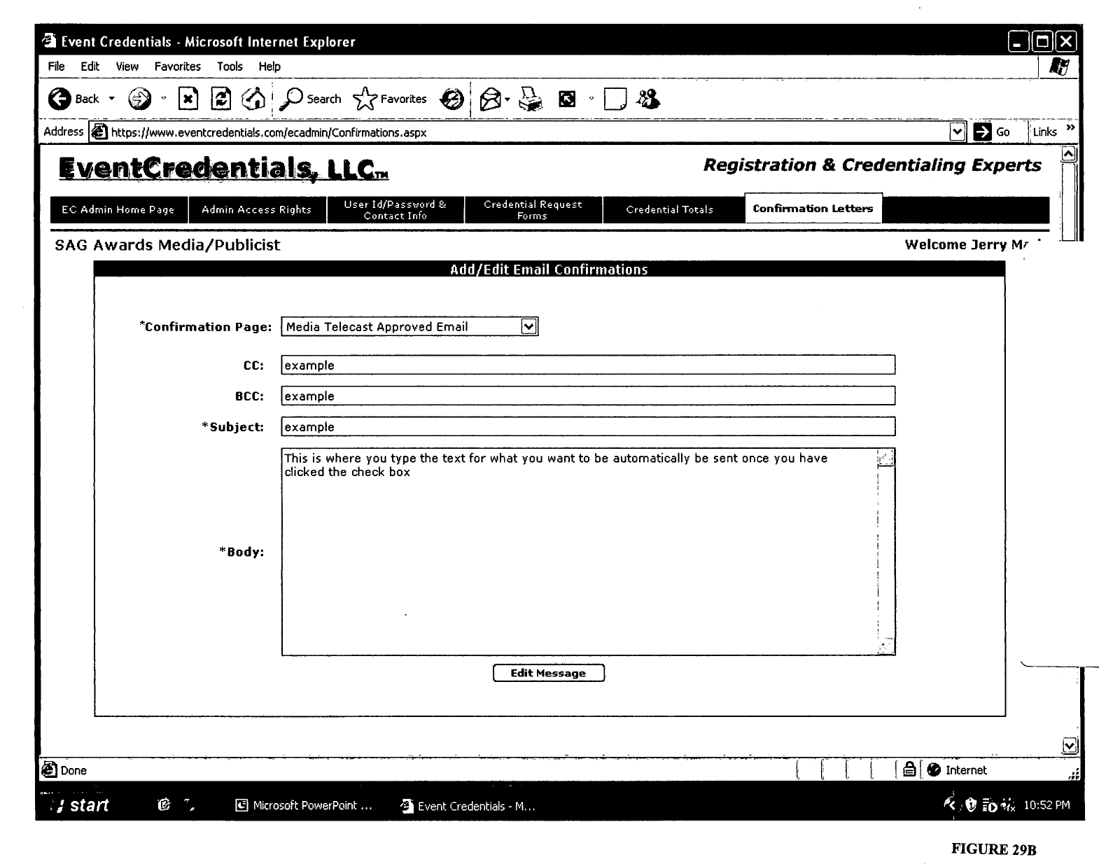

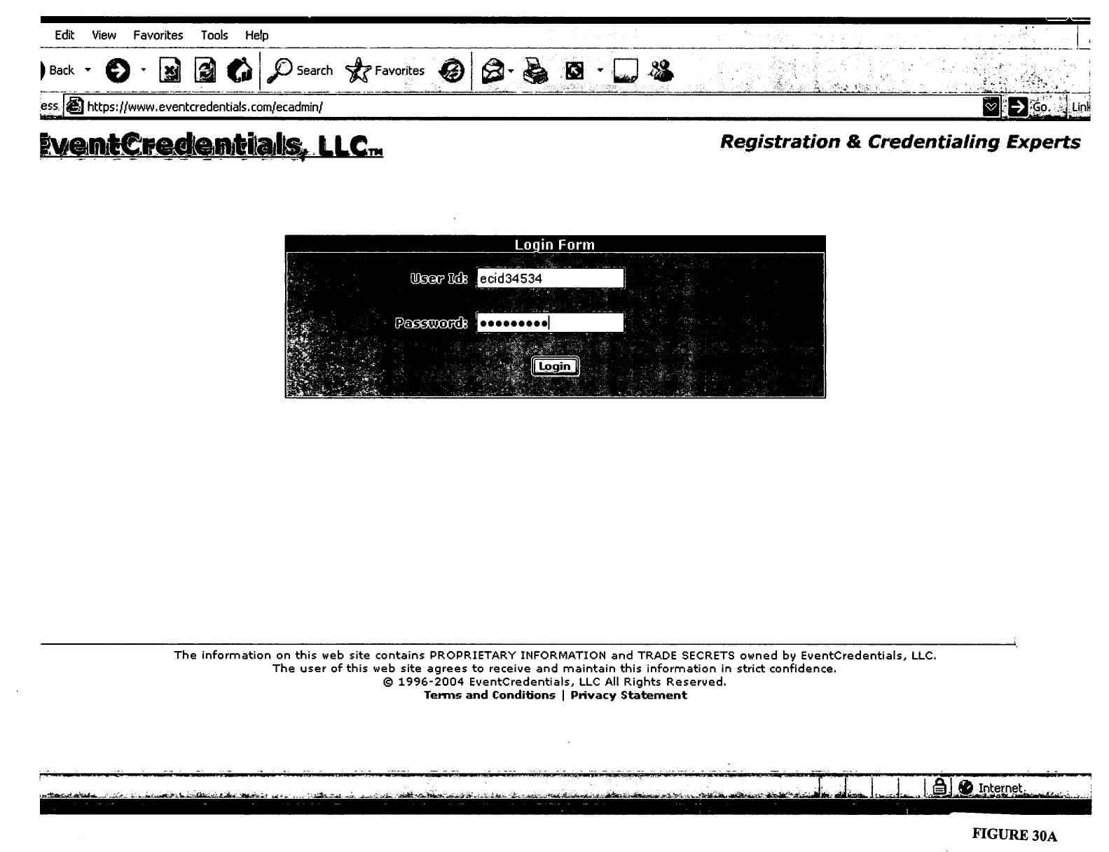

FIG. 28 A-B illustrates exemplary screen shots of an embodiment of a credentials total area. Provided the administrator's unique user ID/password has been given access rights to the credential total area, the administrator can select on the Credential Total in the navigation menu bar at the top of the page and view the credential numbers for all of the review areas, such as the New, Approved, and Denied areas and the sum of all of the areas. A value does not have to be entered into the request form in order for the software to calculate a numeric value. For example, if text was entered, a value could be associated with the text and a sum calculated in this area for quick reference purposes. This area assists administrator's by electronically monitoring the number of credentials they have approved or denied for specific areas or access levels within an event.

FIG. 29 A-B illustrates exemplary screen shots of an embodiment of a credential status letter generator area. This area is where the administrator selects from a drop down menu in the results area in which they would like to attach a standard email that can be distributed to one record, many specific records or all records in that specific area such as, New, Approved, Denied or Display All. The administrator can then copy and paste, or type and then edit/spell check, and the like, to the text box, which will become an email when selected in the specific area. In an embodiment, located directly next to a record in the New, Approved, Denied and Display areas is a specific “send email” check box that when selected will automatically send the email addressed to the contact for that record. The body of this email will be pulled from the credential status letter generator or the Confirmation Letters. This letter can be associated to any of the records in any of the results review areas that reside in the system.

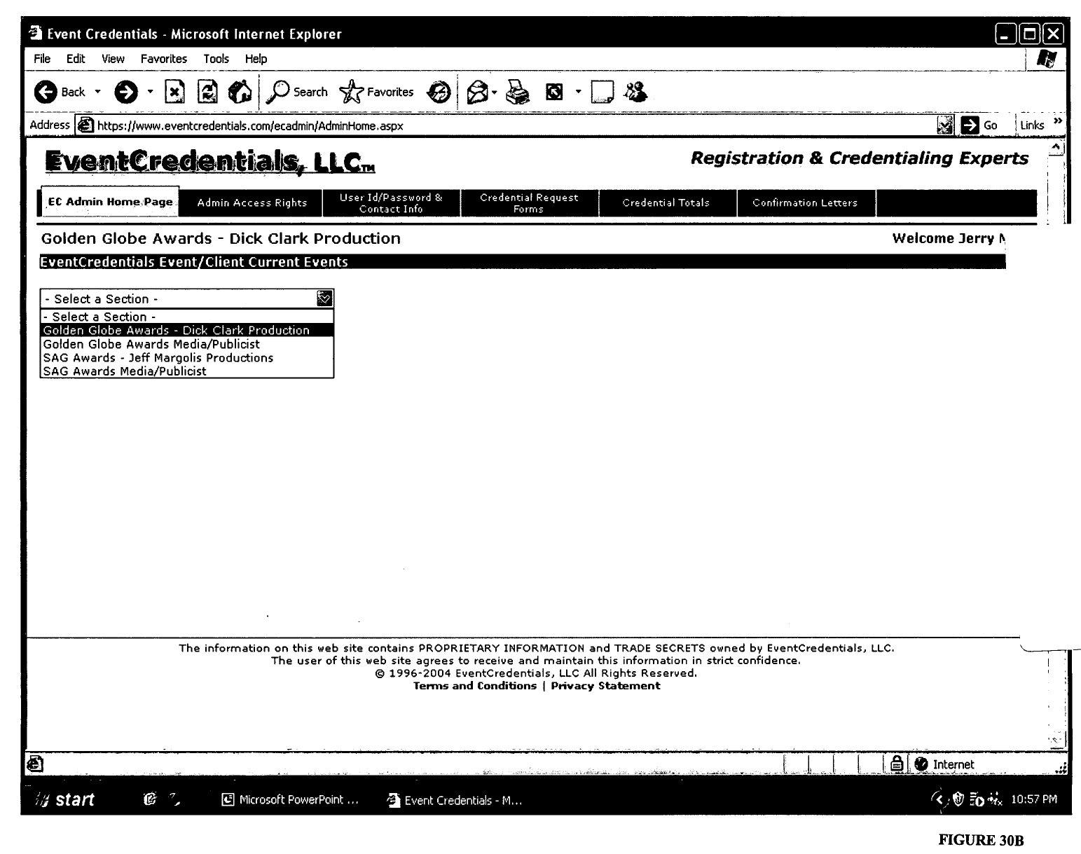

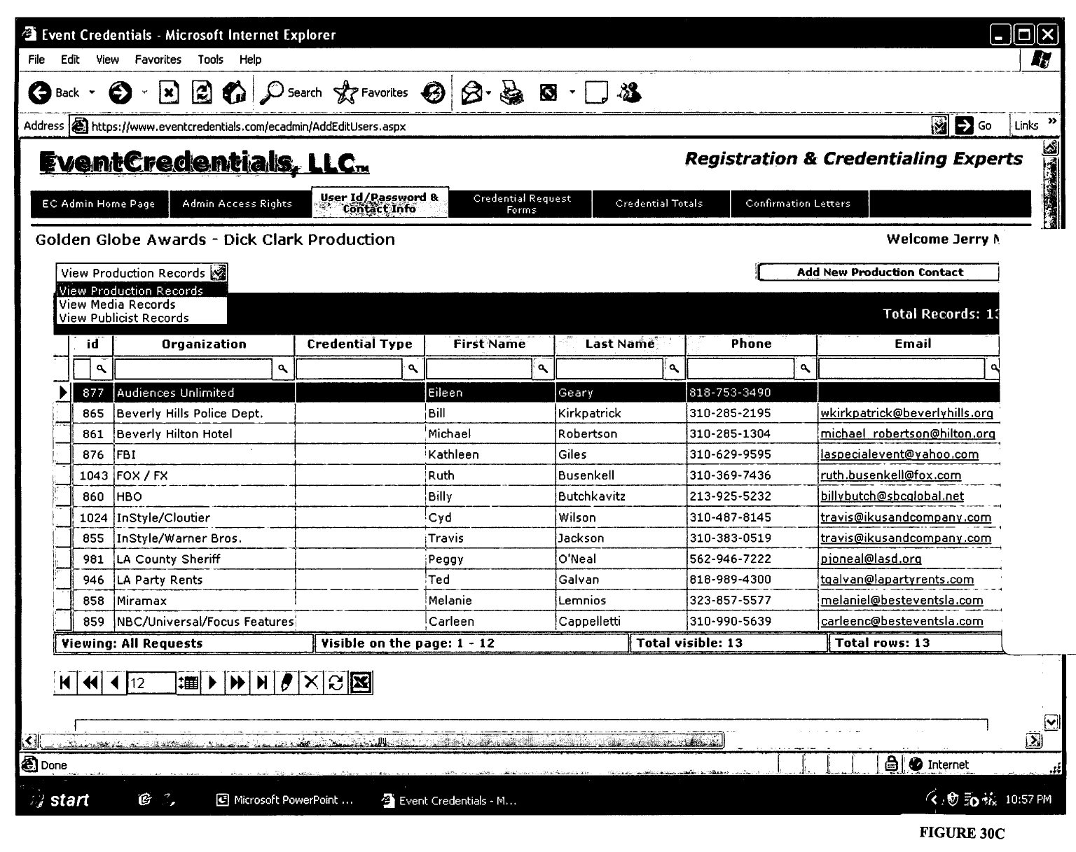

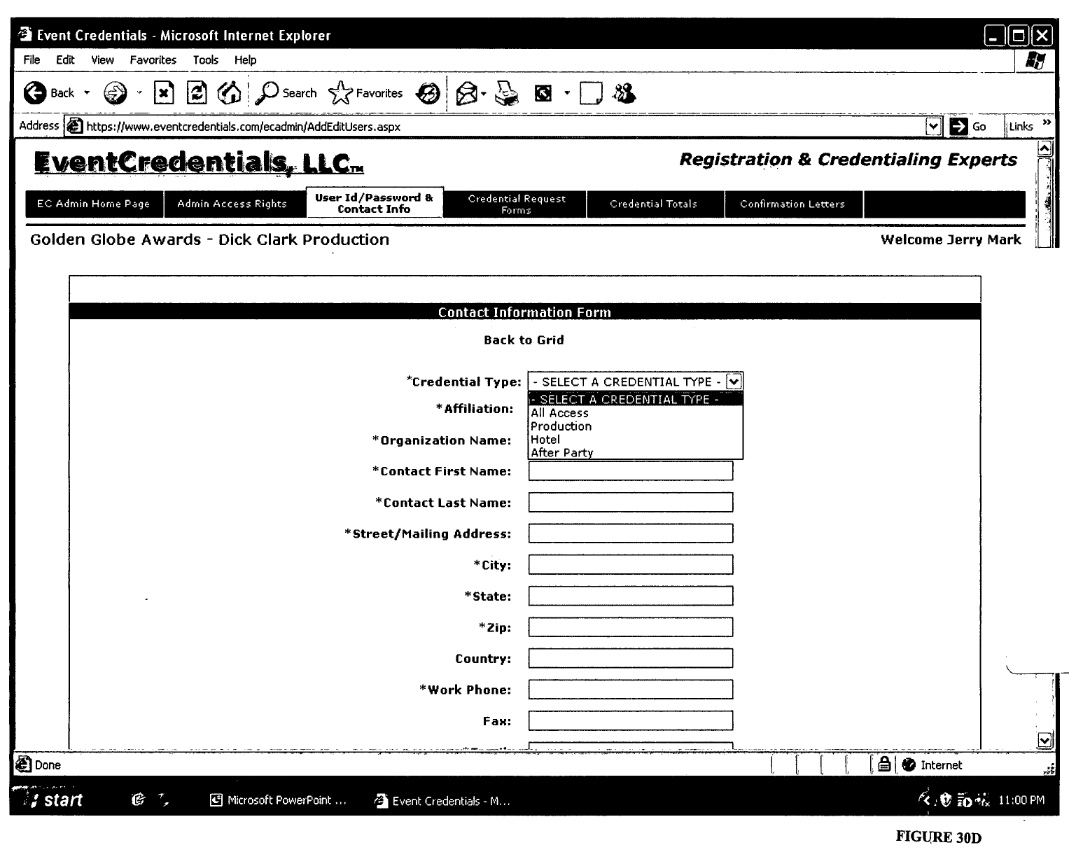

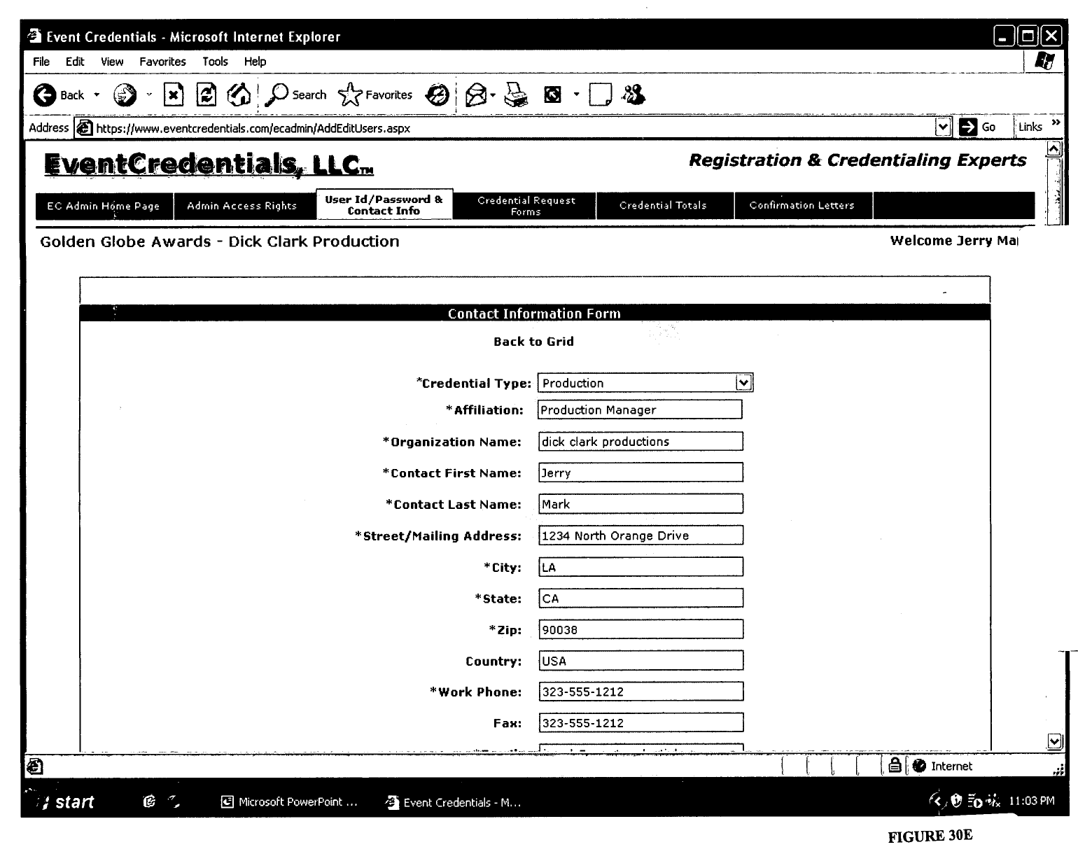

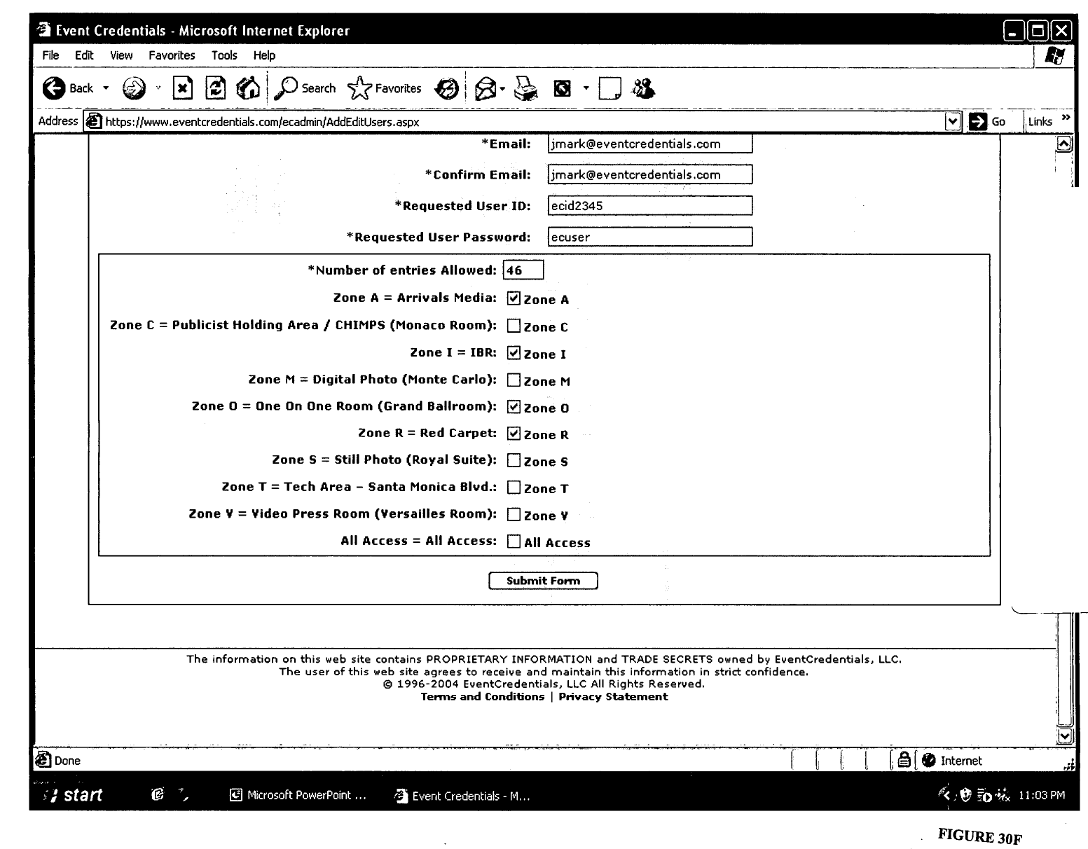

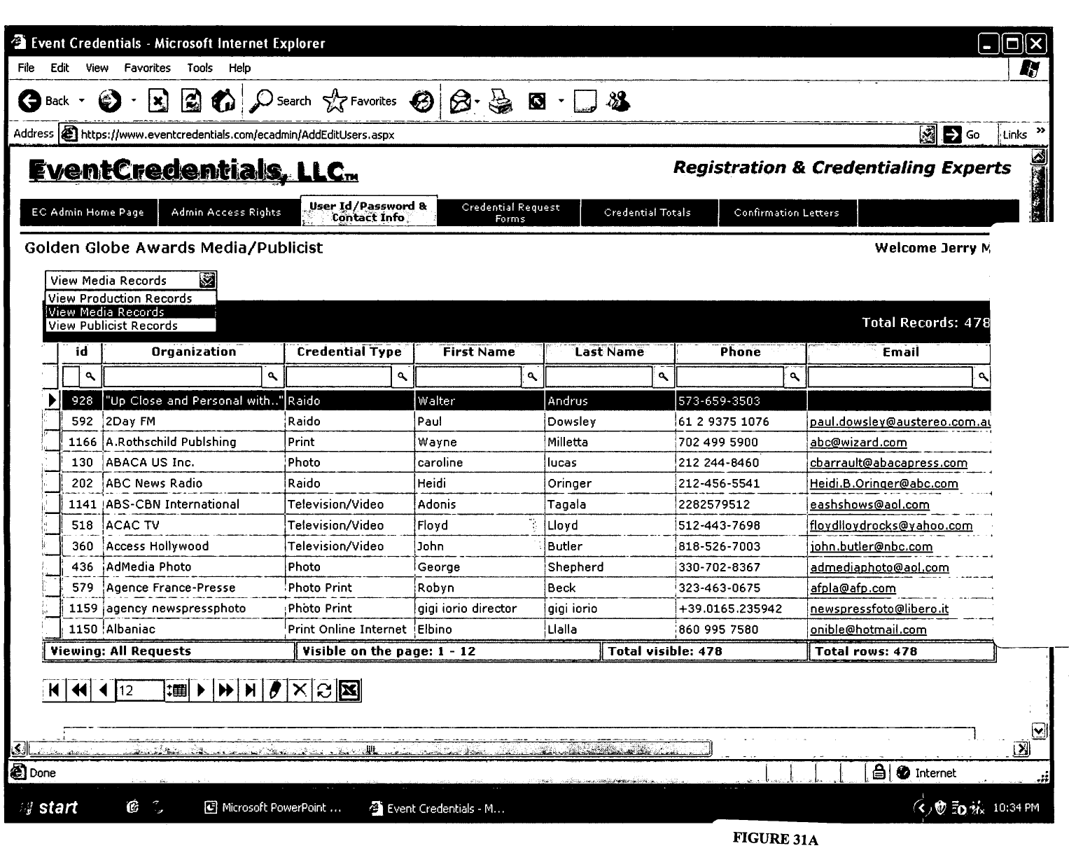

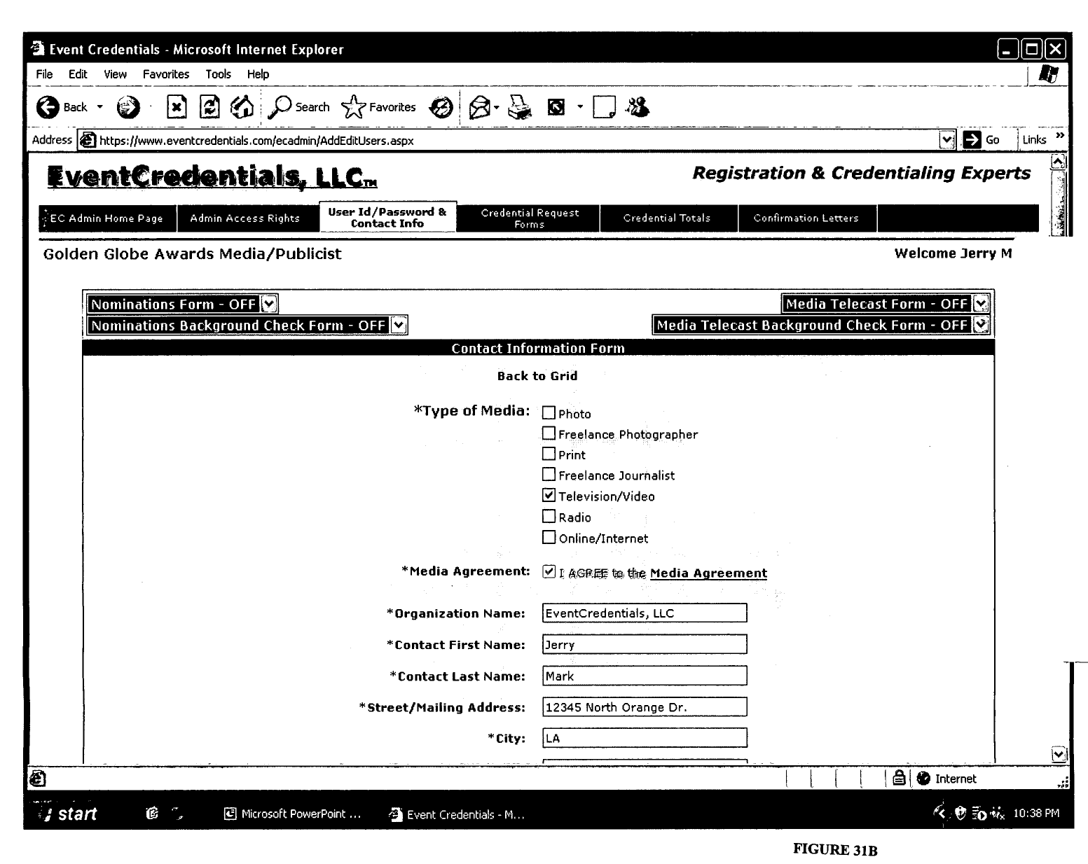

In addition, the administrator 116, 118, 120 can control other aspects of the credentialing process. FIG. 30 A-F illustrates exemplary screen shots of an embodiment of a production user ID and password generator for production staff and vendors and the like. In an embodiment, the administrator 116, 118, 120 creates a user identification enabling a company or an individual to login to the credentialing site.

FIG. 30A-F also illustrates exemplary screen shots of an embodiment of an administrator mass update form. The mass update function allows the administrator 116, 118, 120 to assign a specific access level to a group. Once the administrator 116, 118, 120 selects mass updates, the administrator 116, 118, 120 chooses the table or records upon which to perform mass updates and the zone or credential to assign. The administrator also has the ability to limit the number of credential request forms that can be submitted from an organization. Currently by applying a numeric value to a designated text box in the software the system will recognize how many forms have been submitted and shut off the submit button or the login function as well as indicate to the end user that they have reached their allotted number of entries. Furthermore, the credential request form indicates at the top of the page the total number of entries remaining and the number of entries allocated (see FIG. 22A-F) as well as who has been entered thus far under the organization's assigned user ID/password.

In the embodiment illustrated in FIG. 30A-F, the administrator 116, 118, 120 is assigning zone A to all of the individuals represented in the selected company. In this example, the administrator 116, 118, 120 has pulled down the menu of companies from which a selection can be made, but has not made a selection. Once a company is selected, the server 110 revises the access levels for all of the individuals represented by the company to have access to zone A.

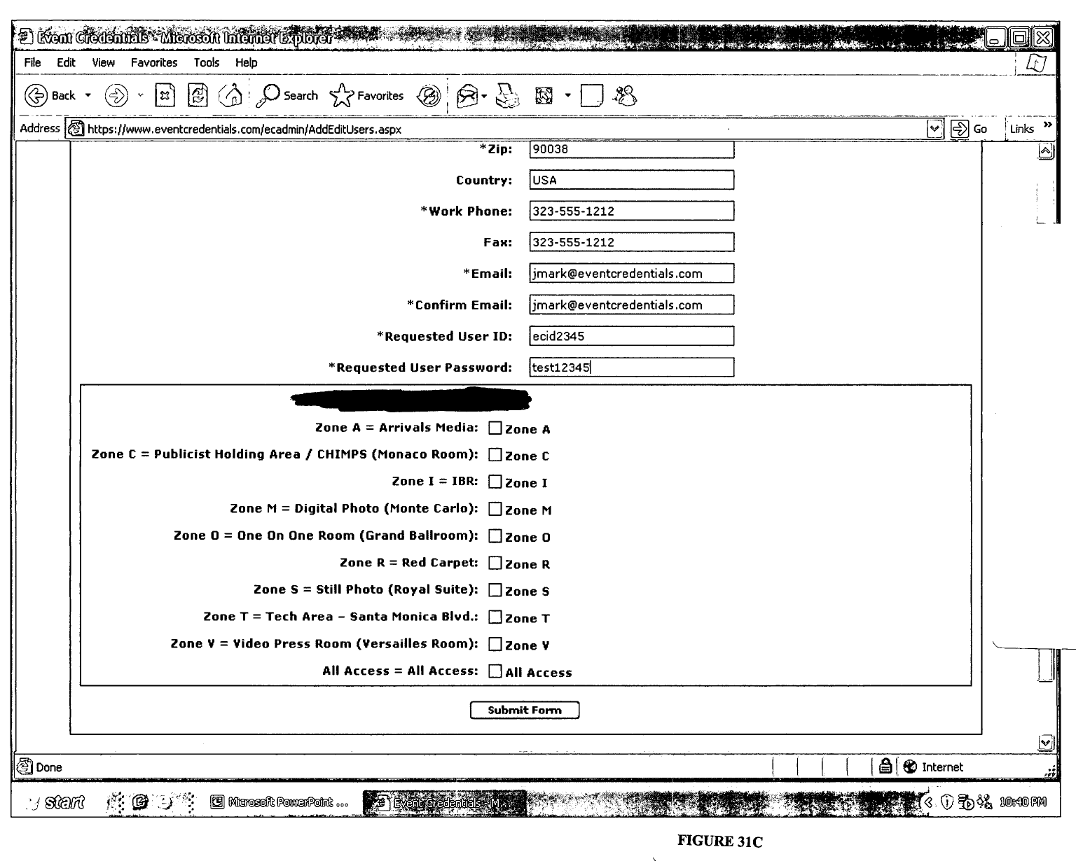

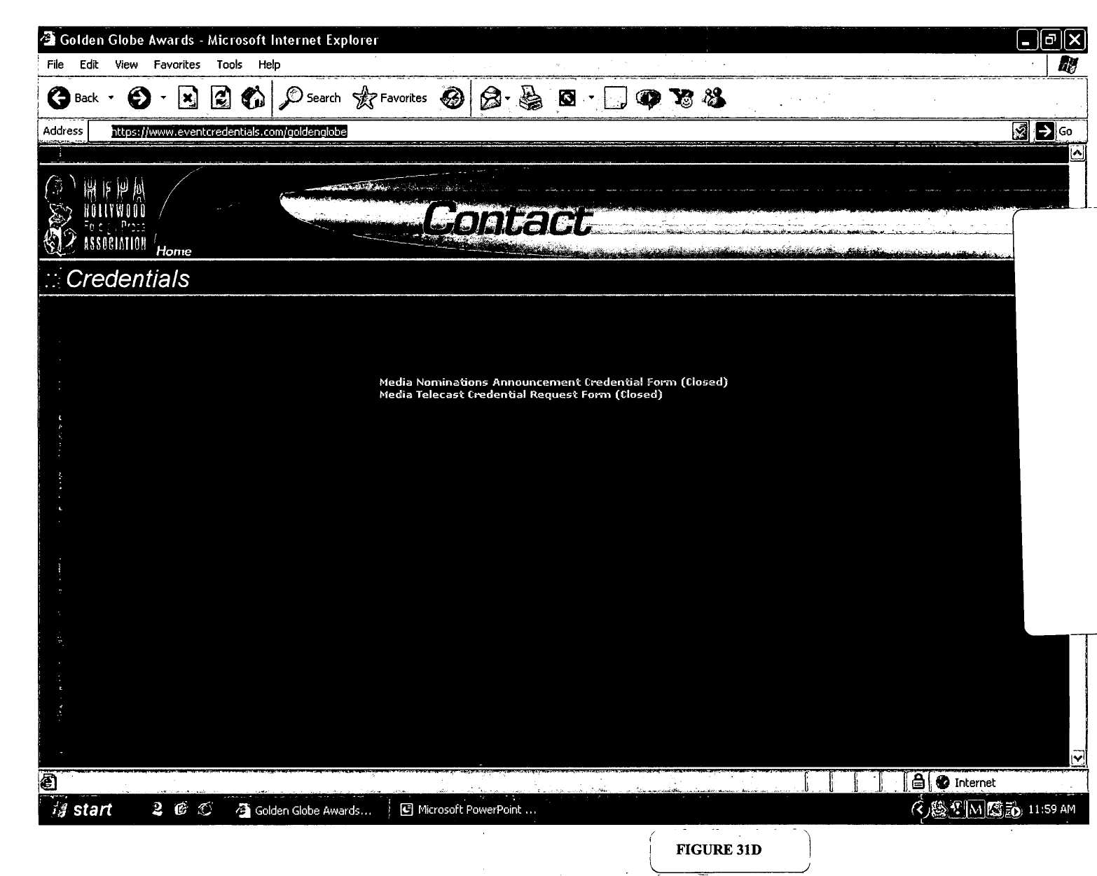

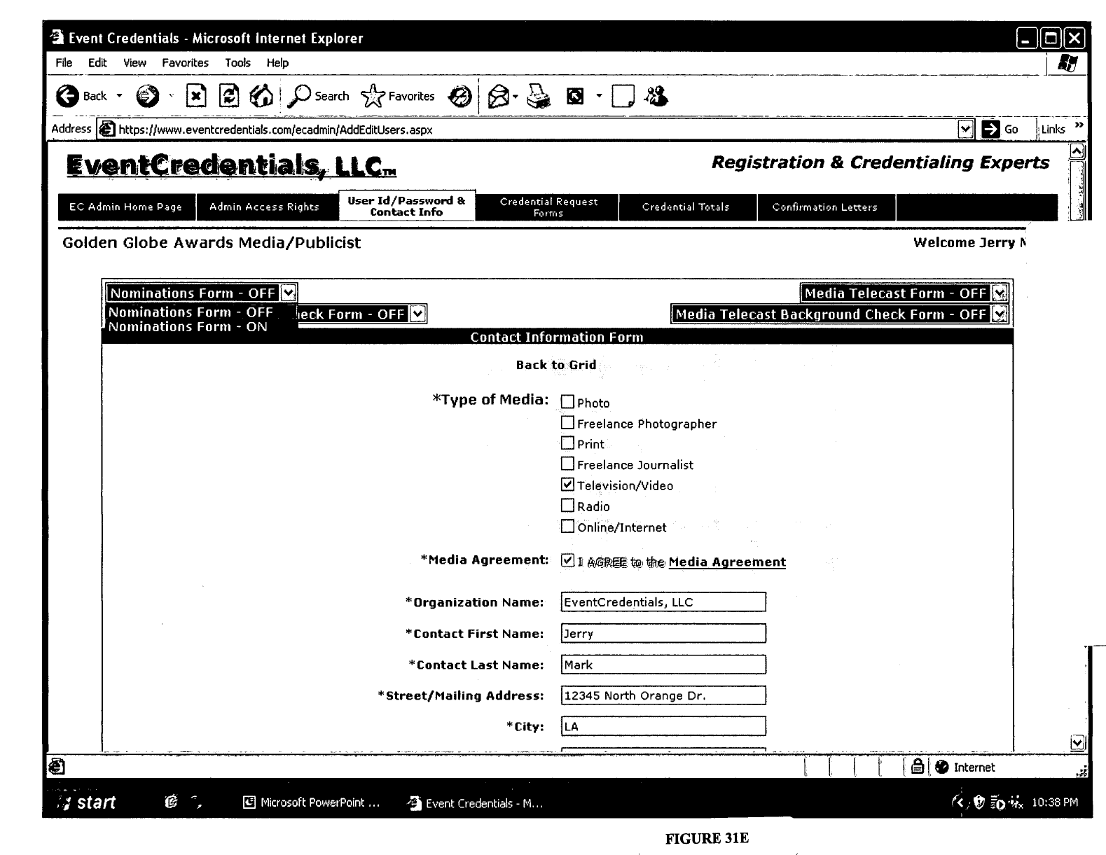

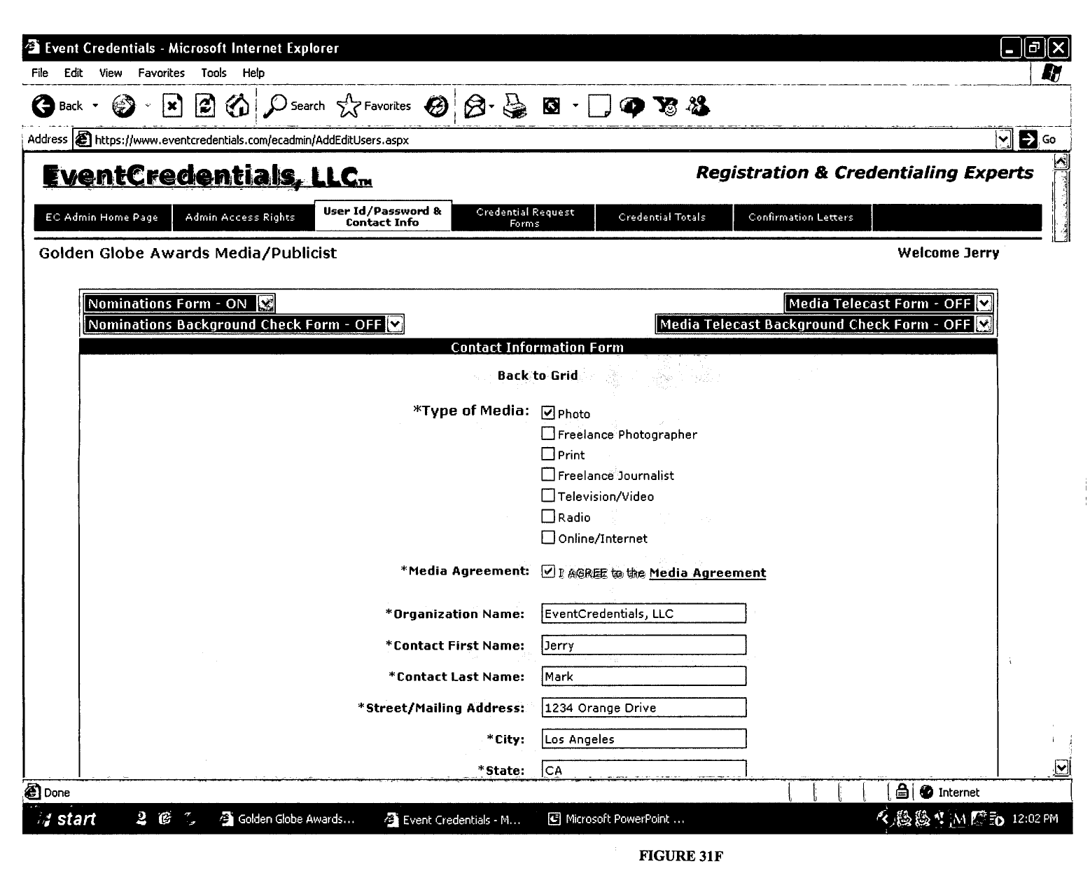

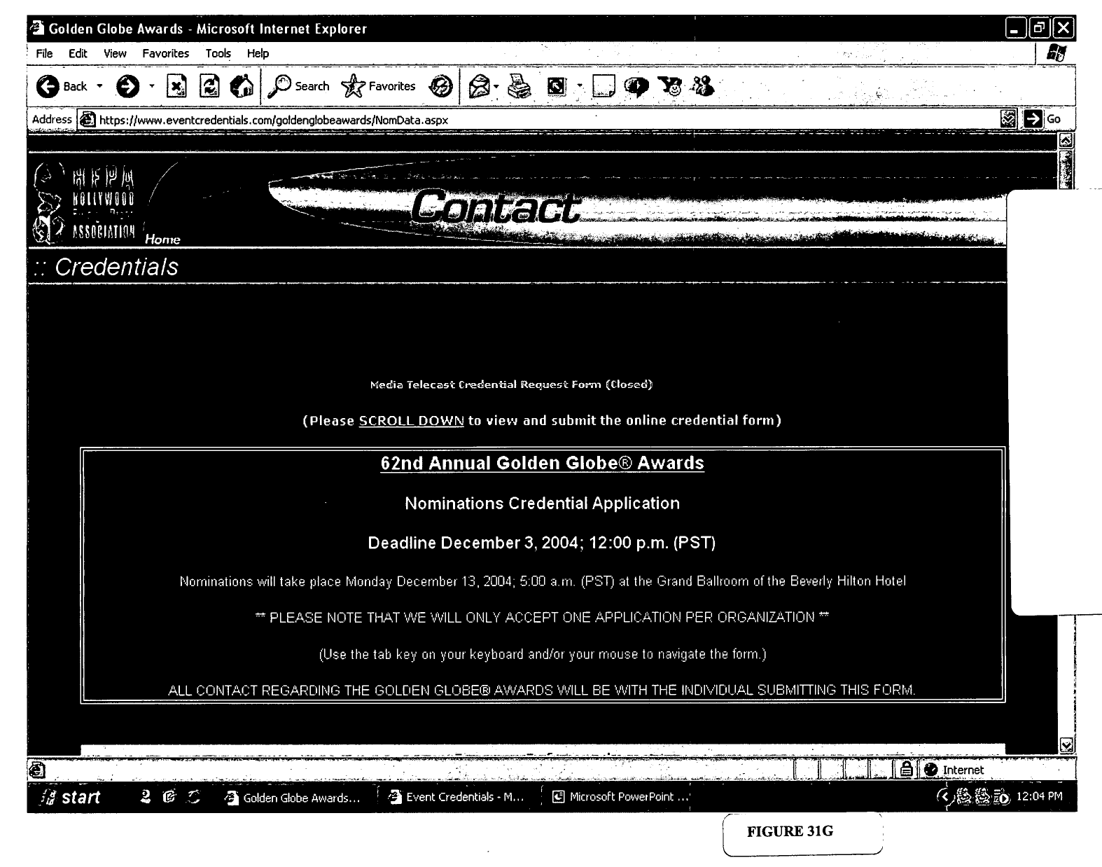

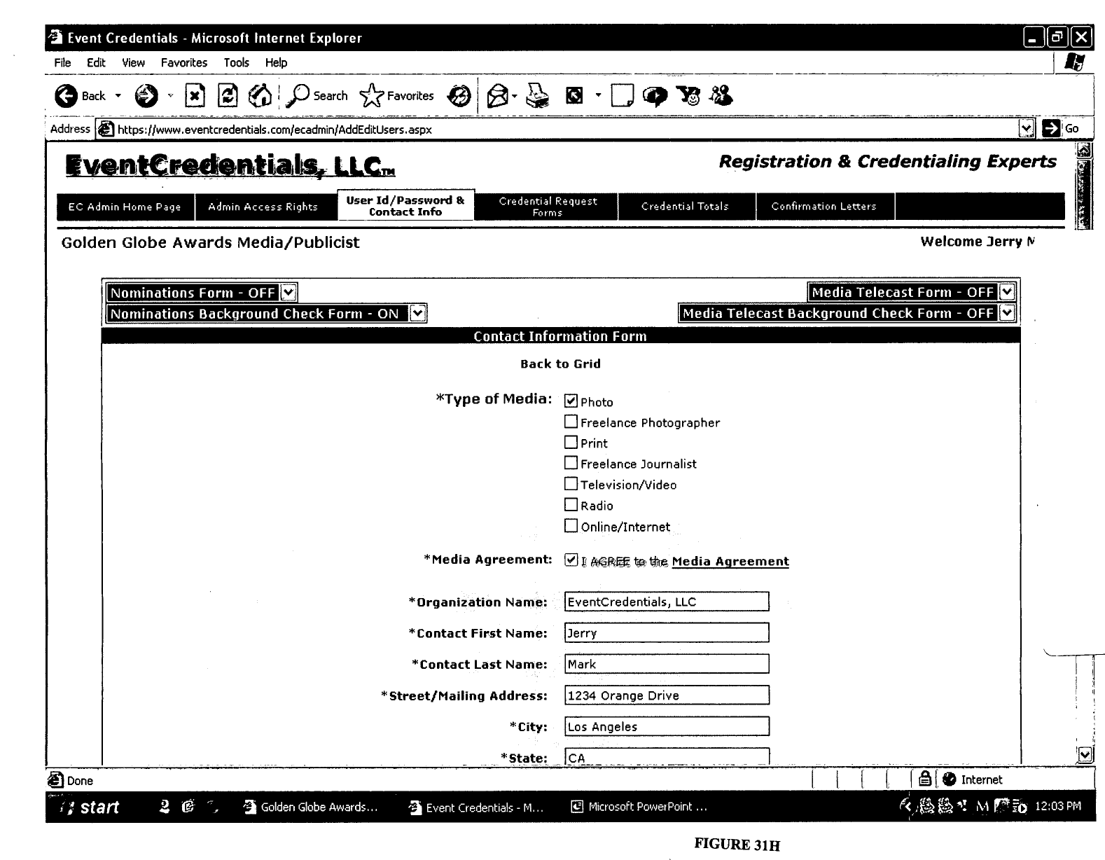

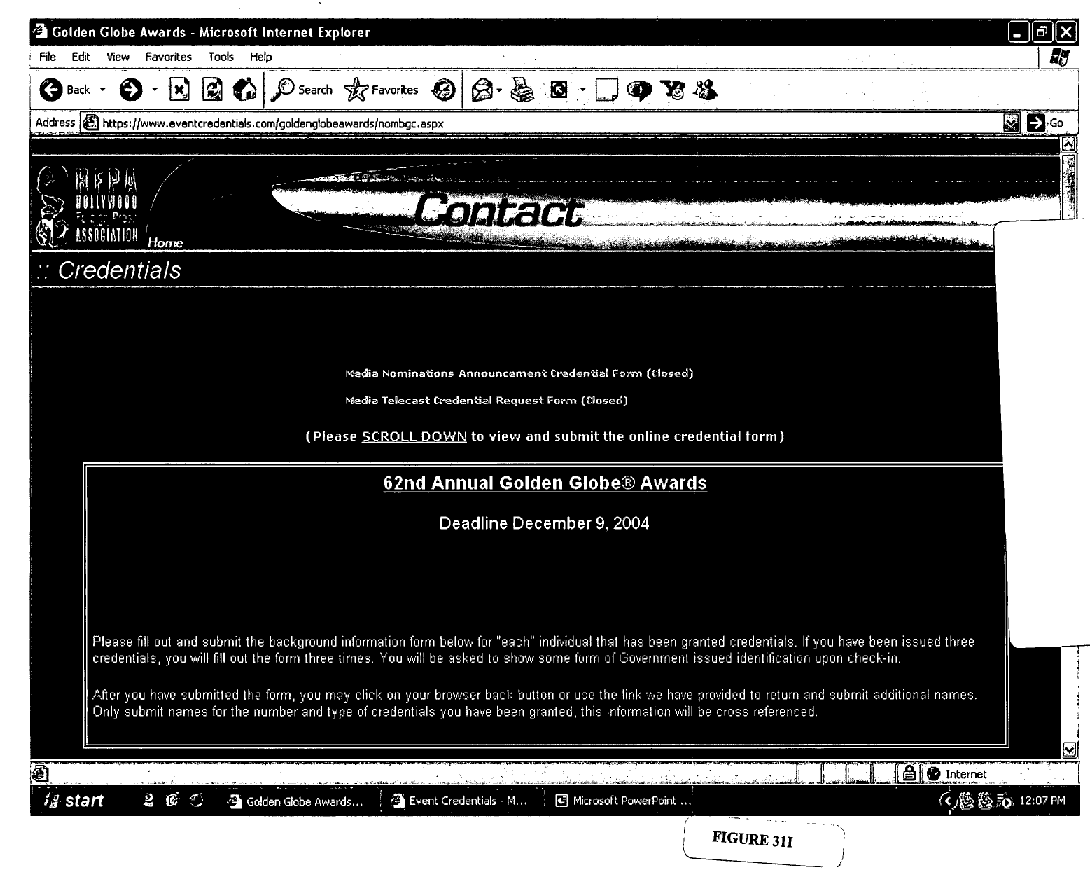

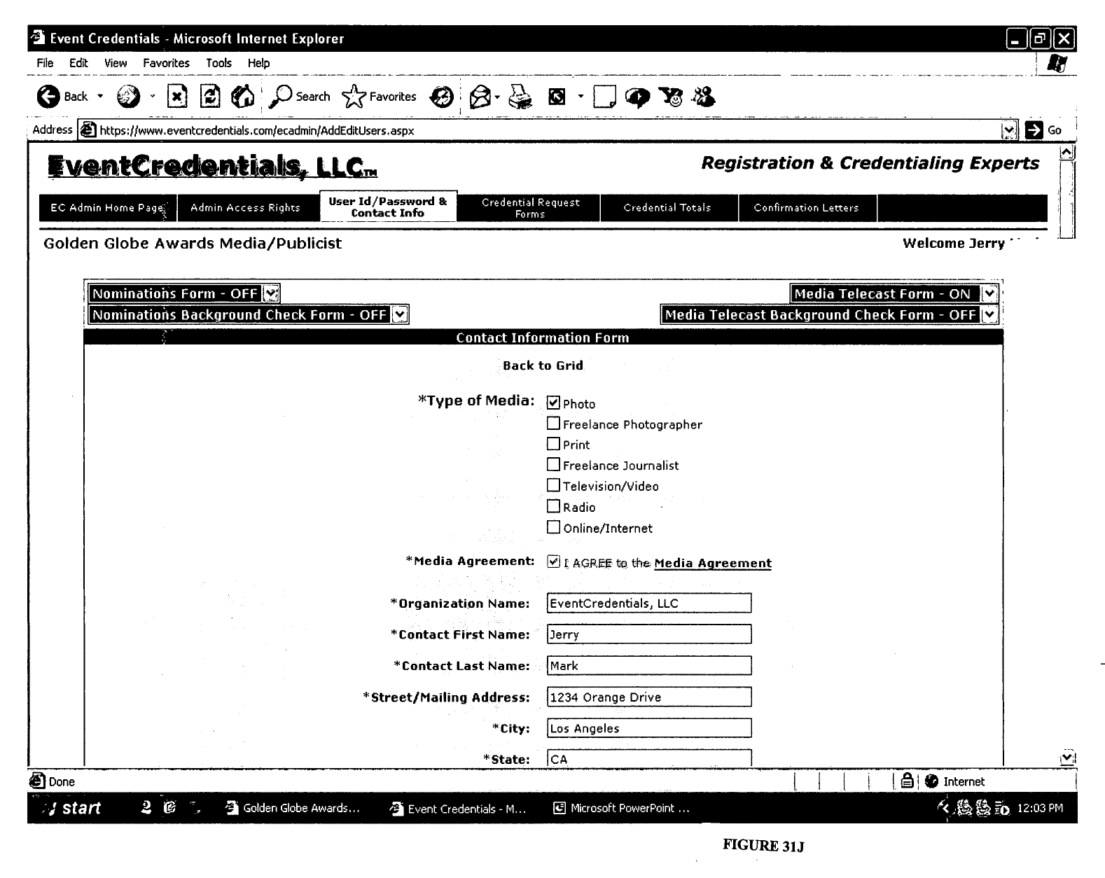

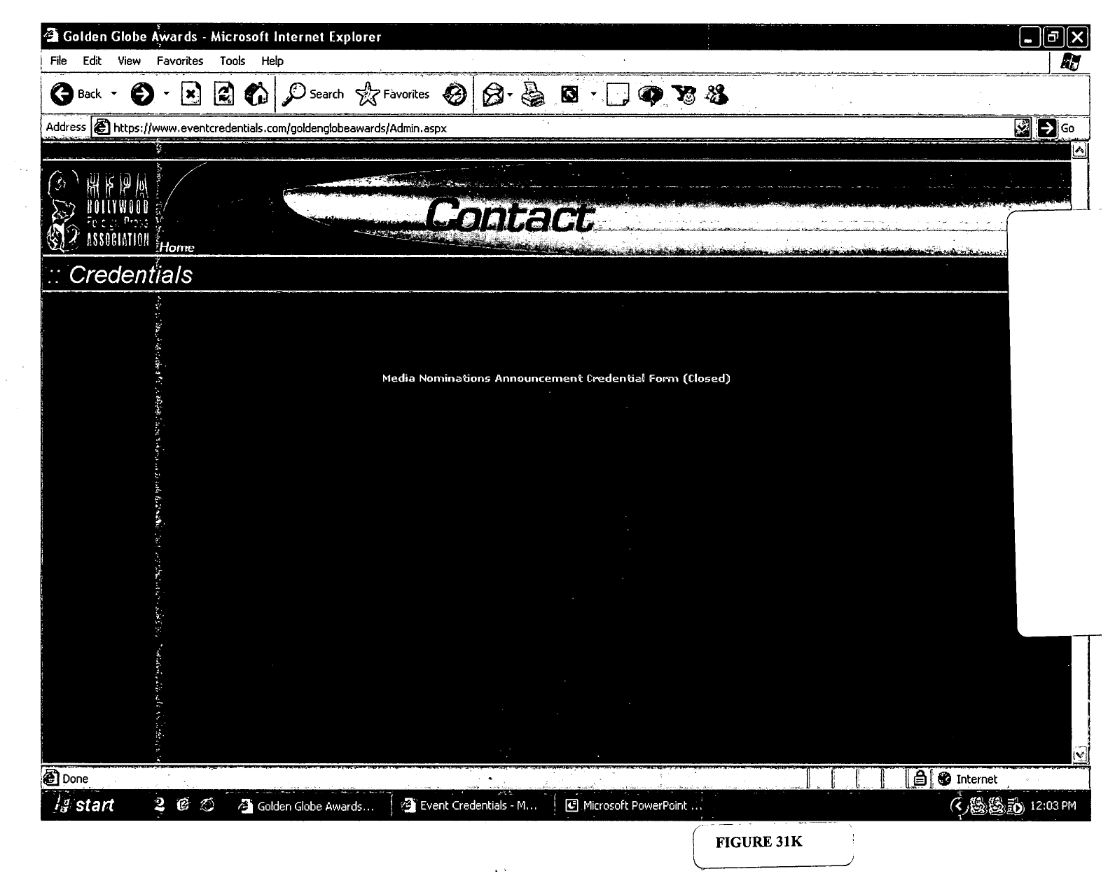

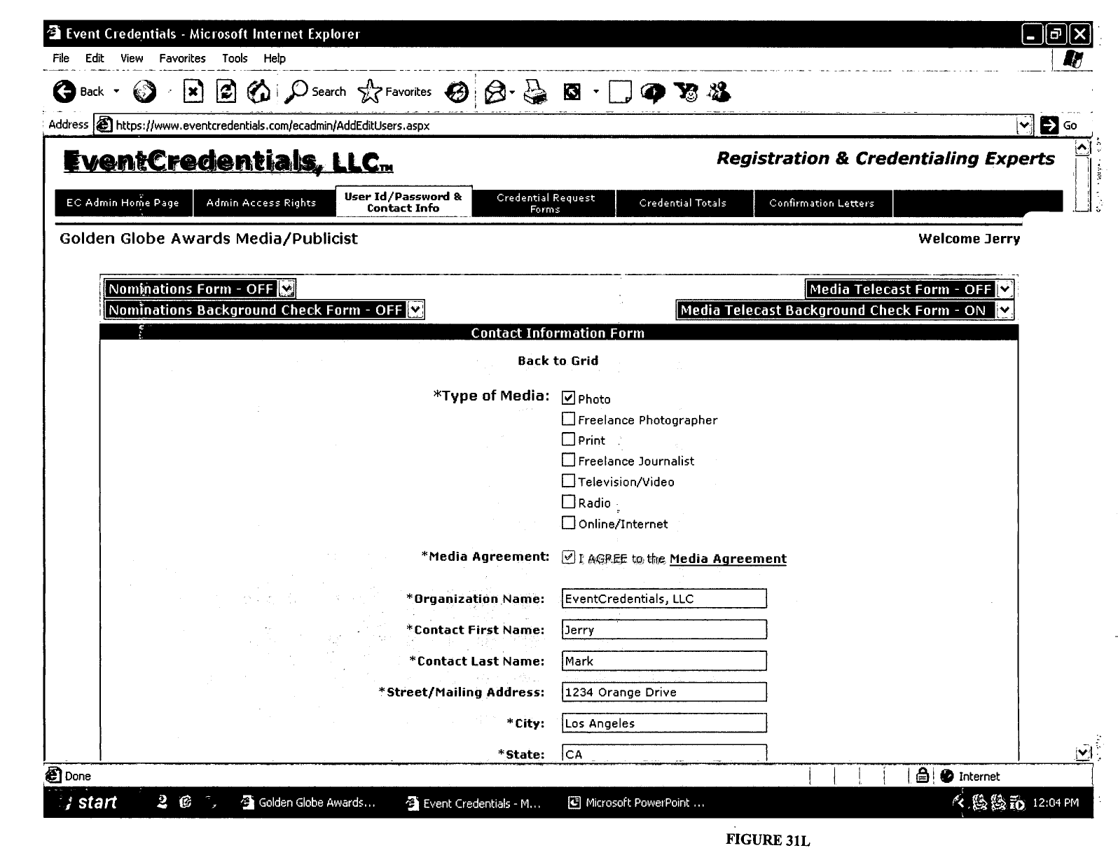

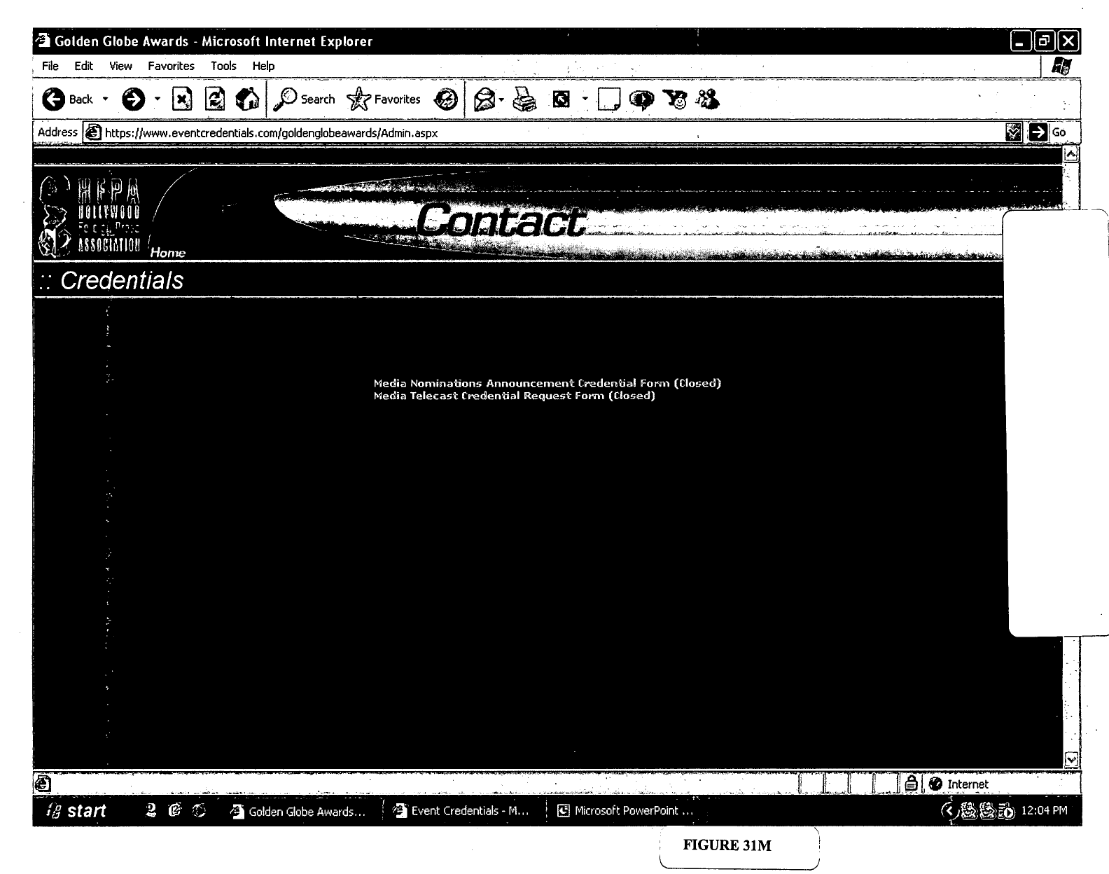

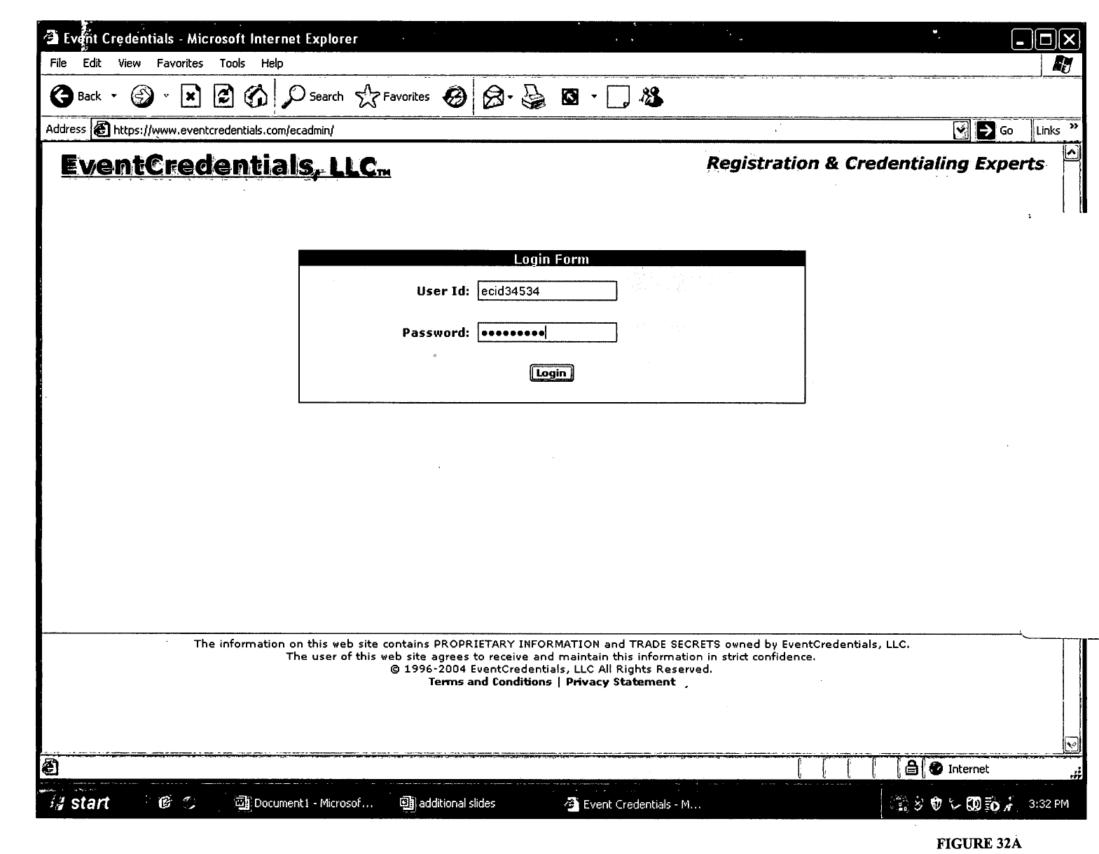

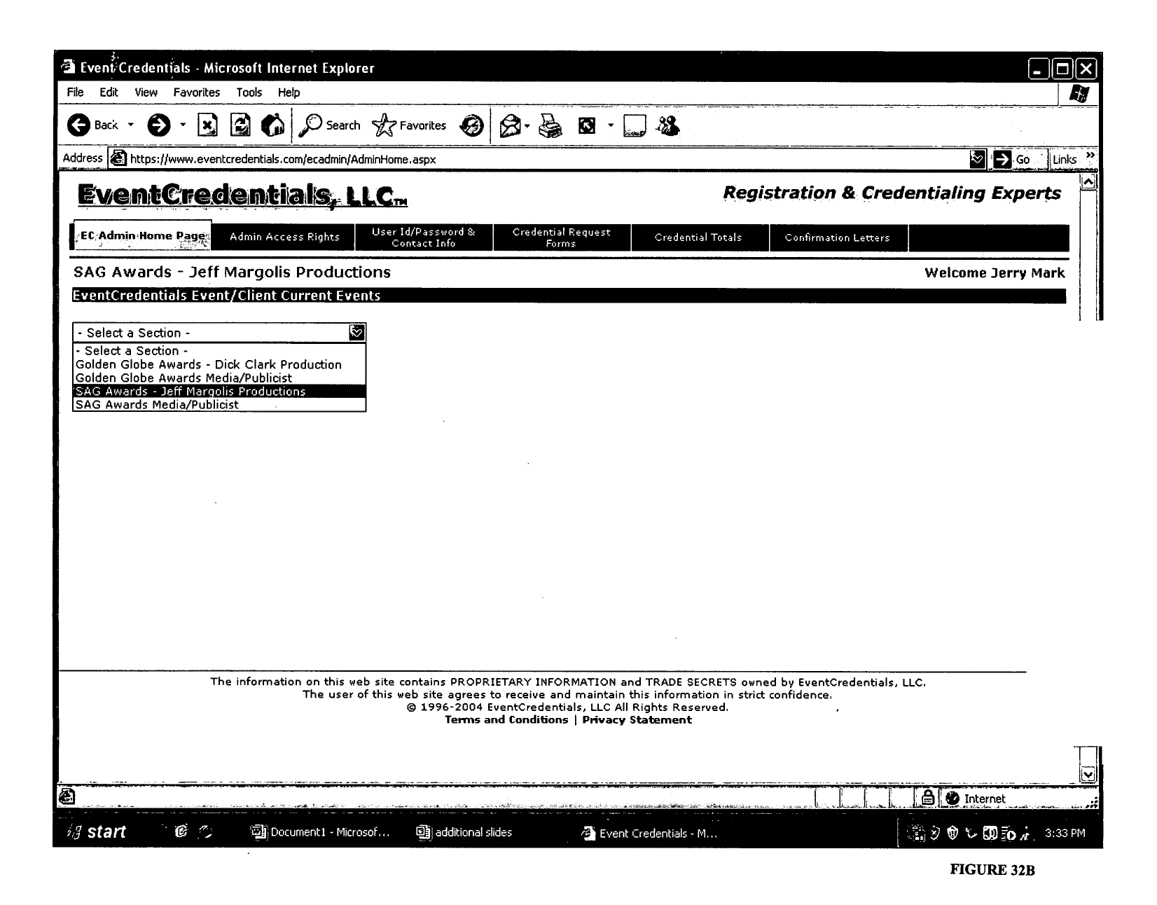

FIG. 31A-M illustrates exemplary screen shots of an embodiment of a user ID and password data holding or review area and administrator open/close form function for production, media, publicist and the like. The administrator 116, 118, 120 uses a form open/close function, for example, after the submission deadline for submitting background check information has passed, and the server 110 has closed the forms. An administrator 116, 118, 120 can allow another registrant 102, 104, 108, 122 to register or to add new people to the background check form and submit it, after the deadline has passed. The administrator 116, 118, 120 opens the forms, the registrant 102, 104, 108, 122 completes the form, and the administrator 116, 118, 120 closes the form. This area can also be used to approve or deny request that have been submitted with or for user ID/passwords wishing to access the request form(s). It can also be used to mass update all of the records attached to a specific user ID/password.

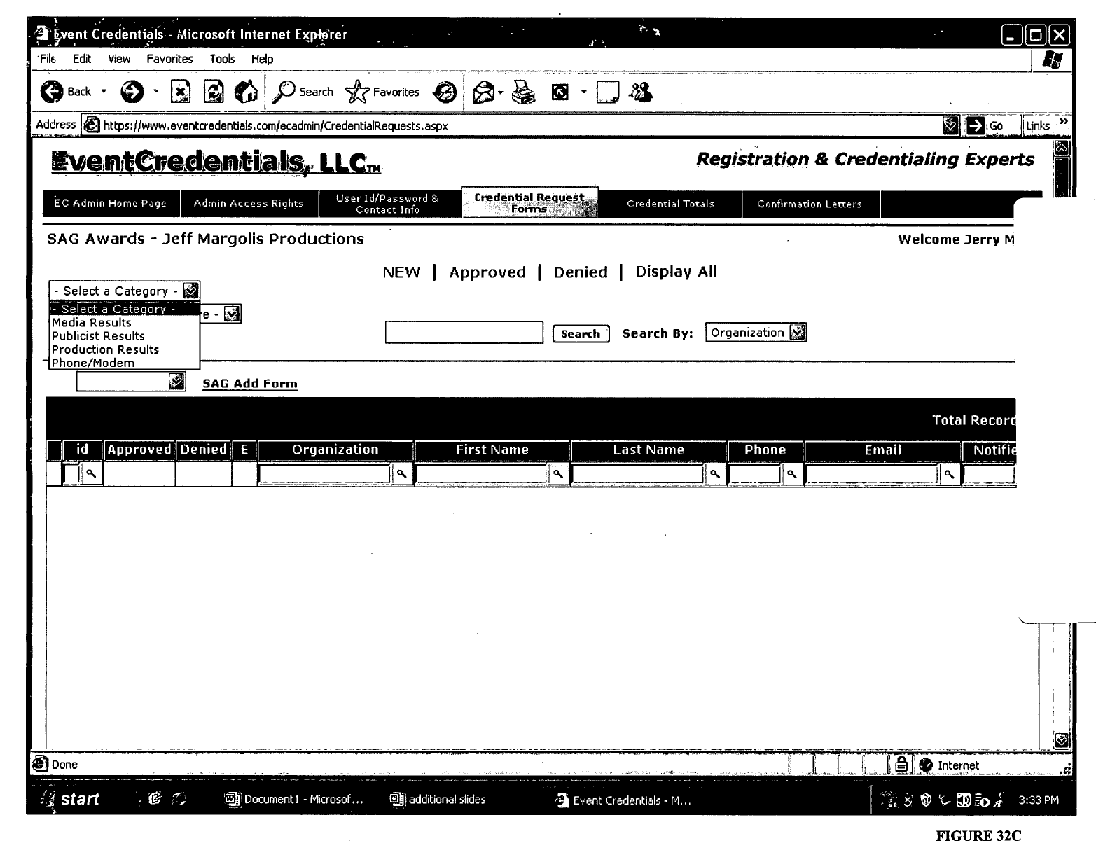

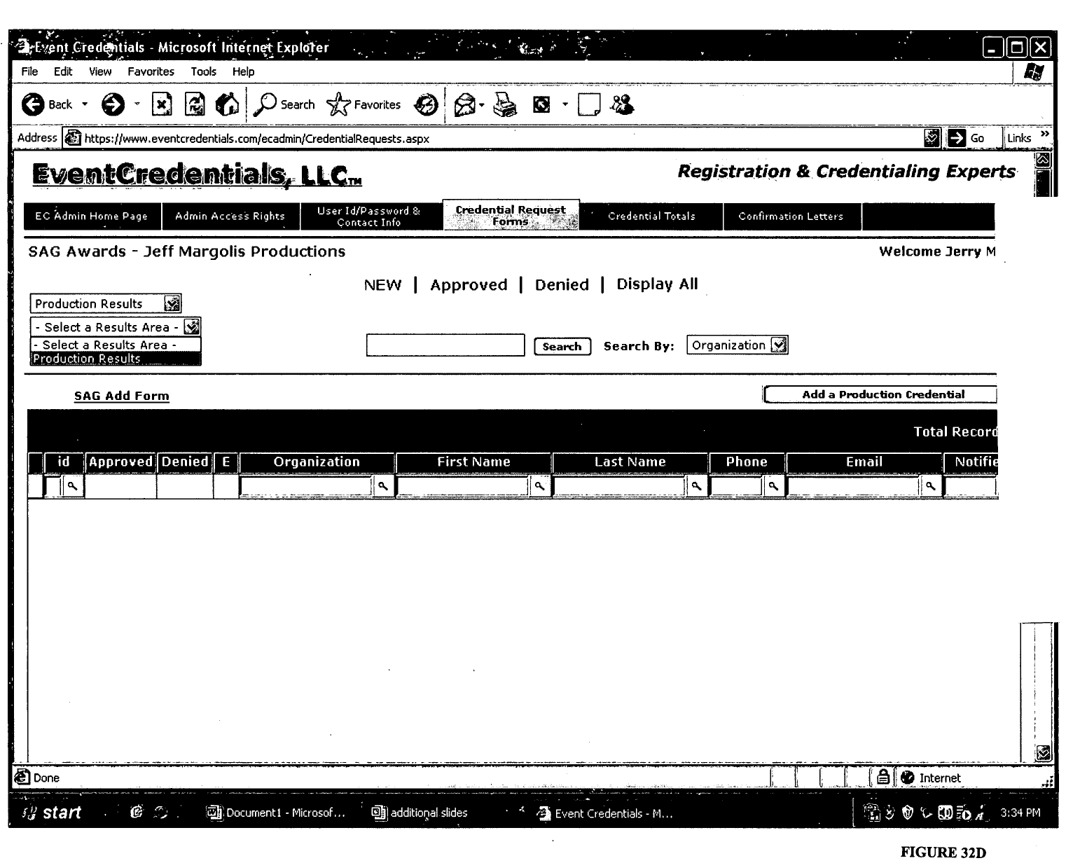

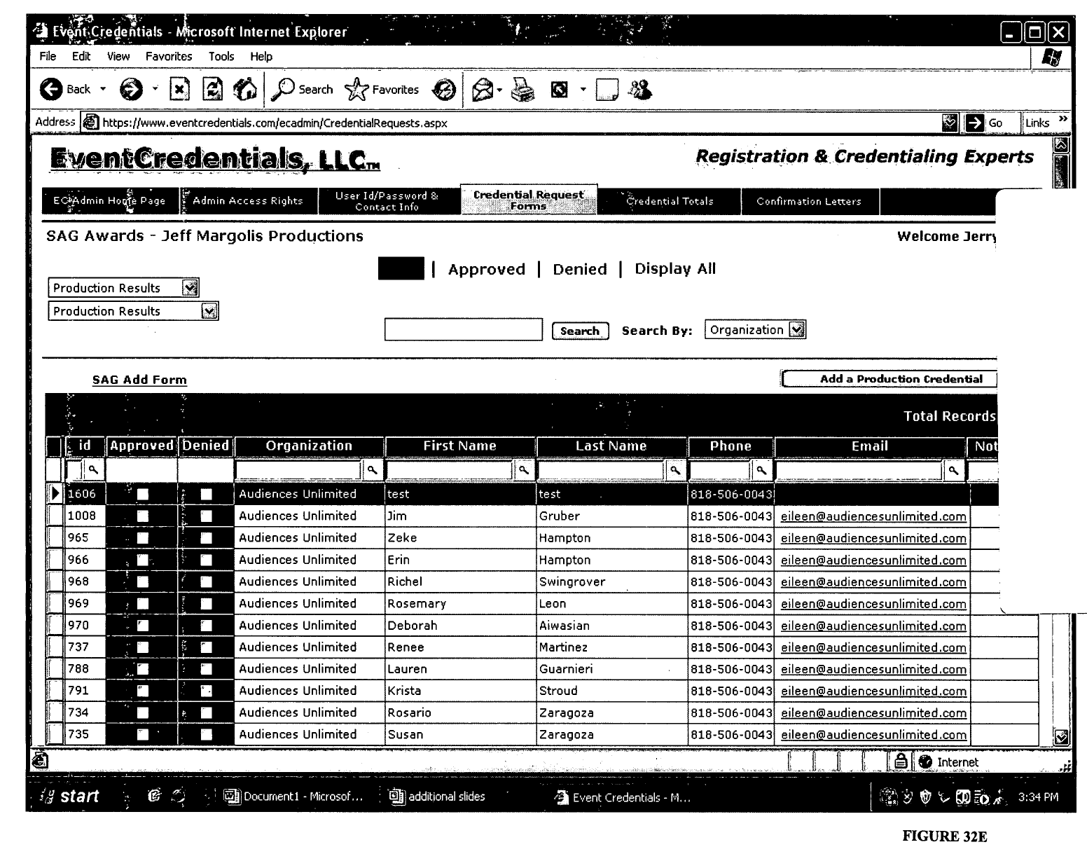

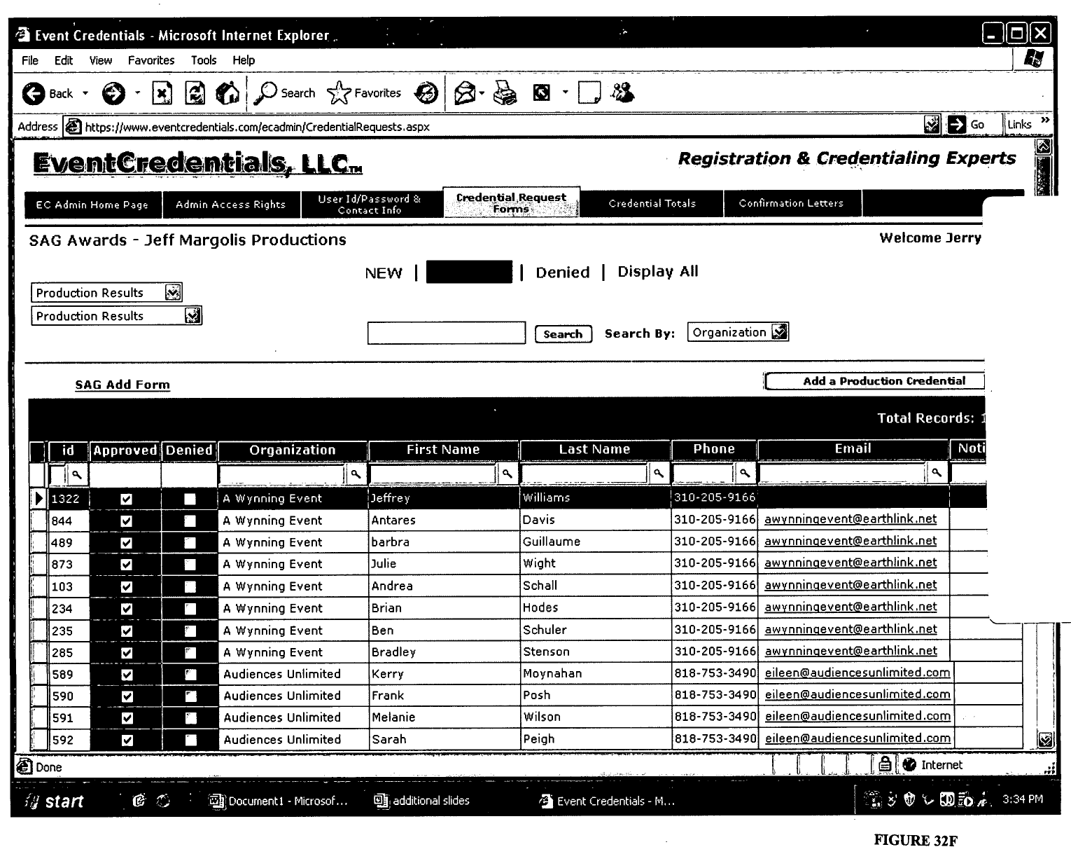

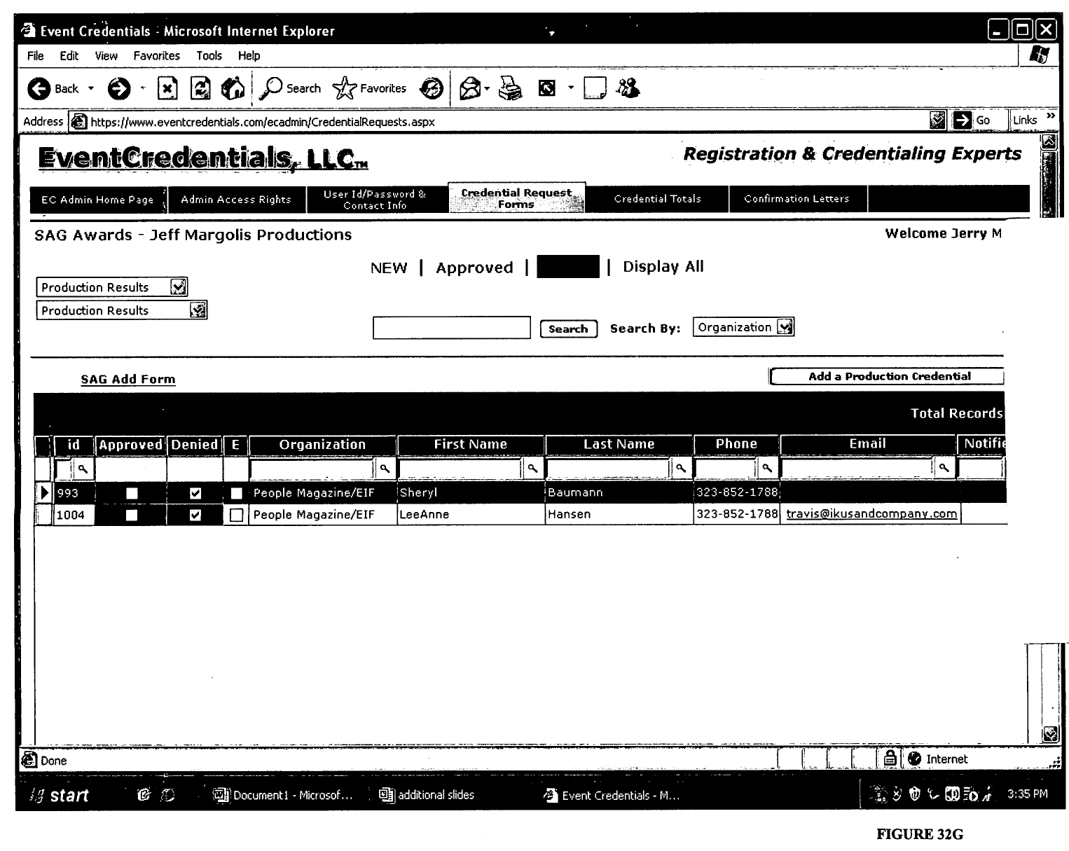

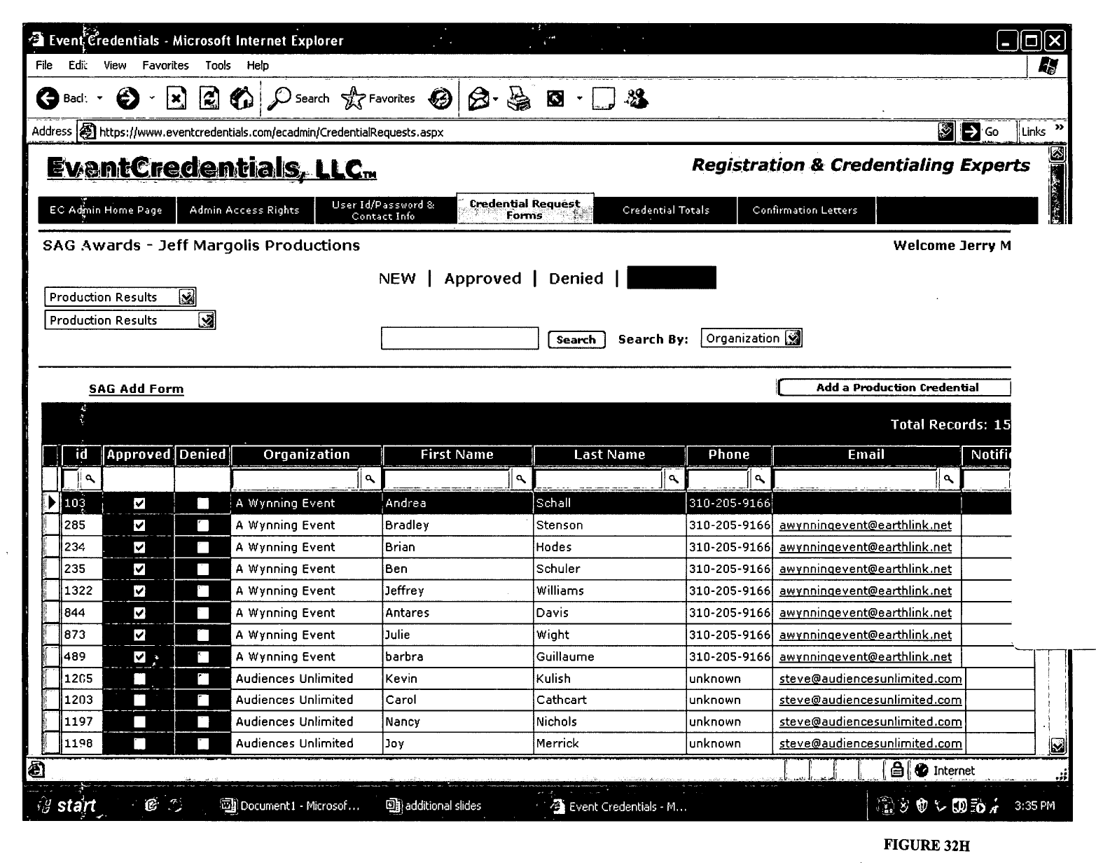

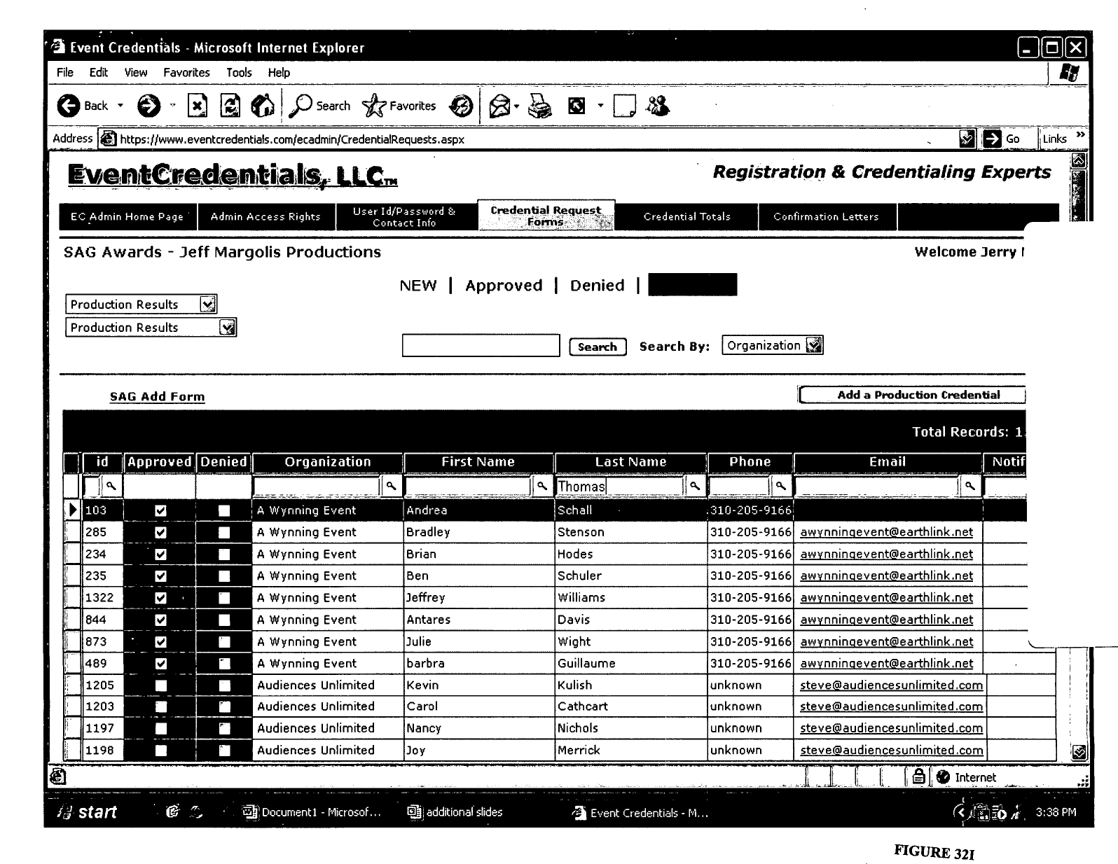

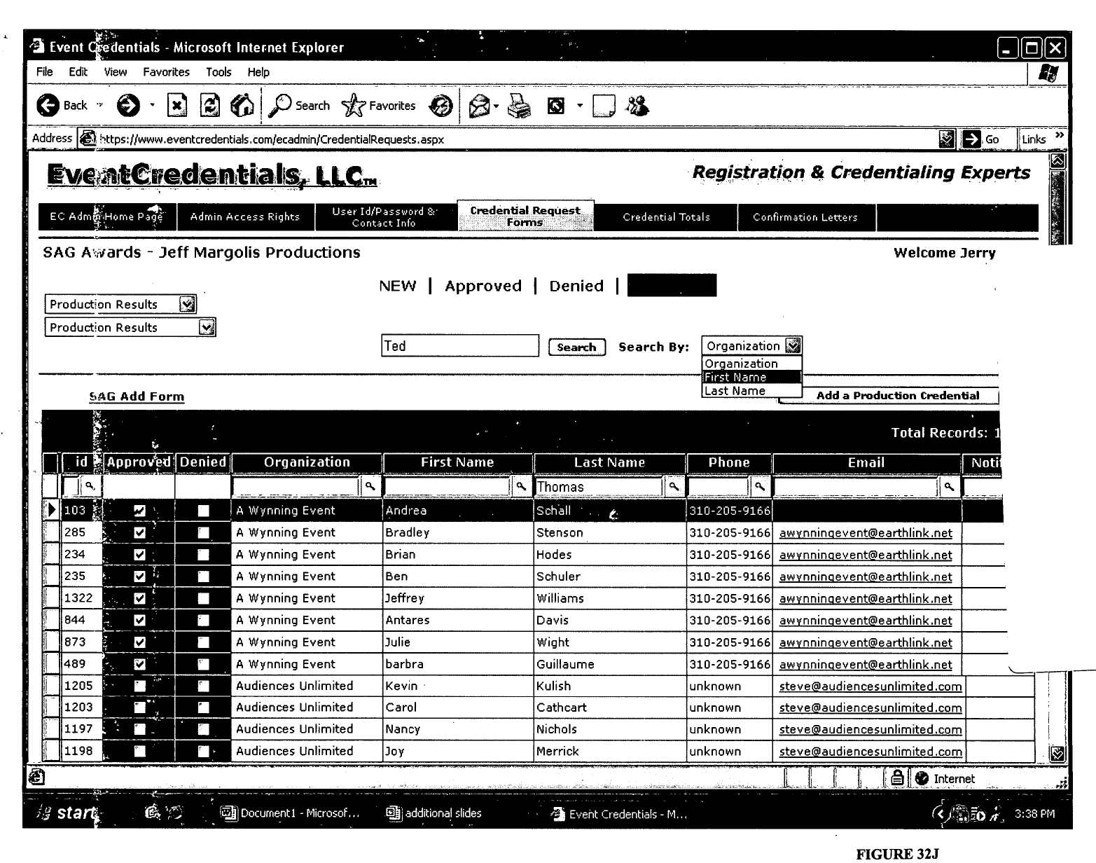

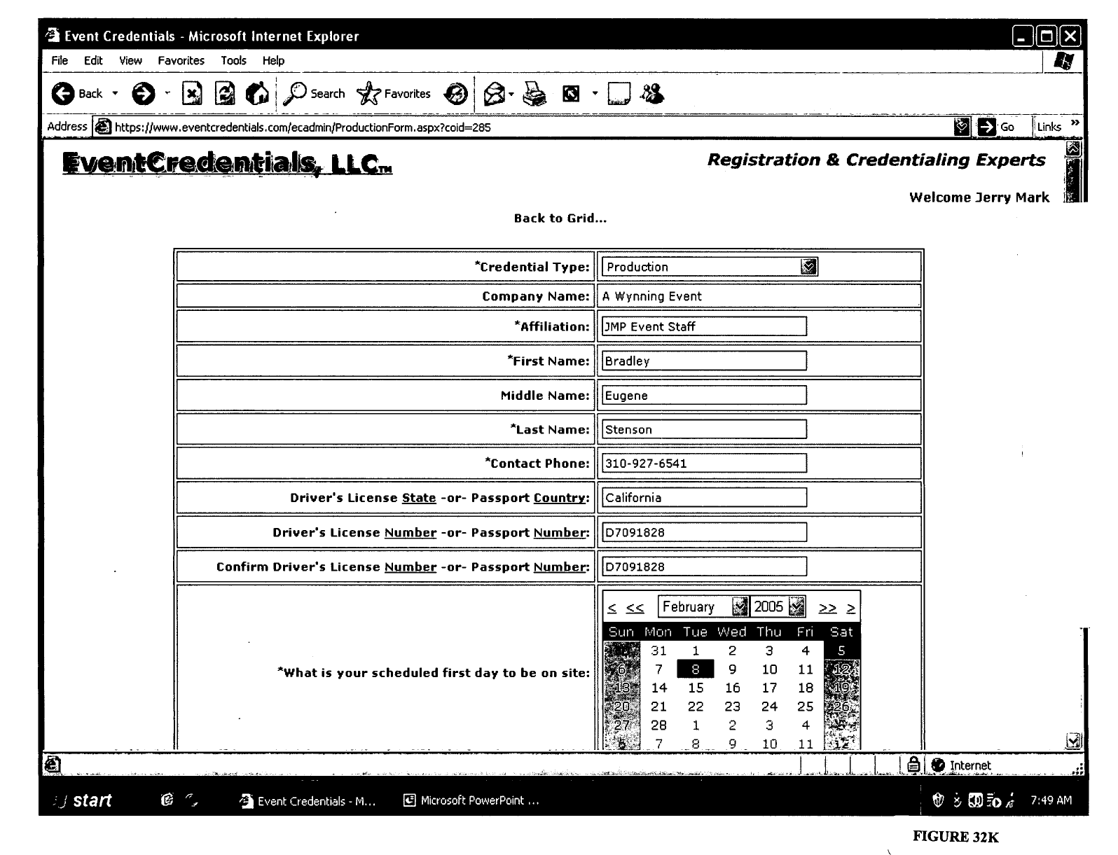

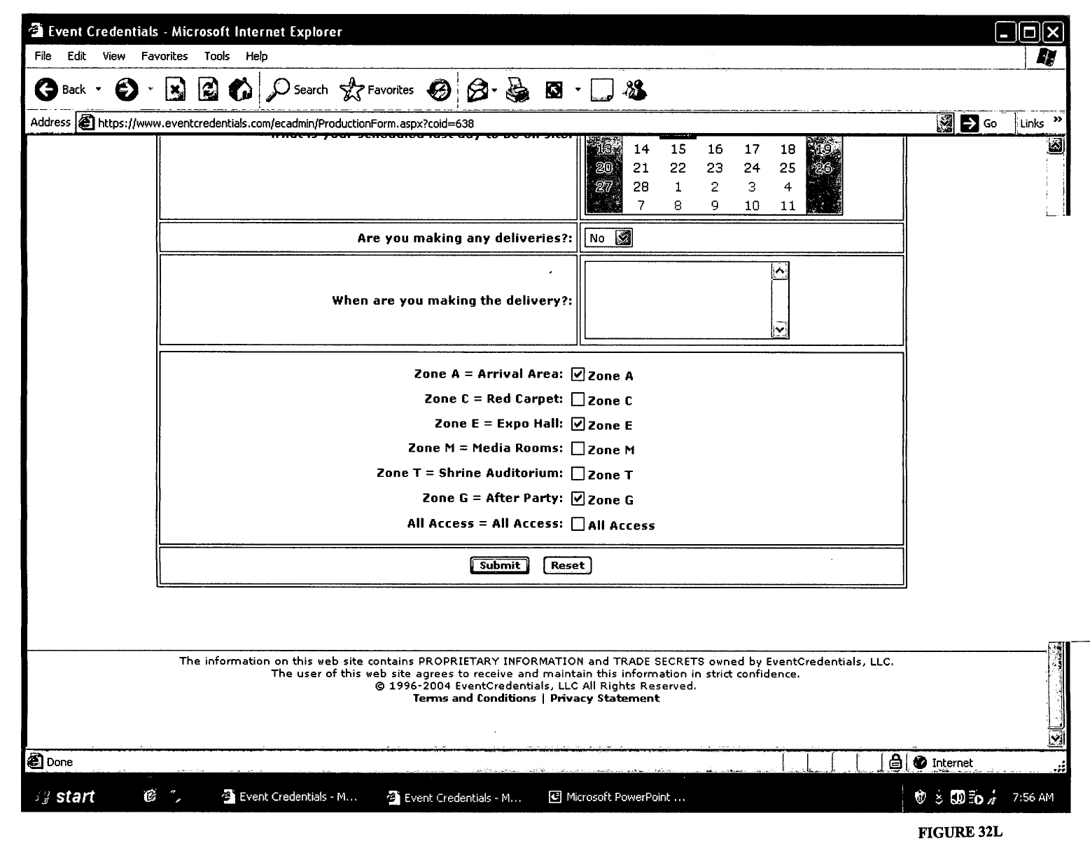

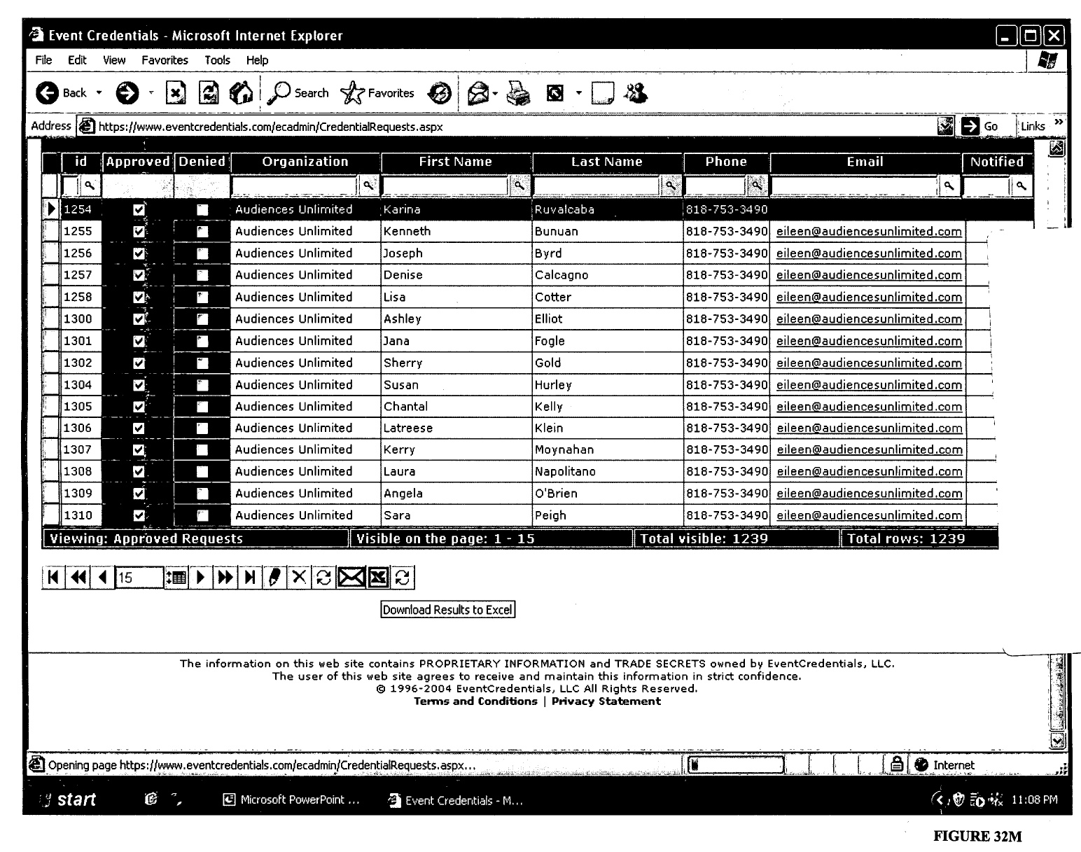

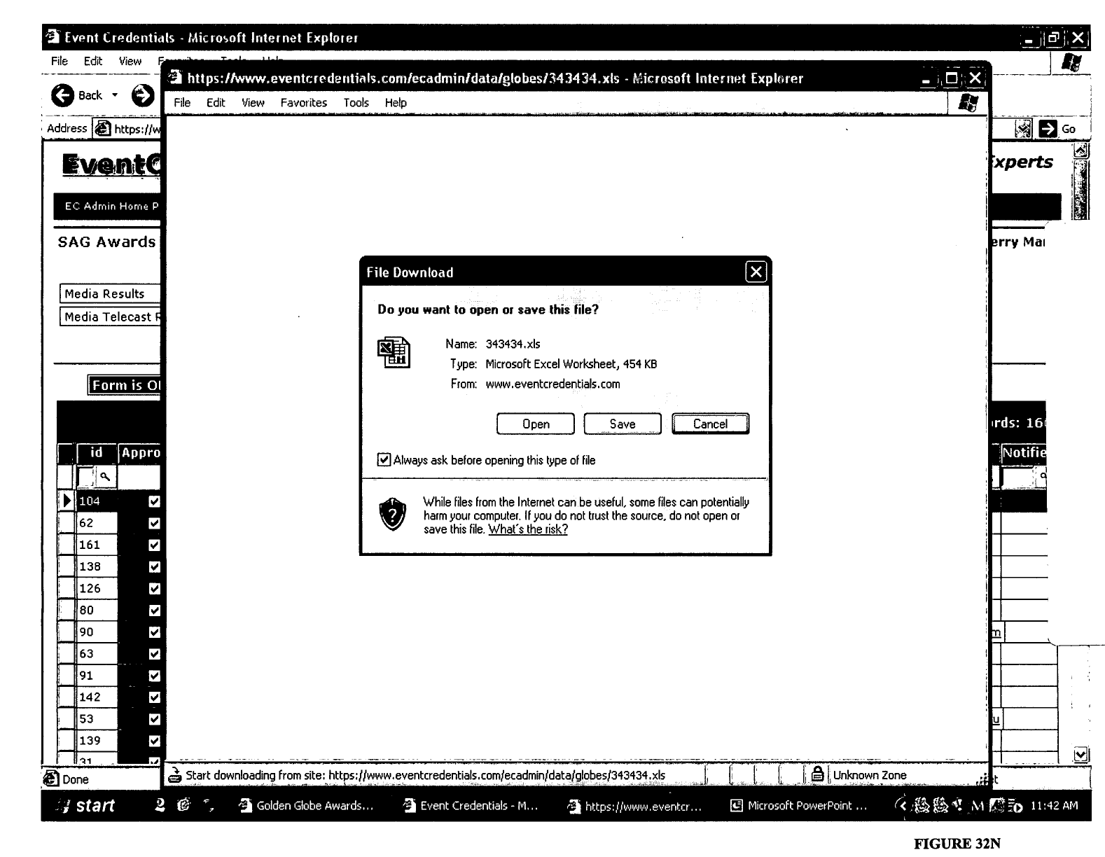

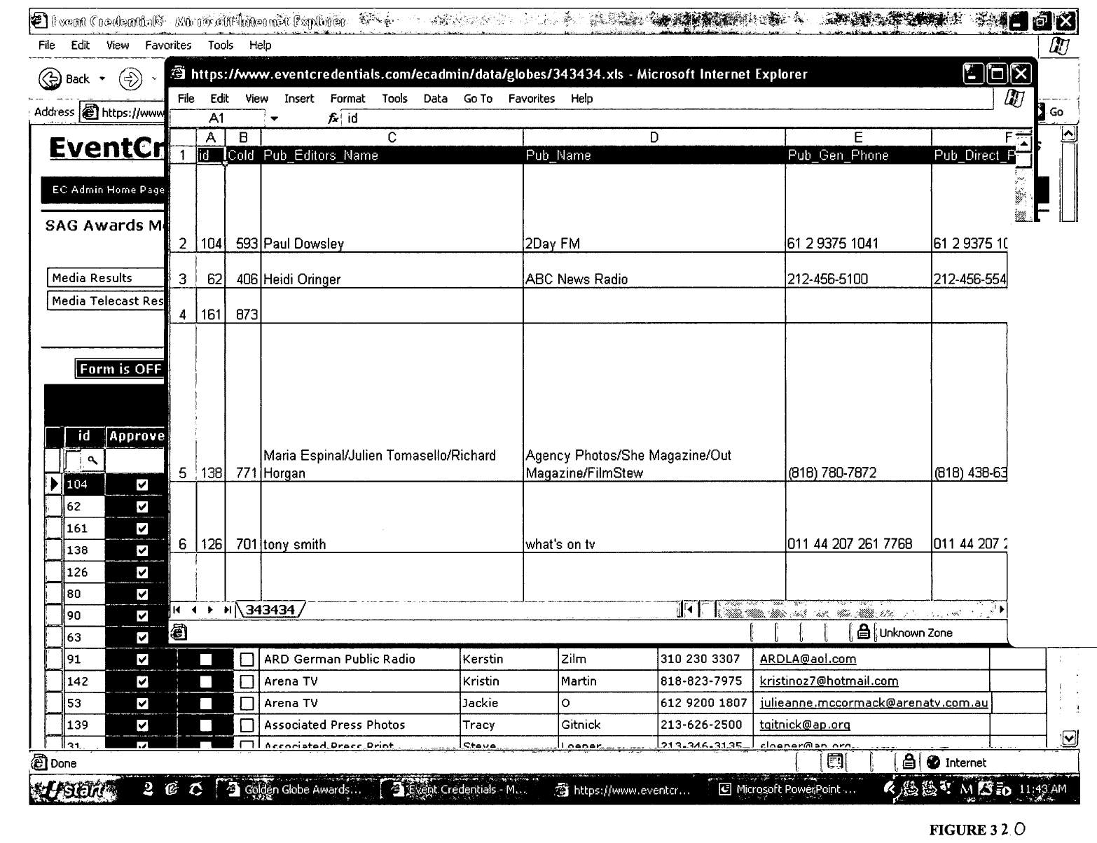

FIG. 32A-O illustrates exemplary screen shots of an embodiment of an administrator production, vendor, and the like, credential request review area which consists of a New, Approved, Denied and Display All areas and form view. The grid or list comprises individuals' records for which the administrator 118 can review, modify, approve, deny, or delete. As in all areas of the site, the results areas can be downloaded to a specific location, a hard drive, for example or viewed in a pop up window through an excel spreadsheet. Once downloaded the spreadsheet can be manipulated and/or sent to other individuals electronically or via mail.

Referring to FIG. 4B, in block 462, background information associated with an individual's record can also be gathered electronically. This information can be cross-referenced electronically with governmental agencies to provide a high level of security at an event.

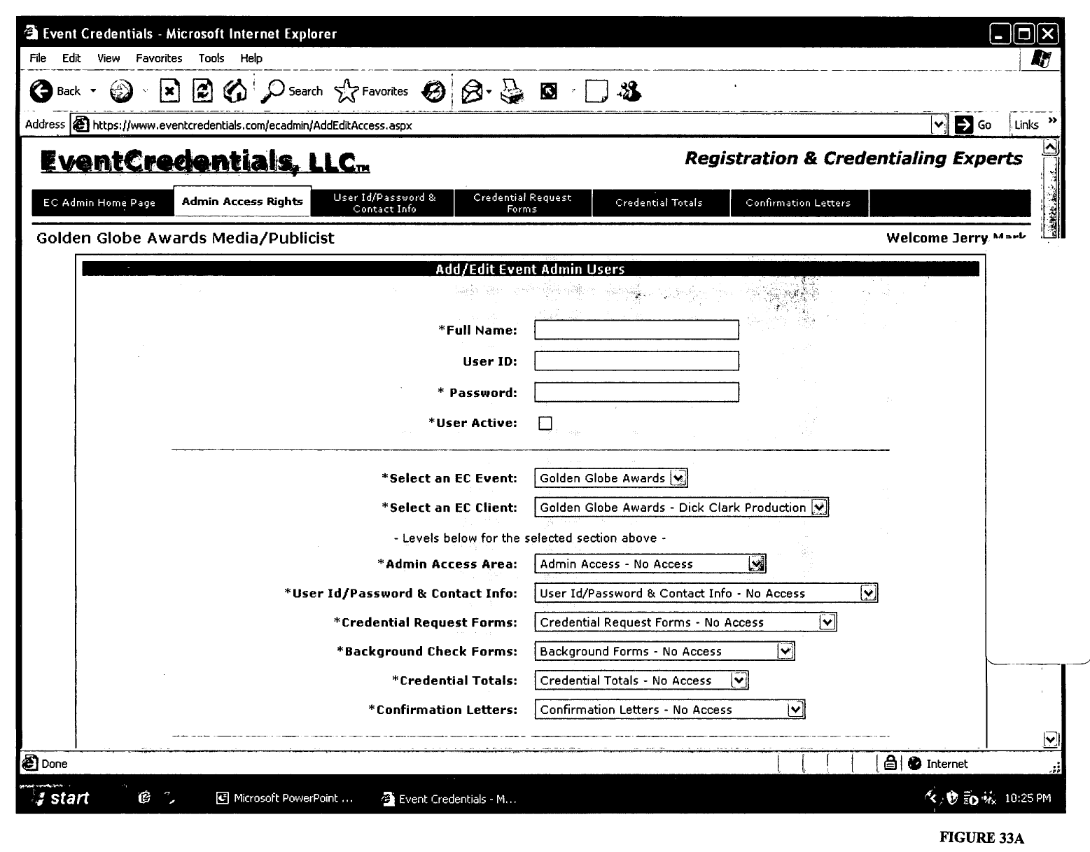

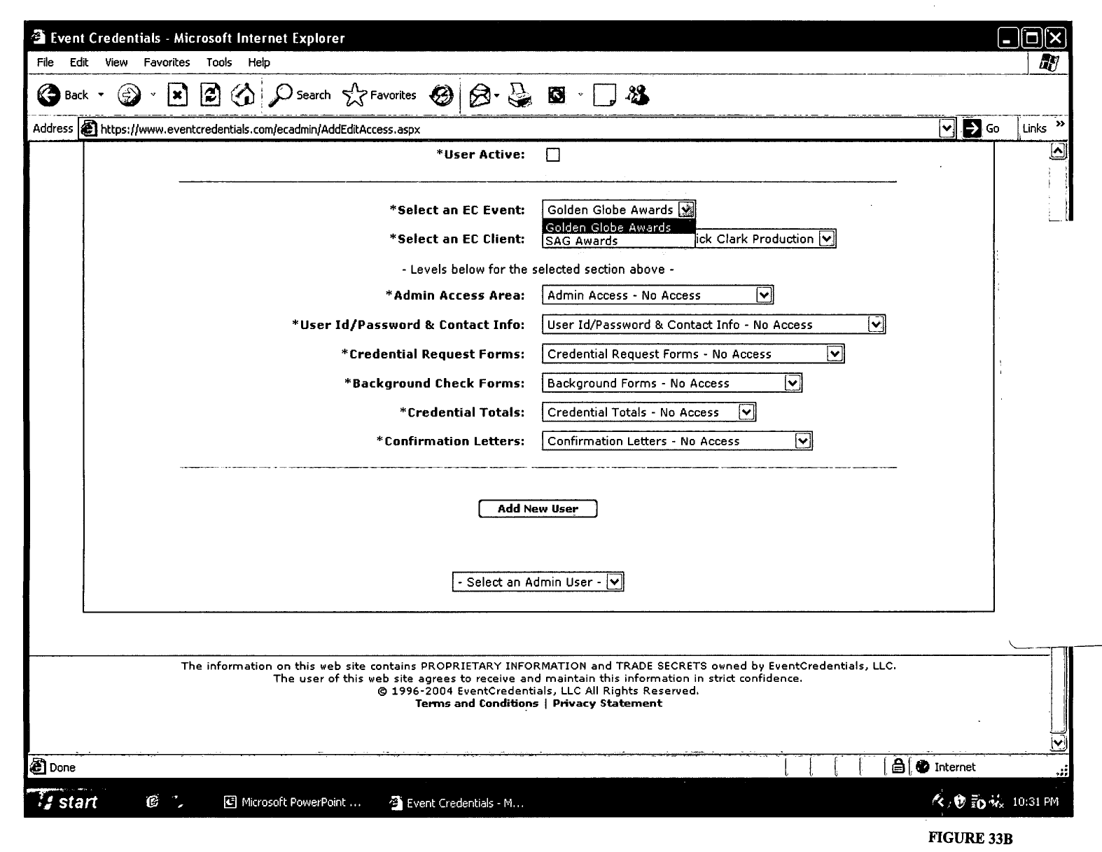

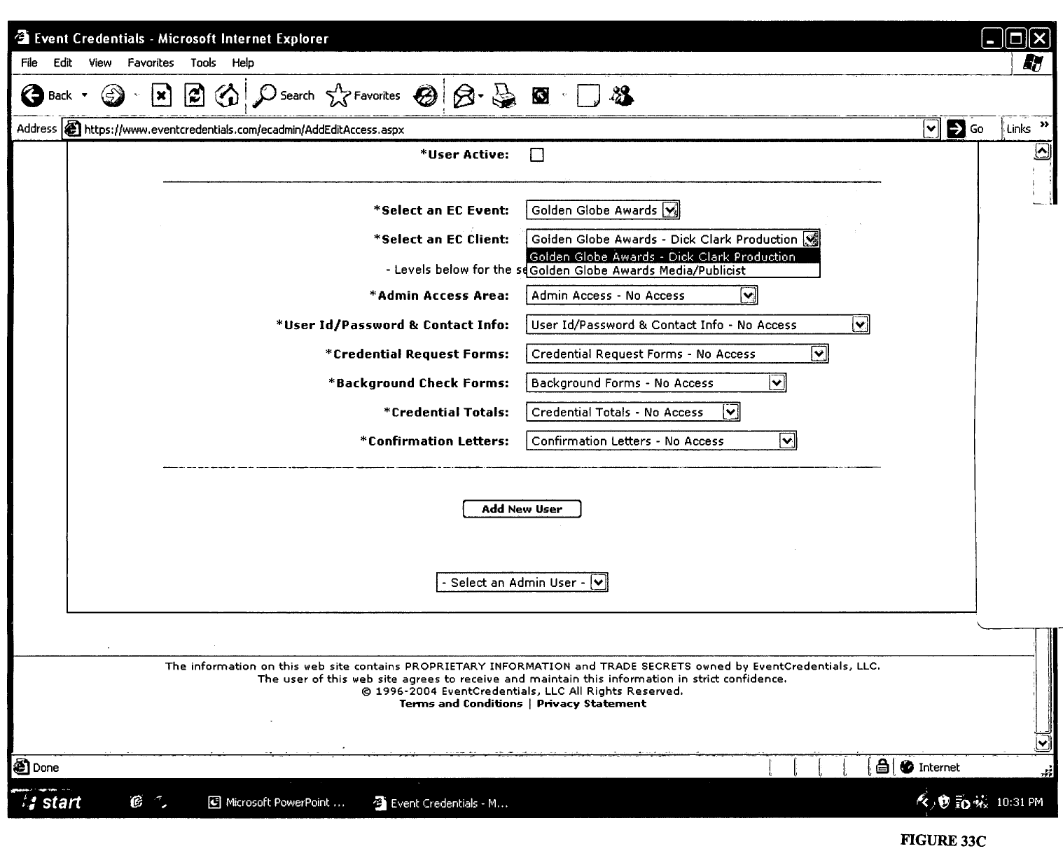

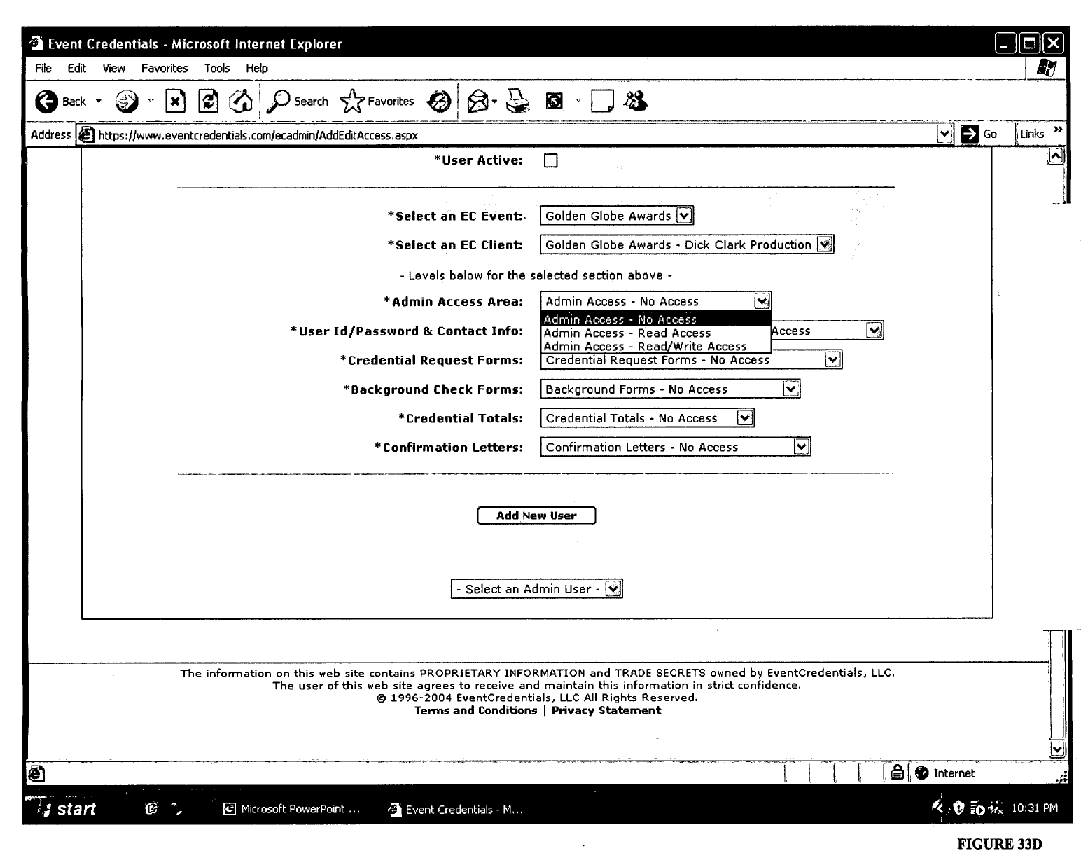

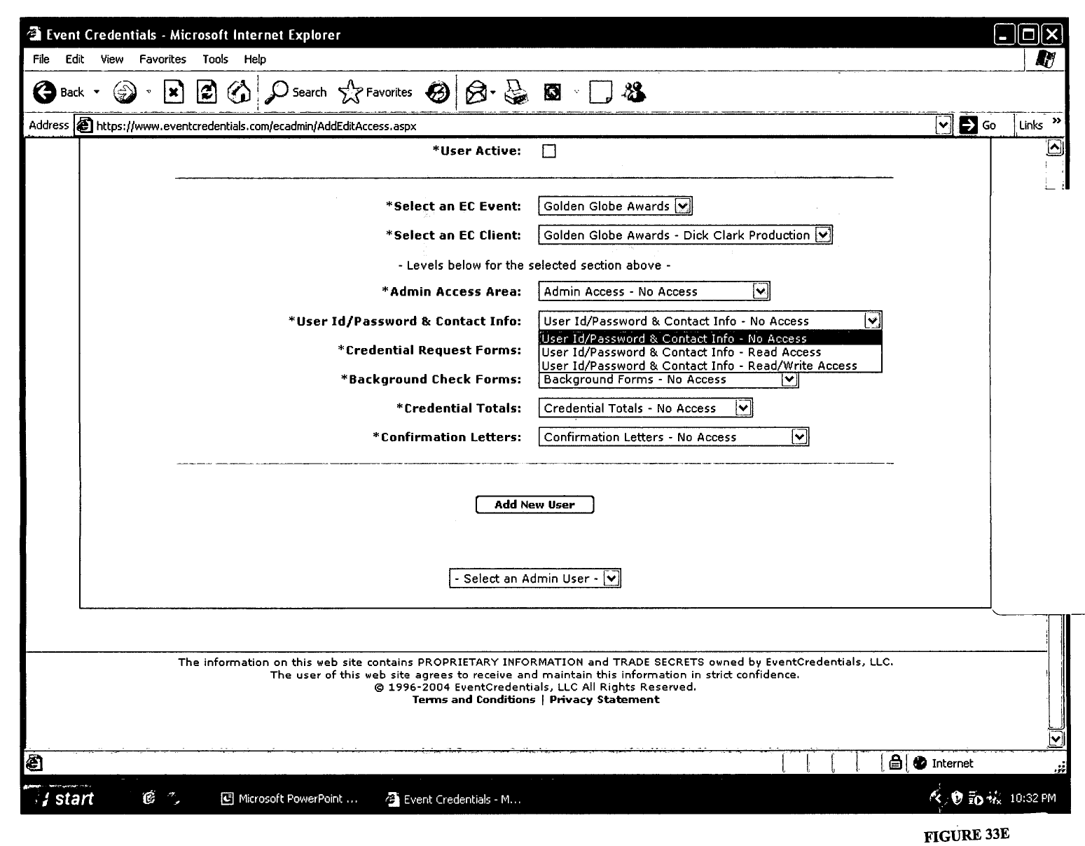

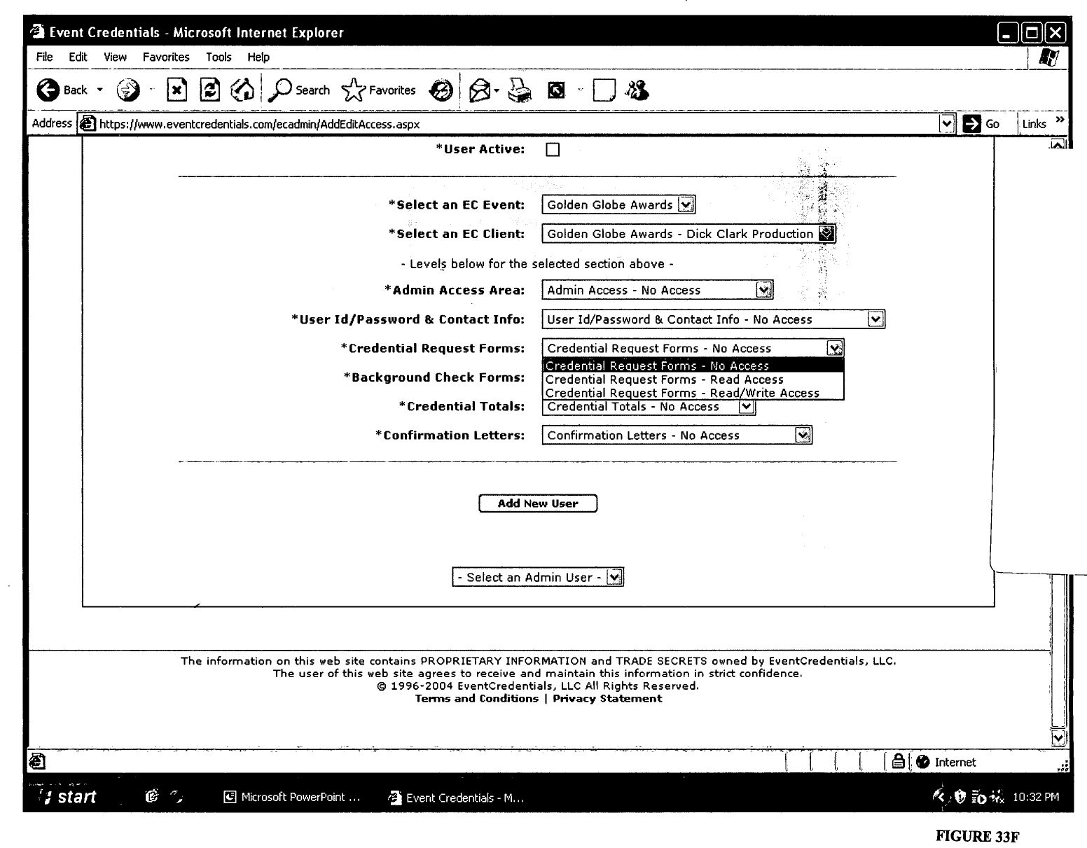

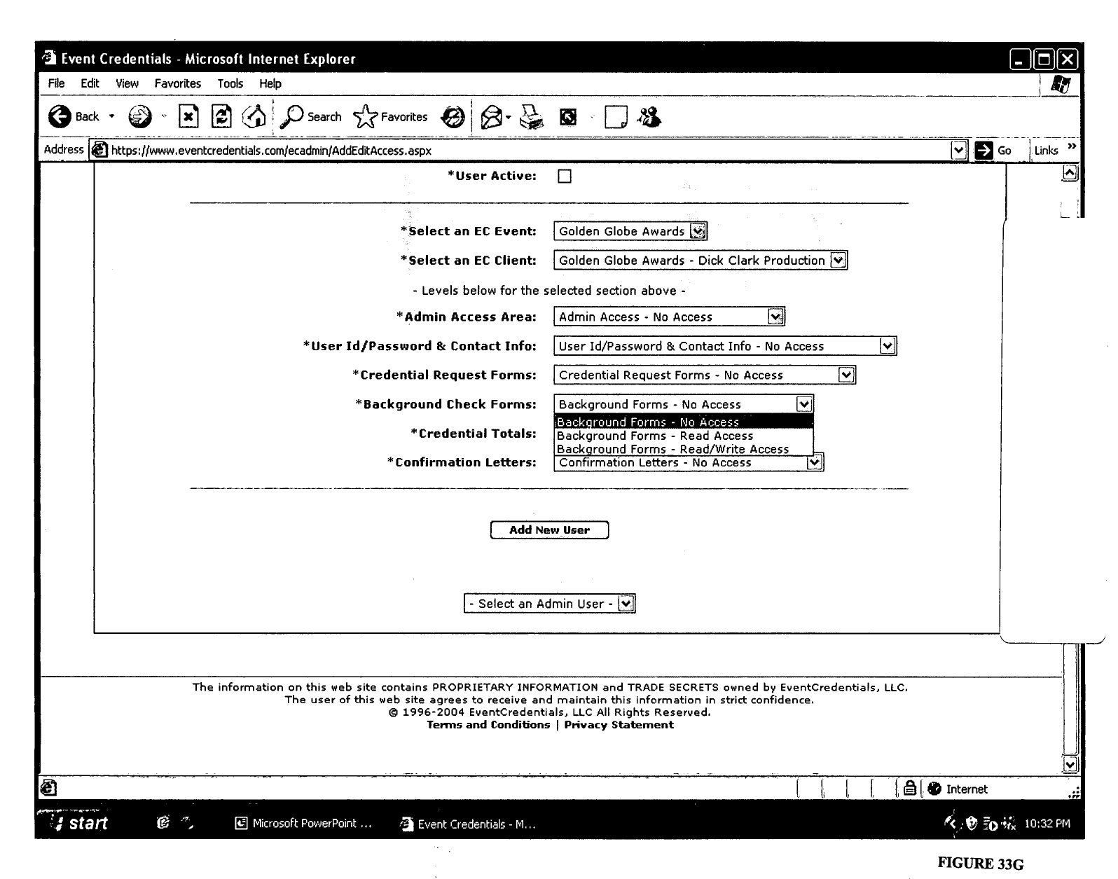

FIG. 33A-J illustrates exemplary screen shots of an embodiment of the administrator access rights assignment area. This area is used by head or lead administrators to assign user ID/passwords to additional administrator's using the site as well as allowing the head or lead administrator to regulate the others access throughout the site. In an embodiment, the administrator would select on the Administrator Access Rights in the navigation menu bar, then fill out the form, and activate the user. The access rights can be applied to one or unlimited number of events which can be selected from in this area. Each area of the site is controlled by allowing or denying access to specific areas or review/results forms and or areas based on the selections made on this page when creating a user ID/password. Access granted to this information can always be reviewed, edited, or revoked later. Read Only access can be applied to a unique user ID/password or full Read/Write access can be applied to the unique user ID/password depending on what is assigned by the head/lead administrator. Every area of the site is access controlled based on the unique user ID/password. User ID/passwords are tracked throughout the site and an EC text log is made for each time an individual visits or makes changes to an area or within an area of the system/site.

### Credentialing Software

After an individual has entered the required information in the form and it has been approved by the administrator for final approval of a physical credential, the credential registration software communicates/integrates directly with the physical credentialing software. In an embodiment, only records that have been approved by the event Administrators will be allowed to flow directly, such as in real time, to the credentialing software via the internet connection, and the like. The credentialing software can be accessed through a local server, which could remain onsite or through an internet connection to a remote server located outside the venue. Once an approved record is transferred to the credentialing software, it is assigned a unique “master” EC ID number, if the individual has not entered a previously assigned EC ID number, which cannot be duplicated by the local or remote server(s). The online registration software and the like, allows individuals to attach a photograph to the credential request or background check form record(s) they are submitting. Photographs can be attached to a record by uploading them through the credential request form, entering the pre-assigned “master” EC ID number that has the individual's photo attached and personal data attached to it in the master database, or by emailing their photograph and having it attached to their record by event staff personnel. The record in the physical credentialing software can repeat back any or all data received during the credential request and background check form process. Most records in the physical credentialing software typically have the individuals First, Middle and Last name as well as Driver's License number, Social Security number, company name, job title, function at event, credential type and affiliation, and the like. The unique record also contains the access levels that the individual has been approved for at the event. Again, once a record is approved by the administrator it is stored in the physical credential software database for later recall, or editing. Edits can be made to data in any of the software systems and can be updated globally across all software(s), database(s) and table(s). A time and date stamp is used to recognize the most recent version or edit. The credential is then manufactured for use at the event.

If the individual has uploaded their picture at time of registration or during the background check process, or has had their picture already attached to their record by emailing it to administrator who attached it, or by using their permanent EC ID number attached to their record in the master database, the credential can be printed at any time. The administrator can print any data on the credential that they collected on the individual at time of registration or added later. The administrator also can have the access zones (levels) assigned/granted for the event printed on the credential.

If an individual has not had a picture attached to his record, the individual will come to the credential center where the workstation operator will locate the record through a personal computer, in an embodiment, verify the identification, and take the digital photo. The workstation operator permanently attaches the individual's digital photo to the unique personal record.

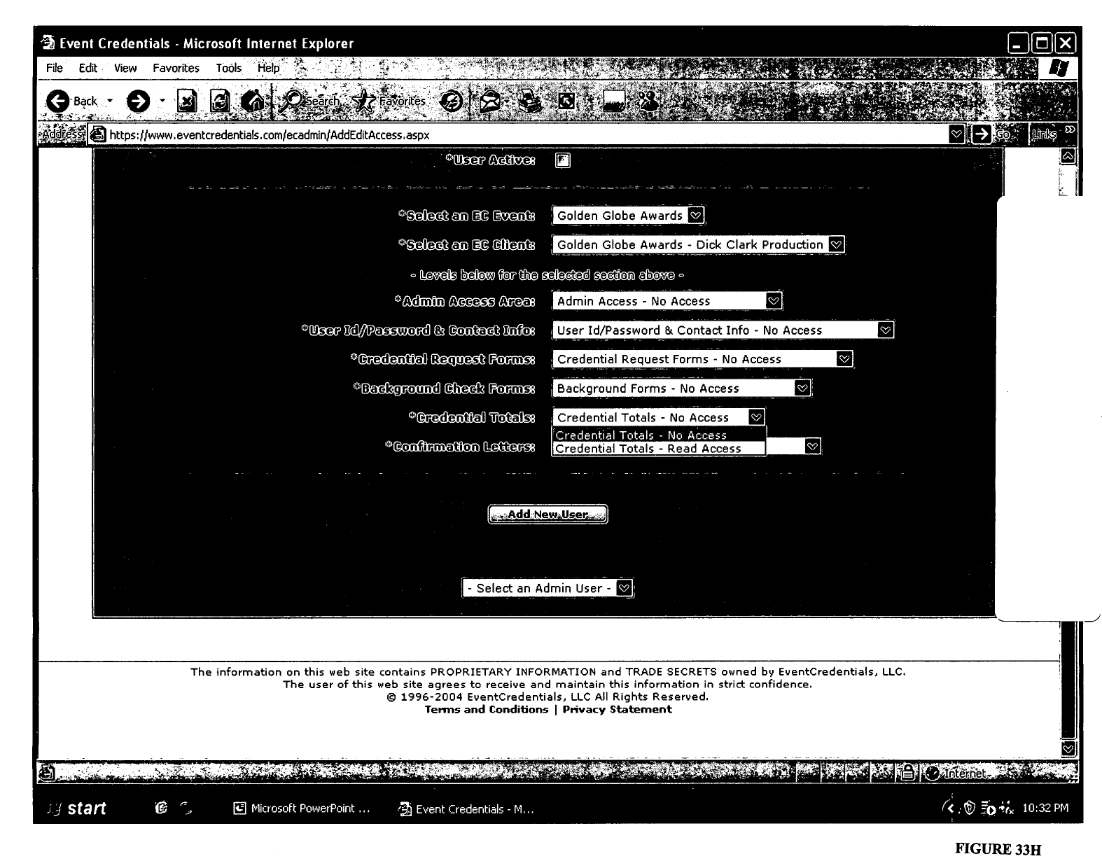

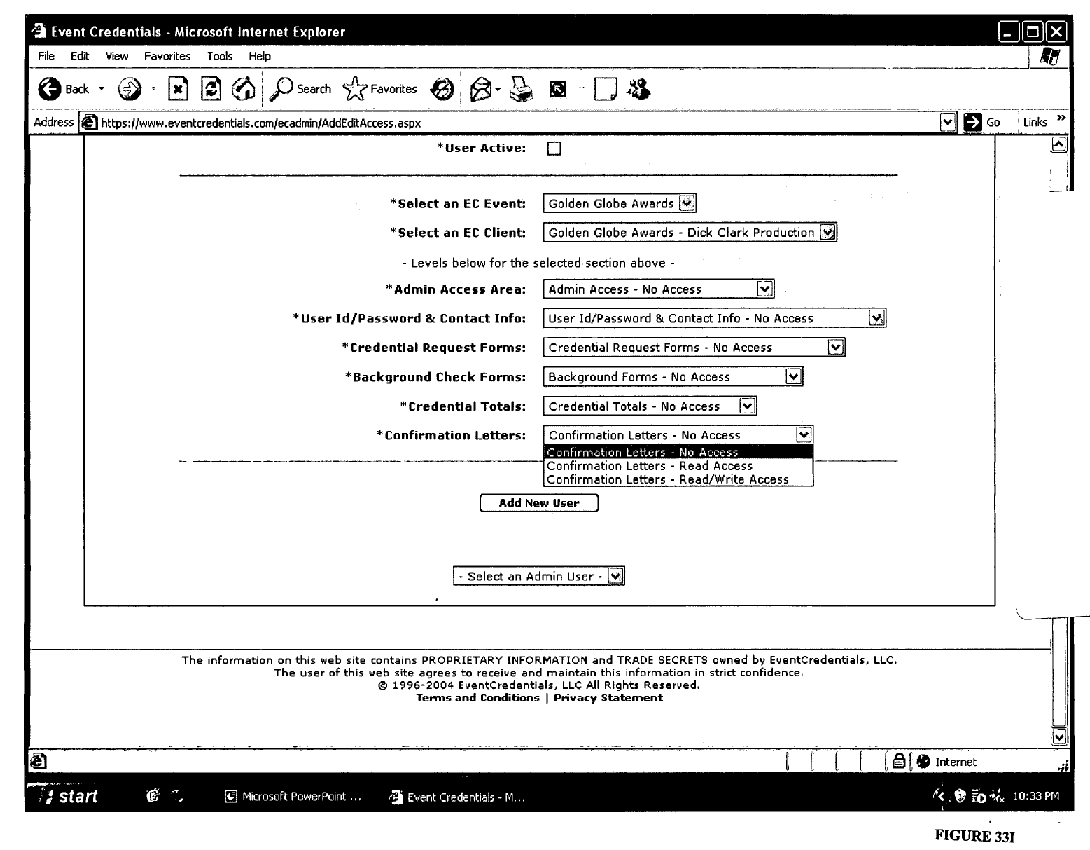

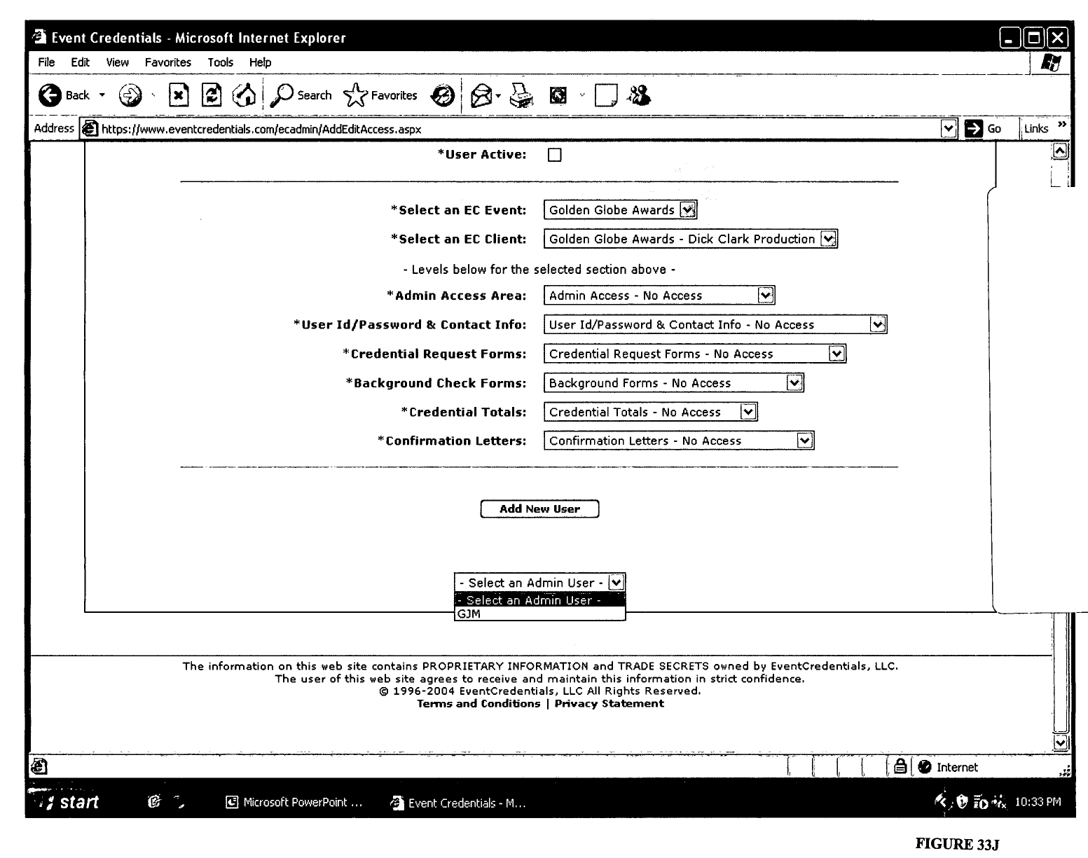

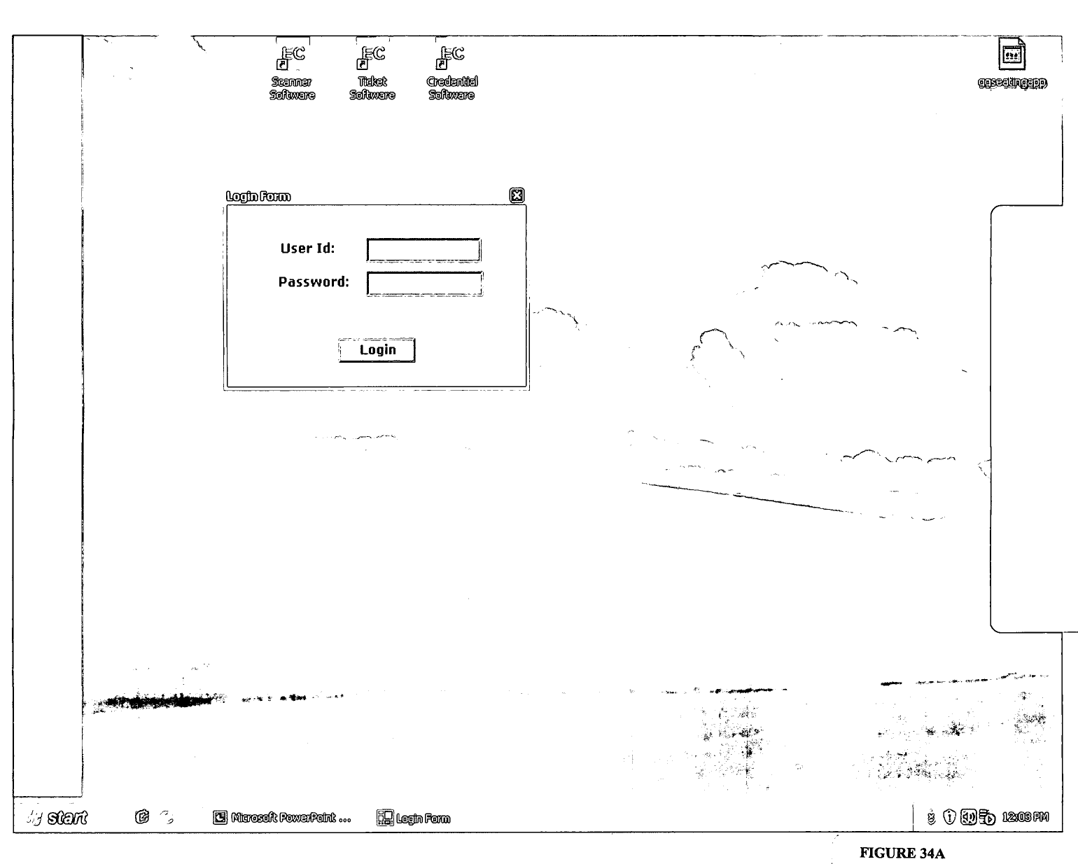

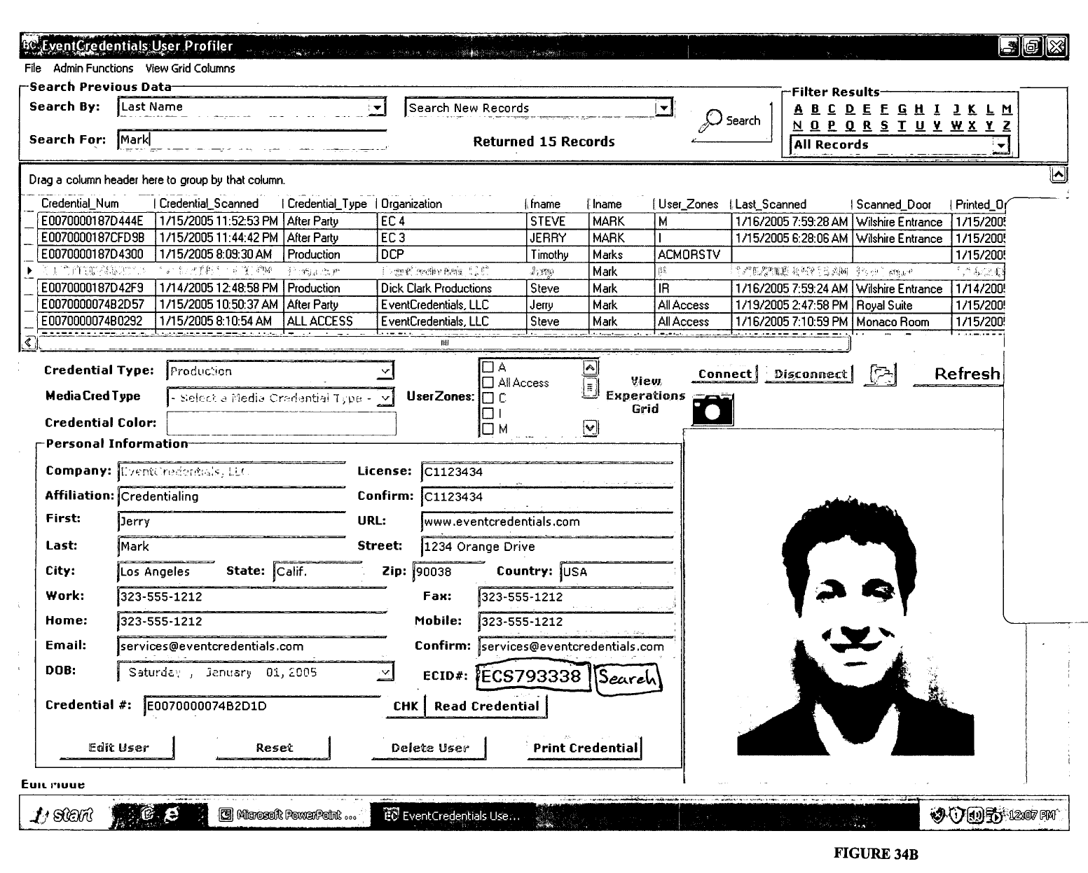

FIG. 34A-B illustrates exemplary screen shots of an embodiment of a Login area and display view for a Workstation Operator. In an embodiment, workstation operators perform a specific job function. In an embodiment, workstation operators locate an individual's record that has been pre-approved, electronically capture or attach an approved individual's photo or enter the individual's EC ID number to auto-populate the individual's photo and other pertinent data from the master EC database, scan the appropriate RFID embedded credential so that the unique chip serial number is associated with the individual's record for this event, and then print the credential. Only the buttons or search functions needed to fulfill these job requirements are functioning in the workstation view of the software. Based on the workstation operator's unique user ID/password information, other buttons and functions have been turned off and are non-functioning. This eliminates the workstation operator's ability to edit a person's record.

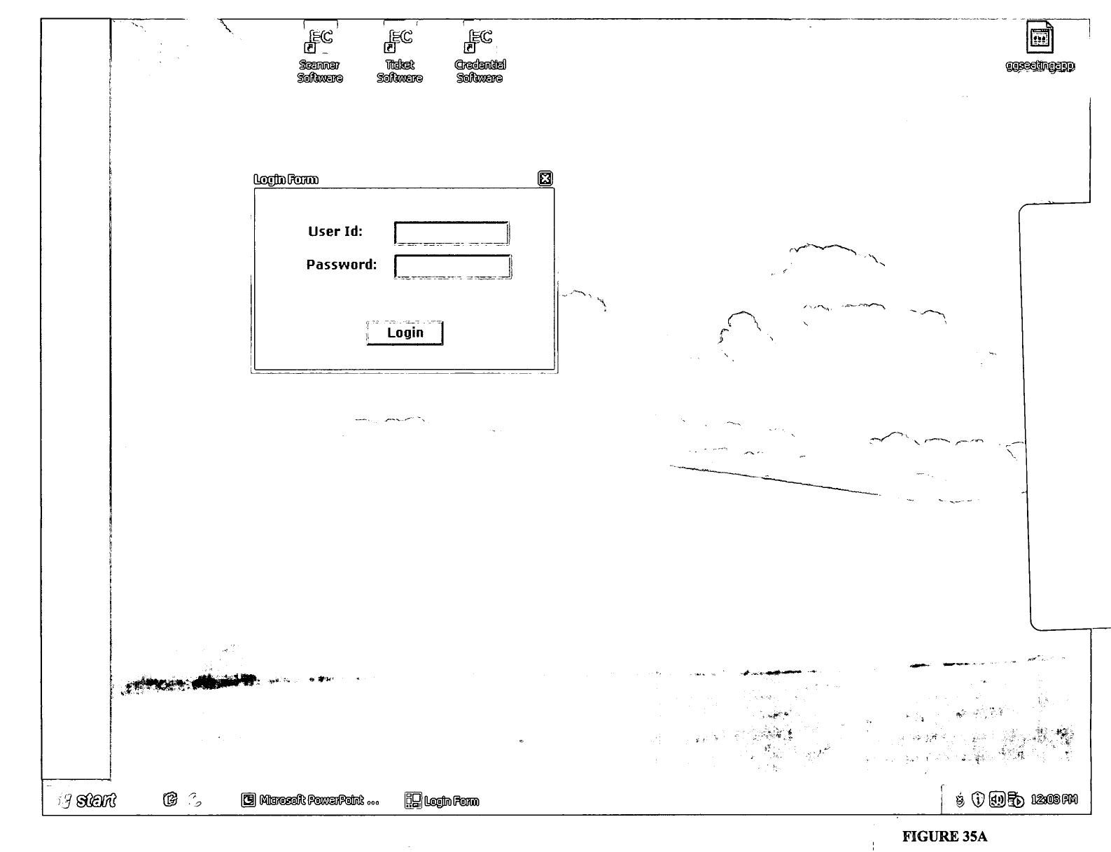

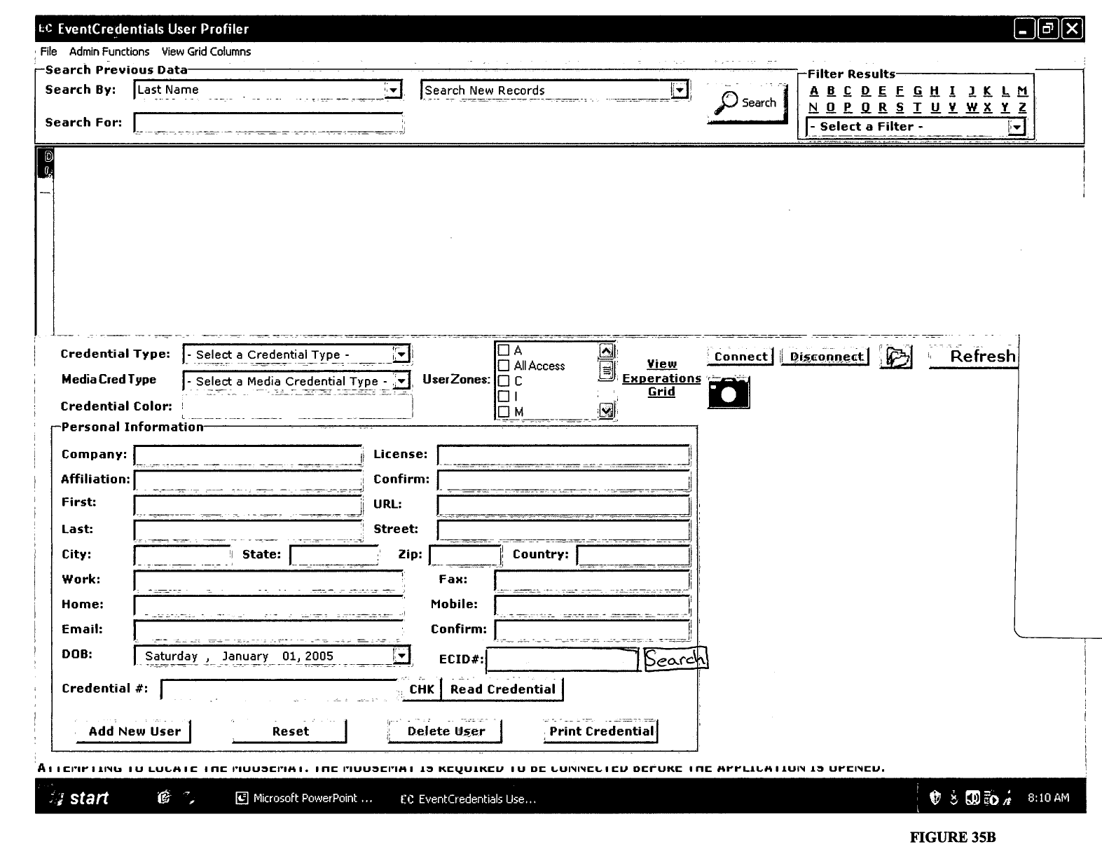

FIG. 35A-B illustrates exemplary screen shots of an embodiment of a Login area for an Administrative user. An administrative user, based on their need, can be allowed multiple levels of access to the credentialing software. The administrative user can be limited to the workstation functionality or can have full Administrative access rights, which allow for manipulation, change or deletion of any data field captured or assigned in the software.

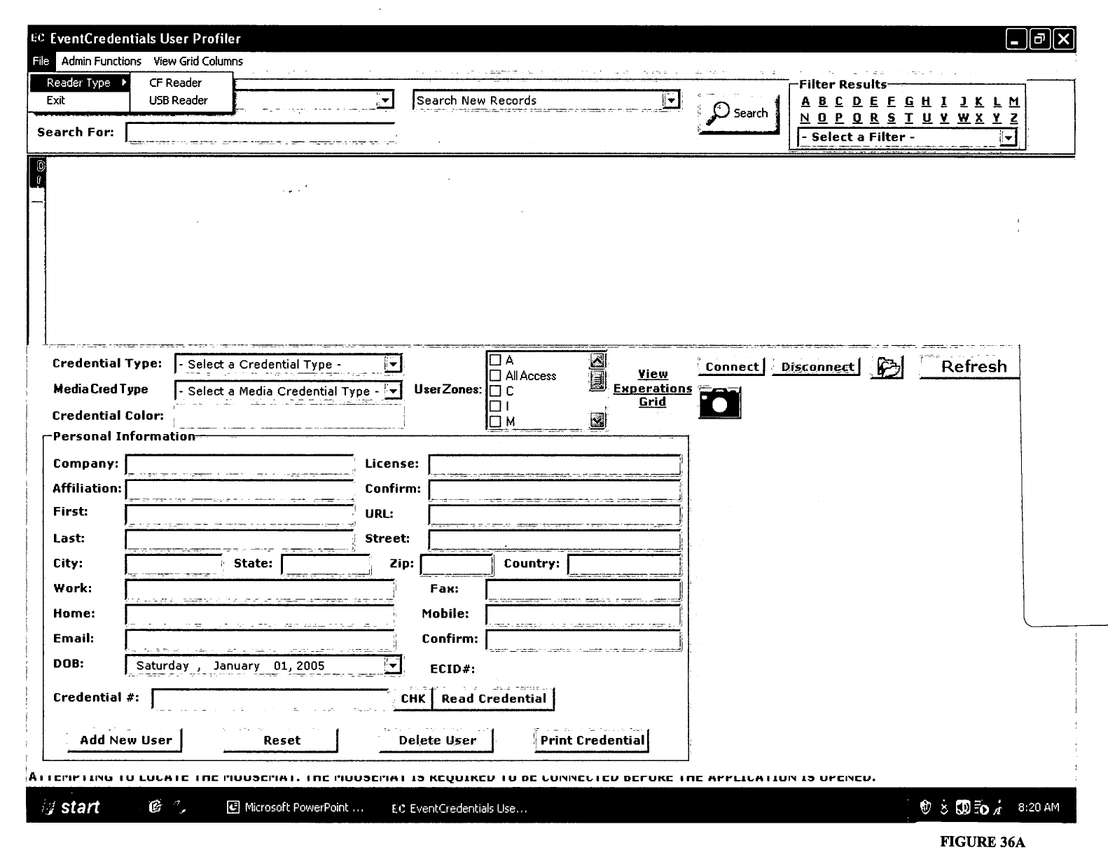

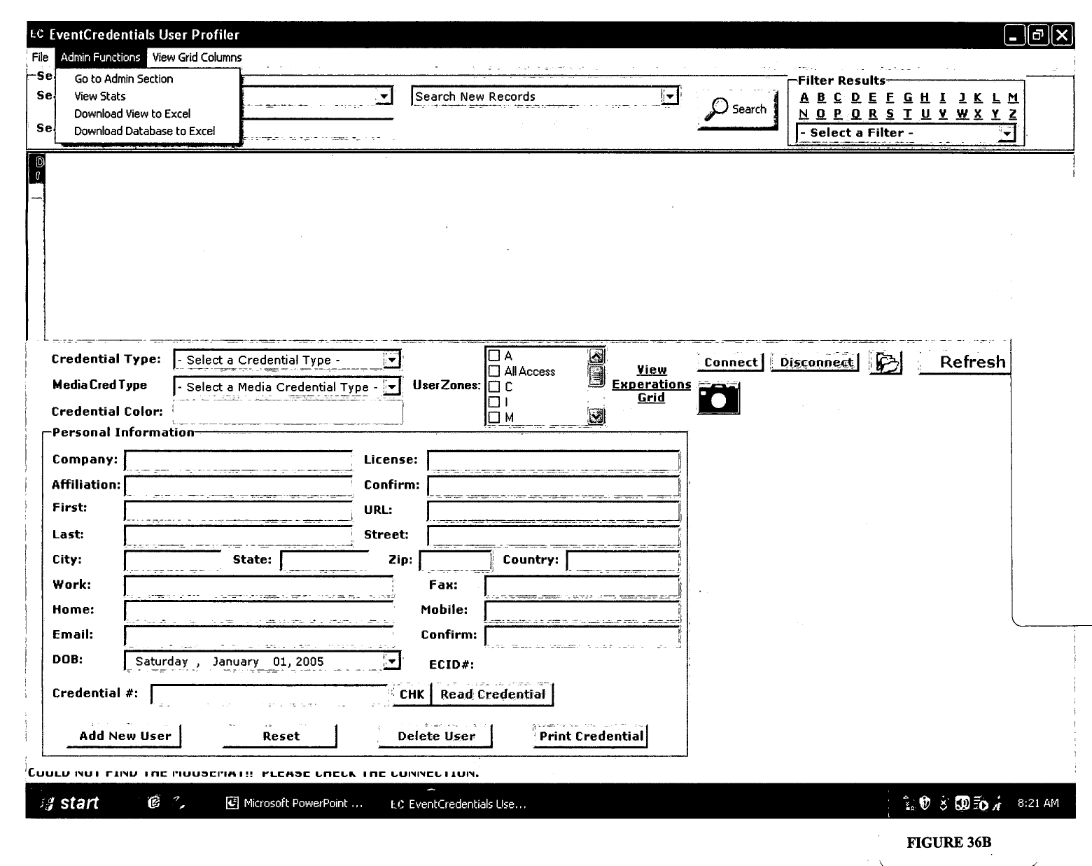

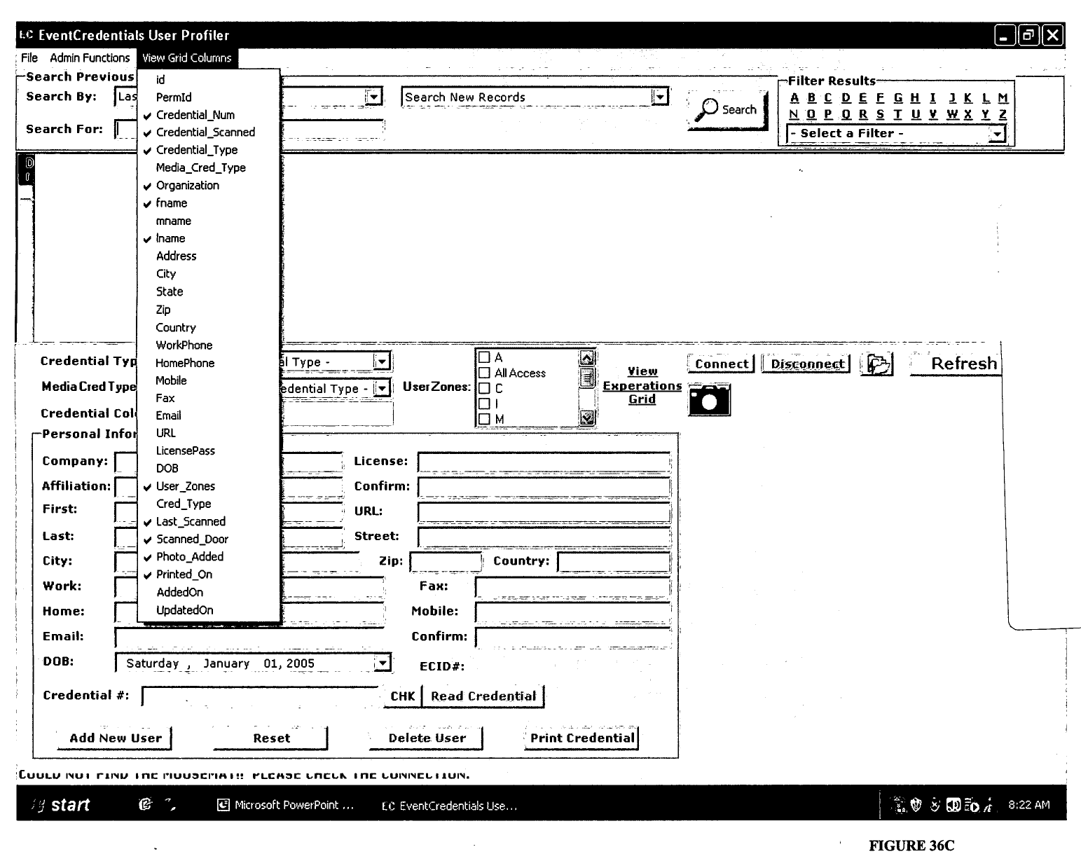

FIG. 36A illustrates exemplary screen shot of an embodiment of the Administrator area and the drop down menu functions, which can include, but are not limited to such functions as the type of radio frequency identification (RFID) reader that will be used with software. In an embodiment, there are two types of scanners or readers, such as, for example, a compact flash (CF) reader, and a universal serial bus (USB) reader. However, the number and type of scanners used will change as technology advances. FIG. 36B illustrates an exemplary screen shot of an embodiment of the “Administrator Functions” located on the top menu bar. FIG. 36B shows the drop-down function to select the download view to excel or download event credential software database to excel file. FIG. 36C illustrates an exemplary screen shot of an embodiment of the grid column headers, which can be turned on and off by checking and un-checking the headers in the View Grid Column drop down menu. In an embodiment, Administrator operators also have all the functions of the workstation operators with increased ability to edit data.

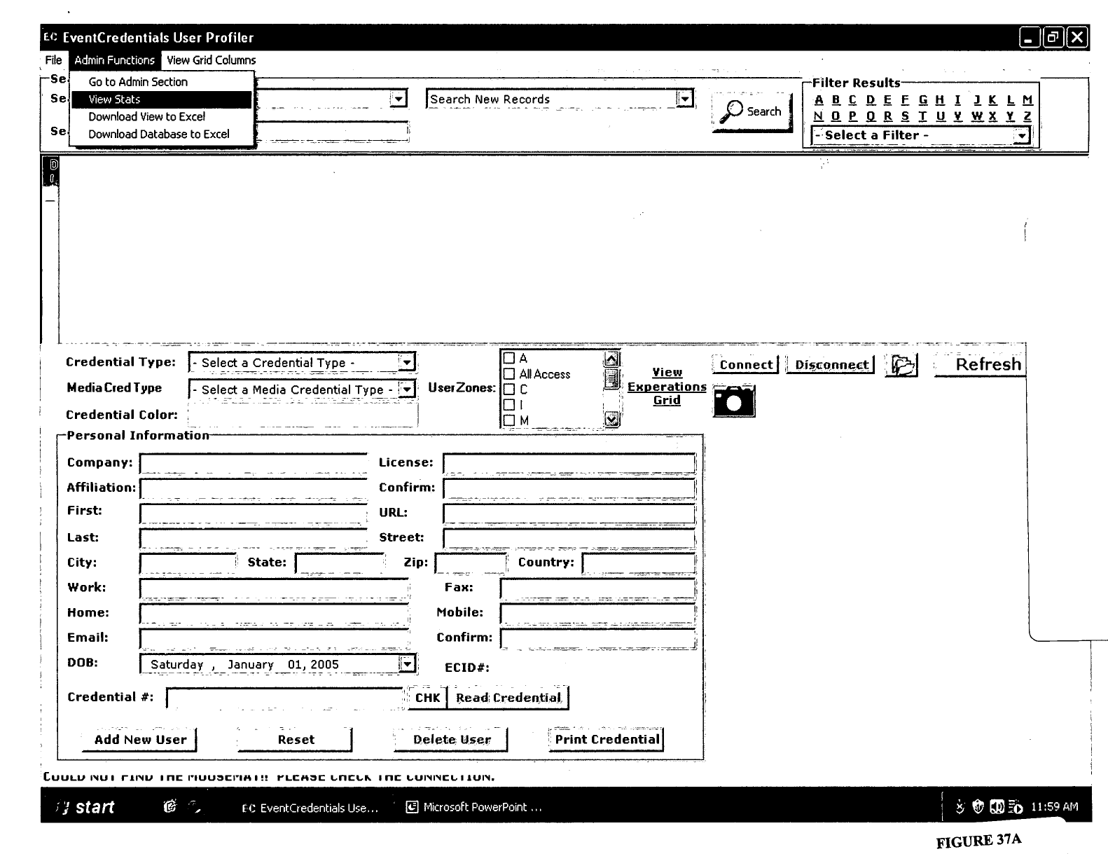

FIG. 37A-B illustrates exemplary screen shots of an embodiment of a View Stats sections which shows all of the Credential Types for an event and the number of individual zones/access levels that have been assigned to each of the different credential types. In an embodiment, the system also shows how many of each credential type has been issued. In an embodiment, the system also shows the total number of slots or individuals approved for each access level/zone.

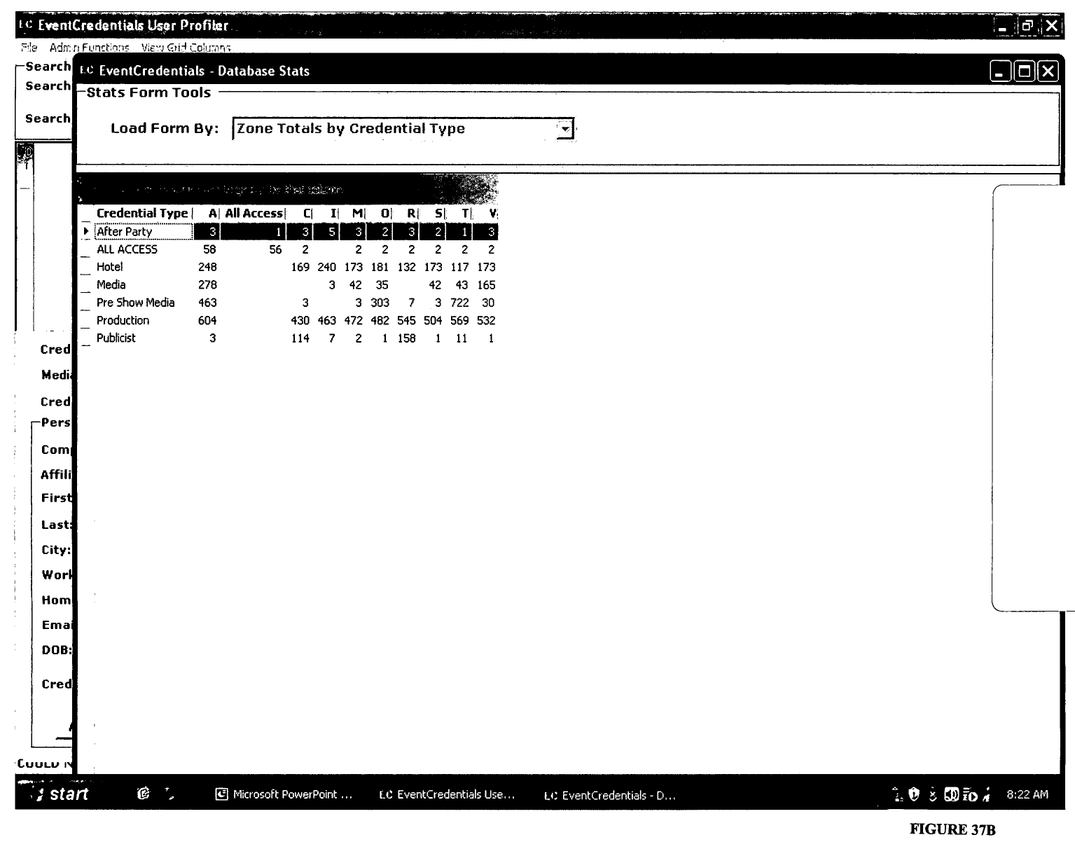

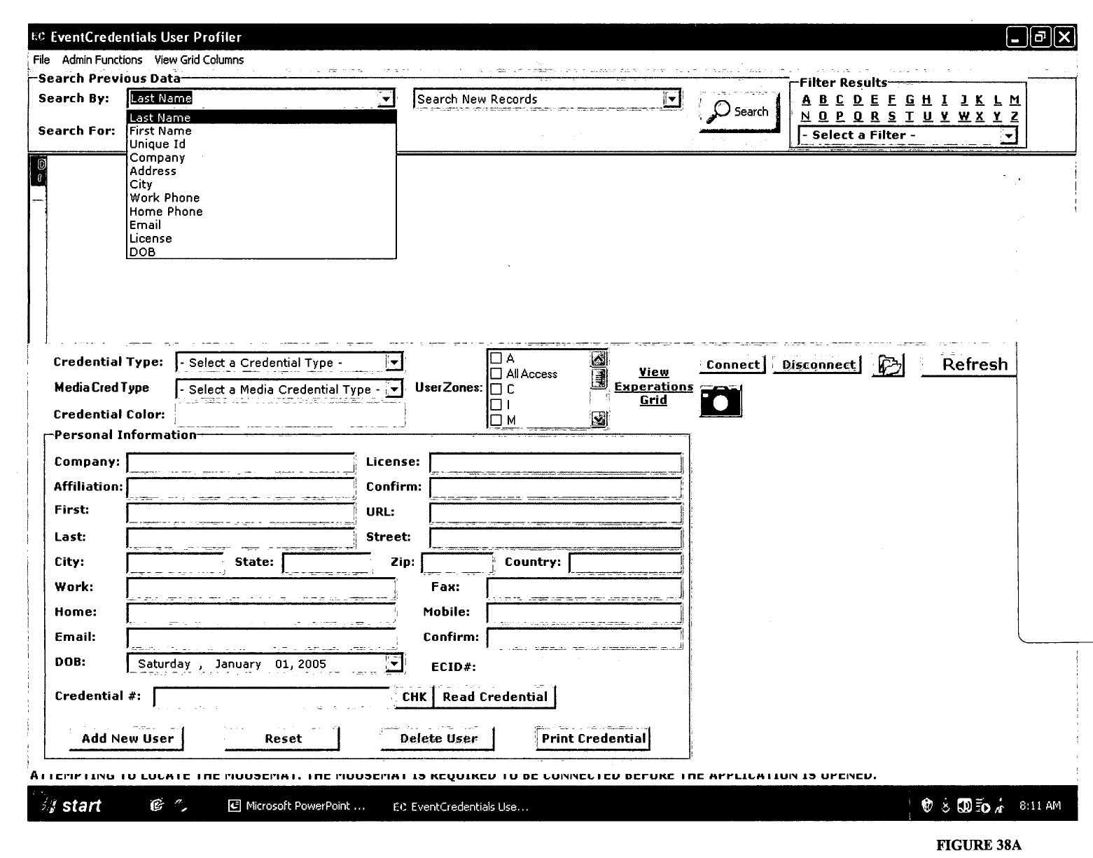

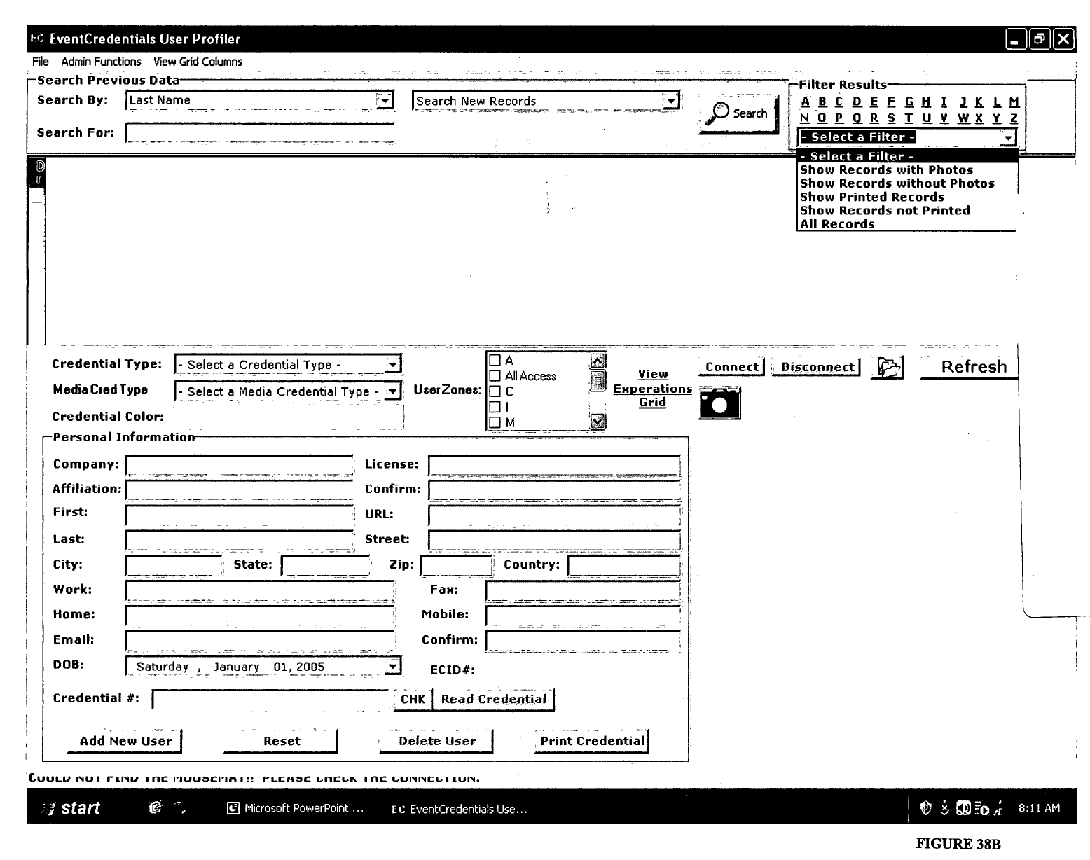

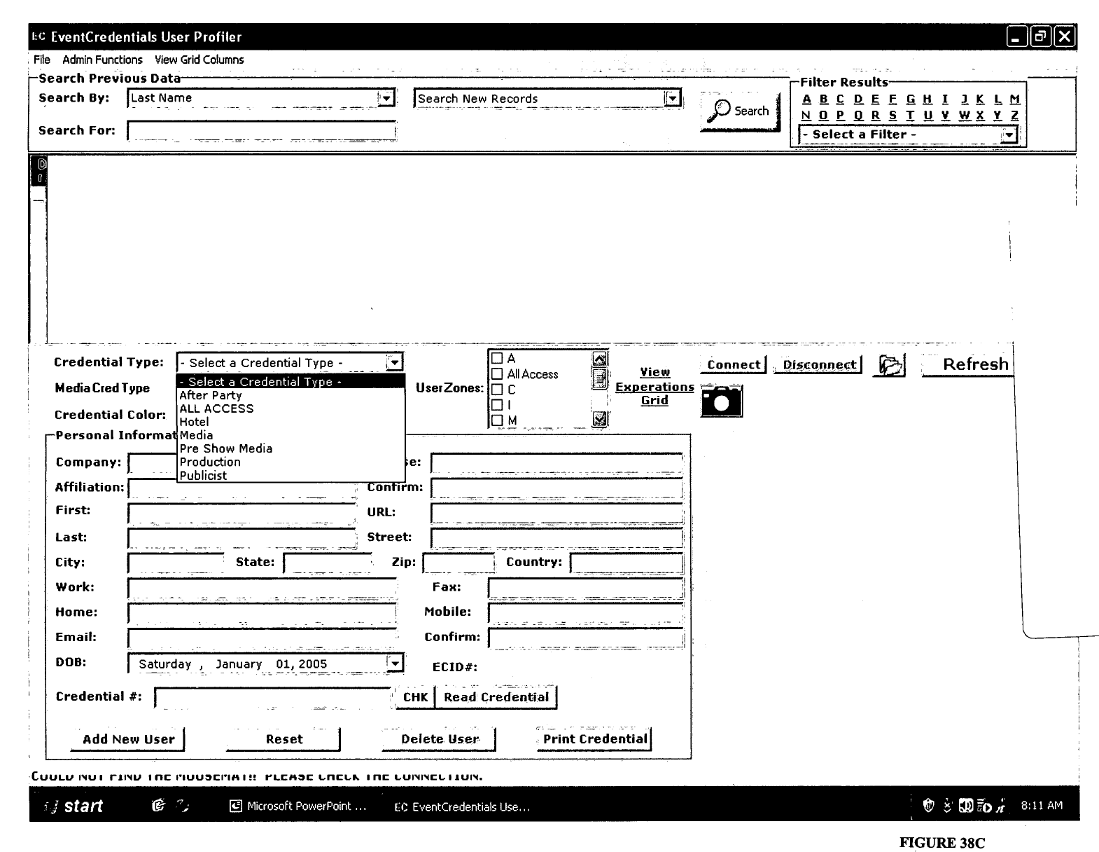

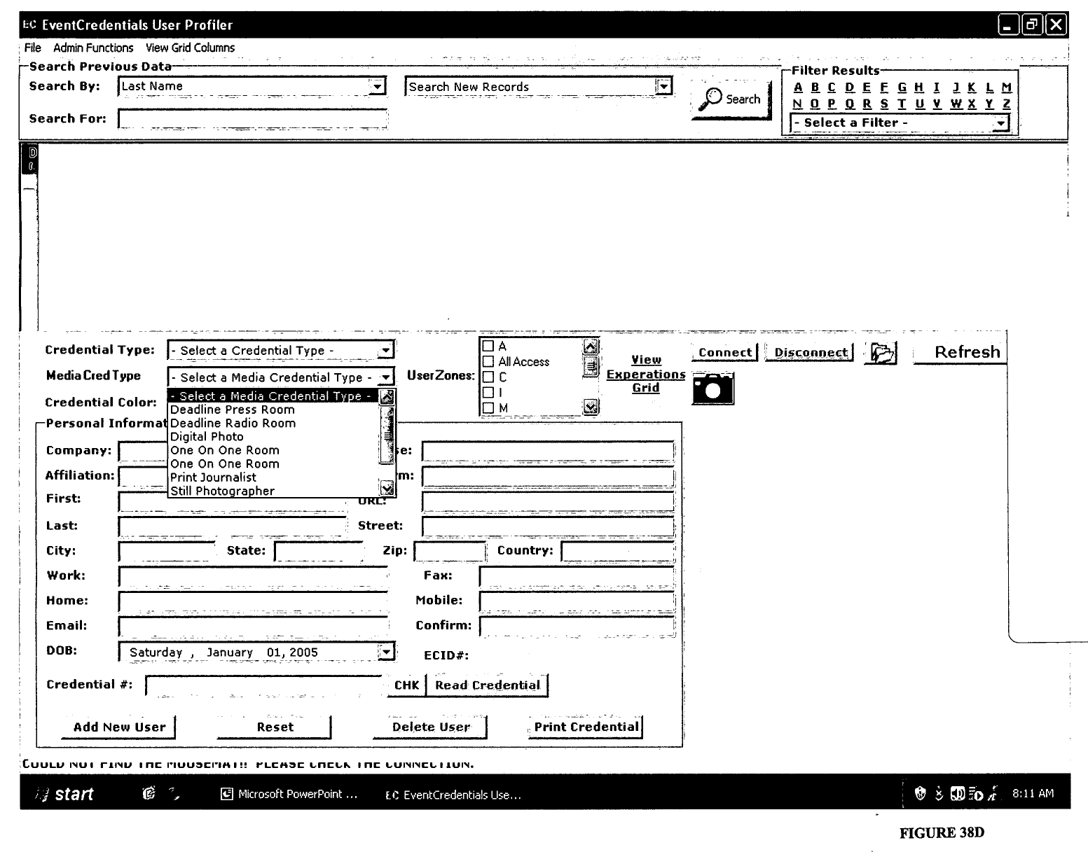

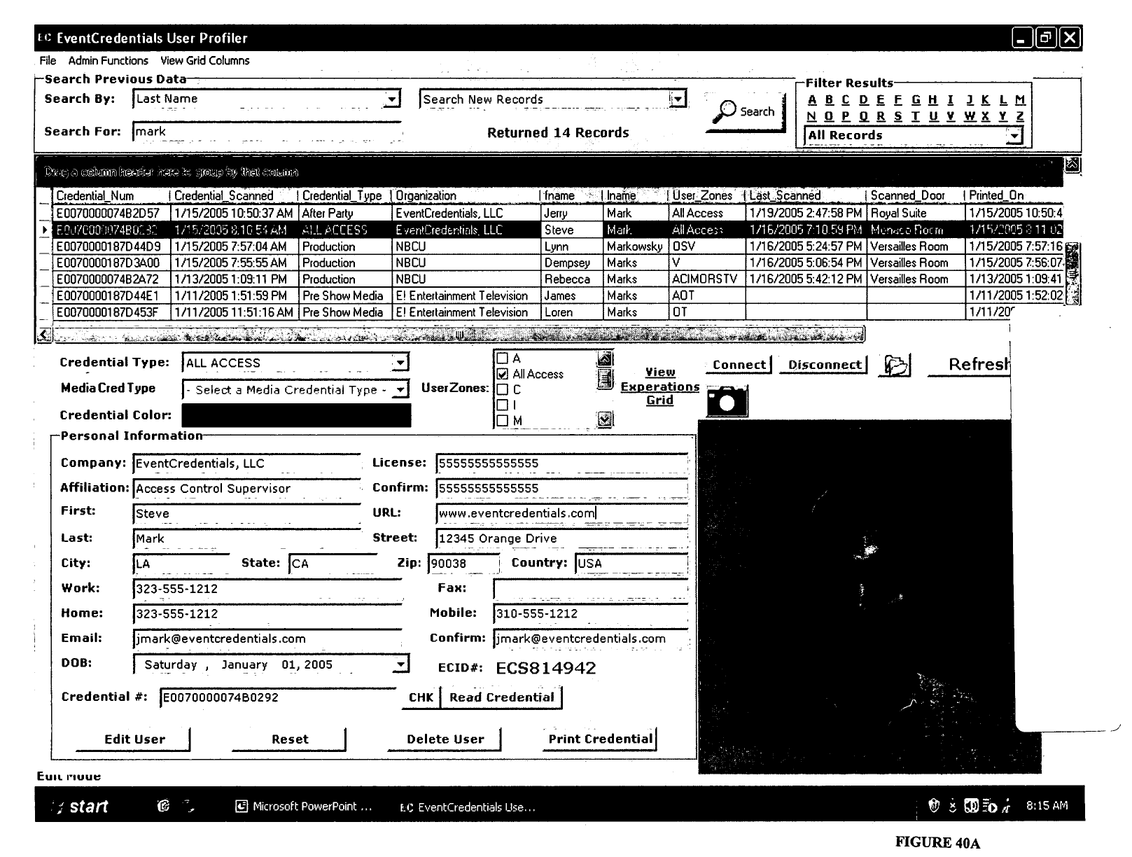

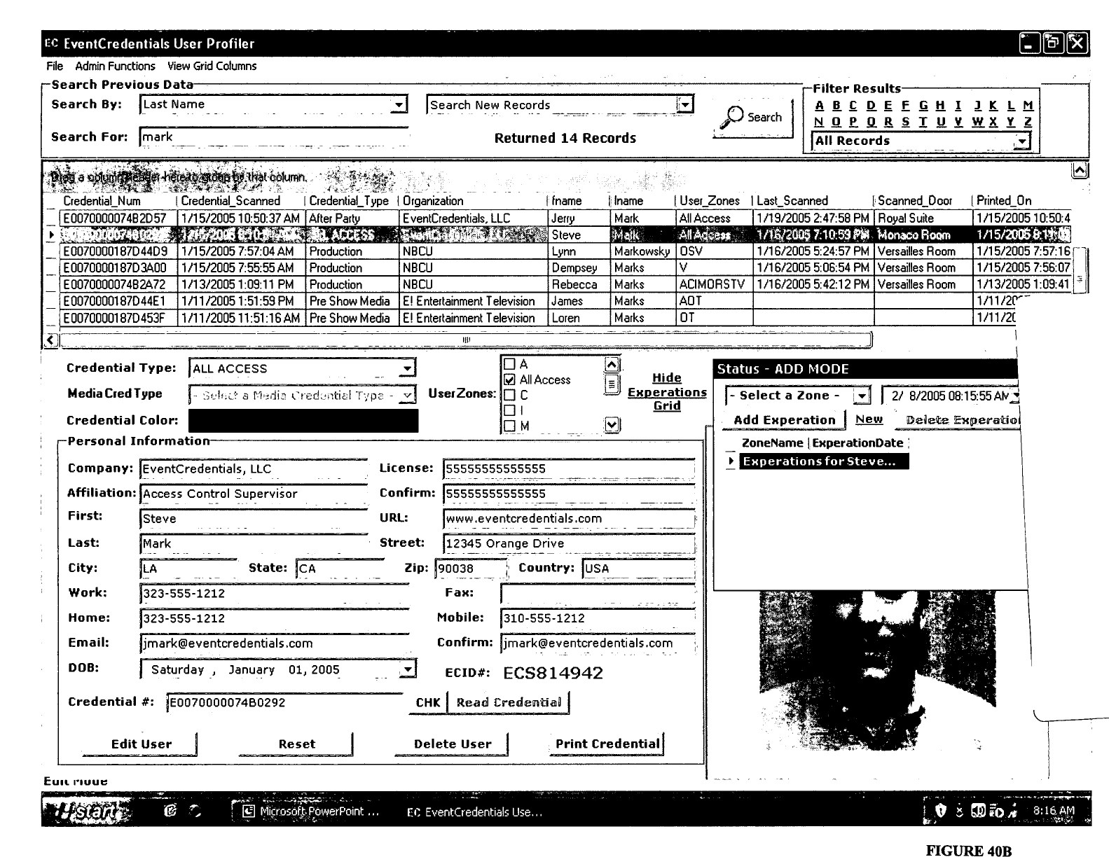

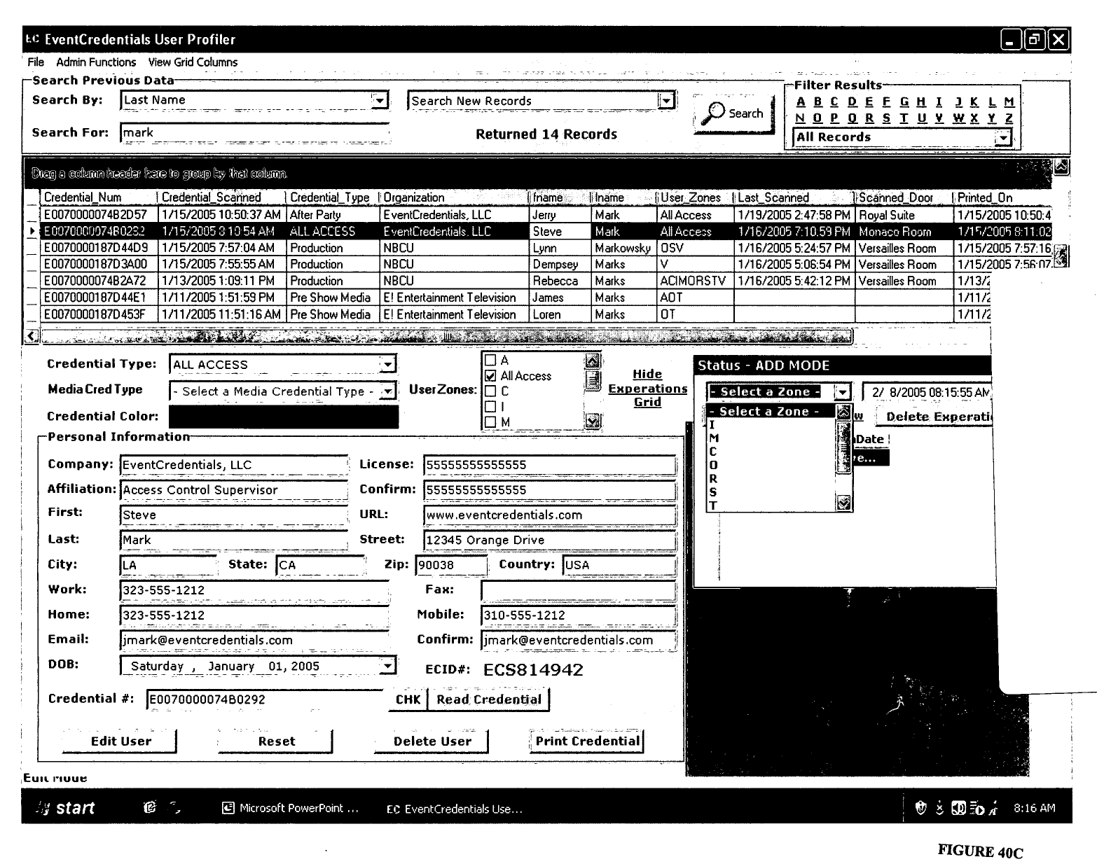

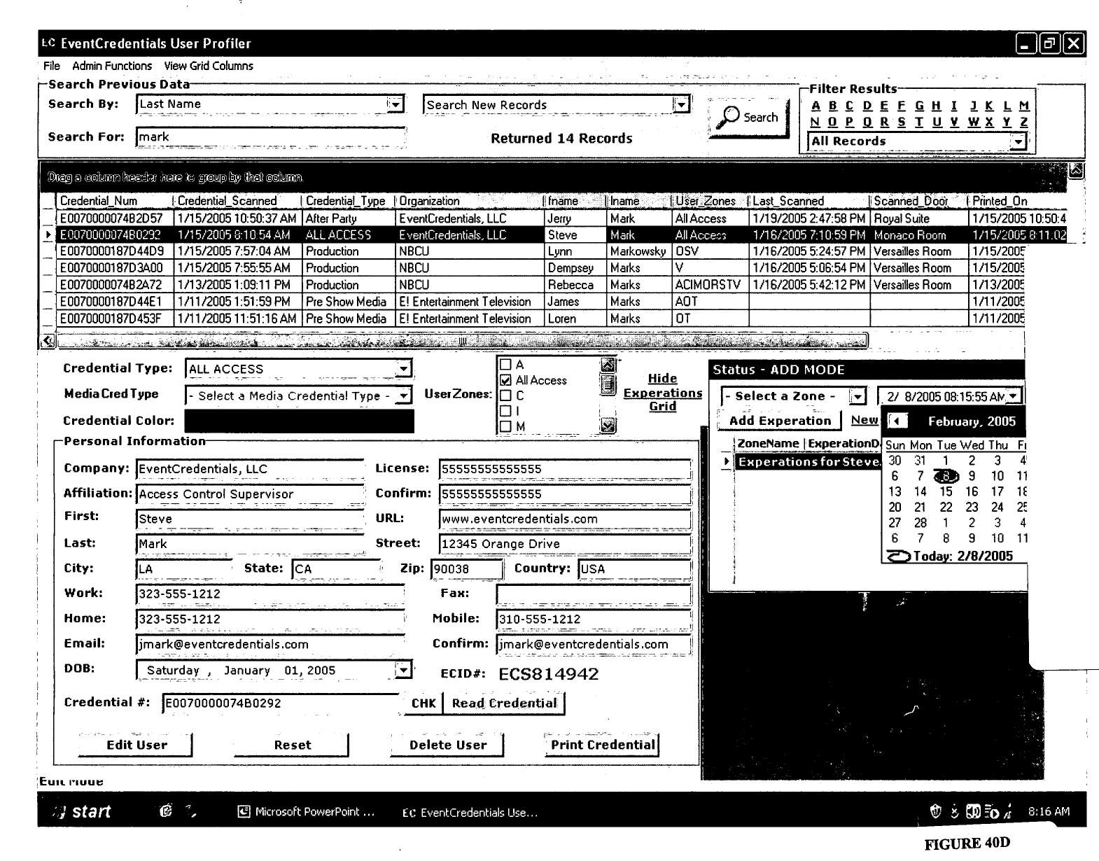

FIG. 38A-D illustrates exemplary screen shots of an embodiment of how the credential software can be searched and filtered. FIG. 38A illustrates the Search By drop down menu field which can be used to select from a list of standard pieces of data used to locate and retrieve records in the credential software. Searches are returned in the blank space below in the middle of the software where a grid will appear and be populated by the specific data housed in the grid of the credentialing software, as seen later in FIG. 40. The administrator can also use the alphabet letters in the filter results area in association with the Search By drop down menu list to return back all records beginning with that letter. For example, by selecting the Last Name in the Search By field, the administrator could select a letter of the alphabet, and receive all of the Last Names starting with the letter chosen. FIG. 38B illustrates an exemplary screen shot of a drop down menu that contains quick query filters that search the entire database. In an embodiment, the menumay list a standard sorts, such as sorts to show records with photos, sorts show records printed, etc, that are frequently used or needed during events. In an embodiment, this list can be expanded to include quick query filters for all data being housed in the database. FIG. 38C illustrates an exemplary screen shot of a drop-down menu used for selecting or displaying a credential type associated with a record. In addition to selecting and displaying the credential type for a specific record the Credential Type drop down can be used to search or group the database by the list currently selected in the drop down menu. After selecting a Credential Type, the operator would select on the Search (magnifying glass) to receive a list of all those individuals using that particular credential type. FIG. 38D illustrates a screen shot of the Media Credential Type drop-down kmenu, which is used to describe the type of affiliation associated to a Media credential. Because there are many different types of media classifications, such as photo, print, radio, and television, for example, a distinction is often required by events among the media credentials. In an embodiment, to accommodate this request, there is a media credential sub-class called Media Credential Type. In addition to being printed on the media credential itself, the sub-class can also be used to search records in the database as mentioned above when describing the search function associated with the Credential Type filter. In an embodiment, credential software can also be searched using the master EC ID number.

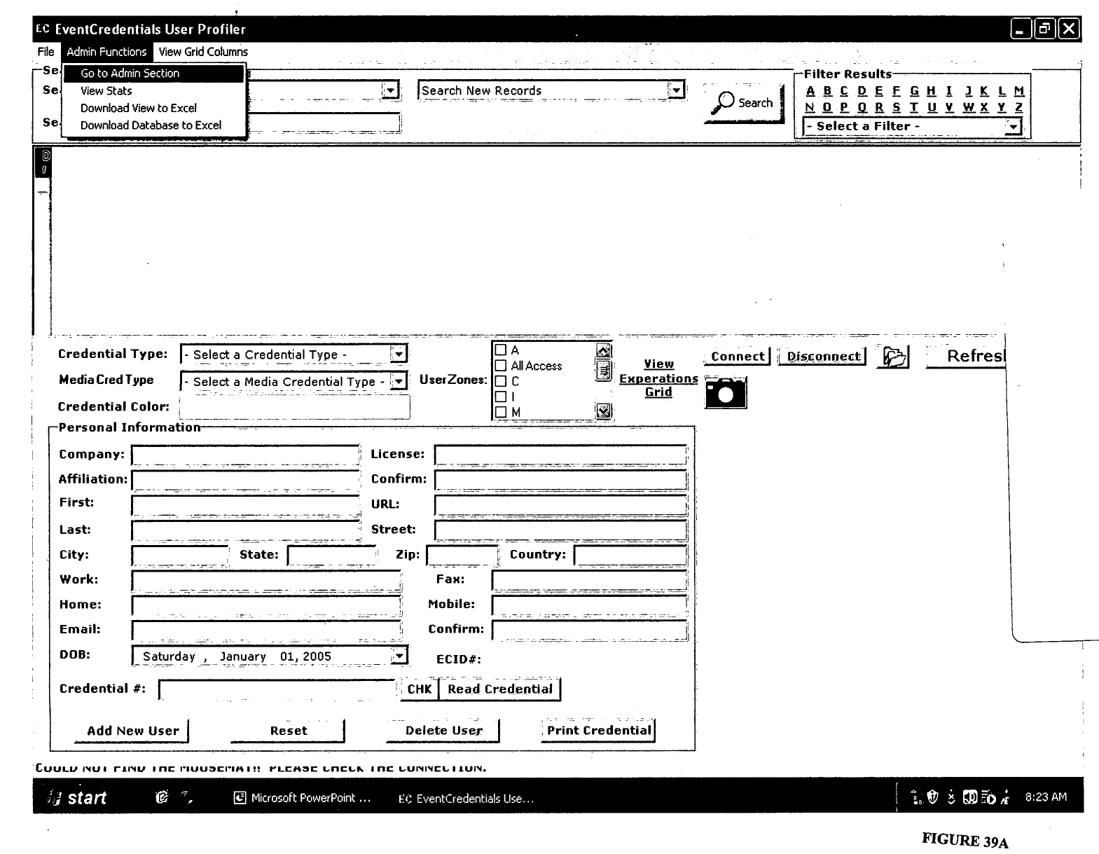

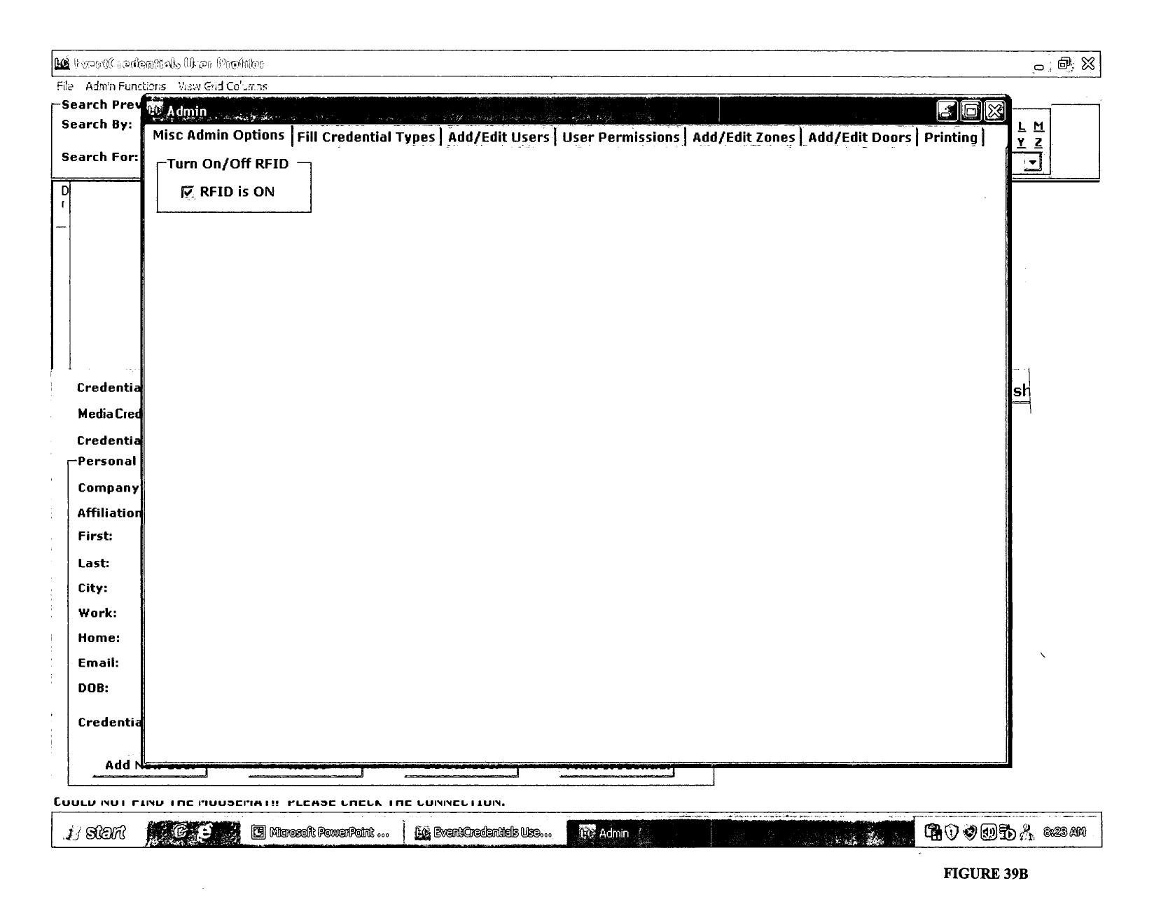

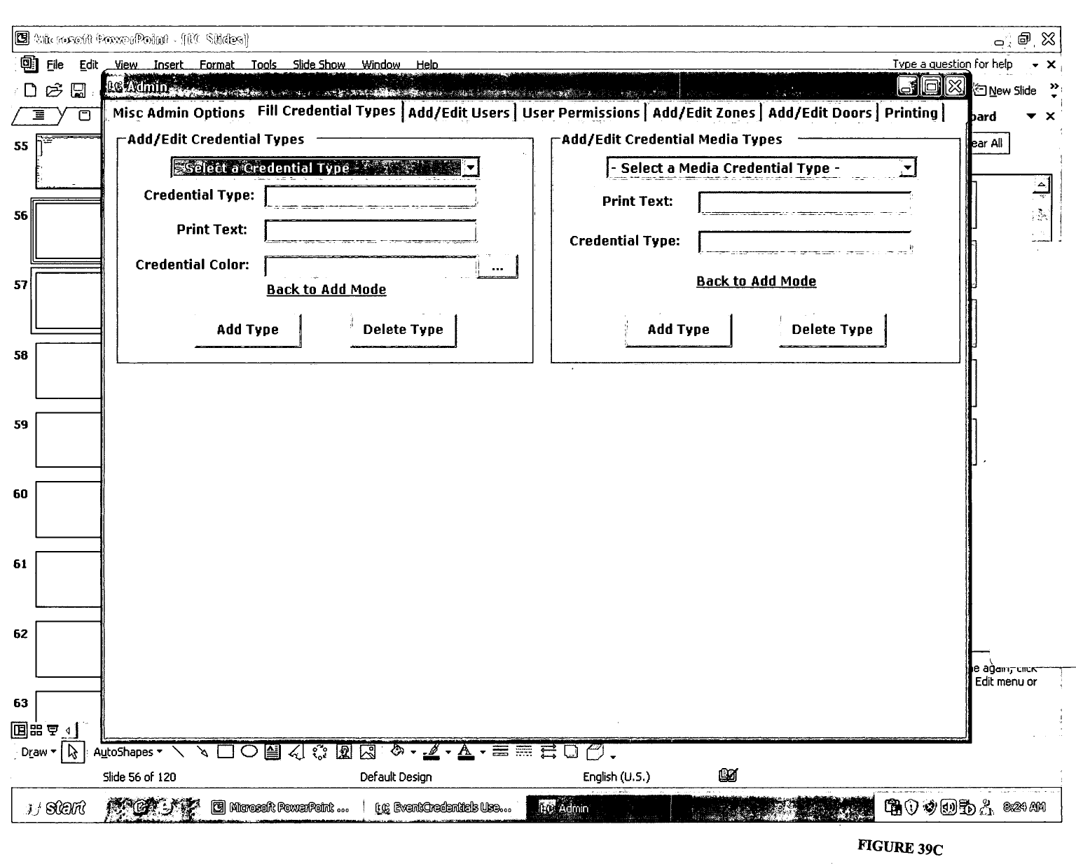

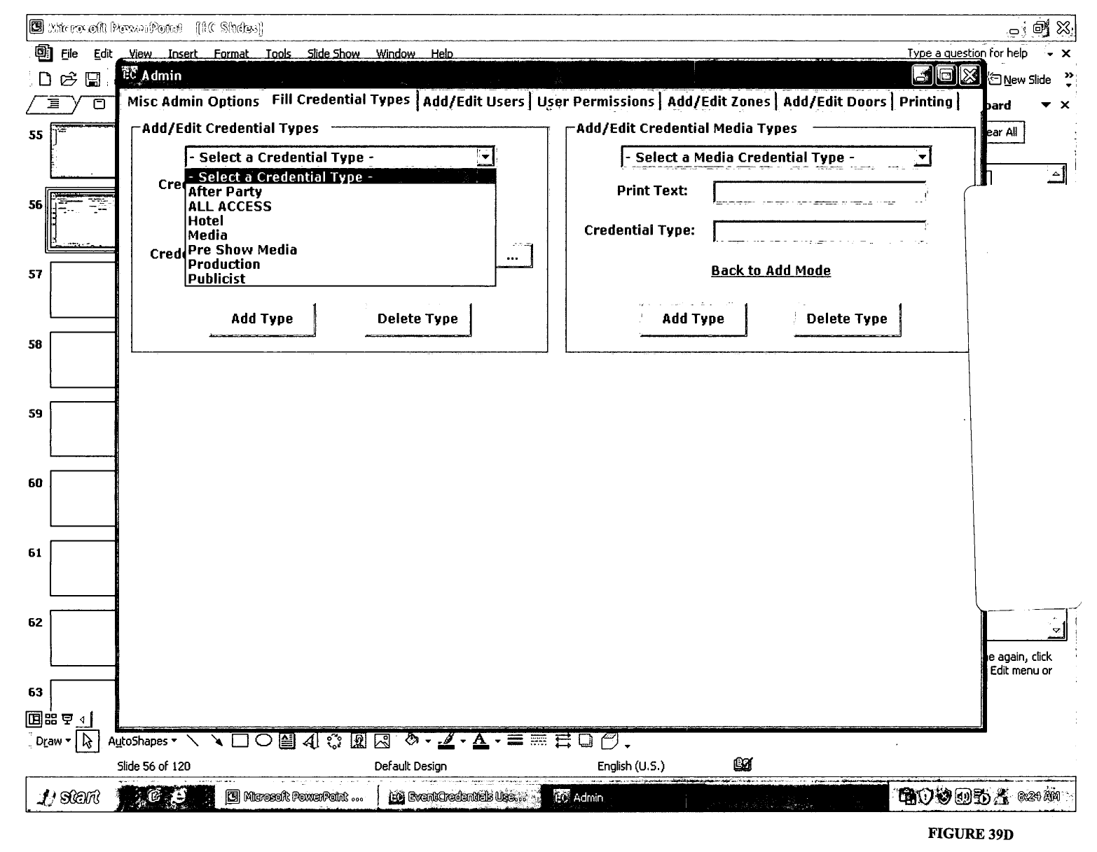

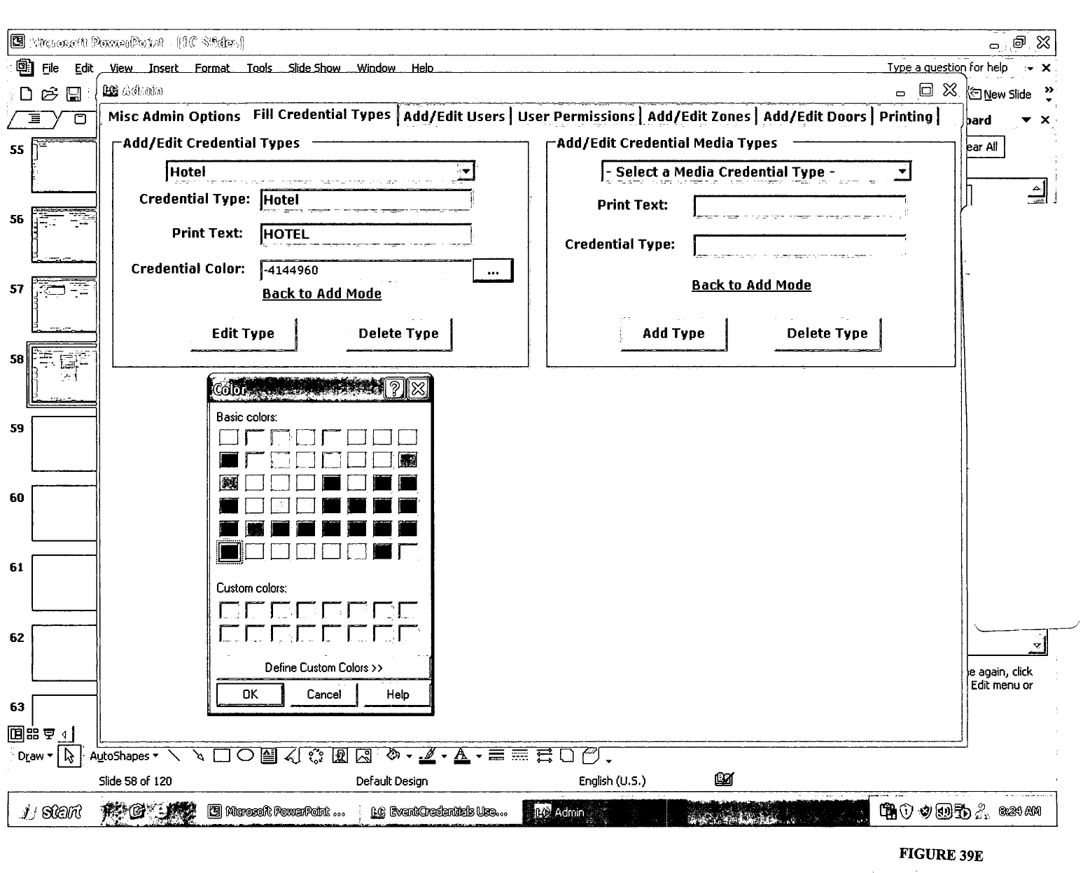

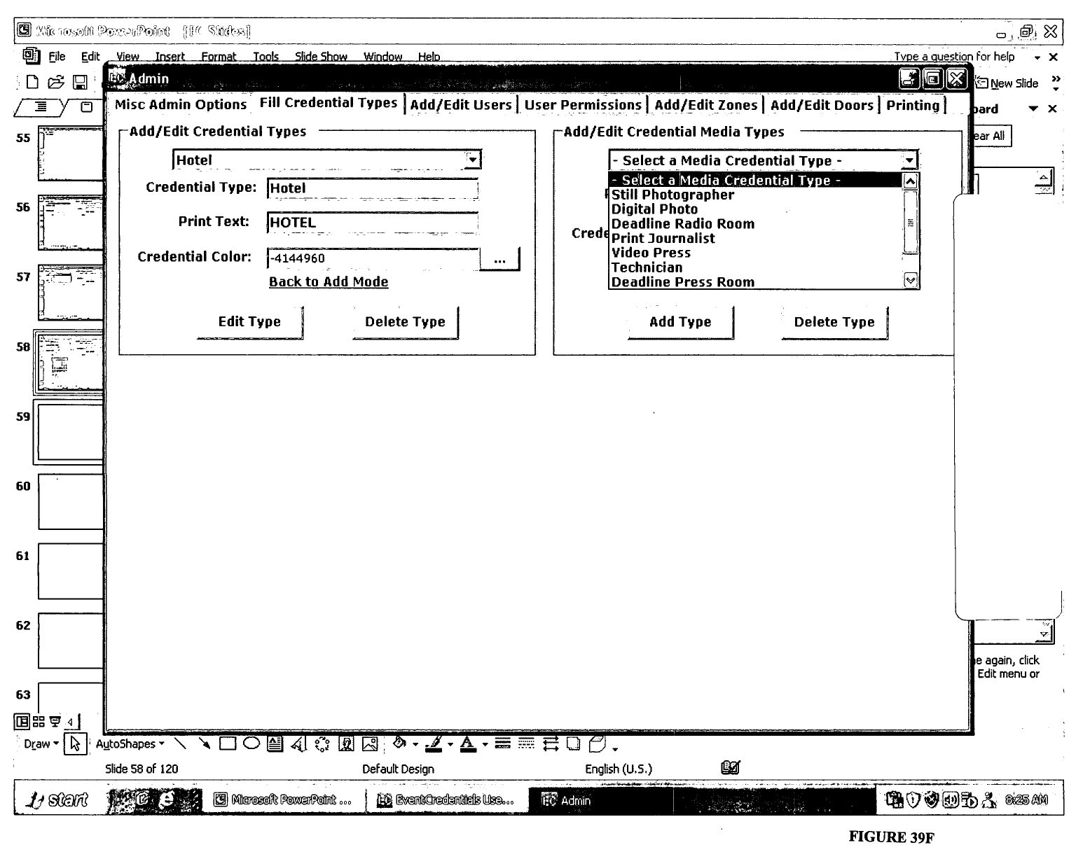

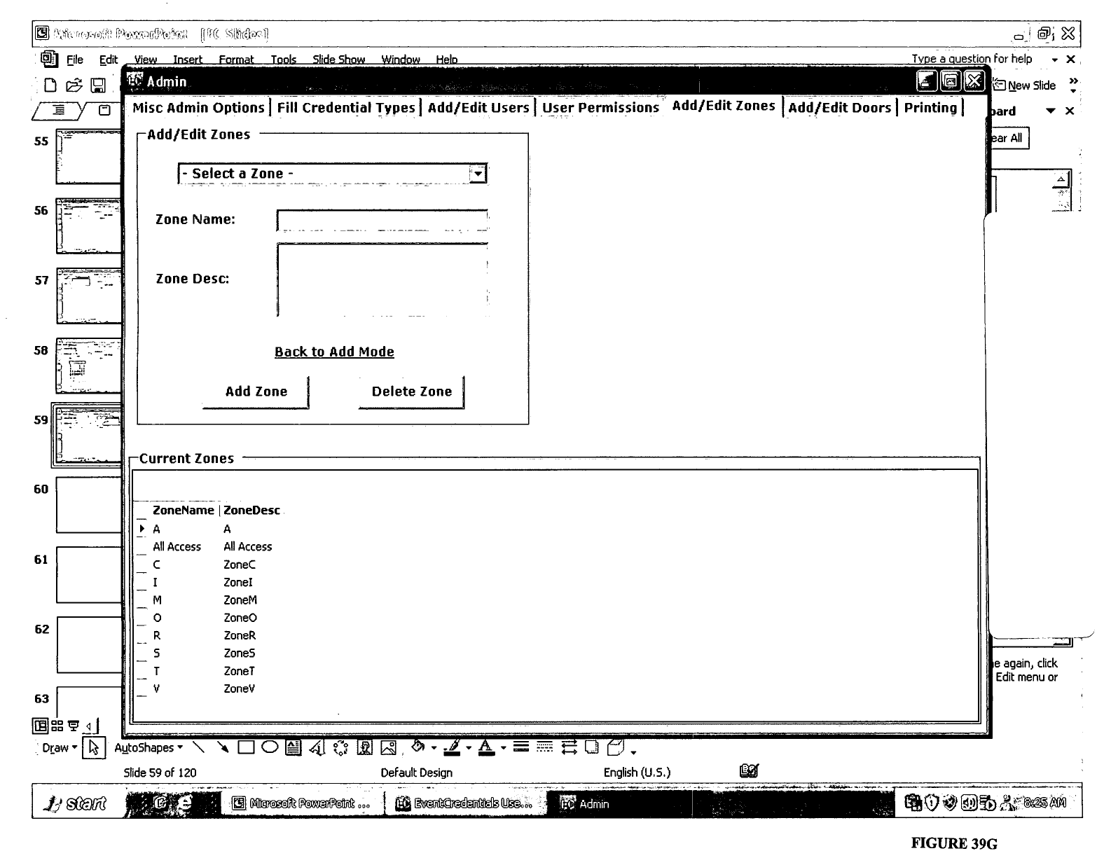

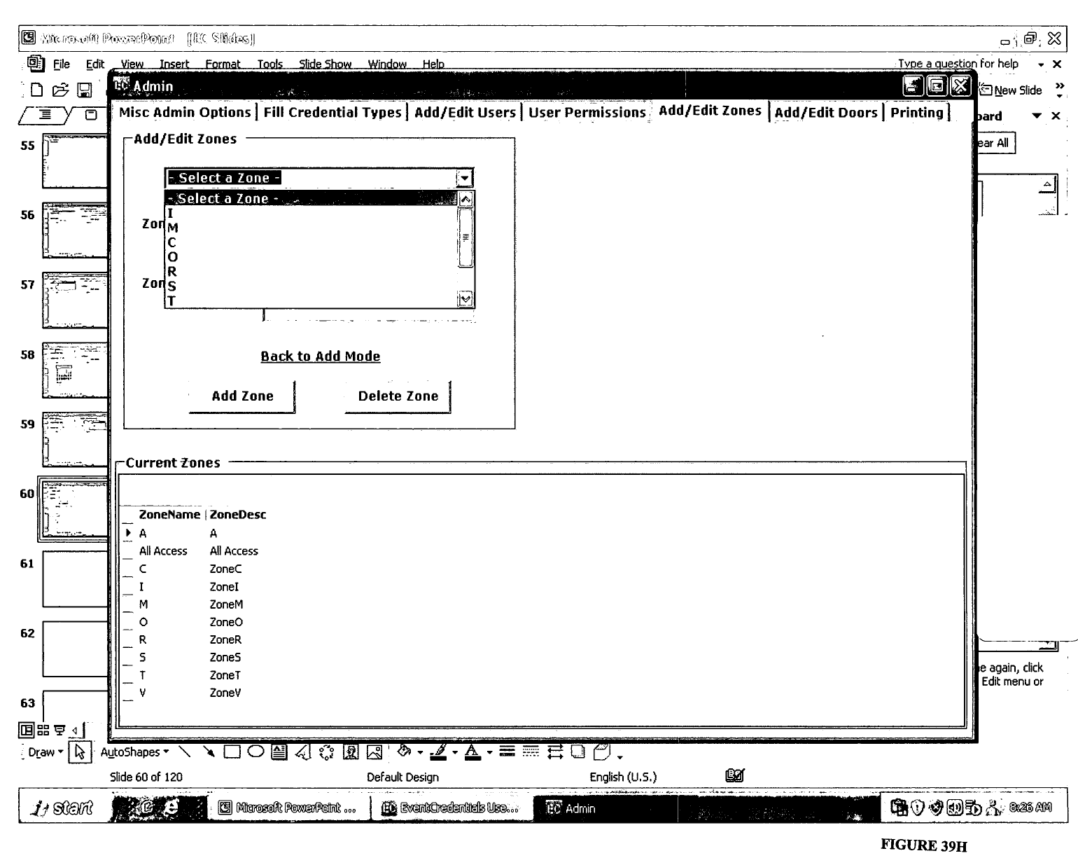

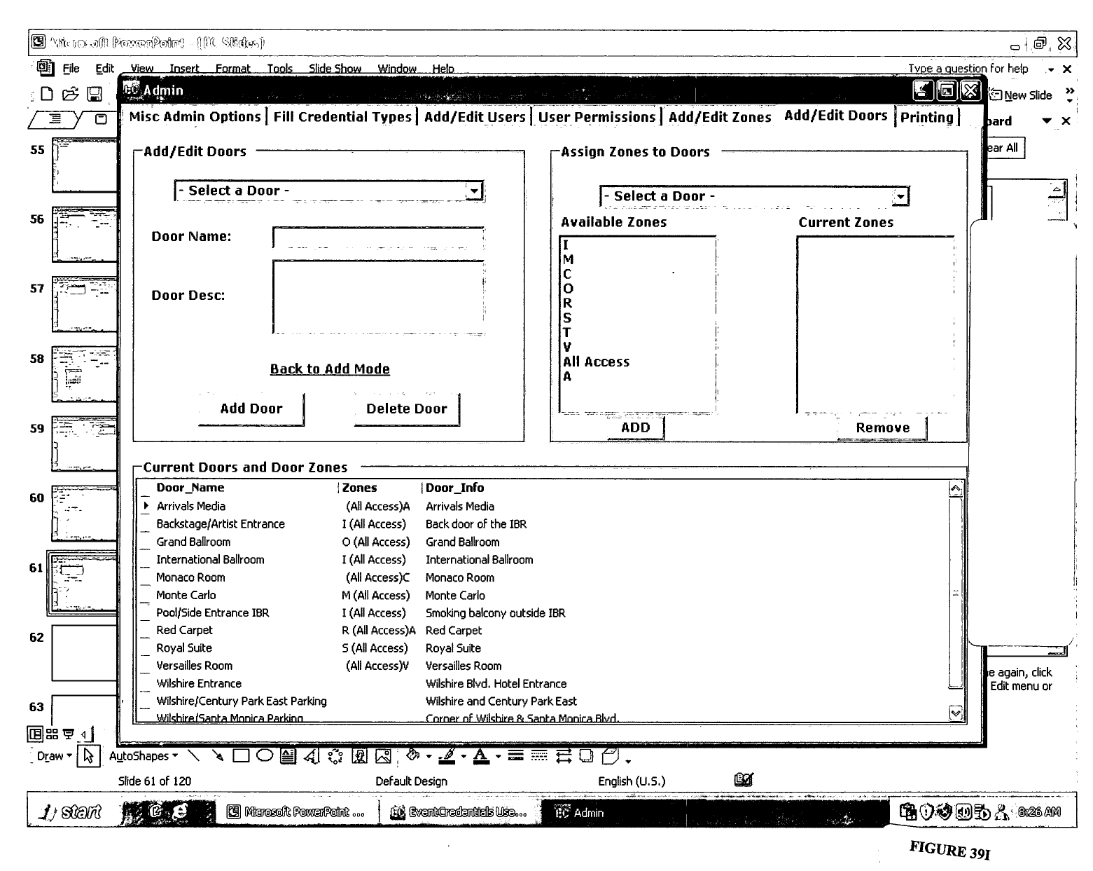

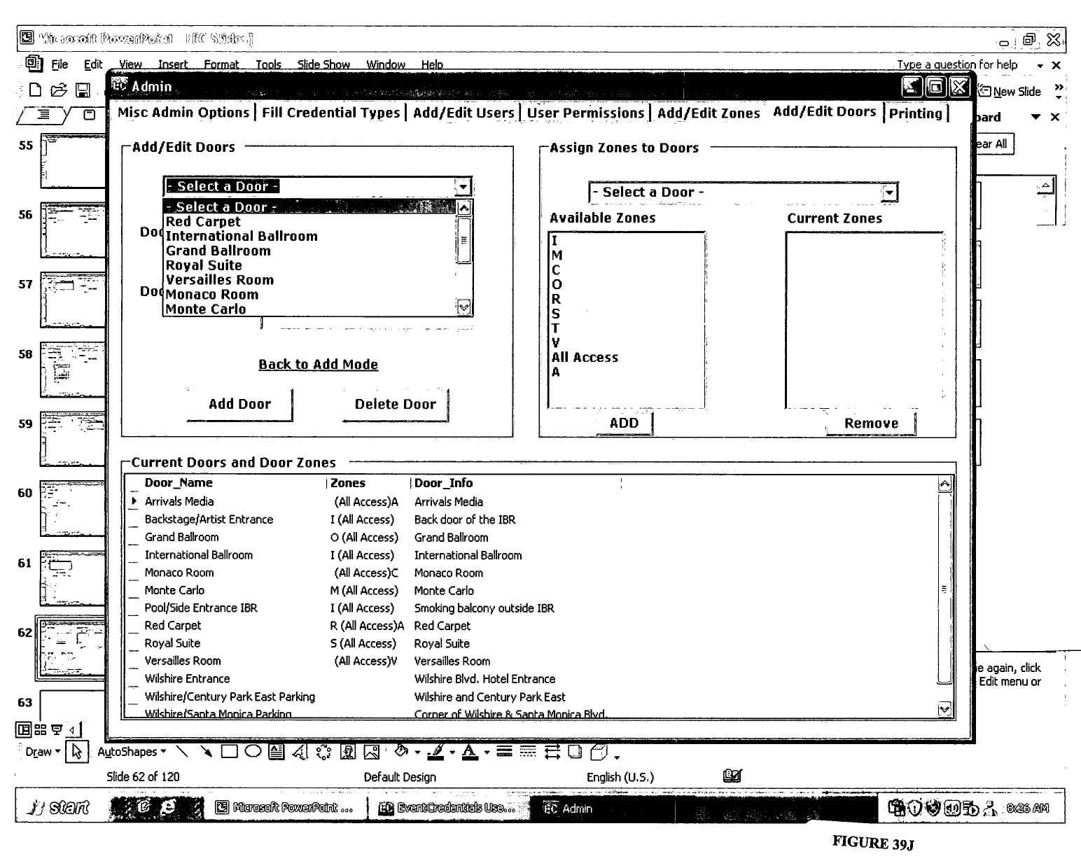

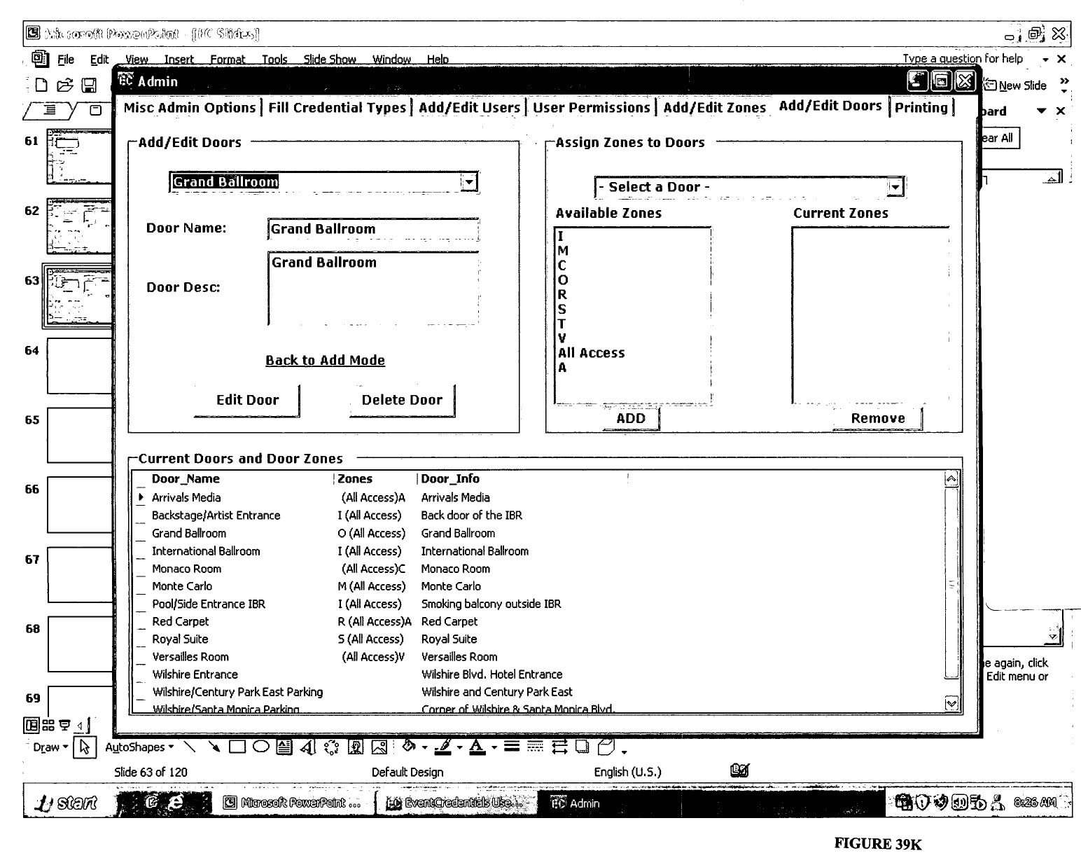

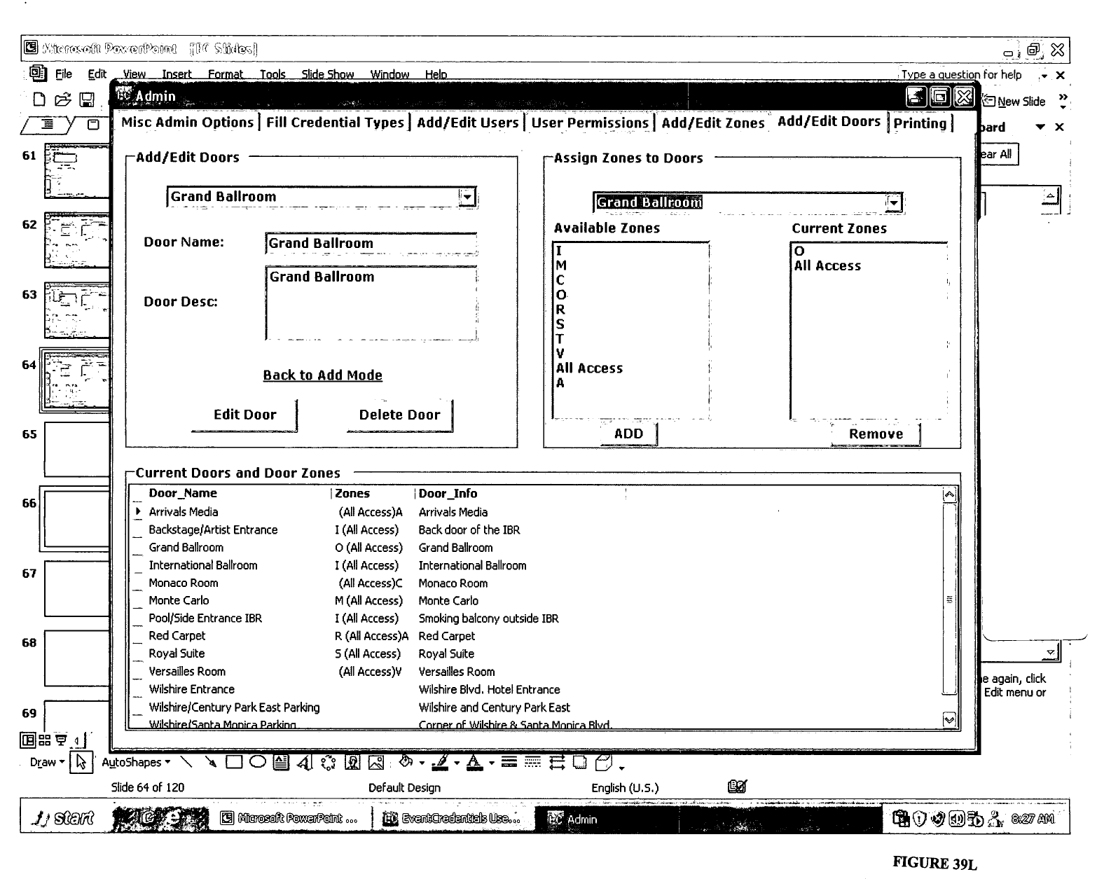

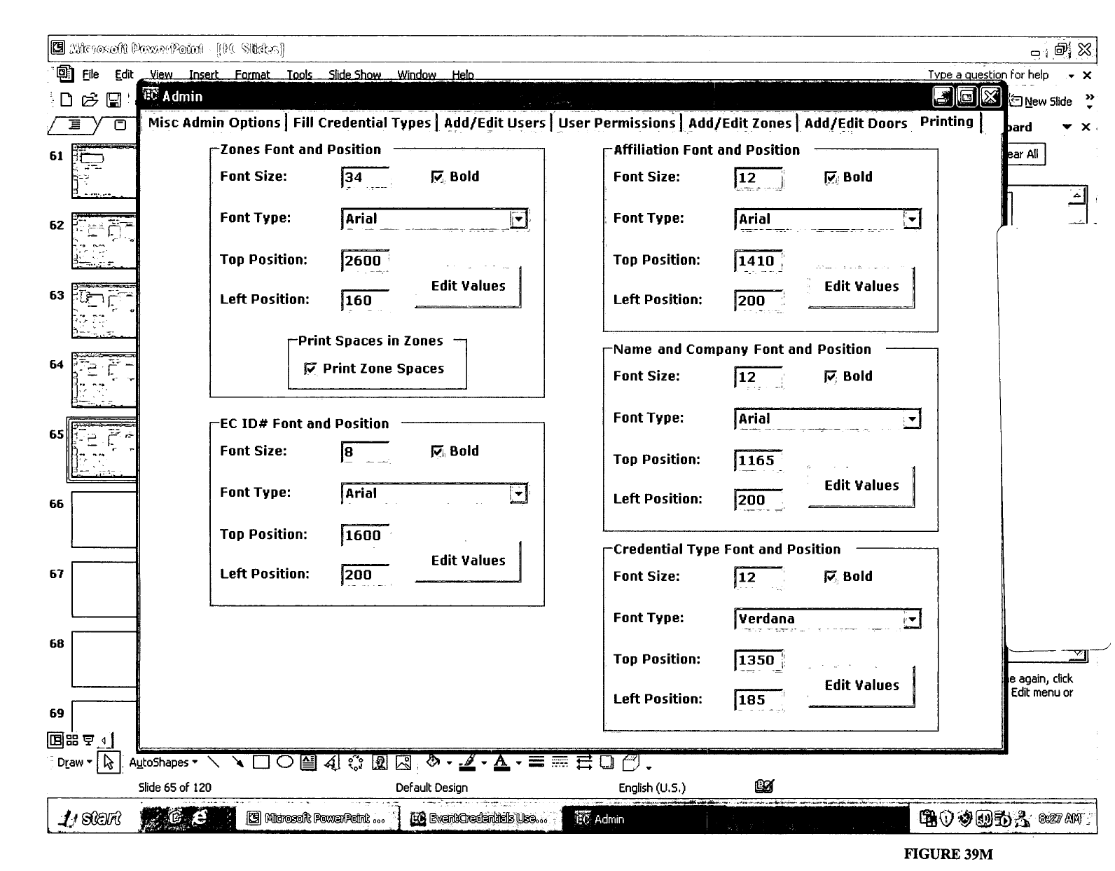

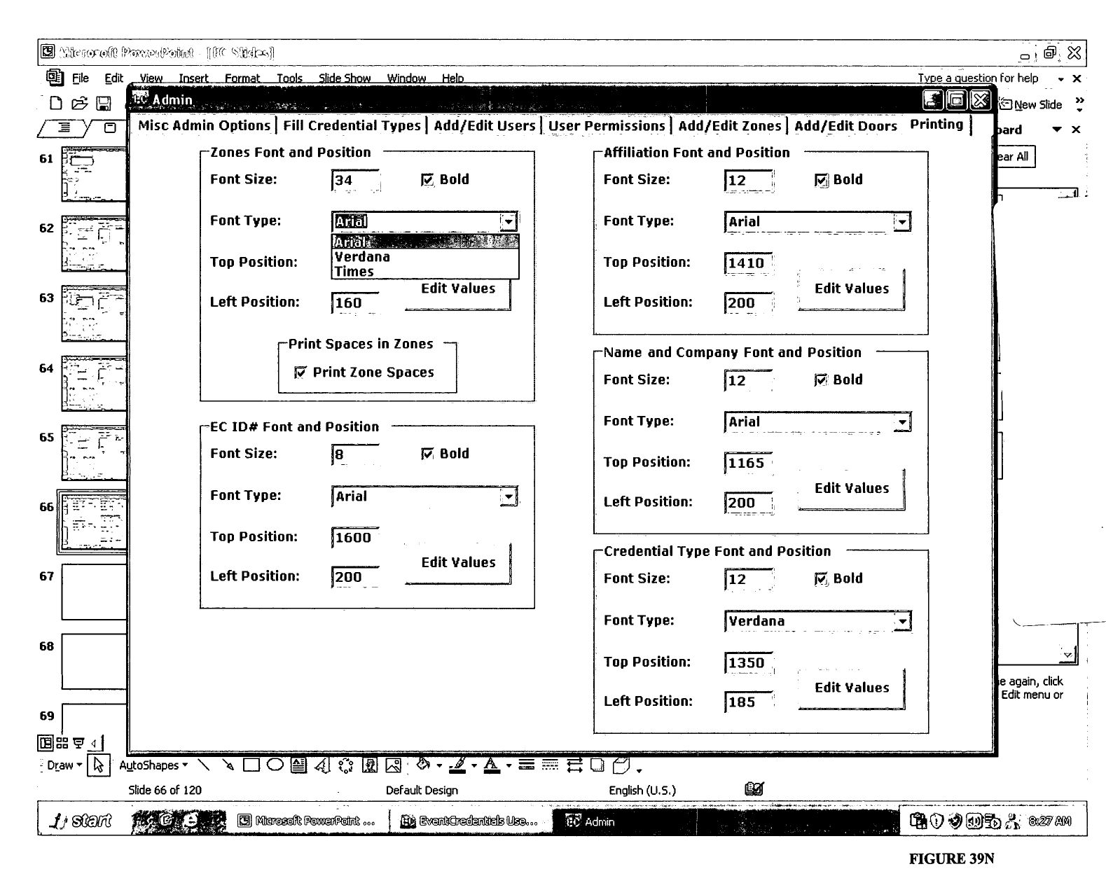

FIG. 39A-N illustrates exemplary screen shots of an embodiment that shows how the Credentialing software can be designed, and/or customized for an event in real time by the administrator.

FIG. 39A illustrates an exemplary screen shot of an embodiment that shows the Administrator Functions drop down menu located at the top left corner of the window on the main page of the software. In an embodiment, administrators that have been approved and granted rights to access the following functions can access the Admisistrator Functions drop down menu.

FIG. 39B illustrates an exemplary screen shot of an embodiment that shows Misc. Administrator Options. In the embodiment shown, this area is used for the RFID chip On/Off button. The software can be used with or without RFID enhanced security option. When the On button is marked with a check in the box or selected, the software is being used to scan the RFID embedded chip information into the software. When the check box is un-checked, the software is allowed to bypass that selection and can be used to print a credential either with a photo or without a photo. In an embodiment, credentials have, in addition to the photo, the individuals name, company name and affiliation at the event, the EC ID number that has now been assigned to the record.

FIG. 39C-E illustrates exemplary screen shots of an embodiment that shows how the software can be easily customized to fit an event by instantly changing the Credential Types which appear in the drop down windows of the main page and are assigned to credentials. Credential types include but are not limited to Media, Production, Vendor, and the like. In the text field supplied in the software, administrators can easily type the list of Credential Types they will be using at an event. The software has a built in function called “Print Text”. In an embodiment, if the administrator enters the Credential Type, the Credential Type text can be printed on the physical credential. In an embodiment, credential templateshaving a pre-printed Credential Type are used, which eliminates the need to print the credential type on the physical credential. However, in an embodiment, the credential type is used when viewing or locating an individual credential record. The function Credential Colorallows the administrator to assign in the software the color that is to be associated with each specific Credential Type. This function helps the workstation operator to easily recognize which type of credential template to use for printing many similar credentials quickly. In an embodiment, an event will associate a unique color to each of their Credential Types. For example, one credential color will be assigned to a certain group, such as production, for example, so the production crew can be easily recognized at the event.

FIG. 39F illustrates exemplary screen shots of an embodiment that shows the Add/Edit/Delete Credential Media Types function. Within the several different types of credentials being issued, there typically is a group for Media, in an embodiment. Some events require that the media type credential be defined in detail. Therefore, incorporated into the software is an area that the administrator can use to create and unlimited number of Media Credential types. As described above in the “Print Text” area for the Credential Types, there is an area for the administrator to enter the Media Credential Type, which will appear in the drop down menu on the main page as well as an area for Print Text, in an embodiment, which will cause the Media Credential Type to be printed on the physical credential.

FIG. 39G-H illustrates exemplary screen shots of an embodiment that shows the Add/Edit/Delete Zones. In an embodiment, this is where the administrator enters the Name, Letter, Number, Color and the like, so that a zone designation can be assigned for a specific area and then later printed on the physical credential or recalled by the electronic RFID scanning equipment. A grid is populated under Current Zones located below the data entry area for reviewing or modifying zones later. In an embodiment, an area has been provided to add a description of the zoned area that is designated in the software and on the physical credential.

FIG. 39l-L illustrates exemplary screen shots of an embodiment that shows the Add/Edit/Delete Doors. When using the RFID embedded computer chip credentials, in an embodiment, there is at least one door at an event that will be checked with an electronic RFID scanning unit. In the embodiment illustrated, the check points are designated as doors because they typically are the entrance to an area or doorway. The administrator assigns a door a name, and if so desired, the administrator can provide a description of that door or general area. After the administrator has added the door, the administrator will assign zone(s) that to the entrance/door. For example, a credential holder would need to have the correct zone selected in the database and on the credential in order to pass through that door/entrance. A grid is provided at the bottom of the window to review or modify the assignments.

FIG. 39M-N illustrates exemplary screen shots of an embodiment that shows the Printing function. In an embodiment, this is the area on the display that is used to plot the text, size, font styles, or colors that will be printed on the credentials. In an embodiment, any piece of information that is to be printed on the credential can be moved around on the credential by changing the coordinates in this area.

FIG. 40A-D illustrates exemplary screen shots of an embodiment that shows the View Expiration Grid. When using the Credential Software in the RFID Mode, in an embodiment, credentials can be deactivated in the event they are lost or stolen. In addition, in an embodiment, zones/access levels can be turned On/Off in real time or set on a timer to turn On/Off over the duration of an event. Years, months, hours, days, minutes and seconds, for example, can be programmed into the software to activate or de-activate data within a record associated to the embedded computer chip inside a credential. By selecting on the View Expiration Grid, a Status window opens which allows selection of a zone or multiple zones and association of a year, date, and time stamp for the credential to expire in association with the specific individual's record being accessed. It is noted, in an embodiemt, that the populating of the grid in the middle of the display shows how the records are returned and viewed in the display. In an embodiment, the column headers of the grid also function as a way to alphabetically sort the column in ascending and descending order by selecting them with the mouse, for example. In another embodiment, the column headers also be hidden using the View Grid Columns tool on the top menu bar. In a further embodiment, the Grid Columns can also be dragged to other points on the grid to change the appearance of the grid. By scrolling to the right, the user can view additional gird column headers.

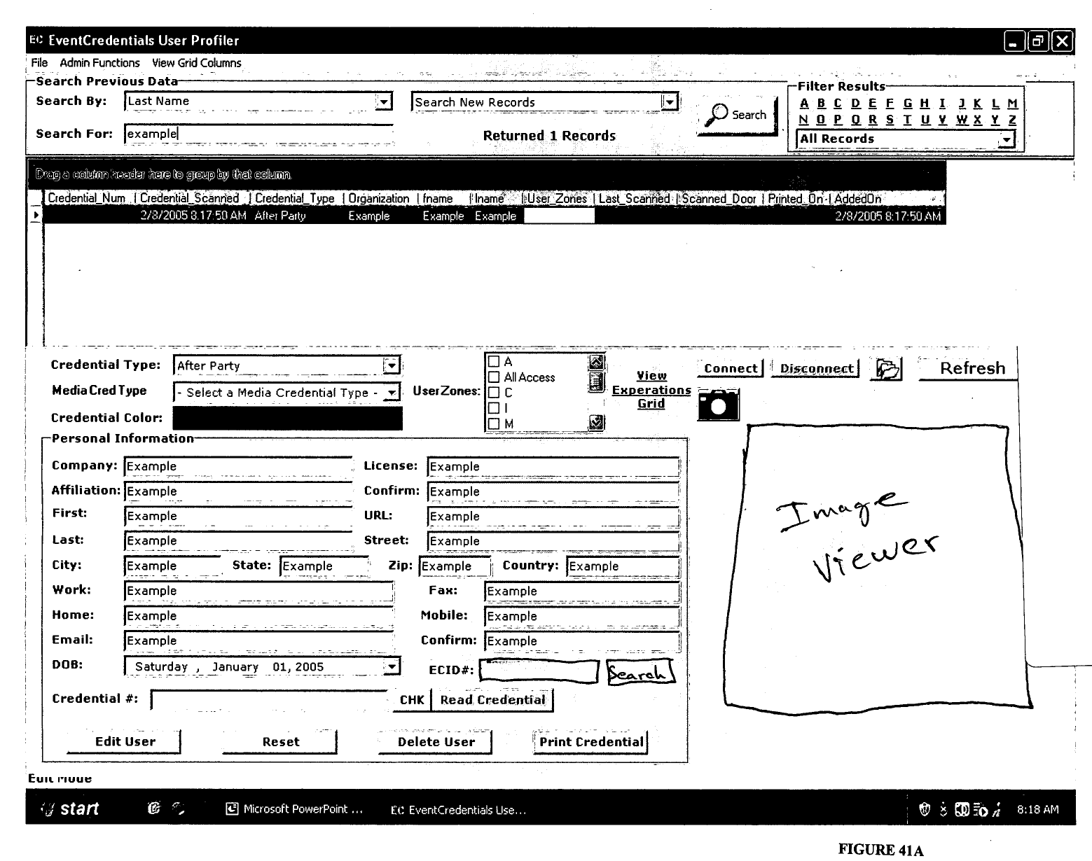

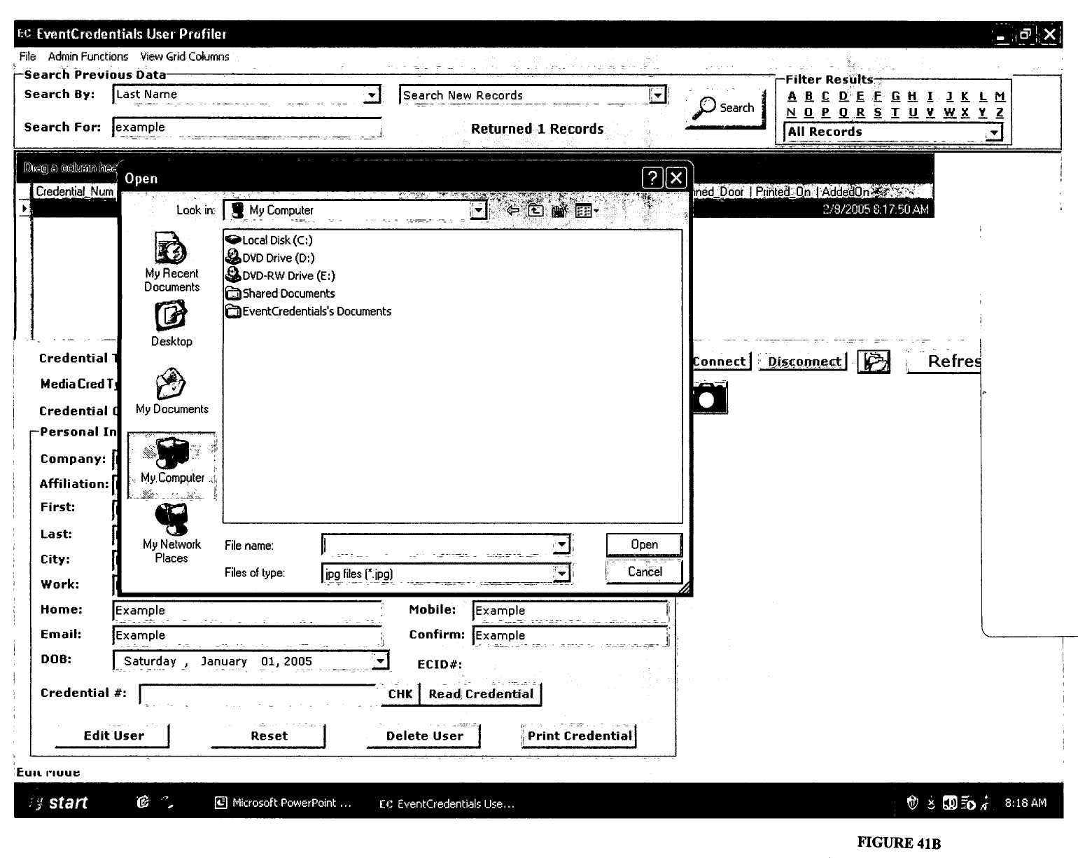

FIG. 41A-B illustrates exemplary screen shots of an embodiment that shows activation of a cameras. Once a record is located in the database, the operator, whether in workstation or administrator mode, can selectsthe Connect button, for example, above the camera icon to activate the camera. In an embodiment, the camera is connected to the computer comprising the Credentialing software. In an embodiment, in the bottom right corner of the display's window, the image appears once the camera is ready to take a photo. In an embodiment, the individual is lined up in the middle of the image viewer and then the operator selects the camera icon to actually take the photo,of the person being credentialed. The image is captured and stored in the database with their record. In an embodiment, an image can also be attached to a record by entering the “master” EC ID number into the software and searching the database. The image attached to the EC ID number is located and appears in the image viewer area and the software asks the operator to save the image to the record. In an embodiment, another way of attaching a photo is to select the folder icon located next to the Refresh button. By selecting this button, the user can search/browse any location on the computer or server used to locate any folders that have copied images to attach to records in the software. If an image is too large, in an embodiment, the software has a cropping tool that allows the user to re-size the photo while looking at it in the image viewer area and then save the re-sized image. This also attaches it to the appropriate record.

In an embodiment, if using the RFID function, the embedded computer chip credential is scanned by selecting the Read Credential button and holding the credential over an RFID scanning device electrically connected to the computer and integrated into the software. The RFID number is then attached to the record and the credential is ready for printing, once printed the credential is laminated. By selecting the CHK (check) button, the credential is verified in the database to determine that the credential is working properly and that the software recognizes the record associated with the credential.

### Physical Credentialing

Referring to FIGS. 3B and 4B, in blocks 358, 460, 462, the administrator 116, 118, 120 completes the approval process and the necessary security procedure and/or background check. In blocks 364, 464, the individual comes to a central location to be credentialed or to receive his/her physical credential.

A physical credential is an object that is usually displayed by an attendee at an event. Event personnel and/or electronic equipment monitor the physical credential to determine if the administrators 116, 118, 120 granted the attendee access to the event and, which areas of the event the administrators 116, 118, 120 granted the attendee access. Each individual physical credential has access areas associated with it. In an embodiment, the access areas are identified by, for example, numbers, letters, colors, ultra-violet ink, and the like, on the surface of the credential. In another embodiment, the access areas are identified by a programmable technology, such as, for example, a radio frequency ID chip embedded into the credential.

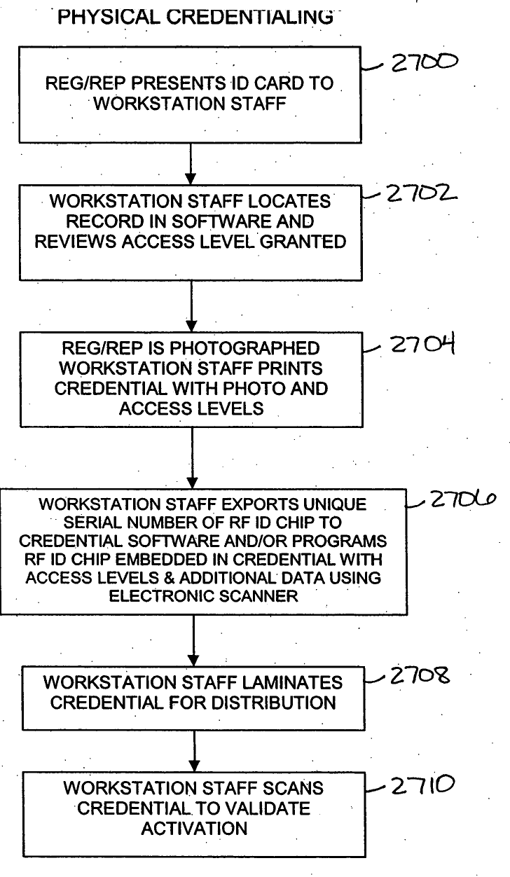

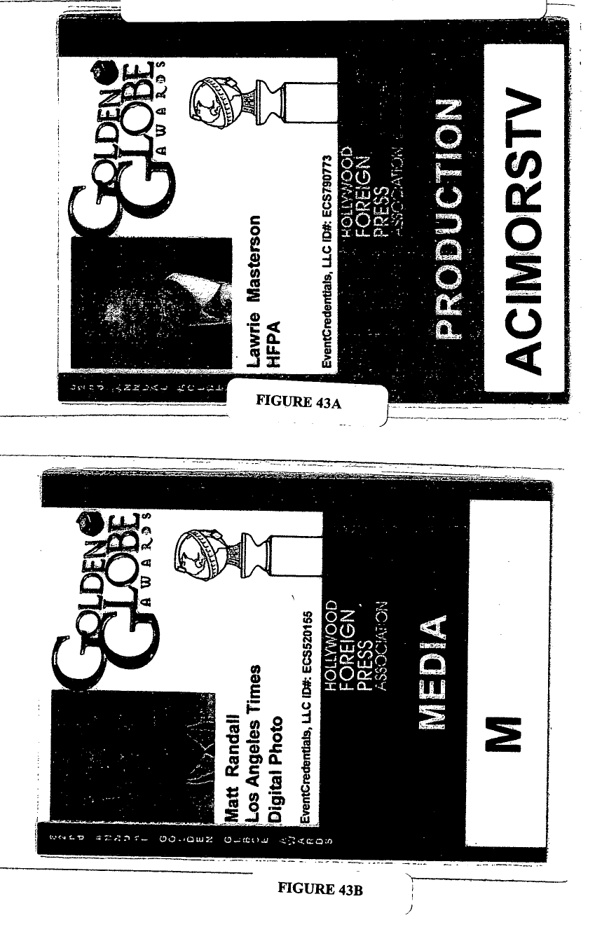

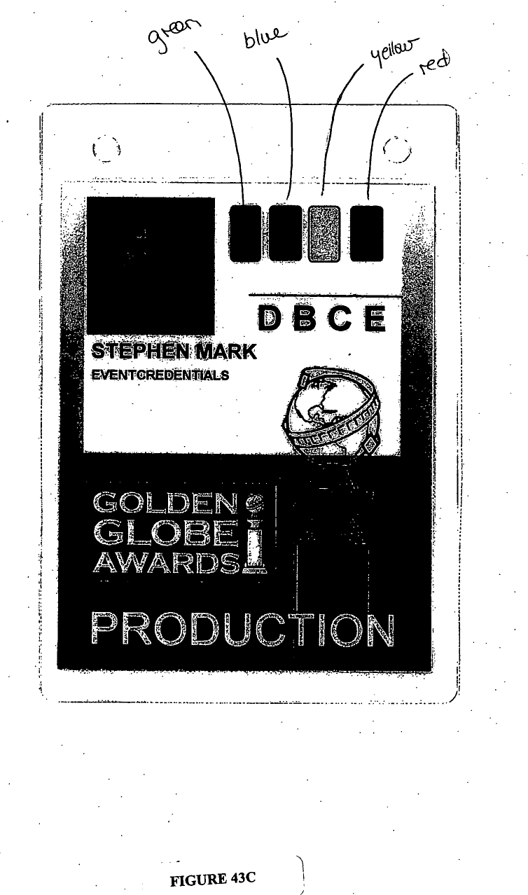

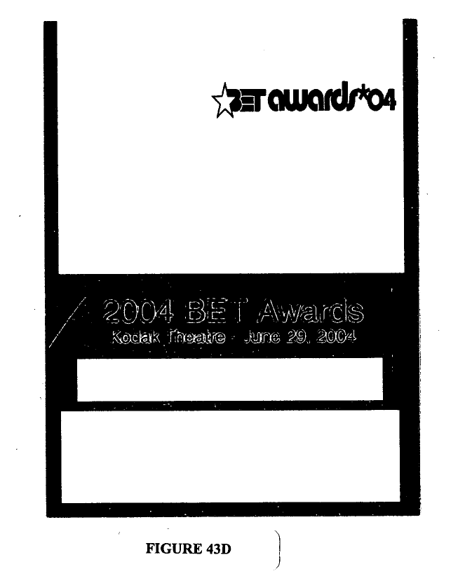

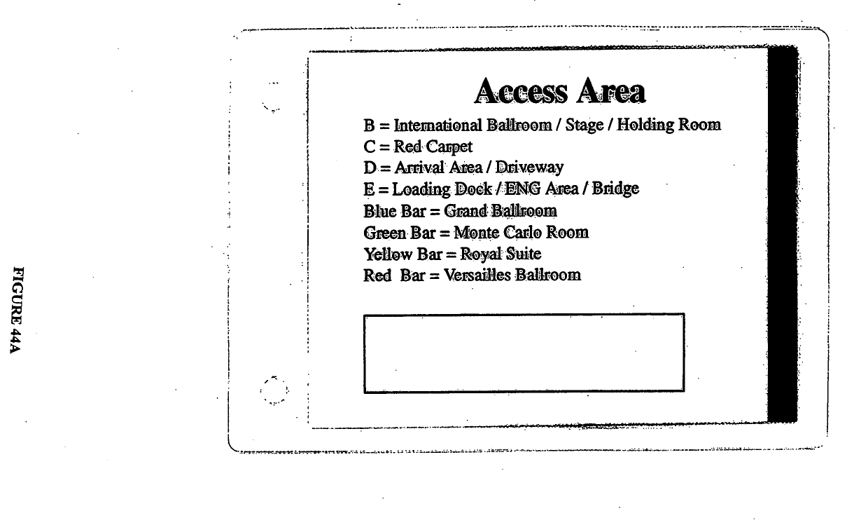

Depending on the level of security at an event, a credential can range from a simple, generic credential to a sophisticated, high tech credential. FIGS. 43A-D, 44A-B, and 46A-B illustrate embodiments of a credential. A generic credential, for example, can be a color-coded pass with the colors of the zones the wearer is allowed to access, as illustrated in FIG. 43C.

An advanced credential can have some type of technology embedded into the credential itself. For example, a photograph, a one dimensional bar code, a two dimensional bar code, a three dimensional bar code, embedded computer chips, biometrics, and the like, are all technologies that can be associated with the event management software for authenticating the access rights of a particular credential. Hardwired and handheld wireless devices positioned throughout the event authenticate the credential by receiving information from the credential and then accessing the record of the credential in the event management software. This can enhance the security required for the event, especially those events attended by high profile personalities.

The use of advanced credentials also allows the system to track and tie information together. For example, the arrival and the attendance of the registrant at an event can be recorded as it occurs. List of attendees and the access levels they entered, which can also be timed stamped, can be generated in real time or later. Administrative alerts can be auto-generated when an individual or a group of credentials is recognized by the credential scanning equipment. The administrator can be notified of an administrative alert through several different types of communication devices, such as, for example, a phone, a pager, a personal digital assistant, and the like.

FIG. 42 illustrates an embodiment of a physical credentialing process. In block 2700 approved registrants visit the credentialing office and present an identification card to the workstation operator. In block 2702 the workstation operator locates the registrant's record, confirms physical identification, and views access granted. In block 2704 the operator photographs the registrant and adds the photograph to the registrant's record. In an embodiment, the operator digitally photographs the registrant.

In another embodiment, where the physical credential comprises a radio frequency identification chip, the operator exports the unique serial number of the radio frequency identification chip to the credential software in block 2706. In an embodiment, the operator programs the radio frequency identification chip with the granted access levels. The operator may program the chip with additional data, such as, for example, the registrant's name, driver's license number, and the like.

The operator prints and laminates the registrant's badge in block 2708. In one embodiment, the badge includes the photo and/or the access levels. In another embodiment, the badge does not include the photo and/or the access levels.

In block 2710, the badge advantageously includes an embedded radio frequency identification chip that is then scanned and activated. Scanners located throughout the venue of the event read the credential to validate access to specific areas.

Referring to FIGS. 3B and 4B, in blocks 362, 466, respectively, the administrators 116, 118, 120 can change the registrant's access levels after the credential is issued. Typically, the administrators 116, 118, 120 can alter the granted access levels for credentials with an embedded programmable device.

### Scanning Software Application

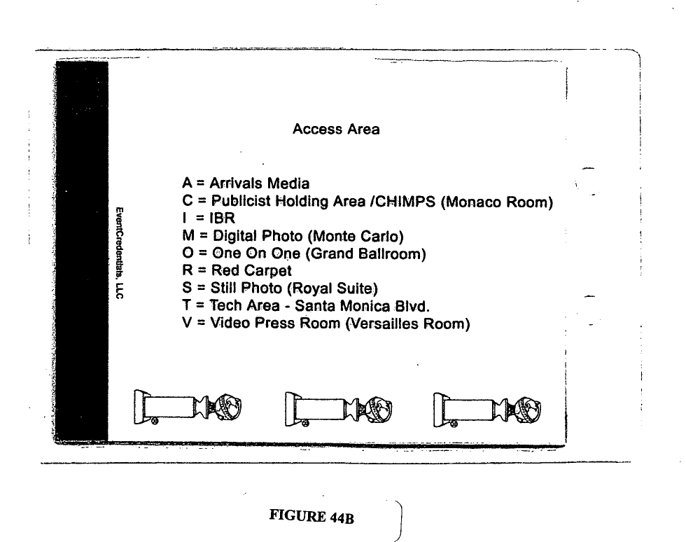

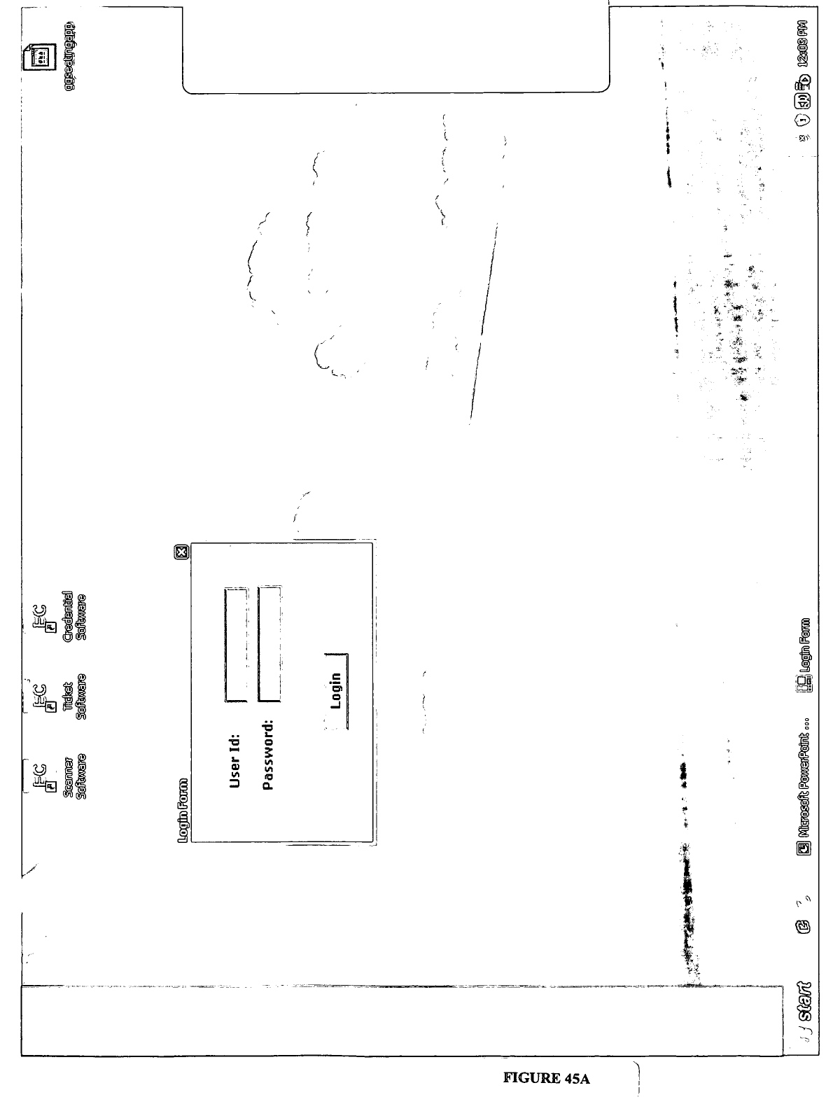

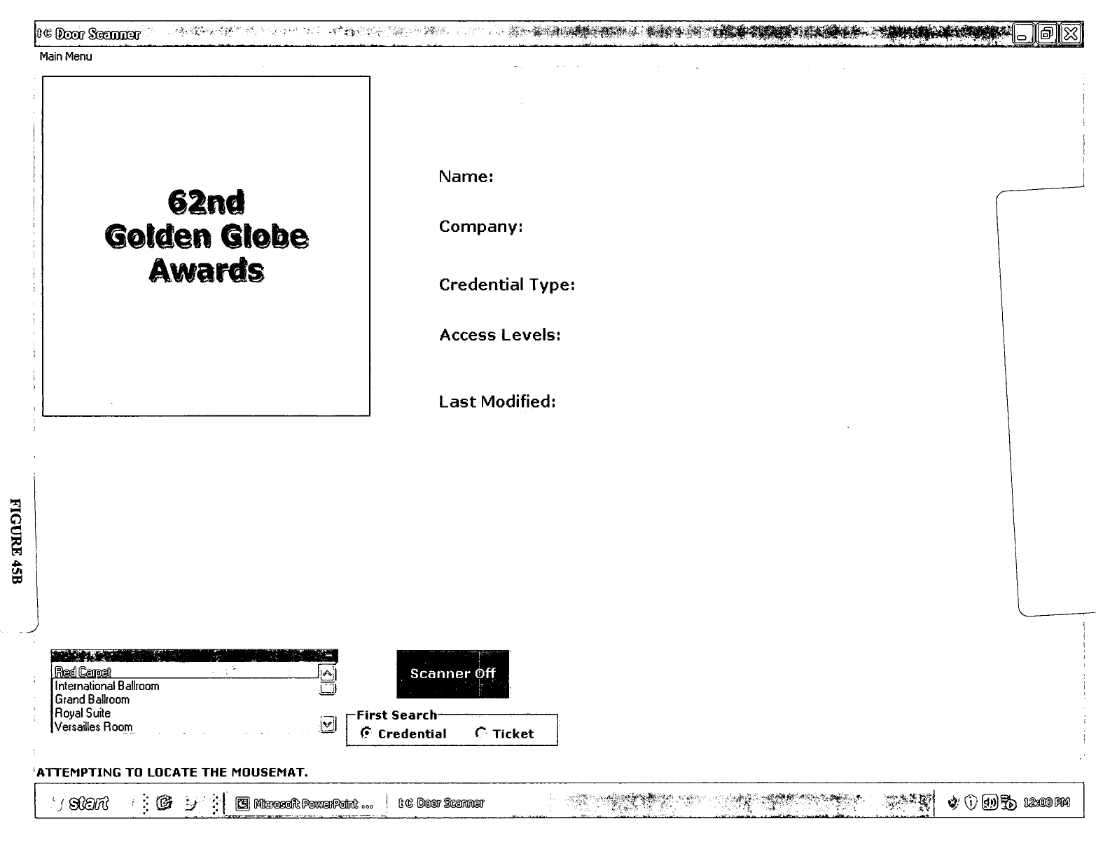

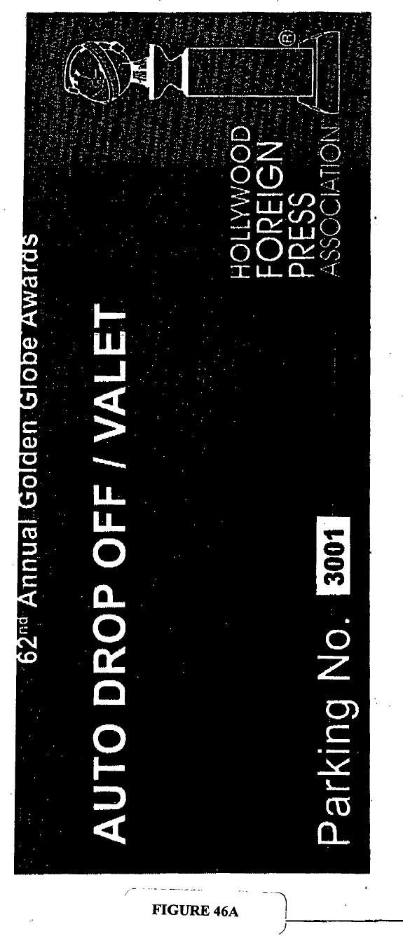

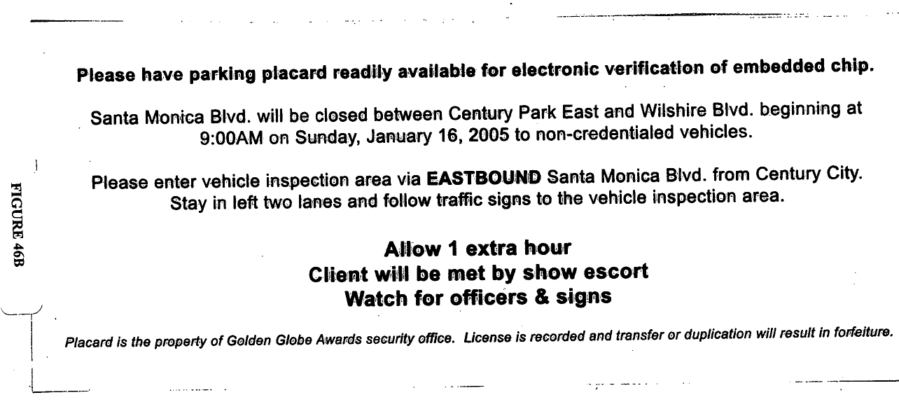

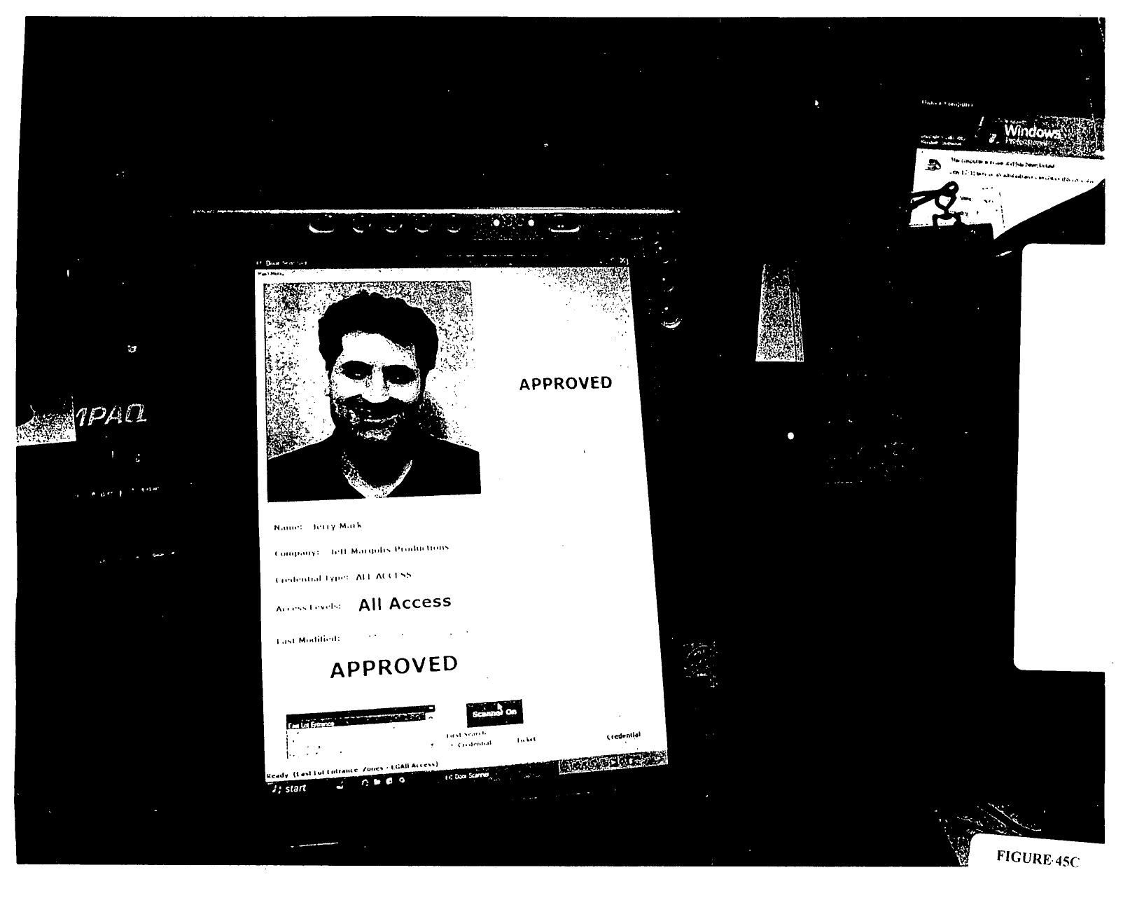

FIG. 45A-C illustrates exemplary screen shots of an embodiment of the scanning software and display screen used to read credentials and/or tickets at an event. If the unique credential/ticket created for the individual has an advanced security device in it, such as an RFID chip, bar code, other scanning mechanism, or the like, then scanning units will be deployed at entrance points to access areas at an event to verify that holder of the credential is same person who was issued the credential and that the person has been granted access to the venue and zone/access level that he is attempting to enter.

Upon scanning of the credential at entry point, in an embodiment, the administrator can program the system to recall and display on the scanner any information that has been collected on the individual and stored in the master database. The RFID chip built into the physical credential has a unique serial number. In an embodiment, the serial number is transmitted, through an intranet, internet, wireless connection, any other communication device, and the like, for example, to the server, which contains the event database. The server then recalls the individual's unique record and transmits back to the scanning unit data. In an embodiment, the data could also be programmed directly on RFID chip for later recall. Such data typically includes, but is not limited to, the photo of the individual, name, company name, title, function at event, and access levels granted throughout the event. If the individual is attempting to enter a granted access area, in an embodiment, the scanner will display a green light or green approved text to inform the operator that access for this individual to the designated area is granted/approved. If the individual is attempting to access an area that to which he does not have access, the display, in an embodiment, in addition to the information stated above, will show a red light and red denied text indicating that the individuals access to the designated area has not been granted. In addition, in an embodiment, an individual or group of individuals could have their records pre-programmed to allow access to a specific zone/access level for a certain period of time, after which the individuals access is revoked or cut-off to the specific area and would be indicated on the scanner monitor by displaying the word expired as well as a time and date stamp to inform the operator of when the expiration to the area took affect. Scanner On/Off button (color coded, green=on & red=off, in an embodiment) located on the scanner monitor display can be turned On/Off by selecting the button with a mouse, stylus, voice recognition and the like. In an embodiment, the scanner display also has a collapsible window, which lists all the doors/entry points programmed into the credential software so that the scanning unit can be moved easily through out the venue when needed. When a new door is selected from the list, in an embodiment, the software recognizes that the door has changed and will grant access to the new door based on the access levels programmed in the software, which allow access through the new door and not the previous door to which it was assigned. In an embodiment, updates to individual records and credentials can be made in real time to the database by the administrator to allow or deny an individual access to a specific door/zone/area, thus eliminating the need to re-issue a credential that is being used at an event. In an embodiment, the system can also disable a credential in the event that it is lost or stolen, thus, denying access to anyone with the disabled credential to the event altogether.

While certain embodiments of the inventions have been described, these embodiments have been presented by way of example only, and are not intended to limit the scope of the inventions. Indeed, the novel methods and systems described herein may be embodied in a variety of other forms. Voice recognition, biometric systems, cell phone, wireless communication device, and the like, may be used to implement the novel methods and systems described herein. Further, functionality associated with any embodiments can be used any or all embodiments presented herein. Furthermore, various omissions, substitutions, and changes in the form of the methods and systems described herein may be made without departing from the spirit of the inventions.

1. A method of controlling access and credentials to an event having associated physical areas and access levels, wherein event organizers limit a number of people allowed in each physical area for security purposes, safety regulations, and safety considerations, and to permit the event to run smoothly, the method comprising:
receiving a request by a registrant for one or more individuals associated with the registrant for access to an event;
presenting the registrant with the terms and conditions of the event over a network;
receiving an acceptance of the terms and conditions from the registrant over the network;
presenting the registrant with a registration form over the network after the registrant has accepted the terms and conditions of the event;
receiving a completed registration form comprising requests to access levels for the event and registration information over the network;
storing requests for the access levels and registration information in a database;
confirming receipt of the completed registration form to the registrant over the network;
receiving changes to the registration information over the network;
modifying the database to include results of an approval process based on the registration information;
notifying the registrant of the results of the approval process, wherein the results of the approval process comprise one of an approved status, a denied status, and an undecided status;
presenting the registrant having access approval with at least one credential and granted access level over a network;
receiving from the registrant background information of the individual assigned the credential over the network;
automatically decrementing a quantity of assigned credentials and access levels after the registrant assigns the credential and access level to each individual over the network; and
modifying the database to include the results of the approval process based on the background information.

2. The method of claim 1 further comprising auto-populating the registration form when the registrant presents a unique pre-assigned identification number.

3. The method of claim 1 further comprising:
sharing the database with credentialing software; and
creating a physical credential based on the shared database information.

4. The method of claim 3 wherein the physical credential comprises at least one of a name, a photograph, an access level, a zone, an RF ID computer chip, a bar code, a biometric measurement, a fingerprint, DNA, a retina scan, voice recognition device, a wireless communication device, and a color.

5. A method of controlling access and credentials to an event having associated access levels, the method comprising:
receiving a request for access to an event by a registrant for one or more individuals associated with the registrant for an event;
presenting the registrant with the terms and conditions of the event over a network;
receiving an acceptance of the terms and conditions from the registrant over the network;
presenting the registrant with a registration form over the network after the registrant has accepted the terms and conditions of the event;
receiving a completed registration form comprising requests to the access levels for an event and registration information over the network;
storing requests for the access levels and registration information in a database;
confirming receipt of the completed registration form to the registrant over the network;
modifying the database to include a status of the requests for the access levels;
notifying the registrant of access approval;
presenting the registrant having access approval with at least one credential and granted access level over a network; and
receiving from the registrant background information of the individual assigned the credential over the network.

6. The method of claim 5 further comprising automatically decrementing a quantity of assigned credentials and access levels after the registrant assigns the credential and access level to each individual over the network.

7. The method of claim 5 wherein the status comprises one of an indication of granting access to areas of the event or an indication of denying access to areas of the event.

8. The method of claim 5 further comprising associating credentials and access levels with event areas in the database.

9. The method of claim 5 further comprising receiving background information over the network and modifying, approving, or denying the status of the assigned credentials and access levels based on the background information.

10. The method of claim 5 further comprising presenting the registrant with a physical credential, the physical credential indicating access to event areas.

11. The method of claim 5 further comprising modifying the database after issuing the credential.

12. The method of claim 5 further comprising electronically cross-referencing the background information.

13. The method of claim 5 further comprising auto-populating login information of the registrant.

14. The method of claim 5 further comprising providing a login identification to the registrant.

15. The method of claim 5 wherein the registration information comprises at least one of a title, address, city, state zip code, work phone number, facsimile number, email address, company name, and company URL.

16. The method of claim 5 wherein the registrant is a representative for a company.

17. The method of claim 5 wherein said modifying the database comprises a review of the database by administrators.

18. The method of claim 5 wherein the background information comprises at least one of an individual's name, a driver's license number, and a passport number.

19. The method of claim 5 wherein the method is implemented as computer readable program code.

20. The method of claim 5 wherein the completed registration information comprises background information.

21. The method of claim 5 further comprising:
sharing the database with credentialing software; and
creating a physical credential based on the shared database information.

22. A method of controlling access and credentials to an event, wherein the event is associated with access levels, the method comprising:
receiving a request for access to an event by a registrant, wherein the registrant represents one or more individuals;
presenting the registrant with a registration form over the network after the registrant has accepted terms and conditions of the event;
receiving a completed registration form comprising requests to access levels for an event and registration information over the network;
storing requests for the access levels and registration information in a database;
modifying the database to include a status of the requests for the access levels; and
presenting the registrant having access approval with at least one credential and granted access level over a network.

23. The method of claim 22 further comprising;
presenting the registrant with the terms and conditions of the event over a network; and
receiving an acceptance of the terms and conditions from the registrant over the network.

24. The method of claim 22 further comprising confirming receipt of the completed registration form to the registrant over the network.

25. The method of claim 22 further comprising notifying the registrant of the status of the requests for the access levels.

26. The method of claim 22 further comprising receiving from the registrant background information of the individual assigned the credential over the network.

27. The method of claim 26 further comprising automatically decrementing a quantity of assigned credentials and access levels after the registrant assigns the credential and access level to each individual over the network.

28. The method of claim 26 further comprising receiving background information over the network and modifying the status of the assigned credentials and access levels based on the background information.

29. The method of claim 22 further comprising presenting the registrant with a physical credential, the physical credential indicating access to event areas.

30. The method of claim 22 wherein the method is implemented as computer readable program code.

31. An article of manufacture comprising a computer readable medium having computer readable program code embodied therein, the computer readable program code for causing a computer to execute a process of controlling access and credentials to an event having associated access levels, the article of manufacture comprising:
computer readable program code configured to receive a request by a registrant for one or more individuals associated with the registrant for access to an event;
computer readable program code configured to present the registrant with a registration form over the network after the registrant has accepted terms and conditions of the event;
computer readable program code configured to receive a completed registration form comprising requests to access levels for an event and registration information over the network;
computer readable program code configured to store requests for the access levels and registration information in a database;
computer readable program code configured to modify the database to include results of an approval process; and
computer readable program code configured to present the registrant having access approval with at least one credential and granted access level over a network.

32. An apparatus for controlling access and credentials to an event having associated access levels, comprising:
means for receiving a request by a registrant for one or more individuals associated with the registrant for access to an event;
means for presenting the registrant with a registration form over the network after the registrant has accepted terms and conditions of the event;
means for receiving a completed registration form comprising requests to access levels for an event and registration information over the network;
means for storing requests for the access levels and registration information in a database;
means for modifying the database to include a status of the requests for the access levels; and
means for presenting the registrant having access approval with at least one credential and granted access level over a network.

33. The method of claim 27 further comprising:
receiving ticket requests over the network; and
presenting acceptance of ticket requests and assigned seating over the network.

34. An apparatus for controlling access and credentials to an event having associated access levels, comprising:
a server comprising a computer processor;
a computer storage medium; and
a database stored in the computer storage medium;
the computer processor including arithmetic logic circuits performing the computer-implemented steps of
receiving a request for access to an event by a registrant for one or more individuals associated with the registrant for an event;
presenting the registrant with the terms and conditions of the event over a network;
receiving an acceptance of the terms and conditions from the registrant over the network;
presenting the registrant with a registration form over the network after the registrant has accepted the terms and conditions of the event;
receiving a completed registration form comprising requests to the access levels for an event and registration information over the network;
storing requests for the access levels and registration information in a database;
confirming receipt of the completed registration form to the registrant over the network;
modifying the database to include a status of the requests for the access levels;
notifying the registrant of access approval;
presenting the registrant having access approval with at least one credential and granted access level over a network; and
receiving from the registrant background information of the individual assigned the credential over the network.

35. In an apparatus for controlling access and credentials to an event having associated access levels, comprising the computer implemented steps of:
a. receiving a request for access to an event by a registrant, wherein the registrant represents one or more individuals;
b. presenting the registrant with a registration form over the network after the registrant has accepted terms and conditions of the event;
c. receiving a completed registration form comprising requests to access levels for an event and registration information over the network;
d. storing requests for the access levels and registration information in a database;
e. modifying the database to include a status of the requests for the access levels; and
f. presenting the registrant having access approval with at least one credential and granted access level over a network.
